(19) United States
(12) Patent Application Publication
(10) Pub. No.: US 2025/0312852 A1
(43) Pub. Date: Oct. 9, 2025

(54) SAFE TREATMENT OF DEBRIS

(71) Applicant: Velo3D, Inc., Fremont, CA (US)

(72) Inventors: Benyamin Buller, Cupertino, CA (US); Alexander John Fisher, San Jose, CA (US); Andrew John Bolton, Santa Rosa, CA (US); Alexander Vladimirovich Varlakhanov, San Carlos, CA (US); Dean Albert Tarrant, Gilroy, CA (US); Eric Hok Wang Kwan, Mountain View, CA (US); Christoph Prossegger, Santa Rosa, CA (US); Stephan Marinus Andrews, San Jose, CA (US)

(73) Assignee: Velo3D, Inc., Fremont, CA (US)

(21) Appl. No.: 18/863,320

(22) PCT Filed: May 5, 2023
(86) PCT No.: PCT/US2023/021231

§ 371 Date: Nov. 5, 2024

Related U.S. Application Data
(60) Provisional application No. 63/339,099, filed on May 6, 2022.
(60) Provisional application No. 63/464,157, filed on May 4, 2023.

(51) Int. Cl. B22F 10/73; B22F 12/70; B33Y 40/00

(52) U.S. Cl. CPC B22F 10/73; B22F 12/70; B33Y 40/00

(57) ABSTRACT

The present disclosure provides three-dimensional (3D) printing processes, apparatuses, devices, software, and systems for controlling and/or safely treating debris.

### PRIORITY APPLICATIONS

This patent application claims priority from U.S. Provisional Patent Application Ser. No. 63/339,099 filed on May 6, 2022; and from U.S. Provisional Patent Application Ser. No. 63/464,157 filed on May 4, 2023; each of which is entirely incorporated herein by reference.

### BACKGROUND

Three-dimensional (3D) printing (e.g., additive manufacturing) is a process for making a three-dimensional object of any shape from a design (e.g., 3D model). The design may be in the form of a data source such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

Three dimensional (3D) models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

The energy beam may be projected on a material bed to transform a portion of the starting material (e.g., pre-transformed material) to form the 3D object. At times, debris (e.g., metal vapor, molten metal, or plasma) may be generated in the enclosure (e.g., above the material bed). The debris may float in the enclosure atmosphere. The debris disposed in the atmosphere may alter at least one characteristic of the energy beam (e.g., its power per unit area) during its passage through the enclosure atmosphere towards the material bed. The debris may alter (e.g., damage) various components of the 3D printing system (e.g., optical window). The debris may alter (e.g., damage) the functionality of various components of the 3D printing system.

At times, during the 3D printing, various material forms become gas-borne. The material forms may compromise (e.g., fine) powder, splatter, spatter, or soot. Some of the gas-borne material may be susceptible to reaction with a reactive agent (e.g., an oxidizing agent). Some of the gas-borne material may violently react, e.g., when coming into contact with the reactive agent. At times, it may be requested to provide low leakage of the reactive agent (e.g., oxygen in the ambient atmosphere) into one or more segments of the 3D printer, e.g., a container in which the debris accumulates. At times, it may be requested to isolate the interior of one or more segments of the 3D printer from a harmful (e.g., violently reactive) level of the reactive agent (e.g., that is present in the atmosphere external to the one or more segments of the 3D printer). At times, it may be requested to preserve a less-reactive or a non-reactive (e.g., inert) atmosphere in at least one segment of the 3D printer (e.g., before, during and/or after the 3D printing). The less reactive gas may be referred to herein as “robust gas”. The less reactive gas may be referred to herein as “robust atmosphere”. In some embodiments, reactive is with the pre-transformed material and/or the debris. In some embodiments, less reactive is compared with reactivity of the gas in the ambient atmosphere external to the 3D printer.

At times, gas-borne material may collect within a filtering mechanism. The gas-borne material may violently react (e.g., ignite, flame and/or combust), when exposed to an atmosphere comprising the reactive agent (e.g., an ambient atmosphere comprising oxygen and/or water). It may be advantageous to incorporate a filter mechanism that is separated (e.g., isolated) from an external (e.g., ambient) atmosphere comprising the reactive agent. It may be advantageous to incorporate a filter mechanism that maintains a less reactive (e.g., inert) interior atmosphere around the accumulated debris, e.g., to facilitate safe disposal of the debris. It may be advantageous to facilitate an uninterrupted removal of the debris from the 3D printing system, e.g., from the filtering mechanism. The uninterrupted removal of the debris may be during operation of the 3D printing system such as during printing.

At times, the debris byproduct generated during 3D printing (e.g., gas-borne material such as soot splatter, or other particulate material) accumulates in a filtering container that is integrated in the gas conveyance system of the 3D printer, e.g., during printing. For example, the debris byproduct generated during 3D printing may accumulate on a filter disposed in a filtering container. For example, the debris byproduct may accumulate in the filtering container. The filtering container may be an integral container that is integrated in the gas flow mechanism of the 3D printing system (e.g., integrated with the channel(s) of the gas flow mechanism). The bulk of the gas may flow through the processing chamber, through the channels of the gas flow mechanism, and through the filtering mechanism. At times, the gas mainly flows through the filtering container, and may (i) diffuse to, or (ii) minorly flow to, the collection container. The debris may require passivation before being discarded (e.g., to a landfill) without posing risk to personnel and/or equipment. Removing the container in which the debris accumulates (e.g., during printing) may disrupt the 3D printing process, such as when the container is integrated in the main gas flow path. Removal of the filtering container from the 3D printing system (e.g., from the gas conveyance system thereof) can be laborious and/or time consuming. The filter may be expensive, e.g., if they require frequent replacement such as when they become clogged with debris. The filtering container can be expensive (e.g., as it may contain sensor(s), filter(s), and/or specialized valve(s)). To reduce cost, the filtering container and/or filter(s) may be cleaned and refurbished for subsequent use (e.g., in another printing cycle), e.g., after passivation and/or removal of the debris from the filtering container.

### SUMMARY

In some aspects, the present disclosure resolves the aforementioned hardships. For example, the present disclosure delineates safe treatment of debris exhaust from filter, e.g., of a 3D printing system. For example, by reversibly coupling and uncoupling a distal container with the filtering container, e.g., during and/or after the filtering operation taking place in the filtering container. Such coupling may use a physical adapter operatively (e.g., physically connected) to the filtering container. The physical adapter may couple (e.g., connect) the filtering container with a distal container through a channel (e.g., a divisible channel such as a channel that can be bifurcated). The distal container (1) may be configured to accommodate the debris, (2) may be configured to facilitate ingress of a passivator to passivate the debris, (3) may be cheaper than the filtering container, (4) can be discarded (e.g., to a landfill) without risk of harm to personnel, (5) is configured to facilitate maintaining an atmosphere similar to the one in the gas flow system (e.g., by facilitating ingress of a robust gas such as an inert gas), (6) can release any pressure buildup, or (7) may include any combination of (1) to (6). The physical adapter (a) may be configured to connect the filtering container with the distal container, (b) may be configured to be reversibly separable into two components to disconnect the filtering container from the distal container (e.g., during printing), (c) may be configured to facilitate flow of debris from the filtering container to the distal container (e.g., during printing), (d) configured to couple to sensor(s) (e.g., oxygen sensor and/or pressure sensor), (e) may comprise one or more valves (e.g., automatic and/or manual) configured to adjust flow of debris through the adapter, (f) may comprise one or more vents, or (g) may include any combination of (a) to (f). The physical adapter may facilitate (I) continuous printing and/or (II) continuous separation of debris such as gas-borne material from the recirculating gas in at least one or more segments of the 3D printer during the 3D printing. The present application describes ways of meeting at least some of these desires and/or requests. The pressure sensor may be manual, e.g., having a moving handle. The pressure sensor may be digital.

In another aspect, a device for filtering debris generated by three-dimensional printing, the device comprises: a distal container configured accommodate the debris filtered at a filtering container, the distal container being configured to reversibly engage and disengage with the filtering container during the filtering of the debris at the filtering container, the device being configured to facilitate a flow of the debris from the filtering container to the distal container, and (i) the device being configured to enclose an internal atmosphere having at least one characteristic different from an ambient atmosphere external to the device, (ii) the device being configured to operatively couple with, or be a portion of, a three-dimensional printing system configured for the three dimensional printing, and/or (iii) the debris being a byproduct of the three-dimensional printing. In some embodiments, the device further comprises a channel having a proximal end and an opposing distal end, the proximal end of the channel being configured to couple with the filtering container, and the distal end of the channel being configured to couple with the distal container. In some embodiments, the channel comprises a hose or a tube. In some embodiments, the channel is of a material comprising a polymer, a resin, an elemental metal, or a metal alloy. In some embodiments, the channel comprises a first type of material exposed to the ambient environment, and a second type of material exposed to the interior space of the channel. In some embodiments, the second type of material is more robust and/or less abrasive, as compared to the first type of material. In some embodiments, the second type of material is more robust and/or less abrasive, as compared to the first type of material with respect to a flow of the debris and any dilutive media during operation. In some embodiments, the second type of material comprises a coating disposed on the first type of material. In some embodiments, the second type of material comprises an anodized material, or chromium. The channel may comprise at least two material types. An internal surface of the channel may be more resistant to abrasion as compared to an external surface of the channel. The internal surface of the channel may comprise chromium or an anodized material. The internal surface of the channel may comprise a coating. In an example, the internal surface of the channel comprises elemental metal, and the external surface of the channel comprises a polymer or a resin. In some embodiments, the channel comprises at least one flexible section. In some embodiments, the channel is flexible. In some embodiments, the channel being configured for reversible engagement and disengagement with the filtering container. In some embodiments, the channel comprises, or is operatively coupled with, one or more vents. In some embodiments, the distal end is configured to reversibly engage and disengage with the distal container. In some embodiments, the distal end is configured to reversibly engage and disengage with the distal container (i) during the filtering of the debris at the filtering container and/or (ii) after the filtering of the debris at the filtering container. In some embodiments, the proximal end is configured to reversibly engage and disengage with the filtering container. In some embodiments, the proximal end is configured to reversibly engage and disengage with the filtering container during the filtering of the debris at the filtering container. In some embodiments, the debris is prone to harmfully react with one or more reactive agents present in the ambient atmosphere, when the debris is exposed to the ambient atmosphere without further treatment comprising passivation or insulation. In some embodiments, the debris exits the filtering container without the further treatment. In some embodiments, the debris accumulates in the filtering container without the further treatment. In some embodiments, the distal container is configured for closure by a lid configured to facilitate ingress of a quelling material facilitating the further treatment, the quelling material comprising a passivating material or an insulating material; and optionally where the passivating material is the insulating material. In some embodiments, the passivating material comprises water. In some embodiments, the insulating material comprises oil. In some embodiments, the internal atmosphere (A) comprises at least one reactive agent at a concentration that is lower than that in the ambient atmosphere and/or (B) is at a pressure above ambient pressure of the ambient atmosphere. In some embodiments, the device further comprises a proximal valve operatively coupled with the filtering container. In some embodiments, the device further comprises one or more sensors configured to measure the at least one characteristic of the internal atmosphere. In some embodiments, the device comprises a channel disposed between the filtering container and the distal container, and where the device further comprises a distal valve configured to couple to the channel at its distal end. In some embodiments, the distal container incudes a lid and a body, In some embodiments, the lid of the distal container is configured to couple to a distal valve, and the body of the distal container is configured to engage with the lid to form a closed distal container. In some embodiments, the body is configured to engage with the lid in a gas tight manner to form the closed distal container. In some embodiments, the closed distal container is configured to reversibly engage and disengage with a channel disposed between the filtering container and the distal container. In some embodiments, the device comprises a channel disposed between the filtering container and the distal container. In some embodiments, the channel comprises a flexible material or a rigid material. In some embodiments, the channel comprises a transparent material or an opaque material. In some embodiments, the channel is a bifurcated channel. In some embodiments, the channel is a single channel. In some embodiments, the filtering container is operatively coupled with, or includes, a collection container configured to collect and/or funnel the debris through the proximal valve. In some embodiments, the collection container is a hopper. In some embodiments, the collection container is configured to collect debris from a filter, from a centrifuge, or from a cyclonic separator. In some embodiments, the filtering container comprises a filter, a centrifuge, or a cyclonic separator. In some embodiments, the filtering container is integrated in a gas flow mechanism. In some embodiments, the gas flow mechanism is included in the three-dimensional printing system configured to print one or more three-dimensional objects in a printing cycle. In some embodiments, the debris comprises a byproduct of the three-dimensional printing. In some embodiments, the byproduct comprises splatter, spatter, or soot. In some embodiments, the debris comprises a starting material of the three-dimensional printing process. In some embodiments, the staring material comprises powder. In some embodiments, the starting material comprises elemental metal, metal alloy, an allotrope of elemental carbon, or ceramic. In some embodiments, the debris comprises elemental metal, metal alloy, an allotrope of elemental carbon, or ceramic. In some embodiments, the one or more sensors comprise a pressure sensor or a sensor configured to sense a reactive agent. In some embodiments, the reactive agent comprises an oxidizing agent. In some embodiments, the reactive agent comprises humidity or oxygen. In some embodiments, the reactive agent is configured to react with a starting material of the three-dimensional printing and/or with a printed three-dimensional object. In some embodiments, the device comprises (a) a proximal valve configured to couple to the filtering container and (b) a distal valve configured to couple to the distal container. In some embodiments, the proximal valve and/or the distal valve, is at least in part automatically controlled. In some embodiments, the proximal valve and/or the distal valve, are at least in part manually controlled. In some embodiments, the proximal valve is automatically controlled, and the distal valve is at least in part manually controlled. In some embodiments, the proximal valve and/or the distal valve are at least in part wirelessly controlled. In some embodiments, the proximal valve and/or the distal valve are at least in part controlled via wire communication. In some embodiments, at least one automatically controllable component of the device is configured to operatively coupling to a control system. In some embodiments, the at least one automatically controllable component comprises a valve, a port, a vent, or a sensor. In some embodiments, the control system utilizes at least one control scheme comprising feedback, feed forward, closed loop, or open loop. In some embodiments, the control system utilizes a control scheme based at least in part on data from the one or more sensors. In some embodiments, the control system is a hierarchical control system having three or more hierarchical control levels. In some embodiments, the device is part of the three-dimensional printing system, and where the control system is configured to control at least one other device in the three-dimensional printing system. In some embodiments, the at least one other device comprises an energy source, an energy beam, a scanner, a layer dispensing mechanism, a gas flow, a pump, a valve, an actuator, an elevator, a piston, a temperature conditioner, a door, or a window. In some embodiments, the control system is of the three-dimensional printing system. In some embodiments, the three-dimensional printing system is configured to print one or more three-dimensional objects in a printing cycle, and where the one or more three-dimensional objects (e.g., and the debris) comprise an elemental metal, a metal alloy, a ceramic, a polymer, a resin, or an allotrope of elemental carbon. In some embodiments, the one or more characteristics of the internal atmosphere comprises temperature, pressure, gas flow direction, gas flow velocity, gas flow acceleration, gas makeup, level (e.g., relative level such as percentage) of reactive agent, or level (e.g., relative level such as percentage) of the debris. In some embodiments, the distal container includes a lid that comprises (a) gas inlet port, (b) gas outlet port, (c) one or more vents, (d) at least one inlet port for a quelling material, or (e) at least one outlet port for the quelling material and any quelling reaction product; wherein, the quelling material comprises (i) a passivating material or (ii) an insulating material; wherein the passivating material is configured to passivate the debris from reacting with a reactive agent present in the ambient atmosphere; and wherein the insulating material is configured to insulate the debris at least in part from contacting a reactive agent present in the ambient atmosphere. In some embodiments, the passivator comprises an oxidizing agent. In some embodiments, the oxidizing agent comprises water. In some embodiments, the insulating agent comprises oil. In some embodiments, the at least one outlet port is operatively coupled with an overfill prevention pipe, the at least one outlet port being for a quelling material comprising (i) a passivator or (ii) an insulator. In some embodiments, the overfill prevention pipe is configured to (i) increase a probability of retaining in the distal container gas above the debris and any dilutive media when the distal container is closed with a lid, and (ii) reduce a probability of overfilling the distal with the quelling material, the distal container being closed with the lid; and optionally where the passivator is the insulator. In some embodiments, the distal container includes a lid configured to engage with a body of the distal container to close the body. In some embodiments, engagement of the lid with the body is in a gas tight manner at least in part by using a fastener comprising a seal, a clamp, or a retention strap. In some embodiments, engagement of the lid with the body is in a gas tight manner at least in part by using a fastener comprising a seal, a clamp, or a retention strap. In some embodiments, engagement of the lid with the body is in a gas tight manner at least in part by using a solid to solid contact, or a compressible seal. In some embodiments, the lid is fastened to the body by one or more fasteners comprising a strap, a clamp, a lock, a lever, or a ring. In some embodiments, the distal container is configured to engage with a maneuvering device for maneuvering the distal container relative to the filtering container. In some embodiments, the maneuvering device comprises a vehicle or an aircraft. In some embodiments, the maneuvering device comprises a forklift, a cart, or a drone. In some embodiments, the maneuvering device comprises a robot. In some embodiments, the maneuvering device configured for automatic maneuvering and/or autonomous maneuvering. In some embodiments, the maneuvering device configured for remote operation. In some embodiments, the distal container is configured to operatively couple to at least one sensor indicative of (i) an amount of debris accumulating in the distal container and/or (ii) status of accumulation of material in the distal container, the material comprising the debris. In some embodiments, the at least one sensor comprises a sensor configured for material level detection. In some embodiments, the at least one sensor comprises an optical sensor. In some embodiments, the at least one sensor comprises a weight sensor, a material flow sensor, a proximity sensor, or a guided wave radar (GWR) system. In some embodiments, the distal container is configured to operatively couple to at least one sensor indicating that a free volume in the distal container has diminished below a threshold. In some embodiments, the distal container is configured to operatively couple to at least one sensor indicating (i) the free volume in the distal container, and/or (ii) the amount of material in the distal container, which material in the distal container comprises the debris. In some embodiments, the distal container is configured to operatively couple to at least one sensor indicating that the amount of material in the distal container reached a threshold, which material in the distal container comprises the debris. In some embodiments, the distal container is configured to operatively couple to at least one weight sensor. In some embodiments, the distal container is configured to operatively couple to at least one weight sensor configured to indicate the amount of material in the distal container, which material in the distal container comprises the debris. In some embodiments, the at least one weight sensor comprises at least one load cell. In some embodiments, the at least one weight sensor is disposed between a mounting plate and a top plate, the top plate being configured to support the distal container. In some embodiments, the top plate comprises supports configured to hinder lateral movement of the distal container. In some embodiments, the at least one load cell is configured to operatively couple with one or more controllers configured to control flow of the debris and any dilutive media into the distal container. In some embodiments, the device is configured to enclose the internal atmosphere having at least one characteristic different from the ambient atmosphere external to the device. In some embodiments, the filtering container is configured to filter the debris by using (a) at least one filter disposed in the filtering container, (b) dilutive media disposed in the filtering container, and (c) gas flow in a first direction towards the filter during the filtering of the debris. In some embodiments, the filtering container is configured to facilitate contact between the dilutive media and the filter during filtering to promote separation of the filter from the debris during filtering of the debris. In some embodiments, the filtering container is configured to facilitate contact between the dilutive media and the filter at least in part by configuring to flow the gas flow in the first direction during filtering. In some embodiments, the filtering container is configured to facilitate release of (i) the dilutive media and/or (ii) the debris, from the filter at least in part by being configured to flow the gas flow in a second direction that comprises a directional component opposing the first direction. In some embodiments, the filtering container is configured to facilitate release from the filter of the debris accumulating on the dilutive media during the filtering, at least in part by being configured to flow the gas flow in the second direction. In some embodiments, the device is configured to receive the debris and any dilutive media after its release from the filter. In some embodiments, the device is configured to receive the debris and any dilutive media after its release from the filter, the debris and any dilutive media transitioning into the device at least in part using gravitational force towards the gravitational center of the ambient environment external to the device. In some embodiments, the dilutive media comprises particulate matter. In some embodiments, the dilutive media comprises particulate matter having a first material type different from a second material type of material of the dilutive media. In some embodiments, the dilutive media comprises ceramic, elemental metal, metal alloy, glass, stone, polymer, or resin. In some embodiments, flowing the gas in the second direction comprises continuous flow or pulsed flow. In some embodiments, the device is configured for transmitting and/or accumulating: (i) the debris and (ii) any dilutive media. In some embodiments, the device is configured to facilitate flow of the debris from the filtering container through a channel to the distal container. In some embodiments, the filtering container couples to a proximal valve that couples to a channel that couped so a distal valve that coupled with the distal container; and where the device is configured to facilitate a flow of the debris from the filtering container, through a proximal valve that is open, through a channel, through a distal valve that is open, and to the distal container. In some embodiments, the device is configured to facilitate the flow of the debris and of dilutive media from the filtering container, through the proximal valve that is open, through the channel, through the distal valve that is open, and to the distal container. In some embodiments, the device is configured to facilitate connection and disconnection of the distal container from a channel coupled with the filtering container during debris filtering; and where the channel is disposed between the distal container and the filtering container. In some embodiments, the connection and disconnection is reversible. In some embodiments, the device is configured to facilitate connection and disconnection of the distal container from the filtering container during debris filtering at least in part by the distal container remaining coupled with a channel during its connecting to the filtering container and during its disconnecting from the filtering container; where the channel is disposed between the distal container and the filtering container; and optionally where the connection and/or disconnection is reversible. In some embodiments, the device is configured to facilitate connection and disconnection of the distal container with respect to the filtering container during debris filtering at least in part by the distal container being respectively connected to or disconnected from a channel during its connecting or disconnecting from the filtering container; where the channel is disposed between the distal container and the filtering container; and optionally where the connection and/or disconnection is reversible. In some embodiments, the device is configured to facilitate reversible connection and disconnection of the distal container from the filtering container during debris filtering at the filtering container. In some embodiments, the device is configured to facilitate reversible connection and disconnection of the distal container from the filtering container during debris filtering at the filtering container and during accumulation of the debris and any dilutive media: (i) in the filtering container and/or (ii) in a collection container that is part of, or is operatively coupled with, the filtering container. In some embodiments, the device is configured to facilitate a flow of the debris from the filtering container to the distal container, and where (i) the device is configured to enclose an internal atmosphere having at least one characteristic different from an ambient atmosphere external to the device, and (ii) the device is configured to operatively couple to, or be a portion of, the three-dimensional printing system. In some embodiments, a printing atmosphere of the three-dimensional printing (A) comprises at least one reactive agent at a concentration that is lower than that in the ambient atmosphere and/or (B) is at a pressure above ambient pressure of the ambient atmosphere. In some embodiments, the device is configured to facilitate a flow of the debris from the filtering container to the distal container, and where (i) the device is configured to enclose an internal atmosphere having at least one characteristic different from an ambient atmosphere external to the device, and (iii) the debris is a byproduct of a three-dimensional printing process. In some embodiments, the device is configured to facilitate a flow of the debris from the filtering container to the distal container, and where (ii) the device is configured to operatively couple to, or be a portion of, a three-dimensional printing system, and (iii) the debris is a byproduct of a three-dimensional printing process. In some embodiments, the device is configured to facilitate a flow of the debris from the filtering container to the distal container, and where (i) the device is configured to enclose an internal atmosphere having at least one characteristic different from an ambient atmosphere external to the device, (ii) the device is configured to operatively couple to, or be a portion of, a three-dimensional printing system, and (iii) the debris is a byproduct of a three-dimensional printing process. In some embodiments, the three-dimensional printing system is configured for printing in an atmosphere that (A) comprises at least one reactive agent at a concentration lower than in the ambient atmosphere and/or (B) is at a pressure above ambient pressure of the ambient atmosphere external to the three-dimensional printer.

In another aspect, a lid for filtering debris generated by three-dimensional printing, the lid comprises: a first surface configured to being exposed to an ambient environment, the first surface comprises: a first inlet configured for receiving gas; a second inlet configured for receiving a quelling material comprising passivating material or an insulating material; a first outlet configured for expelling the gas; a second outlet configured for expelling the quelling material; and a third inlet configured for receiving the debris and any dilutive media, the lid being configured to close an opening of the distal container as part of the device of any of the above devices the ambient environment being external to the distal container when closed by the lid. In some embodiments, the lid is configured to close the distal container such that the distal container closed by the lid is configured to enclose an internal atmosphere having at least one characteristic different from an ambient atmosphere external to the device. In some embodiments, the lid is configured to operatively couple with, or be a portion of, a three-dimensional printing system. In some embodiments, the three-dimensional printing system is configured for printing in an atmosphere that (A) comprises at least one reactive agent at a concentration lower than in the ambient atmosphere and/or (B) is at a pressure above ambient pressure of the ambient atmosphere external to the three-dimensional printer. In some embodiments, the debris is a byproduct of the three-dimensional printing. In some embodiments, the lid further comprises a second surface opposing the first surface, the second surface is configured to face an interior space of the distal container when the lid closes the distal container. In some embodiments, the second surface comprises, or is operatively coupled with, the overflow prevention pipe.

In another aspect, a scale for weighing filtered debris generated by three-dimensional printing, the scale comprises: a top plate configured to support the distal container as part of the device of any of the above devices where top is relative to a gravitational vector pointing towards the gravitational center of the ambient environment external to the distal container; at least one weight sensor configured to weigh the distal container during its filling up by the debris and by any dilutive media; and a mounting plate configured to mount the at least one weight sensor. In some embodiments, the at least one weight sensor comprises at least one load cell. In some embodiments, the top plate comprises supports configured to hinder lateral movement of the distal container. In some embodiments, the supports are configured to hinder lateral movement of the distal container in at least one lateral direction. In some embodiments, the supports are configured to assist alignment of the distal container above the at least one weight sensors. In some embodiments, the supports comprise cylinders. In some embodiments, the supports comprise a curved plane or a non-curved plane. In some embodiments, the supports comprise a plane having a shape respective of a side of the distal container. In some embodiments, the at least one load cell is configured to operatively couple with one or more controllers configured to control flow of the debris and any dilutive media into the distal container. In some embodiments, the scale is configured to aid in reducing a probability of overfilling the distal container with the debris and any dilutive media. In some embodiments, the scale is configured to at least in part determine the amount of debris and any dilutive media in the distal container. In some embodiments, determination of the amount of debris and any dilutive media in the distal container is done at least in part by at least one other sensor. In some embodiments, the at least one other sensor comprises a powder level sensor. In some embodiments, the at least one other sensor comprises a proximity sensor, or a volume sensor. In some embodiments, the at least one other sensor comprises a guided wave radar. In some embodiments, the at least one other sensor comprises an electromagnetic sensor configured to sense electromagnetic radiation. In some embodiments, the scale comprises one or more adjustable feet to level the mounting plate, the top plate, and/or the distal container. In some embodiments, at least one foot of the one or more adjustable feet is automatically adjustable. In some embodiments, at least one foot of the one or more adjustable feet is manually adjustable. In some embodiments, the scale comprises an aligner, and where the mounting plate is aligned with the top plate using the aligner. In some embodiments, the at least one weight sensor is operatively coupled with at least one controller controlling one or more components associated with the distal container, the one or more components comprising (i) one or more other sensors or (ii) one or more valves. In some embodiments, the one or more components are associated with the channel and/or with the lid.

In another aspect, a housing for enclosing filtered debris generated by three-dimensional printing, the housing comprises: a first wall; a second wall; and a door operatively coupled with the first wall with at least one fastener configured to facilitate reversible opening and closing of the door with respect to the first wall and to the second wall, the door comprising a latch configured to engage with the second wall, the housing configured to enclose the distal container as part of the device of any of the above devices In some embodiments, the door comprises a spacer configured to engage with the distal container up on closure of the door when the distal container is in the housing. In some embodiments, the spacer comprises at least one first sensor configured to sense the body of the distal container when the distal container is in the housing and the door of the housing is closed. In some embodiments, the second wall comprises at least one second sensor configured to sense the latch of the door to sense closure of the housing by the door. In some embodiments, the material is included in (a) the first wall, (b) the second wall, (c) the door, or (d) any combination thereof, the material comprises a transparent material, a mesh, or an opaque material. In some embodiments, the material comprises elemental metal or metal alloy. In some embodiments, the housing is configured to enclose a scale supporting to the distal container. In some embodiments, the scale being configured to determine a weight of the distal container during debris accumulation in the distal container. In some embodiments, the housing is configured to enclose the lid of the distal container. In some embodiments, the housing is configured to enclose a portion of the channel operatively coupled with the distal container. In some embodiments, the one or more components are associated with the channel and/or with the lid. In some embodiments, the housing is configured for disposition below the filtering container. In some embodiments, the housing is configured to house the distal container during accumulation of the debris and any dilutive media in the distal container. In some embodiments, the housing is configured to facilitate reversible removal of the distal container from the housing and introduction of the distal container into the housing. In some embodiments, the housing is configured to facilitate the reversible removal and the reversible introduction of the distal container by the maneuvering mechanism.

In another aspect, an apparatus for debris filtering, the apparatus comprising one or more controllers configured to (a) operatively couple to the any of the above devices; and (b) directing usage of at least one component of the device in association with filtering of the debris. In some embodiments, the one or more controllers utilize, or direct utilization of, at least one control scheme comprising feedback, feed forward, closed loop, or open loop. In some embodiments, the one or more controllers comprise at least one connector configured to connect to a power source. In some embodiments, the one or more controllers being configured to operatively couple to a power source at least in part by (I) having a power socket and/or (II) being configured for wireless power transfer using inductive charging. In some embodiments, the filtering container and/or the distal container is operatively coupled with at least one sensor to which the one or more controllers are operatively coupled with, and where control by the one or more controllers is based at least in part on signals obtained from the at least one sensor. In some embodiments, the one or more controllers utilizes, or direct utilization of, a control scheme based at least in part on data from the one or more sensors. In some embodiments, the one or more controllers form, or are part of, a hierarchical control system having three or more hierarchical control levels. In some embodiments, the one or more controllers is configured to control, or direct control of, at least one other device in the three-dimensional printing system. In some embodiments, the one or more controllers are included at the control system of the three-dimensional printing system. In some embodiments, at least two operations are executed, or directed, by the same controller of the one or more controllers. In some embodiments, at least two operations are executed, or directed, by different controllers of the one or more controllers. In some embodiments, the one or more controllers controlling the device are different from at least one controller controlling the filtering container. In some embodiments, the one or more controllers and the at least one controller are operatively coupled with the control system controlling a three-dimensional printer configured for the three-dimensional printing. In some embodiments, the one or more controllers and the at least one controller are operatively coupled with the proximal valve. In some embodiments, the one or more controllers is coupled with the at least one controller.

In another aspect, non-transitory computer readable program instructions for debris filtering, the program instructions, when ready by one or more processors operatively couped to the device of any of the above devices cause the one or more processors to execute, or direct execution of, one or more operations associated with filtering of the debris. In some embodiments, the one or more processors utilize, or direct utilization of, at least one control scheme comprising feedback, feed forward, closed loop, or open loop. In some embodiments, the filtering container and/or the distal container is operatively coupled with at least one sensor to which the one or more processors are operatively coupled with, and where control executed, or directed, by the one or more processors is based at least in part on signals obtained from the at least one sensor. In some embodiments, the control utilizes a control scheme based at least in part on data from the one or more sensors. In some embodiments, the one or more processors form, or are part of, a hierarchical system having three or more hierarchical levels. In some embodiments, the one or more processors are configured to control, or direct control of, at least one other device in the three-dimensional printing system. In some embodiments, the one or more processors are included in the control system of the three-dimensional printing system. In some embodiments, the program instructions where at least two operations are executed, or directed, by the same processor the one or more processors. In some embodiments, the program instructions where at least two operations are executed, or directed, by different processors of the one or more processors. In some embodiments, the program instructions are embedded in a medium. In some embodiments, the program instructions are embedded in a different media. In some embodiments, the program instructions are first program instructions configured to control the device are different than second program instructions configured to control the filtering container. In some embodiments, the first program instruction and the second program instruction are configured to receive input and/or generate output relating to the proximal valve. In some embodiments, the program instructions where first program instructions and the second program instruction are configured to receive input and/or generate output from each other. In some embodiments, the first program instructions are read by the one or more processors that is a first one or more processors and the second program instructions are read by a second one or more processors. In some embodiments, the program instructions where first one or more processors and the second one or more processors are configured to receive input and/or generate output from each other. In some embodiments, the first program instructions and the second program instructions are part of a program instruction set configured to control the three-dimensional printer configured for the three-dimensional printing.

In another aspect, a system for debris filtering in three-dimensional printing, the system comprising providing the three-dimensional printing system comprising, or operatively coupled with, the device of any of the above devices; the three-dimensional printing system generating the debris during the three-dimensional printing.

In another aspect, a method for debris filtering, the method comprises providing the device of any of the above devices; and using the device in association with filtering of the debris.

In another aspect, a method for debris filtering, the method comprises: during the debris filtering in a filtering container: (e.g., reversibly) (A) engaging a distal container with the filtering container and (B) disengaging the distal container from the filtering container, and (i) the method further comprises enclosing an internal atmosphere in the device, the internal atmosphere having at least one characteristic different from an ambient atmosphere external to the device, (ii) the method further comprises coupling the filtering container to a three-dimensional printing system configured for three-dimensional printing, and/or (iii) printing at least one three-dimensional object and generating the debris as a byproduct of the three-dimensional printing. In some embodiments, the method further comprises in the filtering container: filtering the debris from a gas flow. In some embodiments, the at least one characteristic of the internal atmosphere comprises temperature, pressure, gas flow direction, gas flow velocity, gas flow acceleration, gas makeup, level (e.g., relative level such as percentage) of reactive agent, or level (e.g., relative level such as percentage) of debris. In some embodiments, the method further comprises conveying the debris from the filtering container through a channel to the distal container, where the internal atmosphere is of the channel, of the distal container and of the filtering container. In some embodiments, the channel comprises a hose or a tube. In some embodiments, the channel comprises at least one flexible section; and optionally where the channel is flexible. In some embodiments, the internal atmosphere comprises (A) comprises at least one reactive agent at a concentration that is lower than that in the ambient atmosphere and/or (B) is at a pressure above ambient pressure of the ambient atmosphere. In some embodiments, the method further comprises printing the at least one three-dimensional object and generating the debris being filtered during the debris filtering. In some embodiments, a printing atmosphere of the three-dimensional printing comprises (A) comprises at least one reactive agent at a concentration that is lower than that in the ambient atmosphere and/or (B) is at a pressure above ambient pressure of the ambient atmosphere. In some embodiments, the at least one three-dimensional object (e.g., and the debris) comprise an elemental metal, a metal alloy, a polymer, a resin, an allotrope of elemental carbon, or a ceramic. In some embodiments, the method further comprises sensing (i) a volume of any free volume in the distal container, (ii) an amount of any material in the distal container, which material in the distal container comprises the debris and/or (iii) a weight of the distal container with any of the material. In some embodiments, the method further comprises sensing a weight of the distal container during and/or after the filtering. In some embodiments, sensing the weight is at least in part by using at least one weight sensor. In some embodiments, the at least one weight sensor comprises at least one load cell. In some embodiments, the at least one weight sensor is disposed between a mounting plate and a top plate, the top plate being configured to support the distal container. In some embodiments, the top plate comprises supports configured to hinder lateral movement of the distal container. In some embodiments, the at least one load cell is configured to operatively couple with one or more controllers configured to control flow of the debris and any dilutive media into the distal container. In some embodiments, the method further comprises filtering the debris at least in part by using (a) at least one filter disposed in a filtering container, (b) dilutive media disposed in the filtering container, and (c) gas flow in a first direction towards the filter during the filtering of the debris. In some embodiments, during filtering in the filtering container, contacting between the dilutive media and the filter during filtering to promote separation of the filter from the debris during filtering of the debris. In some embodiments, during filtering in the filtering container, contacting between the dilutive media and the filter at least in part by flowing the gas flow in the first direction during filtering. In some embodiments, the method further comprises releasing (i) the dilutive media and/or (ii) the debris, from the filter at least in part by flowing the gas flow in a second direction that comprises a directional component opposing the first direction. In some embodiments, the method further comprises releasing the debris accumulating on the dilutive media from the filter at least in part by being flowing the gas flow in the second direction. In some embodiments, the method further comprises transitioning the debris and any dilutive media to the distal container upon release from the filter. In some embodiments, during the transitioning of the debris and any dilutive media after release from the filter, the debris and any dilutive media transition at least in part using gravitational force directed towards the gravitational center of the ambient environment external to the device. In some embodiments, the dilutive media comprises particulate matter. In some embodiments, the dilutive media comprises particulate matter having a first material type different from a second material type of material of the dilutive media. In some embodiments, the dilutive media comprises ceramic, elemental metal, metal alloy, glass, stone, polymer, or resin. In some embodiments, flowing the gas in the second direction comprises continuous flow or pulsed flow. In some embodiments, the method further comprises controlling three-dimensional printing by a control system. In some embodiments, the method further comprises operatively coupling the distal container with a control system configured for controlling one or more operations of the method, and optionally controlling three-dimensional printing at least in part by the control system. In some embodiments, the control system comprises at least three hierarchical control levels. In some embodiments, the debris is prone to harmfully react with one or more reactive agents present in the ambient atmosphere, when the debris is exposed to the ambient atmosphere without further treatment comprising passivation or insulation. In some embodiments, the debris exits the filtering container without the further treatment. In some embodiments, the debris accumulates in the filtering container without the further treatment. In some embodiments, the distal container is configured for closure by a lid configured to facilitate ingress of a quelling material facilitating the further treatment, the quelling material comprising a passivating material or an insulating material; and optionally where the passivating material is the insulating material. In some embodiments, the passivating material comprises water. In some embodiments, the insulating material comprises oil. In some embodiments, the method further comprises flowing a less reactive gas from a gas source to the distal container, the a less reactive gas being less reactive with the debris as compared to a reactivity of the debris with the ambient atmosphere external to the distal container. In some embodiments, the less reactive gas comprises at least one reactive agent at a concentration that is lower than that in the ambient atmosphere. In some embodiments, the method further comprises flowing the less reactive gas into the distal container and into a channel disposed between the distal container and the filtering container. In some embodiments, flowing comprises purging. In some embodiments, the method further comprises sensing the at least one characteristic different from the ambient atmosphere external to the distal container when closed with the lid. In some embodiments, the method where sensing comprises (i) sensing a pressure and/or (ii) sensing a level of a reactive agent. In some embodiments, the reactive agent comprises oxygen or water. In some embodiments, the method further comprises engaging a lid of the distal container with a body of the distal container to form the distal container that is closed. In some embodiments, the method further comprises engaging a distal end of a channel with the distal container, and engaging a proximal end of the channel with the filtering container, the distal end opposing the proximal end, the channel configured to convey the debris therethrough. In some embodiments, engaging the distal end of the channel is reversible. In some embodiments, engaging the distal end of the channel to the distal container is at least in part by engaging the distal end of the channel with a lid of the distal container. In some embodiments, engaging the proximal end of the channel with the filtering container through a proximal valve. In some embodiments, the channel comprises a hose or a tube. In some embodiments, the channel comprises at least one flexible section; and optionally where the channel is flexible. In some embodiments, the one or more characteristics of the internal atmosphere comprises temperature, pressure, gas flow direction, gas flow velocity, gas flow acceleration, gas makeup, level (e.g., relative level such as percentage) of reactive agent, or level (e.g., relative level such as percentage) of debris. In some embodiments, the one or more characteristics of the internal atmosphere comprises pressure, or level (e.g., relative level such as percentage) of reactive agent. In some embodiments, the internal atmosphere (A) comprises at least one reactive agent at a concentration that is lower than that in the ambient atmosphere and/or (B) is at a pressure above ambient pressure of the ambient atmosphere. In some embodiments, the method further comprises conveying the debris from the filtering container through a channel to the distal container. In some embodiments, the method further comprises removing the distal container and/or the channel during filtering of the debris in the filtering container. In some embodiments, the method further comprises exchanging the distal container and/or the channel during filtering of the debris in the filtering container. In some embodiments, the method further comprises removing the distal container and/or the channel during printing of one or more three-dimensional objects in a three-dimensional printing system generating the debris. In some embodiments, the method further comprises exchanging the distal container and/or the channel during printing of one or more three-dimensional objects in a three-dimensional printing system generating the debris. In some embodiments, the method further comprises operatively coupling the distal container to a weight sensor. In some embodiments, the method further comprises operatively coupling the distal container to a maneuvering mechanism. In some embodiments, the method further comprises operatively coupling the distal container with a control system configured for controlling one or more operations of the method, and optionally controlling three-dimensional printing at least in part by the control system. In some embodiments, the method further comprises operatively coupling the distal container with a control system configured for controlling the three-dimensional printing system and one or more operations of the method. In some embodiments, the control system comprises at least three hierarchical control levels. In some embodiments, the method further comprises coupling the filtering container to the distal container having a proximal valve at least in part by (i) coupling the proximal valve to a proximal end of a channel having an opposing distal end, and (ii) coupling the distal end of the channel to a distal valve that is part of, or is coupled with, a lid of the distal container; where operations (i) and (ii) can be performed at any order. In some embodiments, the method further comprises shutting the distal valve prior to engaging the distal end of a channel with the lid through the distal valve. In some embodiments, the method further comprises shutting the proximal valve prior to engaging the proximal end of the channel with the filtering container through the proximal valve. In some embodiments, prior to engaging the proximal end of the channel with the filtering container through the proximal valve, the method further comprises (i) opening the distal valve and (ii) conditioning an internal atmosphere disposed in the distal container and/or in the channel, to have the at least one characteristic different from the ambient atmosphere external to the distal container when closed with the lid. In some embodiments, conditioning the internal atmosphere is relative to one or more thresholds. In some embodiments, the method further comprises operatively coupling the distal container to a gas source from which a less reactive gas flows, the a less reactive gas being less reactive with the debris as compared to an ambient atmosphere external to the distal container. In some embodiments, the less reactive gas comprises at least one reactive agent in a concentration that is lower than that in the ambient atmosphere. In some embodiments, the method further comprises flowing the less reactive gas into the first interior volume and/or into the second interior volume. In some embodiments, flowing comprises purging. In some embodiments, the method further comprises sensing the at least one characteristic different from the ambient atmosphere external to the distal container when closed with the lid. In some embodiments, the method further comprises controlling the purging at least in part by using the at least one characteristic sensed. In some embodiments, sensing the at least one characteristic comprises (i) sensing a pressure and/or (ii) sensing a level of a reactive agent. In some embodiments, the reactive agent comprises oxygen or water. In some embodiments, the method further comprises controlling flow of the less reactive gas based at least in part on sensing the at least one characteristic different from the ambient atmosphere. In some embodiments, the method further comprises engaging a maneuvering mechanism with the distal container after, before, or during disengagement of the distal container from the filtering container. In some embodiments, the method further comprises maneuvering the distal container with respect to the filtering container. In some embodiments, the method further comprises maneuvering the distal container to a passivation station, to storage, or for disposal. In some embodiments, the maneuvering mechanism comprises a vehicle or an aircraft. In some embodiments, the maneuvering mechanism comprises a forklift, a cart, or a drone. In some embodiments, the maneuvering mechanism comprises a robot. In some embodiments, the method further comprises (i) automatically maneuvering or (ii) autonomously maneuvering, the maneuvering mechanism. In some embodiments, the method further comprises remotely operating the maneuvering mechanism. In some embodiments, the method further comprises engaging with the distal container a source of a quelling material comprising (i) a passivator or (ii) an insulator. In some embodiments, in the distal container, during interaction of the debris with the quelling material, the distal container comprises an atmosphere that is less reactive with the debris as compared to the ambient atmosphere external to the distal container. In some embodiments, the method further comprises ceasing introduction of the quelling material into the distal container once excess material is expelled through an exit port having an overfill prevention pipe. In some embodiments, the method further comprises using the overfill prevention pipe to (i) increase a probability of retaining in the distal container gas above the debris and any dilutive media, and (ii) reduce a probability of overfilling the distal container with the quelling material. In some embodiments, the passivator is the insulator. In some embodiments, the passivator and/or the insulator comprises a liquid material or a flowable semisolid material. In some embodiments, the passivator and/or the insulator comprises a gaseous material. In some embodiments, the passivator comprises an oxidizing agent. In some embodiments, the passivator comprises oxygen or water. In some embodiments, the passivator comprises a material reactive with the debris to form a reaction product is that is less harmfully (e.g., violently) reactive with the ambient atmosphere under normal conditions presiding in the ambient environment external to the distal container, wherein less harmfully reactive comprises not harmfully reactive. In some embodiments, not violently reactive comprises (i) not measurably reactive, (ii) controllably reactive, or (iii) moderately reactive. In some embodiments, not violently reactive comprises (i) a non-exothermic reaction, (ii) an endothermic reaction, (ii) a reaction that does not generate measurable fumes, splatter, spatter, flashes, or flames, (iii) a reaction that elevates the temperature of the debris by at most about 50 degrees Celsius (° C.), 30° C., or 10° C., or (iv) a reaction that elevates the pressure in the distal container by at most about 1 pounds per square inch (PSI), 0.5 PSI, 0.25 PSI, or 0.1 PSI above ambient pressure external to the distal container (when closed with the lid). In some embodiments, the passivator includes water in the form of solid, liquid, vapor, suspension, gas borne droplets, snow, or as part of a semisolid. In some embodiments, the insulator includes a hydrophobic material. In some embodiments, the hydrophobic material comprises a paraffin, or an oil. In some embodiments, the passivator reacts with a surface of the debris to form an oxide. In some embodiments, engaging a source of a quelling material with the distal container is with an ingress port of the distal container, the quelling material comprising a passivator or an insulator. In some embodiments, the ingress port is disposed at a lid of the container. In some embodiments, the method further comprises inserting a quelling material comprising (i) a passivator or (ii) an insulator. In some embodiments, the method further comprises inserting into an interior of the distal container the quelling material to (i) passivate the debris and/or (ii) insulate the debris. In some embodiments, the method further comprises exchanging a lid of the distal container after the debris has been (i) passivated and/or (ii) insulated with respect to the ambient environment. In some embodiments, the lid is a first lid, and where the first lid is exchanged to a second lid that, as compared to the first lid, is cheaper, simpler, and/or more ubiquitous. In some embodiments, the first lid and/or the second lid comprises at least one vent valve. In some embodiments, the method further comprises disposing of the distal container (e.g., per jurisdictional standards).

In another aspect, an apparatus for debris filtering, the apparatus comprising one or more controllers configured to execute, or direct execution of, one or more operations of any of the above methods. In some embodiments, the one or more controllers utilize, or direct utilization of, at least one control scheme comprising feedback, feed forward, closed loop, or open loop. In some embodiments, the one or more controllers comprise at least one connector configured to connect to a power source. In some embodiments, the one or more controllers being configured to operatively couple to a power source at least in part by (I) having a power socket and/or (II) being configured for wireless power transfer using inductive charging. In some embodiments, the filtering container and/or the distal container is operatively coupled with at least one sensor to which the one or more controllers are operatively coupled with, and where control by the one or more controllers is based at least in part on signals obtained from the at least one sensor. In some embodiments, the one or more controllers utilizes, or direct utilization of, a control scheme based at least in part on data from the one or more sensors. In some embodiments, the one or more controllers form, or are part of, a hierarchical control system having three or more hierarchical control levels. In some embodiments, the one or more controllers is configured to control, or direct control of, at least one device in the three-dimensional printing system. In some embodiments, the one or more controllers are included in a control system of the three-dimensional printing system. In some embodiments, at least two operations are executed, or directed, by the same controller of the one or more controllers. In some embodiments, at least two operations are executed, or directed, by different controllers of the one or more controllers.

In another aspect, non-transitory computer readable program instructions for debris filtering, the program instructions, when ready by one or more processors, cause the one or more processors to execute, or direct execution of, one or more operations of any of the above methods. In some embodiments, the one or more processors utilize, or direct utilization of, at least one control scheme comprising feedback, feed forward, closed loop, or open loop. In some embodiments, the filtering container and/or the distal container is operatively coupled with at least one sensor to which the one or more processors are operatively coupled with, and where control executed, or directed, by the one or more processors is based at least in part on signals obtained from the at least one sensor. In some embodiments, the control utilizes a control scheme based at least in part on data from the one or more sensors. In some embodiments, the one or more processors form, or are part of, a hierarchical system having three or more hierarchical levels. In some embodiments, the one or more processors are configured to control, or direct control of, at least one other device in the three-dimensional printing system. In some embodiments, the one or more processors are included in a control system of the three-dimensional printing system. In some embodiments, the program instructions where at least two operations are executed, or directed, by the same processor the one or more processors. In some embodiments, at least two operations are executed, or directed, by different processors of the one or more processors. In some embodiments, the program instructions are embedded in a medium. In some embodiments, the program instructions are embedded in a different media. In some embodiments, the program instructions are first program instructions configured to control the distal container are different than second program instructions configured to control the filtering container; and optionally where the first program instructions are configured to control (i) one or more sensors operatively coupled with the distal container, (ii) one or more valves operatively coupled with the distal container, (iii) one or more sensors operatively coupled with a channel that is coupled with the distal container, (iv) one or more valves operatively coupled with the channel that is coupled with the distal container, (v) one or more sensors operatively coupled with a lid that is coupled with the distal container, and/or (vi) one or more valves operatively coupled with the lid that is coupled with the distal container. In some embodiments, the first program instruction and the second program instruction are configured to receive input and/or generate output relating to the proximal valve. In some embodiments, the first program instructions and the second program instruction are configured to receive input and/or generate output from each other. In some embodiments, the first program instructions are read by the processor that is a first processor and the second program instructions are read by a second processor. In some embodiments, the first processor and the second processor are configured to receive input and/or generate output from each other. In some embodiments, the first program instructions and the second program instructions are part of a program instruction set configured to control a three-dimensional printer configured for the three-dimensional printing.

In another aspect, a device for debris filtering, the device being configured to effectuate one or more operations of the method in any of the above methods.

In another aspect, a device for weighing filtered debris generated by three-dimensional printing, the device comprises: a top plate configured to support a distal container configured accommodate the debris filtered at a filtering container during the three-dimensional printing, the top being relative to a gravitational vector pointing towards the gravitational center of the ambient environment external to the distal container that is closed; at least one weight sensor configured to weigh the distal container during its filling up by the debris and by any dilutive media; and a mounting plate configured to mount the at least one weight sensor. In some embodiments, the at least one weight sensor comprises at least one load cell. In some embodiments, the top plate comprises supports configured to hinder lateral movement of the distal container. In some embodiments, the supports are configured to hinder lateral movement of the distal container in at least one lateral direction. In some embodiments, the supports are configured to assist alignment of the distal container above the at least one weight sensors. In some embodiments, the supports comprise cylinders. In some embodiments, the supports comprise a curved plane or a non-curved plane. In some embodiments, the supports comprise a plane having a shape respective of a side of the distal container. In some embodiments, the at least one load cell is configured to operatively couple with one or more controllers configured to control flow of the debris and any dilutive media into the distal container. In some embodiments, the device is configured to aid in reducing a probability of overfilling the distal container with the debris and any dilutive media. In some embodiments, the device is configured to at least in part determine the amount of debris and any dilutive media in the distal container. In some embodiments, determination of the amount of debris and any dilutive media in the distal container is done at least in part by at least one other sensor. In some embodiments, the at least one other sensor comprises a powder level sensor. In some embodiments, the at least one other sensor comprises a proximity sensor, or a volume sensor. In some embodiments, the at least one other sensor comprises a guided wave radar. In some embodiments, the at least one other sensor comprises an electromagnetic sensor configured to sense electromagnetic radiation. In some embodiments, the device comprises one or more adjustable feet to level the mounting plate, the top plate, and/or the distal container. In some embodiments, at least one foot of the one or more adjustable feet is automatically adjustable. In some embodiments, at least one foot of the one or more adjustable feet is manually adjustable. In some embodiments, the debris is prone to harmfully react with one or more reactive agents present in the ambient atmosphere, when the debris is exposed to the ambient atmosphere without further treatment comprising passivation or insulation. In some embodiments, the debris exits the filtering container without the further treatment. In some embodiments, the debris accumulates in the filtering container without the further treatment. In some embodiments, the distal container is configured for closure by a lid configured to facilitate ingress of a quelling material facilitating the further treatment, the quelling material comprising a passivating material or an insulating material; and optionally where the passivating material is the insulating material. In some embodiments, the passivating material comprises water. In some embodiments, the insulating material comprises oil. In some embodiments, the device comprises an aligner, and where the mounting plate is aligned with the top plate using the aligner. In some embodiments, the at least one weight sensor is operatively coupled with at least one controller controlling one or more components associated with the distal container, the one or more components comprising (i) one or more other sensors or (ii) one or more valves. In some embodiments, the one or more components are associated with a channel connecting the distal container with the filtering container and/or with the lid closing the distal container. In some embodiments, the channel comprises at least one flexible portion. In some embodiments, the channel is flexible. In some embodiments, the channel comprises a hose or a tube. In some embodiments, the device is configured to weigh the distal container (e.g., in real time) during filtration of the debris and/or during the three-dimensional printing. In some embodiments, the distal container is configured to reversibly engage and disengage with the filtering container (i) during the filtering of the debris at the filtering container and/or (ii) after the filtering of the debris at the filtering container. In some embodiments, a channel is configured to facilitate a flow of the debris from the filtering container to the distal container, the channel being operatively coupled with the distal container and with the filtering container. In some embodiments, (i) the distal container closed by a lid is configured to enclose an internal atmosphere having at least one characteristic different from an ambient atmosphere external to the device, (ii) the distal container is configured to operatively couple with, or be a portion of, a three-dimensional printing system, and/or (iii) the debris comprises a byproduct of the three-dimensional printing.

In another aspect, an apparatus for debris filtering, the apparatus comprising one or more controllers configured to (a) operatively couple to any of the above devices; and (b) directing usage of at least one component of the device in association with filtering of the debris and/or with weighing the distal container. In some embodiments, the one or more controllers utilize, or direct utilization of, at least one control scheme comprising feedback, feed forward, closed loop, or open loop. In some embodiments, the one or more controllers comprise at least one connector configured to connect to a power source. In some embodiments, the one or more controllers being configured to operatively couple to a power source at least in part by (I) having a power socket and/or (II) being configured for wireless power transfer using inductive charging. In some embodiments, the device, filtering container and/or the distal container is operatively coupled with at least one sensor to which the one or more controllers are operatively coupled with, and where control by the one or more controllers is based at least in part on signals obtained from the at least one sensor. In some embodiments, the one or more controllers utilizes, or direct utilization of, a control scheme based at least in part on data from the one or more sensors. In some embodiments, the one or more controllers form, or are part of, a hierarchical control system having three or more hierarchical control levels. In some embodiments, the one or more controllers is configured to control, or direct control of, at least one other device in the three-dimensional printing system. In some embodiments, the one or more controllers are included at a control system of the three-dimensional printing system. In some embodiments, at least two operations are executed, or directed, by the same controller of the one or more controllers. In some embodiments, at least two operations are executed, or directed, by different controllers of the one or more controllers. In some embodiments, the one or more controllers controlling the device are different from at least one controller controlling the filtering container. In some embodiments, the one or more controllers and the at least one controller are operatively coupled with a control system controlling a three-dimensional printer configured for the three-dimensional printing. In some embodiments, the one or more controllers and the at least one controller are operatively coupled with the at least one weight sensor and/or at least one other sensor. In some embodiments, the one or more controllers is coupled with the at least one controller.

In another aspect, non-transitory computer readable program instructions for debris filtering, the program instructions, when ready by one or more processors operatively couped to any of the above devices; cause the one or more processors to execute, or direct execution of, one or more operations associated with filtering of the debris and/or with weighing the distal container. In some embodiments, the one or more processors utilize, or direct utilization of, at least one control scheme comprising feedback, feed forward, closed loop, or open loop. In some embodiments, the device, the filtering container and/or the distal container, is operatively coupled with at least one sensor to which the one or more processors are operatively coupled with, and where control executed, or directed, by the one or more processors is based at least in part on signals obtained from the at least one sensor. In some embodiments, the at least one sensor comprises the at least one weight sensor or the at least one other sensor. In some embodiments, the control utilizes a control scheme based at least in part on data from the one or more sensors. In some embodiments, the one or more processors form, or are part of, a hierarchical system having three or more hierarchical levels. In some embodiments, the one or more processors are configured to control, or direct control of, at least one other device in the three-dimensional printing system. In some embodiments, the one or more processors are included in a control system of the three-dimensional printing system. In some embodiments, the program instructions where at least two operations are executed, or directed, by the same processor the one or more processors. In some embodiments, the program instructions where at least two operations are executed, or directed, by different processors of the one or more processors. In some embodiments, the program instructions are embedded in a medium. In some embodiments, the program instructions are embedded in a different media. In some embodiments, the program instructions are first program instructions configured to control the device are different than second program instructions configured to control the filtering container. In some embodiments, the first program instruction and the second program instruction are configured to receive input and/or generate output relating to the proximal valve. In some embodiments, the program instructions where first program instructions and the second program instruction are configured to receive input and/or generate output from each other. In some embodiments, the first program instructions are read by the processor that is a first processor and the second program instructions are read by a second processor. In some embodiments, the program instructions where first processor and the second processor are configured to receive input and/or generate output from each other. In some embodiments, the first program instructions and the second program instructions are part of a program instruction set configured to control a three-dimensional printer configured for the three-dimensional printing.

In another aspect, a system for debris filtering in three-dimensional printing, the system comprising providing a three-dimensional printing system comprising, or operatively coupled with, any of the above devices, the three-dimensional printing system generating the debris during its operation.

In another aspect, a method for debris filtering, the method comprises providing any of the above devices; and using the device in association with filtering of the debris and/or with weighing the distal container.

In another aspect, a device for enclosing filtered debris generated by three-dimensional printing, the device comprises: a first wall; a second wall; and a door operatively coupled with the first wall with at least one fastener configured to facilitate reversible opening and closing of the door with respect to the first wall and to the second wall, the door comprising a latch configured to engage with the second wall, the device configured to enclose a distal container configured accommodate the debris filtered at a filtering container during the three-dimensional printing. In some embodiments, the device is configured to enclose the distal container during filtration of the debris and/or during the three-dimensional printing. In some embodiments, the door comprises a spacer configured to engage with the distal container up on closure of the door when the distal container is in the device. In some embodiments, the spacer comprises at least one first sensor configured to sense the body of the distal container when the distal container is in the device and the door of the device is closed. In some embodiments, the second wall comprises at least one second sensor configured to sense the latch of the door to sense closure of the device by the door. In some embodiments, material is included in (a) the first wall, (b) the second wall, (c) the door, or (d) any combination thereof, the material comprises a transparent material, a mesh, or an opaque material. In some embodiments, the material comprises elemental metal or metal alloy. In some embodiments, the device is configured to enclose a scale supporting to the distal container. In some embodiments, the scale being configured to determine a weight of the distal container during debris accumulation in the distal container. In some embodiments, the debris is prone to harmfully react with one or more reactive agents present in the ambient atmosphere, when the debris is exposed to the ambient atmosphere without further treatment comprising passivation or insulation. In some embodiments, the debris exits the filtering container without the further treatment. In some embodiments, the debris accumulates in the filtering container without the further treatment. In some embodiments, the distal container is configured for closure by a lid configured to facilitate ingress of a quelling material facilitating the further treatment, the quelling material comprising a passivating material or an insulating material; and optionally where the passivating material is the insulating material. In some embodiments, the passivating material comprises water. In some embodiments, the insulating material comprises oil. In some embodiments, the device is configured to enclose the lid of the distal container. In some embodiments, the device is configured to enclose a portion of the channel operatively coupled with the distal container. In some embodiments, the device is configured for disposition below the filtering container. In some embodiments, the device is configured to house the distal container during accumulation of the debris and any dilutive media in the distal container. In some embodiments, the device is configured to facilitate reversible removal of the distal container from the device and introduction of the distal container into the device. In some embodiments, the device is configured to facilitate the reversible removal and the reversible introduction of the distal container by the maneuvering mechanism. In some embodiments, the one or more components are associated with a channel connecting the distal container with the filtering container and/or with the lid closing the distal container. In some embodiments, the channel comprises at least one flexible portion. In some embodiments, the channel is flexible. In some embodiments, the channel comprises a hose or a tube. In some embodiments, the device is configured to facilitate (e.g., allow) weighing the distal container during filtration of the debris and/or during the three-dimensional printing. In some embodiments, the distal container is configured to reversibly engage and disengage with the filtering container during the filtering of the debris at the filtering container. In some embodiments, a channel is configured to facilitate a flow of the debris from the filtering container to the distal container, the channel being operatively coupled with the distal container and with the filtering container. In some embodiments, (i) the distal container closed by a lid is configured to enclose an internal atmosphere having at least one characteristic different from an ambient atmosphere external to the device, (ii) the distal container is configured to operatively couple with, or be a portion of, a three-dimensional printing system, and/or (iii) the debris comprises a byproduct of the three-dimensional printing.

In another aspect, an apparatus for debris filtering, the apparatus comprising one or more controllers configured to (a) operatively couple to any of the above devices; and (b) directing usage of at least one component of the device in association with filtering of the debris and/or with housing the distal container. In some embodiments, the one or more controllers utilize, or direct utilization of, at least one control scheme comprising feedback, feed forward, closed loop, or open loop. In some embodiments, the one or more controllers comprise at least one connector configured to connect to a power source. In some embodiments, the one or more controllers being configured to operatively couple to a power source at least in part by (I) having a power socket and/or (II) being configured for wireless power transfer using inductive charging. In some embodiments, the device, filtering container and/or the distal container is operatively coupled with at least one sensor to which the one or more controllers are operatively coupled with, and where control by the one or more controllers is based at least in part on signals obtained from the at least one sensor. In some embodiments, the one or more controllers utilizes, or direct utilization of, a control scheme based at least in part on data from the one or more sensors. In some embodiments, the one or more controllers form, or are part of, a hierarchical control system having three or more hierarchical control levels. In some embodiments, the one or more controllers is configured to control, or direct control of, at least one other device in the three-dimensional printing system. In some embodiments, the one or more controllers are included at a control system of the three-dimensional printing system. In some embodiments, at least two operations are executed, or directed, by the same controller of the one or more controllers. In some embodiments, at least two operations are executed, or directed, by different controllers of the one or more controllers. In some embodiments, the one or more controllers controlling the device are different from at least one controller controlling the filtering container. In some embodiments, the one or more controllers and the at least one controller are operatively coupled with a control system controlling a three-dimensional printer configured for the three-dimensional printing. In some embodiments, the one or more controllers and the at least one controller are operatively coupled with the at least one first sensor and/or at least one second sensor. In some embodiments, the one or more controllers is coupled with the at least one controller.

In another aspect, non-transitory computer readable program instructions for debris filtering, the program instructions, when ready by one or more processors operatively couped to any of the above devices to cause the one or more processors to execute, or direct execution of, one or more operations associated with filtering of the debris and/or with housing the distal container. In some embodiments, the one or more processors utilize, or direct utilization of, at least one control scheme comprising feedback, feed forward, closed loop, or open loop. In some embodiments, the device, the filtering container and/or the distal container, is operatively coupled with at least one sensor to which the one or more processors are operatively coupled with, and where control executed, or directed, by the one or more processors is based at least in part on signals obtained from the at least one sensor. In some embodiments, the at least one sensor comprises the at least one first sensor or the at least one second sensor. In some embodiments, the control utilizes a control scheme based at least in part on data from the one or more sensors. In some embodiments, the one or more processors form, or are part of, a hierarchical system having three or more hierarchical levels. In some embodiments, the one or more processors are configured to control, or direct control of, at least one other device in the three-dimensional printing system. In some embodiments, the one or more processors are included in a control system of the three-dimensional printing system. In some embodiments, the program instructions where at least two operations are executed, or directed, by the same processor the one or more processors. In some embodiments, the program instructions where at least two operations are executed, or directed, by different processors of the one or more processors. In some embodiments, the program instructions are embedded in a medium. In some embodiments, the program instructions are embedded in a different media. In some embodiments, the program instructions are first program instructions configured to control the device are different than second program instructions configured to control the filtering container. In some embodiments, the first program instruction and the second program instruction are configured to receive input and/or generate output relating to the proximal valve. In some embodiments, the program instructions where first program instructions and the second program instruction are configured to receive input and/or generate output from each other. In some embodiments, the first program instructions are read by the processor that is a first processor and the second program instructions are read by a second processor. In some embodiments, the program instructions where first processor and the second processor are configured to receive input and/or generate output from each other. In some embodiments, the first program instructions and the second program instructions are part of a program instruction set configured to control a three-dimensional printer configured for the three-dimensional printing.

In another aspect, a system for debris filtering in three-dimensional printing, the system comprising providing a three-dimensional printing system comprising or operatively coupled with, any of the above devices; the three-dimensional printing system generating the debris during its operation.

In another aspect, a method for debris filtering, the method comprises providing any of the above devices; and using the device in association with filtering of the debris and/or with housing the distal container.

In another aspect, a device for filtering debris generated by three-dimensional printing, the device comprising a lid comprises: a first surface configured to being exposed to an ambient environment, the first surface comprises: a first inlet configured for receiving gas; a second inlet configured for receiving a quelling material comprising passivating material or an insulating material; a first outlet configured for expelling the gas; a second outlet configured for expelling the quelling material; and a third inlet configured for receiving the debris and any dilutive media, the device being configured to close an opening of the distal container configured accommodate the debris filtered at a filtering container, the lid being configured to reversibly engage and disengage with the filtering container during the filtering of the debris at the filtering container, the device being configured to facilitate a flow of the debris from the filtering container to the distal container, and where (i) the lid being configured to close the distal container such that the distal container closed by the lid is configured to enclose an internal atmosphere having at least one characteristic different from an ambient atmosphere external to the distal container when closed by the lid, (ii) the lid being configured to operatively couple with, or be a portion of, a three-dimensional printing system configured for the three dimensional printing, and/or (iii) the debris is a byproduct of the three-dimensional printing. In some embodiments, the lid is configured to close the distal container such that the distal container closed by the lid is configured to enclose an internal atmosphere having at least one characteristic different from an ambient atmosphere external to the distal container when closed by the lid. In some embodiments, the lid is configured to operatively couple with, or be a portion of, a three-dimensional printing system configured for the three dimensional printing. In some embodiments, the debris is a byproduct of the three-dimensional printing. In some embodiments, the lid further comprises a second surface opposing the first surface, the second surface is configured to face an interior space of the distal container when the lid closes the distal container. In some embodiments, the second surface comprises, or is operatively coupled with, the overflow prevention pipe. In some embodiments, the lid is configured to (e.g., reversibly) engage with a channel having a proximal end and an opposing distal end, the proximal end of the channel being configured to couple with the filtering container, and the distal end of the channel being configured to couple with the distal container. In some embodiments, the channel being configured for reversible engagement and disengagement with the third inlet of the lid. In some embodiments, the distal end is configured to reversibly engage and disengage with the third inlet of the lid. In some embodiments, the distal end is configured to reversibly engage and disengage with the distal container (i) during the filtering of the debris at the filtering container and/or (ii) after the filtering of the debris at the filtering container. In some embodiments, the proximal end is configured to reversibly engage and disengage with the filtering container. In some embodiments, the proximal end is configured to reversibly engage and disengage with the filtering container (i) during the filtering of the debris at the filtering container and/or (ii) after the filtering of the debris at the filtering container. In some embodiments, the debris is prone to harmfully react with one or more reactive agents present in the ambient atmosphere, when the debris is exposed to the ambient atmosphere without further treatment comprising passivation or insulation. In some embodiments, the debris exits the filtering container without the further treatment. In some embodiments, the debris accumulates in the filtering container without the further treatment. In some embodiments, the passivating material comprises water. In some embodiments, the insulating material comprises oil. In some embodiments, the internal atmosphere (A) comprises at least one reactive agent at a concentration that is lower than that in the ambient atmosphere and/or (B) is at a pressure above ambient pressure of the ambient atmosphere. In some embodiments, the device further comprises a proximal valve operatively coupled with the third inlet. In some embodiments, the lid is operatively coupled with, or comprises, one or more sensors configured to measure the at least one characteristic of the internal atmosphere. In some embodiments, the one or more sensors comprise a pressure sensor or a sensor configured to sense a reactive agent. In some embodiments, the reactive agent comprises an oxidizing agent. In some embodiments, the reactive agent comprises humidity or oxygen. In some embodiments, the reactive agent is configured to react with a starting material of the three-dimensional printing and/or with a printed three-dimensional object. In some embodiments, the distal container comprises a body configured to engage with the lid in a gas tight manner to form the closed distal container. In some embodiments, the lid is configured to reversibly engage and disengage with a channel disposed between (i) the distal container and (ii) the lid of the filtering container closed by the lid. In some embodiments, the channel comprises a flexible material or a rigid material. In some embodiments, the channel comprises a transparent material or an opaque material. In some embodiments, the channel is a bifurcated channel. In some embodiments, the channel is a single channel. In some embodiments, the filtering container is operatively coupled with, or includes, a collection container configured to collect and/or funnel the debris through the proximal valve. In some embodiments, the collection container is a hopper. In some embodiments, the collection container is configured to collect debris from a filter, from a centrifuge, or from a cyclonic separator. In some embodiments, the filtering container comprises a filter, a centrifuge, or a cyclonic separator. In some embodiments, the filtering container is integrated in a gas flow mechanism. In some embodiments, the gas flow mechanism is included in the three-dimensional printing system configured to print one or more three-dimensional objects in a printing cycle. In some embodiments, the debris comprises a byproduct of the three-dimensional printing. In some embodiments, the byproduct comprises splatter, spatter, or soot. In some embodiments, the debris comprises a starting material of the three-dimensional printing process. In some embodiments, the staring material comprises powder. In some embodiments, the starting material comprises elemental metal, metal alloy, an allotrope of elemental carbon, or ceramic. In some embodiments, the debris comprises elemental metal, metal alloy, an allotrope of elemental carbon, or ceramic. In some embodiments, the third inlet includes, or is configured to operatively couple with, a proximal valve configured to couple to the filtering container (e.g., through a channel). In some embodiments, the proximal valve is at least in part automatically controlled. In some embodiments, the proximal valve is at least in part manually controlled. In some embodiments, the proximal valve is at least in part wirelessly controlled. In some embodiments, the proximal valve is at least in part controlled via wire communication. In some embodiments, at least one automatically controllable component of the lid is configured to operatively coupling to a control system. In some embodiments, the device further comprises at least one automatically controllable component comprising a valve, or a sensor. In some embodiments, the control system utilizes at least one control scheme comprising feedback, feed forward, closed loop, or open loop. In some embodiments, the control system utilizes a control scheme based at least in part on data from the one or more sensors. In some embodiments, the control system is a hierarchical control system having three or more hierarchical control levels. In some embodiments, the device is part of the three-dimensional printing system, and where the control system is configured to control at least one other device in the three-dimensional printing system. In some embodiments, the at least one other device comprises an energy source, an energy beam, a scanner, a layer dispensing mechanism, a gas flow, a pump, a valve, an actuator, an elevator, a piston, a temperature conditioner, a door, or a window. In some embodiments, the control system is of the three-dimensional printing system. In some embodiments, the three-dimensional printing system is configured to print one or more three-dimensional objects in a printing cycle, and where the one or more three-dimensional objects (e.g., and the debris) comprise an elemental metal, a metal alloy, a ceramic, a polymer, a resin, or an allotrope of elemental carbon. In some embodiments, the one or more characteristics of the internal atmosphere comprises temperature, pressure, gas flow direction, gas flow velocity, gas flow acceleration, gas makeup, level (e.g., relative level such as percentage) of reactive agent, or level (e.g., relative level such as percentage) of the debris. In some embodiments, the passivating material is configured to passivate the debris from reacting with a reactive agent present in the ambient atmosphere (e.g., in ambient conditions); and where the insulating material insulates the debris at least in part from contacting a reactive agent present in the ambient atmosphere. In some embodiments, the passivator comprises an oxidizing agent. In some embodiments, the oxidizing agent comprises water. In some embodiments, the insulating agent comprises oil. In some embodiments, the second outlet is operatively coupled with an overfill prevention pipe, the at least one outlet port being for a quelling material comprising (i) a passivator or (ii) an insulator. In some embodiments, the overfill prevention pipe is configured to (i) increase a probability of retaining in the distal container gas disposed above the debris and any dilutive media when the distal container is closed with the lid, and (ii) reduce a probability of overfilling the distal with the quelling material, the distal container being closed with the lid. In some embodiments, the filtering container is configured to filter the debris by using (a) at least one filter disposed in the filtering container, (b) dilutive media disposed in the filtering container, and (c) gas flow in a first direction towards the filter during the filtering of the debris. In some embodiments, the filtering container is configured to facilitate contact between the dilutive media and the filter during filtering to promote separation of the filter from the debris during filtering of the debris. In some embodiments, the filtering container is configured to facilitate contact between the dilutive media and the filter at least in part by configuring to flow the gas flow in the first direction during filtering. In some embodiments, the filtering container is configured to facilitate release of (i) the dilutive media and/or (ii) the debris, from the filter at least in part by being configured to flow the gas flow in a second direction that comprises a directional component opposing the first direction. In some embodiments, the filtering container is configured to facilitate release from the filter of the debris accumulating on the dilutive media during the filtering, at least in part by being configured to flow the gas flow in the second direction. In some embodiments, the device is configured to receive the debris and any dilutive media after its release from the filter. In some embodiments, the device is configured to receive the debris and any dilutive media after its release from the filter, the debris and any dilutive media transitioning through the third inlet of the device at least in part using gravitational force towards the gravitational center of the ambient environment external to the device. In some embodiments, the dilutive media comprises particulate matter. In some embodiments, the dilutive media comprises particulate matter having a first material type different from a second material type of material of the dilutive media. In some embodiments, the dilutive media comprises ceramic, elemental metal, metal alloy, glass, stone, polymer, or resin. In some embodiments, flowing the gas in the second direction comprises continuous flow or pulsed flow. In some embodiments, the lid is configured to close a body of the distal container to enclose an internal atmosphere of the distal container. In some embodiments, the lid is configured to engage with the body in a gas tight manner at least in part by using a fastener comprising a seal, a clamp, or a retention strap. In some embodiments, the lid is configured to engage with the body in a gas tight manner at least in part by using a solid to solid contact, or a compressible seal. In some embodiments, the lid is configured to fasten to the body by one or more fasteners comprising a strap, a clamp, a lock, a lever, or a ring. In some embodiments, the lid is configured to operatively couple with, or include, at least one sensor indicative of (i) an amount of debris accumulating in the distal container and/or (ii) status of accumulation of material in the distal container, the material comprising the debris. In some embodiments, the at least one sensor comprises a sensor configured for material level detection. In some embodiments, the at least one sensor comprises an optical sensor. In some embodiments, the at least one sensor comprises a weight sensor, a material flow sensor, a proximity sensor, or a guided wave radar (GWR) system. In some embodiments, wherein the lid is configured to operatively couple to at least one sensor indicating that (i) a volume of any free volume in the distal container, (ii) an amount of any material in the distal container, which material in the distal container comprises the debris and/or (iii) a weight of the distal container with any of the material. In some embodiments, the lid is configured to operatively couple to at least one sensor indicating that a free volume in the distal container has diminished below a threshold. In some embodiments, the lid is configured to operatively couple to at least one sensor indicating that the amount of material in the distal container reached a threshold, which material in the distal container comprises the debris. In some embodiments, the lid is configured to operatively couple to at least one weight sensor. In some embodiments, the at least one weight sensor comprises at least one load cell. In some embodiments, the at least one weight sensor is disposed between a mounting plate and a top plate, the top plate being configured to support the distal container. In some embodiments, the top plate comprises supports configured to hinder lateral movement of the distal container. In some embodiments, the at least one load cell is configured to operatively couple with one or more controllers configured to control flow of the debris and any dilutive media through the third inlet of the lid and into the distal container closed by the lid. In some embodiments, the distal container closed by the lid is configured to enclose the internal atmosphere having at least one characteristic different from the ambient atmosphere external to the device. In some embodiments, the lid is configured for transmitting (i) the debris and (ii) any dilutive media from the filtering container and through the third inlet. In some embodiments, the dilutive media comprises particulate matter. In some embodiments, the dilutive media comprises ceramic, elemental metal, metal alloy, glass, stone, polymer, or resin. In some embodiments, flowing the gas in the second direction comprises continuous flow or pulsed flow. In some embodiments, the lid is configured to operatively coupled to a channel coupled to the filtering container through a channel to the distal container. In some embodiments, during debris filtering, the lid is configured to facilitate connection and disconnection of the third inlet from a channel coupled with the filtering container; where during operation the channel is disposed between the lid and the filtering container. In some embodiments, the connection and disconnection is reversible. In some embodiments, the device is configured to facilitate connection and disconnection of the lid from the filtering container during debris filtering at least in part by the lid remaining coupled with a channel during its connecting to the filtering container and during its disconnecting from the filtering container; where the channel is disposed between the distal container and the filtering container; and optionally where the connection and/or disconnection is reversible. In some embodiments, the device is configured to facilitate connection and disconnection of the lid with respect to the filtering container during debris filtering at least in part by the lid being respectively connected to or disconnected from a channel during its connecting or disconnecting from the filtering container; where the channel is disposed between the distal container and the filtering container; and optionally where the connection and/or disconnection is reversible. In some embodiments, the device is configured to facilitate reversible connection and disconnection of the distal container from the lid during debris filtering at the filtering container, and during accumulation of the debris and any dilutive media: (i) in the filtering container and/or (ii) in a collection container that is part of, or is operatively coupled with, the filtering container. In some embodiments, the device is configured to facilitate a flow of the debris from the filtering container to the distal container closed by the lid, and where (i) the device is configured to enclose an internal atmosphere in the distal container closed by the lid, the internal atmosphere having at least one characteristic different from an ambient atmosphere external to the device, and (ii) the device is configured to operatively couple to, or be a portion of, the three-dimensional printing system. In some embodiments, a printing atmosphere of the three-dimensional printing (A) comprises at least one reactive agent at a concentration that is lower than that in the ambient atmosphere and/or (B) is at a pressure above ambient pressure of the ambient atmosphere. In some embodiments, the device is configured to facilitate a flow of the debris from the filtering container to the distal container closed by the lid, and where (i) the lid is configured to enclose an internal atmosphere in the distal container closed by the lid, the internal atmosphere having at least one characteristic different from an ambient atmosphere external to the device, and (iii) the debris is a byproduct of a three-dimensional printing process. In some embodiments, the device is configured to facilitate a flow of the debris from the filtering container through the third inlet, and where (ii) the device is configured to operatively couple to, or be a portion of, a three-dimensional printing system, and (iii) the debris is a byproduct of a three-dimensional printing process. In some embodiments, the device is configured to facilitate a flow of the debris from the filtering container to the distal container closed by the lid, and where (i) the lid is configured to enclose an internal atmosphere in the container closed by the lid, the internal atmosphere having at least one characteristic different from an ambient atmosphere external to the device, (ii) the device is configured to operatively couple to, or be a portion of, a three-dimensional printing system, and (iii) the debris is a byproduct of a three-dimensional printing process.

In another aspect, an apparatus for debris filtering, the apparatus comprising one or more controllers configured to (a) operatively couple to any of the above devices; and (b) directing usage of at least one component of the device in association with filtering of the debris. In some embodiments, the one or more controllers utilize, or direct utilization of, at least one control scheme comprising feedback, feed forward, closed loop, or open loop. In some embodiments, the filtering container and/or the lid is operatively coupled with at least one sensor to which the one or more controllers are operatively coupled with, and where control by the one or more controllers is based at least in part on signals obtained from the at least one sensor. In some embodiments, the one or more controllers utilizes, or direct utilization of, a control scheme based at least in part on data from the one or more sensors. In some embodiments, the one or more controllers form, or are part of, a hierarchical control system having three or more hierarchical control levels. In some embodiments, the one or more controllers is configured to control, or direct control of, at least one other device in the three-dimensional printing system. In some embodiments, the one or more controllers are included in the control system of the three-dimensional printing system. In some embodiments, at least two operations are executed, or directed, by the same controller of the one or more controllers. In some embodiments, at least two operations are executed, or directed, by different controllers of the one or more controllers. In some embodiments, the one or more controllers controlling the device are different from at least one controller controlling the filtering container. In some embodiments, the one or more controllers and the at least one controller are operatively coupled with a control system controlling a three-dimensional printer configured for the three-dimensional printing. In some embodiments, the one or more controllers and the at least one controller are operatively coupled with the proximal valve. In some embodiments, the one or more controllers is coupled with the at least one controller.

In another aspect, non-transitory computer readable program instructions for debris filtering, the program instructions, when ready by one or more processors operatively couped to any of the above devices cause the one or more processors to execute, or direct execution of, one or more operations associated with filtering of the debris. In some embodiments, the one or more processors utilize, or direct utilization of, at least one control scheme comprising feedback, feed forward, closed loop, or open loop. In some embodiments, the filtering container and/or the lid is operatively coupled with at least one sensor to which the one or more processors are operatively coupled with, and where control executed, or directed, by the one or more processors is based at least in part on signals obtained from the at least one sensor. In some embodiments, the control utilizes a control scheme based at least in part on data from the one or more sensors. In some embodiments, the one or more processors form, or are part of, a hierarchical system having three or more hierarchical levels. In some embodiments, the one or more processors are configured to control, or direct control of, at least one other device in the three-dimensional printing system. In some embodiments, the one or more processors are included in the control system of the three-dimensional printing system. In some embodiments, the program instructions where at least two operations are executed, or directed, by the same processor the one or more processors. In some embodiments, the program instructions where at least two operations are executed, or directed, by different processors of the one or more processors. In some embodiments, the program instructions are embedded in a medium. In some embodiments, the program instructions are embedded in a different media. In some embodiments, the program instructions are first program instructions configured to control the device are different than second program instructions configured to control the filtering container. In some embodiments, the first program instruction and the second program instruction are configured to receive input and/or generate output relating to a proximal valve operatively coupled with the filtering container. In some embodiments, the program instructions where first program instructions and the second program instruction are configured to receive input and/or generate output from each other. In some embodiments, the first program instructions are read by the one or more processors that is a first one or more processors and the second program instructions are read by a second one or more processors. In some embodiments, the program instructions where first one or more processors and the second one or more processors are configured to receive input and/or generate output from each other. In some embodiments, the first program instructions and the second program instructions are part of a program instruction set configured to control the three-dimensional printing system configured for the three-dimensional printing.

In another aspect, a system for debris filtering in three-dimensional printing, the system comprising providing the three-dimensional printing system comprising, or operatively coupled with, any of the above devices; the three-dimensional printing system generating the debris during the three-dimensional printing.

In another aspect, a method for debris filtering, the method comprises providing any of the above devices; and using the device in association with filtering of the debris.

In another aspect, a method for debris disposal, the method comprises: (a) transferring an amount of the debris into a distal container closed by a lid, the amount reaching a first threshold being a first maximum threshold; (b) inserting quelling material into the distal container to engage the quelling material with the debris and form a content of the distal container, the quelling material reaching a second threshold being a second maximum threshold, the quelling material comprising a passivating material or an insulating material; and (c) transferring the distal container for disposal of the debris, the distal container comprising the content, where (i) at least during operation (a) and (b), the distal container closed by the lid comprises an internal atmosphere having at least one characteristic different from an ambient atmosphere external to the distal container closed by the lid, (ii) the distal container being configured to operatively couple with, or be a portion of, a three-dimensional printing system configured for the three dimensional printing, and/or (iii) the debris is a byproduct of the three-dimensional printing. In some embodiments, at least during operation (a) and (b), the distal container closed by the lid comprises an internal atmosphere having at least one characteristic different from an ambient atmosphere external to the distal container closed by the lid. In some embodiments, the distal container being configured to operatively couple with, or be a portion of, a three-dimensional printing system configured for the three dimensional printing. In some embodiments, the debris is a byproduct of the three-dimensional printing. In some embodiments, the method further comprises filtering the debris at least in part by using (a) at least one filter disposed in a filtering container, (b) dilutive media disposed in the filtering container, and (c) gas flow in a first direction towards the filter during the filtering of the debris. In some embodiments, during filtering in the filtering container, contacting between the dilutive media and the filter during filtering to promote separation of the filter from the debris during filtering of the debris. In some embodiments, during filtering in the filtering container, contacting between the dilutive media and the filter at least in part by flowing the gas flow in the first direction during filtering. In some embodiments, the method further comprises releasing (i) the dilutive media and/or (ii) the debris, from the filter at least in part by flowing the gas flow in a second direction that comprises a directional component opposing the first direction. In some embodiments, the method further comprises, releasing the debris accumulating on the dilutive media from the filter at least in part by being flowing the gas flow in the second direction. In some embodiments, the method further comprises transitioning the debris and any dilutive media to the distal container upon release from the filter. In some embodiments, during the transitioning of the debris and any dilutive media after release from the filter, the debris and any dilutive media transition at least in part using gravitational force directed towards the gravitational center of the ambient environment external to the device. In some embodiments, the dilutive media comprises particulate matter. In some embodiments, the dilutive media comprises particulate matter having a first material type different from a second material type of material of the dilutive media. In some embodiments, the dilutive media comprises ceramic, elemental metal, metal alloy, glass, stone, polymer, or resin. In some embodiments, flowing the gas in the second direction comprises continuous flow or pulsed flow. In some embodiments, the method further comprises determining the first threshold based at least in part on measuring of an amount of the debris and any dilutive media in the distal container, whether directly or indirectly. In some embodiments, measuring the amount of the debris and any dilutive media in the distal container is during (a). In some embodiments, measuring comprises weighing using a weighing system. In some embodiments, measuring comprises weighing using one or more sensors. In some embodiments, the one or more sensors comprise a load cell. In some embodiments, the one or more sensors comprise a guided wave radar. In some embodiments, the one or more sensors are configured to sense electromagnetic waves. In some embodiments, the method further comprises determining the second threshold based at least in part on using an overflow prevention pipe that is operatively coupled with the lid, or that is part of the lid, the overflow prevention pipe extending into an internal space of the distal container closed by the lid. In some embodiments, the method further comprises coupling the overflow prevention pipe with an exhaust channel disposed in an ancillary container filled at least in part with an indicator, the exhaust pipe having an exit opening disposed in the indicator. In some embodiments, the method further comprises observing expulsion of gas from the distal container closed by the lid, through the overflow prevention pipe, through the exhaust channel, and into the indicator. In some embodiments, the gas is of the internal atmosphere disposed in the distal container. In some embodiments, the indicator comprises a liquid or a semisolid material. In some embodiments, the indicator is indicative of (i) the gas flowing into the indicator, (ii) the gas ceasing to flow into the indicator, and/or (iii) the quelling material flowing into the indicator. In some embodiments, the method further comprises determining (A) when the quelling material flows into the indicator and/or (B) when the gas ceases to flow into the indicator. In some embodiments, the method further the indicator comprises a first flowable non-gaseous material, where the quelling material is a second flowable non-gaseous material, and where the indicator indicates (I) that the gas flows through the indicator by bubbling, and (II) that the gas ceases from flowing through the indicator by an absence of bubbling. In some embodiments, the first flowable non-gaseous material is the same material type as the second flowable non-gaseous material. In some embodiments, the first flowable non-gaseous material is a different material type than the second flowable non-gaseous material. In some embodiments, the first flowable non-gaseous material comprises a liquid, or a semisolid; and where the second flowable non-gaseous material comprises a liquid, or a semisolid. In some embodiments, the first flowable non-gaseous material comprises water or oil; and where the second flowable non-gaseous material comprises water or oil. In some embodiments, the method further comprises using one or more sensors to determine indication of the indicator. In some embodiments, the one or more sensors comprises an optical sensor, and audio senor, an olfactory sensor, or a chemical sensor; and optionally where the olfactory sensor is the chemical sensor. In some embodiments, the method further comprises using average human vision, hearing, and/or smelling, to determine indication of the indicator. In some embodiments, the method further comprises after operation (b) and before operation (c), allowing the quelling material to interact with the debris while in the distal container that is closed. In some embodiments, to interact comprises to chemically react. In some embodiments, to chemically react comprises to passivate the debris. In some embodiments, to interact comprises to insulate the debris. In some embodiments, allowing the quelling material to interact with the debris is for a predetermined time historically known to be sufficient for safe handling of the debris in the ambient environment by a user. In some embodiments, allowing the quelling material to interact with the debris is according to an indication known to be sufficient for safe handling of the debris in the ambient environment by a user. In some embodiments, the indication comprises at least one characteristic of an interior space of the distal container, the at least one characteristic comprising a temperature, a pressure, a level of a reactive agent, or a level of a reaction product. In some embodiments, the method further comprises exchanging the lid to another lid for disposal of the debris. In some embodiments, while allowing the quelling material to interact with the debris, the distal container is closed by the lid or by another lid. In some embodiments, the method further comprises exchanging the lid to another lid for disposal of the debris. In some embodiments, the method further comprises filtering the debris from a gas flow in a filtering container operatively coupled with the distal container. In some embodiments, the at least one characteristic of the internal atmosphere comprises temperature, pressure, gas flow direction, gas flow velocity, gas flow acceleration, gas makeup, level (e.g., relative level such as percentage) of reactive agent, or level (e.g., relative level such as percentage) of debris. In some embodiments, the method further comprises conveying the debris from the filtering container through a channel to the distal container. In some embodiments, the channel comprises a hose or a tube. In some embodiments, the channel comprises at least one flexible section; and optionally where the channel is flexible. In some embodiments, the internal atmosphere comprises (A) comprises at least one reactive agent at a concentration that is lower than that in the ambient atmosphere and/or (B) is at a pressure above ambient pressure of the ambient atmosphere. In some embodiments, a printing atmosphere of the three-dimensional printing (A) comprises at least one reactive agent at a concentration that is lower than that in the ambient atmosphere and/or (B) is at a pressure above ambient pressure of the ambient atmosphere. In some embodiments, the method further comprises printing the at least one three-dimensional object and generating the debris being filtered during the debris filtering. In some embodiments, the at least one three-dimensional (e.g., and the debris) comprise an elemental metal, a metal alloy, a polymer, a resin, an allotrope of elemental carbon, or a ceramic. In some embodiments, the method further sensing a weight of the distal container during and/or after the filtering. In some embodiments, sensing the weight is at least in part by using at least one weight sensor. In some embodiments, the at least one weight sensor comprises at least one load cell. In some embodiments, the at least one weight sensor is disposed between a mounting plate and a top plate, the top plate being configured to support the distal container. In some embodiments, the top plate comprises supports configured to hinder lateral movement of the distal container. In some embodiments, the at least one load cell is configured to operatively couple with one or more controllers configured to control flow of the debris and any dilutive media into the distal container. In some embodiments, the method further comprises controlling three-dimensional printing by a control system. In some embodiments, the method further comprises operatively coupling the distal container with a control system configured for controlling one or more operations of the method, and optionally controlling three-dimensional printing at least in part by the control system. In some embodiments, the control system comprises at least three hierarchical control levels. In some embodiments, the debris is prone to harmfully react with one or more reactive agents present in the ambient atmosphere, when the debris is exposed to the ambient atmosphere without further treatment comprising passivation or insulation. In some embodiments, the debris exits the filtering container without the further treatment. In some embodiments, the debris accumulates in the filtering container without the further treatment. In some embodiments, the passivating material comprises water. In some embodiments, the insulating material comprises oil. In some embodiments, the method further comprises flowing a less reactive gas from a gas source to the distal container, the a less reactive gas being less reactive with the debris as compared to a reactivity of the debris with the ambient atmosphere external to the distal container. In some embodiments, the less reactive gas comprises at least one reactive agent at a concentration that is lower than that in the ambient atmosphere. In some embodiments, the method further comprises flowing the less reactive gas into the distal container and into a channel disposed between the distal container and the filtering container. In some embodiments, flowing comprises purging. In some embodiments, the method further comprises sensing the at least one characteristic different from the ambient atmosphere external to the distal container closed by the lid. In some embodiments, sensing comprises (i) sensing a pressure and/or (ii) sensing a level of a reactive agent. In some embodiments, the reactive agent comprises oxygen or water. In some embodiments, the method further comprises engaging the lid of the distal container with a body of the distal container to form the distal container that is closed. In some embodiments, the method further comprises (e.g., reversibly) engaging a distal end of a channel with the distal container, and engaging a proximal end of the channel with a filtering container, the distal end opposing the proximal end, the channel configured to convey the debris therethrough. In some embodiments, engaging the distal end of the channel to the distal container is at least in part by engaging the distal end of the channel with the lid of the distal container. In some embodiments, engaging the proximal end of the channel with the filtering container through a proximal valve. In some embodiments, the channel comprises a hose or a tube. In some embodiments, the channel comprises at least one flexible section; and optionally where the channel is flexible. In some embodiments, the one or more characteristics of the internal atmosphere comprises temperature, pressure, gas flow direction, gas flow velocity, gas flow acceleration, gas makeup, level (e.g., relative level such as percentage) of reactive agent, or level (e.g., relative level such as percentage) of debris. In some embodiments, the one or more characteristics of the internal atmosphere comprises pressure, or level (e.g., relative level such as percentage) of reactive agent. In some embodiments, the internal atmosphere (A) comprises at least one reactive agent at a concentration that is lower than that in the ambient atmosphere and/or (B) is at a pressure above ambient pressure of the ambient atmosphere. In some embodiments, the method further comprises conveying the debris from the filtering container through a channel to the distal container. In some embodiments, the method further comprises removing the distal container and/or the channel during filtering of the debris in the filtering container. In some embodiments, the method further comprises exchanging the distal container and/or the channel during filtering of the debris in the filtering container. In some embodiments, the method further comprises removing the distal container and/or the channel during printing of one or more three-dimensional objects in a three-dimensional printing system generating the debris. In some embodiments, the method further comprises exchanging the distal container and/or the channel during printing of one or more three-dimensional objects in a three-dimensional printing system generating the debris. In some embodiments, the method further comprises operatively coupling the distal container to a weight sensor. In some embodiments, the method further comprises operatively coupling the distal container to a maneuvering mechanism. In some embodiments, the method further comprises operatively coupling the distal container with a control system configured for controlling one or more operations of the method, and optionally controlling three-dimensional printing at least in part by the control system. In some embodiments, the method further comprises operatively coupling the distal container with a control system configured for controlling one or more operations of the method, and optionally controlling three-dimensional printing at least in part by the control system. In some embodiments, the control system comprises at least three hierarchical control levels. In some embodiments, the method further comprises coupling the filtering container to the distal container having a proximal valve at least in part by (i) coupling the proximal valve to a proximal end of a channel having an opposing distal end, and (ii) coupling the distal end of the channel to a distal valve that is part of, or is coupled with, a lid of the distal container; where operations (i) and (ii) can be performed at any order. In some embodiments, the method further comprises shutting the distal valve prior to engaging the distal end of a channel with the lid through the distal valve. In some embodiments, the method further comprises shutting the proximal valve prior to engaging the proximal end of the channel with the filtering container through the proximal valve. In some embodiments, prior to engaging the proximal end of the channel with the filtering container through the proximal valve, the method further comprises (i) opening the distal valve and (ii) conditioning an internal atmosphere disposed in the distal container and/or in the channel, to have the at least one characteristic different from the ambient atmosphere external to the device. In some embodiments, conditioning the internal atmosphere is relative to one or more thresholds. In some embodiments, the method further comprises operatively coupling the distal container to a gas source from which a less reactive gas flows, the a less reactive gas being less reactive with the debris as compared to an ambient atmosphere external to the distal container. In some embodiments, the less reactive gas comprises at least one reactive agent in a concentration that is lower than that in the ambient atmosphere. In some embodiments, the method further comprises flowing the less reactive gas (e.g., robust gas) into the first interior volume and/or into the second interior volume. In some embodiments, flowing comprises purging. In some embodiments, the method further comprises sensing the at least one characteristic different from the ambient atmosphere external to the distal container when closed with the lid. In some embodiments, the method further comprises controlling the purging at least in part by using the at least one characteristic sensed. In some embodiments, sensing the at least one characteristic comprises (i) sensing a pressure and/or (ii) sensing a level of a reactive agent. In some embodiments, the reactive agent comprises oxygen or water. In some embodiments, the method further comprises controlling flow of the less reactive gas based at least in part on sensing the at least one characteristic different from the ambient atmosphere. In some embodiments, the method further comprises engaging a maneuvering device with the distal container after, before, or during disengagement of the distal container from the filtering container. In some embodiments, the method further comprises maneuvering the distal container with respect to the filtering container. In some embodiments, the method further comprises maneuvering the distal container to a passivation station, to storage, or for disposal. In some embodiments, the maneuvering mechanism comprises a vehicle or an aircraft. In some embodiments, the maneuvering mechanism comprises a forklift, a cart, or a drone. In some embodiments, the maneuvering mechanism comprises a robot. In some embodiments, the method further comprises (i) automatically maneuvering or (ii) autonomously maneuvering, the maneuvering device. In some embodiments, the method further comprises remotely operating the maneuvering mechanism. In some embodiments, the method further comprises engaging with the distal container a source of the quelling material. In some embodiments, in the distal container, during interaction of the debris with the quelling material, the distal container comprises an atmosphere that is less reactive with the debris as compared to the ambient atmosphere external to the distal container. In some embodiments, the method further comprises ceasing introduction of the quelling material into the distal container once excess material is expelled through an exit port having an overfill prevention pipe. In some embodiments, the method further comprises using the overfill prevention pipe to (i) increase a probability of retaining in the distal container gas above the debris and any dilutive media, the distal container being closed with the lid, and (ii) reduce a probability of overfilling the distal container with the quelling material. In some embodiments, the passivating material is the insulating material. In some embodiments, the quelling material comprises a liquid or a flowable semisolid. In some embodiments, the quelling material comprises a gaseous material. In some embodiments, the passivating material comprises an oxidizing agent. In some embodiments, the passivating material comprises oxygen or water. In some embodiments, the passivating material comprises a material reactive with the debris to form a reaction product is that is less harmfully (e.g., violently) reactive with the ambient atmosphere under normal conditions presiding in the ambient environment external to the distal container, wherein less harmfully reactive comprises not harmfully reactive. In some embodiments, not violently reactive comprises (i) not measurably reactive, (ii) controllably reactive, or (iii) moderately reactive. In some embodiments, not violently reactive comprises (i) a non-exothermic reaction, (ii) an endothermic reaction, (ii) a reaction that does not generate measurable fumes, splatter, spatter, flashes, or flames, (iii) a reaction that elevates the temperature of the debris by at most about 50 degrees Celsius (° C.), 30° C., or 10° C., or (iv) a reaction that elevates the pressure in the distal container by at most about 1 pounds per square inch (PSI), 0.5 PSI, 0.25 PSI, or 0.1 PSI above ambient pressure external to the distal container (when closed with the lid). In some embodiments, the passivating material comprises water in the form of solid, liquid, vapor, suspension, gas borne droplets, snow, or as part of a semisolid. In some embodiments, the insulating material comprises a hydrophobic material. In some embodiments, the hydrophobic material comprises a paraffin, or an oil. In some embodiments, the passivating material is configured to react with a surface of the debris to form an oxide. In some embodiments, engaging a source of the quelling material with the distal container is with an ingress port of the distal container. In some embodiments, the ingress port is disposed at the lid of the container. In some embodiments, the method further comprises inserting the quelling material. In some embodiments, the method further comprises inserting into an interior of the distal container the quelling material into the distal container is to (i) passivate the debris and/or (ii) insulate the debris, with respect to the ambient atmosphere. In some embodiments, the method further comprises exchanging a lid of the distal container after the debris has been (i) passivated and/or (ii) insulated to a degree that is safely handled by a user (e.g., per jurisdictional standards). In some embodiments, the lid is a first lid, and where the first lid is exchanged to a second lid that, as compared to the first lid, is cheaper, simpler, and/or more ubiquitous. In some embodiments, the first lid and/or the second lid comprises at least one vent valve. In some embodiments, the method further comprises disposing of the distal container.

In another aspect, an apparatus for debris filtering, the apparatus comprising one or more controllers configured to execute, or direct execution of, one or more operations of any of the methods above. In some embodiments, the one or more controllers utilize, or direct utilization of, at least one control scheme comprising feedback, feed forward, closed loop, or open loop. In some embodiments, the one or more controllers comprise at least one connector configured to connect to a power source. In some embodiments, the one or more controllers being configured to operatively couple to a power source at least in part by (I) having a power socket and/or (II) being configured for wireless power transfer using inductive charging. In some embodiments, the filtering container, the lid, the channel, and/or the distal container is operatively coupled with at least one sensor to which the one or more controllers are operatively coupled with, and where control by the one or more controllers is based at least in part on signals obtained from the at least one sensor. In some embodiments, the one or more controllers utilizes, or direct utilization of, a control scheme based at least in part on data from the one or more sensors. In some embodiments, the one or more controllers form, or are part of, a hierarchical control system having three or more hierarchical control levels. In some embodiments, the one or more controllers is configured to control, or direct control of, at least one other device in the three-dimensional printing system. In some embodiments, the one or more controllers are included in a control system of the three-dimensional printing system. In some embodiments, at least two operations are executed, or directed, by the same controller of the one or more controllers. In some embodiments, at least two operations are executed, or directed, by different controllers of the one or more controllers.

In another aspect, non-transitory computer readable program instructions for debris filtering, the program instructions, when ready by one or more processors, cause the one or more processors to execute, or direct execution of, one or more operations of any of the methods above In some embodiments, the one or more processors utilize, or direct utilization of, at least one control scheme comprising feedback, feed forward, closed loop, or open loop. In some embodiments, the filtering container and/or the distal container is operatively coupled with at least one sensor to which the one or more processors are operatively coupled with, and where control executed, or directed, by the one or more processors is based at least in part on signals obtained from the at least one sensor. In some embodiments, the control utilizes a control scheme based at least in part on data from the one or more sensors. In some embodiments, the one or more processors form, or are part of, a hierarchical system having three or more hierarchical levels. In some embodiments, the one or more processors are configured to control, or direct control of, at least one other device in the three-dimensional printing system. In some embodiments, the one or more processors are included in a control system of the three-dimensional printing system. In some embodiments, the program instructions where at least two operations are executed, or directed, by the same processor the one or more processors. In some embodiments, the program instructions where at least two operations are executed, or directed, by different processors of the one or more processors. In some embodiments, the program instructions are embedded in a medium. In some embodiments, the program instructions are embedded in a different media. In some embodiments, the program instructions are first program instructions configured to control the distal container are different than second program instructions configured to control the filtering container; and optionally where the first program instructions are configured to control (i) one or more sensors operatively coupled with the distal container, (ii) one or more valves operatively coupled with the distal container, (iii) one or more sensors operatively coupled with a channel that is coupled with the distal container, (iv) one or more valves operatively coupled with the channel that is coupled with the distal container, (v) one or more sensors operatively coupled with a lid that is coupled with the distal container, (vi) one or more valves operatively coupled with the lid that is coupled with the distal container, or (v) any combination thereof. In some embodiments, the first program instruction and the second program instruction are configured to receive input and/or generate output relating to the proximal valve. In some embodiments, the program instructions where first program instructions and the second program instruction are configured to receive input and/or generate output from each other. In some embodiments, the first program instructions are read by the processor that is a first processor and the second program instructions are read by a second processor. In some embodiments, the program instructions where first processor and the second processor are configured to receive input and/or generate output from each other. In some embodiments, the first program instructions and the second program instructions are part of a program instruction set configured to control a three-dimensional printer configured for the three-dimensional printing.

In another aspect, a device for debris filtering, the device being configured to effectuate one or more operations of the method in any of the above methods.

Another aspect of the present disclosure provides systems, apparatuses, controllers, and/or non-transitory computer-readable medium (e.g., software) that implement any of the methods disclosed herein.

In another aspect, an apparatus for printing one or more 3D objects comprises a controller (or controllers) that is/are programmed to direct a mechanism used in a 3D printing methodology to implement (e.g., effectuate) any of the method disclosed herein, wherein the controller is operatively coupled with (e.g., to) the mechanism.

In another aspect, the one or more controllers disclosed herein comprise a computer software product, e.g., as disclosed herein.

In another aspect, a computer software product, comprising a non-transitory computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with (e.g., to) the mechanism.

Another aspect of the present disclosure provides a device (e.g., apparatus) for effectuating the methods, operations of an apparatus, and/or operations inscribed by non-transitory computer readable program instructions (e.g., inscribed on a media/medium).

Another aspect of the present disclosure provides a system for effectuating the methods, operations of an apparatus, and/or operations inscribed by non-transitory computer readable program instructions (e.g., inscribed on a media/medium), disclosed herein.

Another aspect of the present disclosure provides systems, apparatuses (e.g., controller(s)), and/or non-transitory computer-readable program instructions (e.g., software) that implement any of the methods disclosed herein. The program instructions can be inscribed on at least one medium (e.g., on a medium or on media).

In another aspect, an apparatus (e.g., for printing one or more 3D objects and/or for treatment of debris) comprises at least one controller that is programmed to direct a mechanism used in a 3D printing methodology to implement (e.g., effectuate) any of the method and/or operations disclosed herein, wherein the controller(s) is operatively coupled with (e.g., to) the mechanism. The controller(s) may implement any of the methods and/or operations disclosed herein. The controller may comprise, or be operatively coupled with (e.g., to), a hierarchical control system. The hierarchical control system may comprise at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects and/or for treatment of debris) comprises at least one controller that is programmed to implement (e.g., effectuate), or direct implementation of, the method, process, and/or operation disclosed herein. The controller may implement any of the methods, processes, and/or operations disclosed herein.

In another aspect, non-transitory computer readable program instructions (e.g., for printing one or more 3D objects and/or for treatment of debris), when read by one or more processors, is configured to execute, or direct execution of, the method, process, and/or operation disclosed herein. The controller may implement any of the methods, processes, and/or operations disclosed herein. At least a portion of the one or more processors can be part of a 3D printer, outside of the 3D printer, in a location remote from the 3D printer (e.g., in the cloud).

In another aspect, a system for printing one or more 3D objects comprises an apparatus (e.g., used in a 3D printing methodology and/or used in treatment of debris) and at least one controller that is programmed to direct operation of the apparatus, wherein the at least one controller is operatively coupled with (e.g., to) the apparatus. The apparatus may include any apparatus or device disclosed herein. The at least one controller may implement, or direct implementation of, any of the methods disclosed herein. The at least one controller may direct any apparatus (or component thereof) disclosed herein.

In another aspect, a computer software product, comprising a non-transitory computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with (e.g., to) the mechanism. Wherein the mechanism comprises an apparatus or an apparatus component.

Another aspect of the present disclosure provides a non-transitory computer-readable medium/media comprising machine-executable code that, upon execution by one or more computer processors, implements any of the methods and/or operations disclosed herein.

Another aspect of the present disclosure provides a non-transitory computer-readable medium comprising machine-executable code that, upon execution by one or more computer processors, effectuates directions of the controller(s), e.g., as disclosed herein.

Another aspect of the present disclosure provides a computer system comprising one or more computer processors and a non-transitory computer-readable medium/media coupled thereto. The non-transitory computer-readable medium comprises machine-executable code that, upon execution by the one or more computer processors, implements any of the methods disclosed herein and/or effectuates directions of the controller(s) disclosed herein.

In another aspect, a method of operating a data-processing system comprising any method described herein.

In another aspect, a data-processing apparatus or system comprising means for carrying out any method described herein.

In another aspect, a computer program (e.g., product) adapted to perform any method described herein.

In another aspect, a computer readable storage medium, media, or data carrier comprising any program (e.g., software) described herein.

In another aspect, a computer program product comprising instructions that, when read by one or more processors operatively coupled with (e.g., to) any mechanism described herein, cause the mechanism to execute one or more operations of any of the methods described herein, wherein the mechanism comprises an apparatus, device, system, or any of their components.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.,” “FIGs.,” “Fig.,” and “Figs.” herein), of which:

FIG. 1 schematically illustrates a side view of a three-dimensional (3D) printer and its components;

FIG. 2 schematically illustrates a side view of a 3D printer and its components;

FIG. 3 schematically illustrates a side view of components in a 3D printer;

FIG. 4 schematically illustrates a side view of a 3D printer and its components;

FIG. 5 schematically illustrates a side view of a 3D printer and its components;

FIG. 6 schematically illustrated various components of a 3D printing system and portions thereof;

FIG. 7 schematically illustrates a 3D printing system and a user;

FIG. 8 schematically illustrates various components of a 3D printing system and portions thereof;

FIG. 9 illustrates a path;

FIG. 10 schematically illustrates a computer control system that is programmed or otherwise configured to facilitate the formation of one or more 3D objects;

FIG. 11 schematically illustrates various 3D printer components;

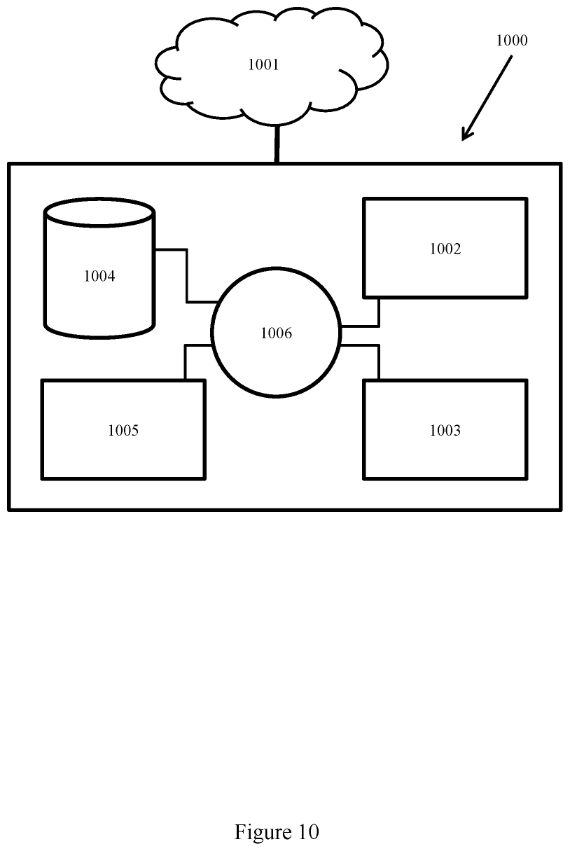

FIG. 10 schematically illustrates a side view of a 3D printer and its components;

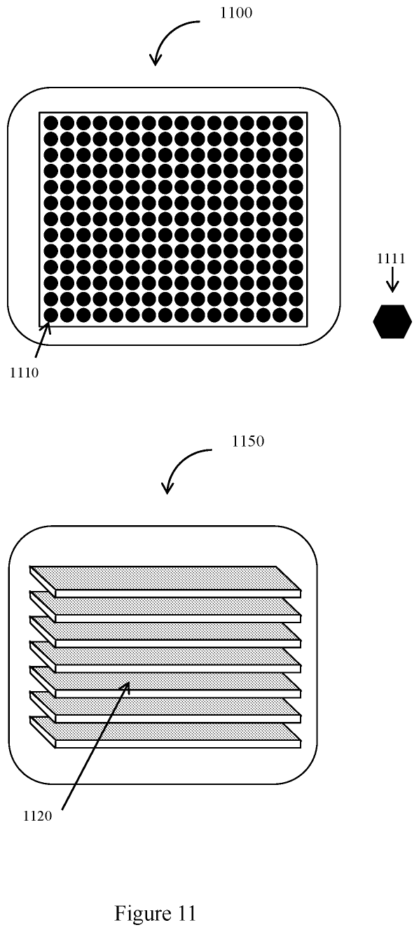

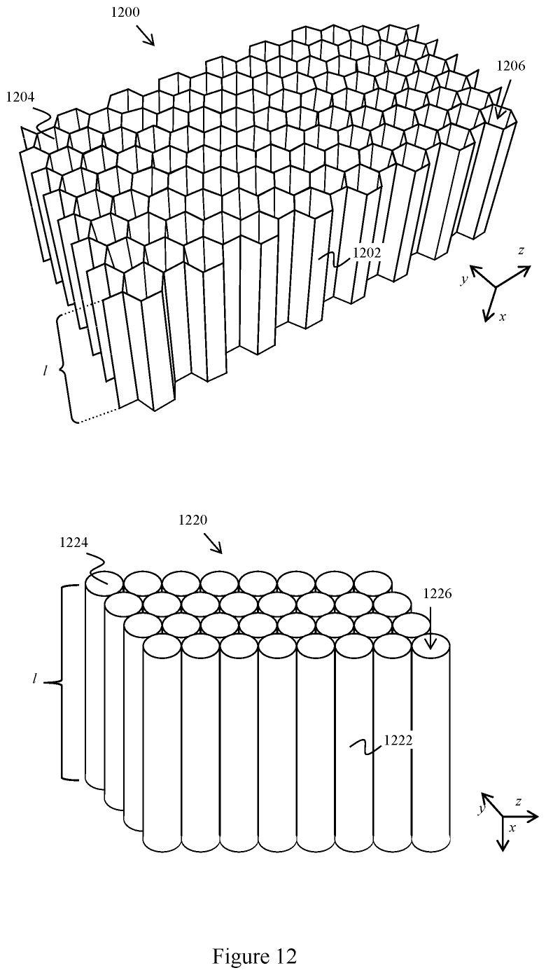

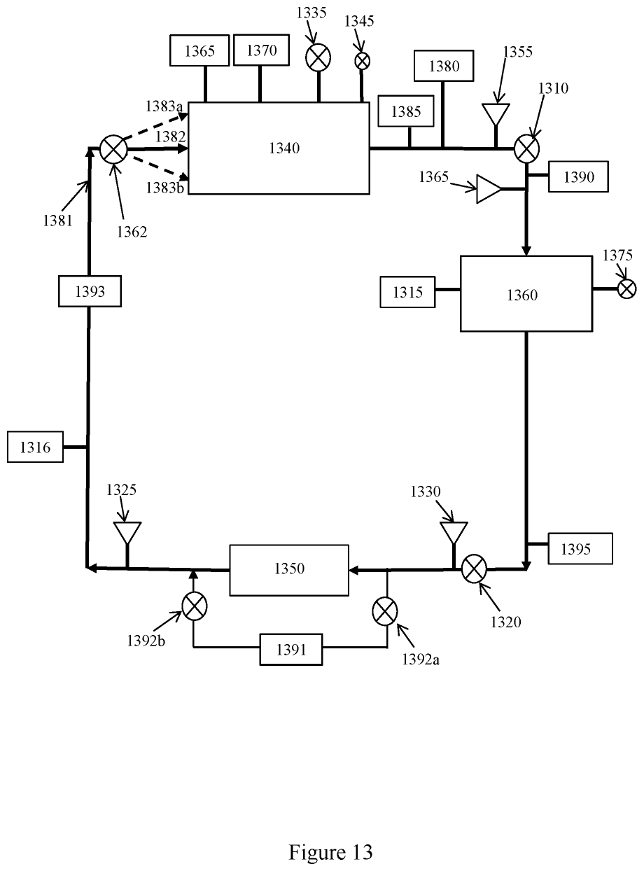

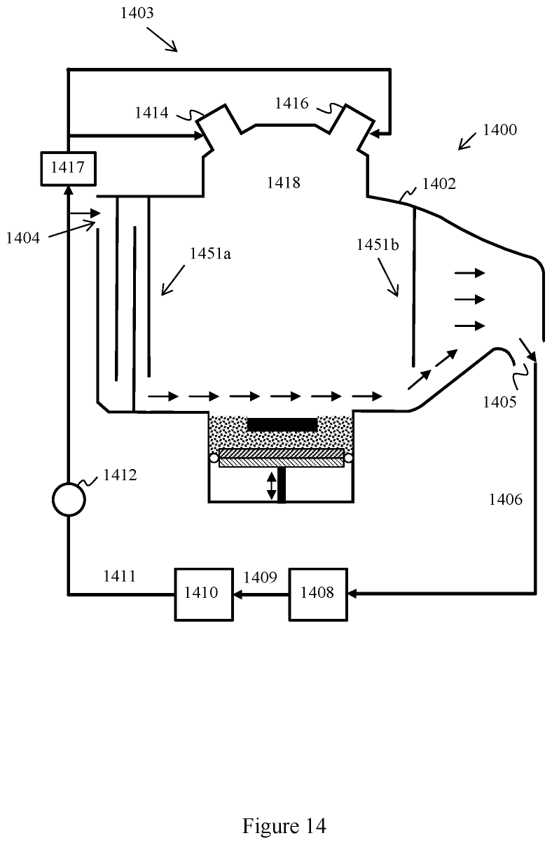

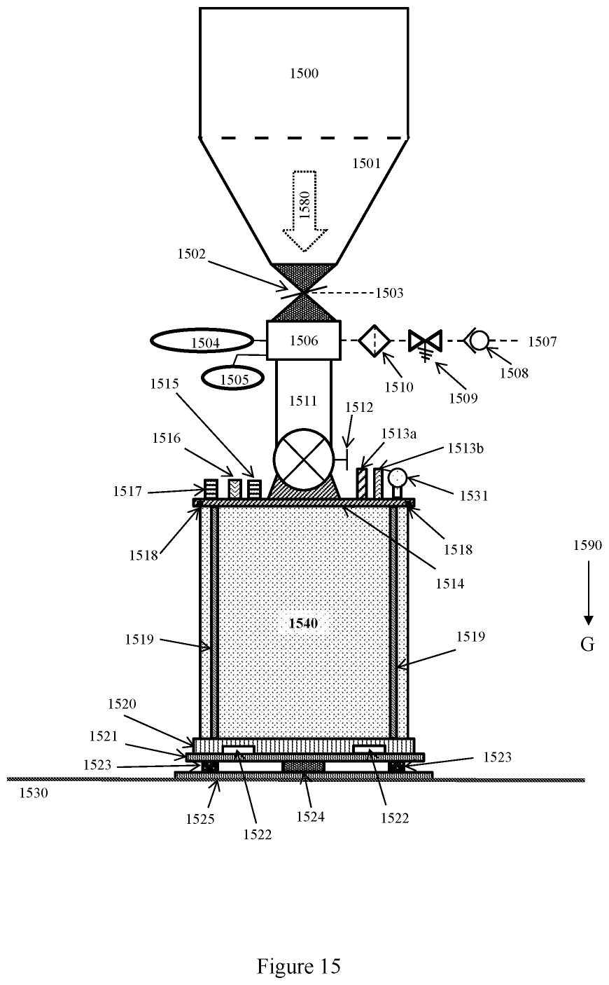

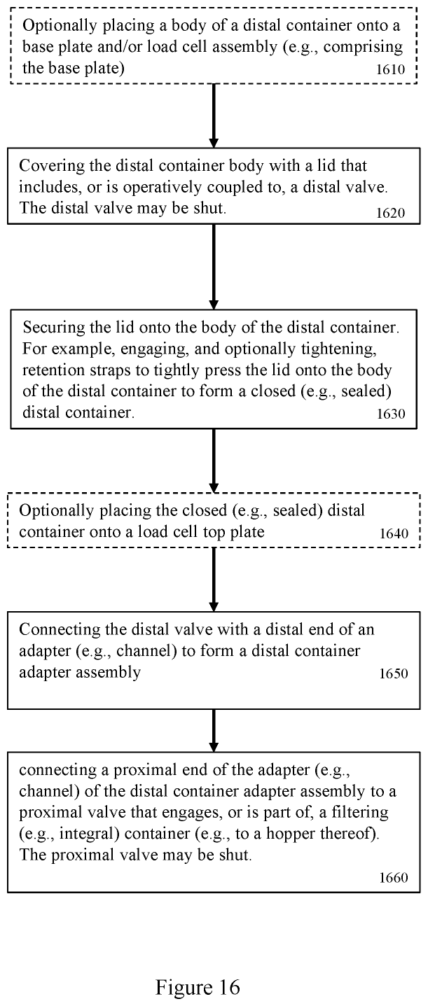

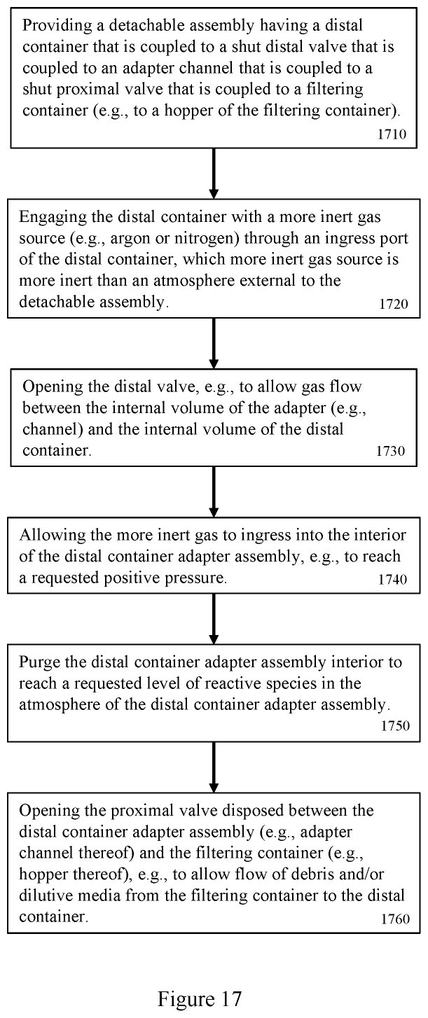

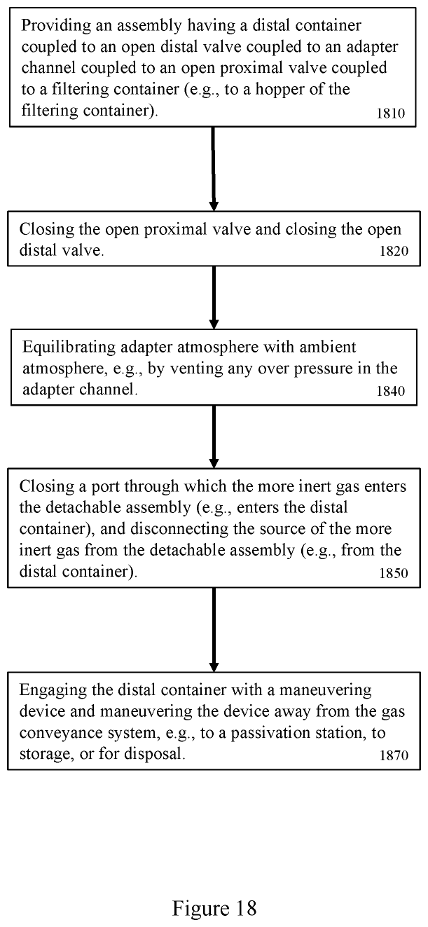

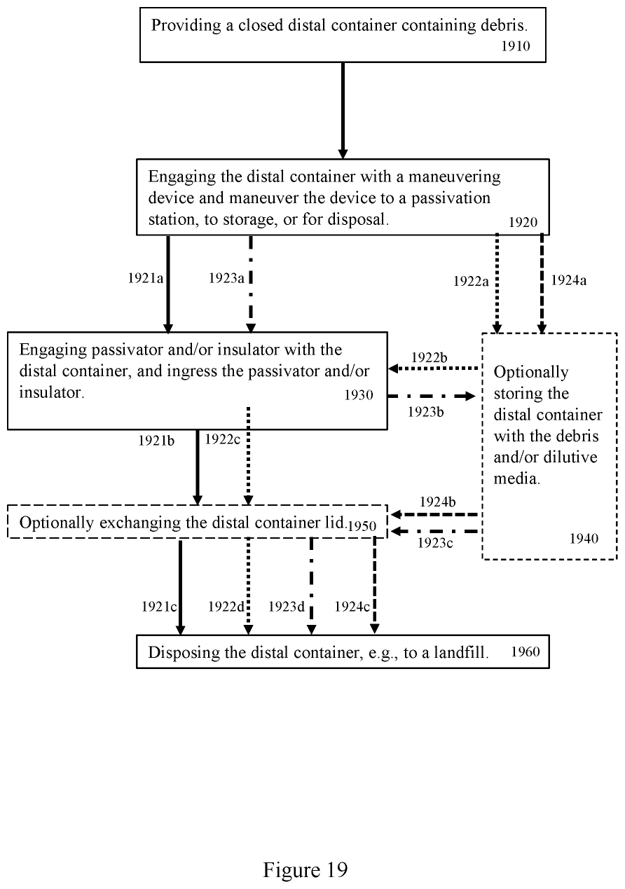

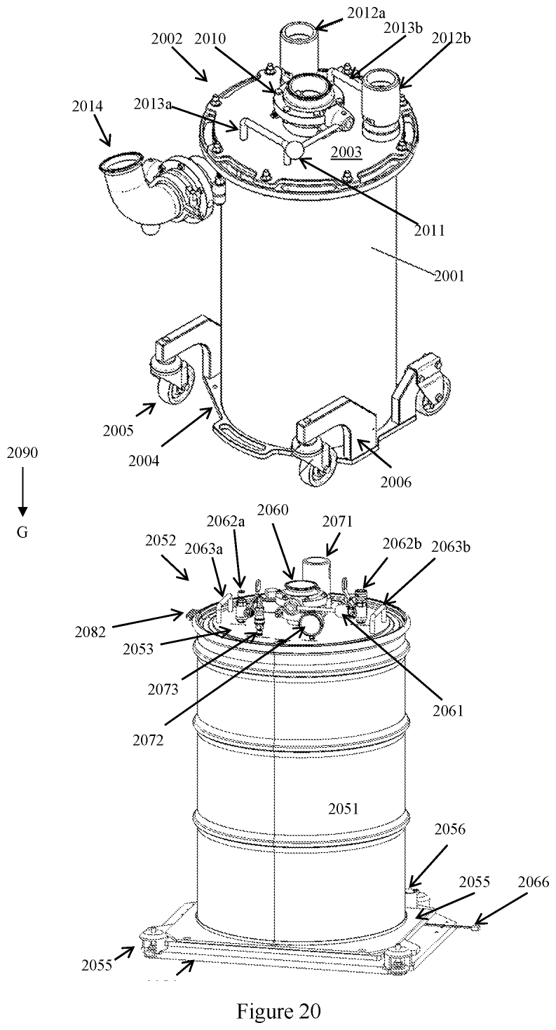

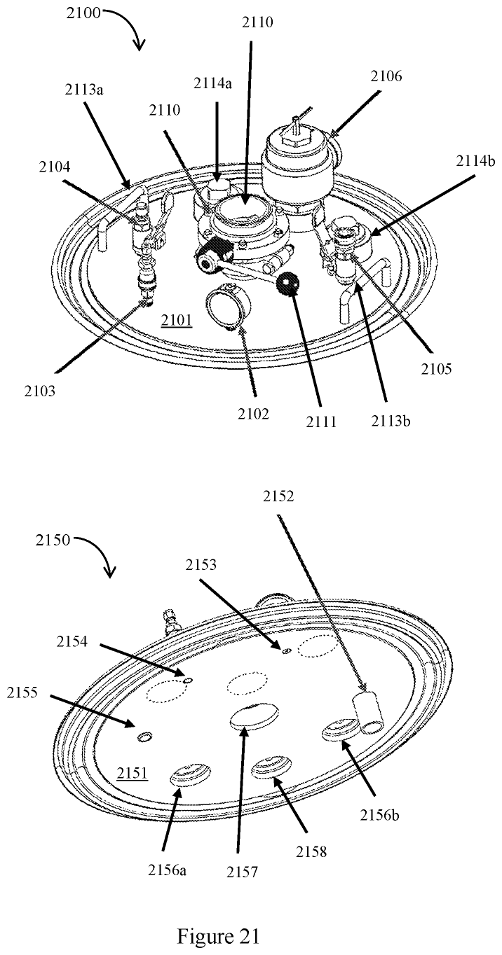

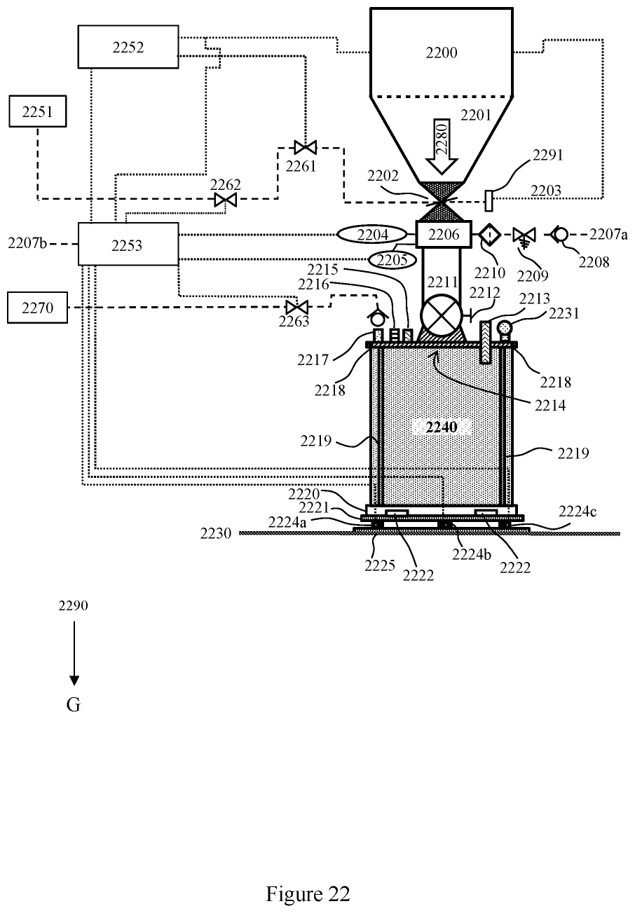

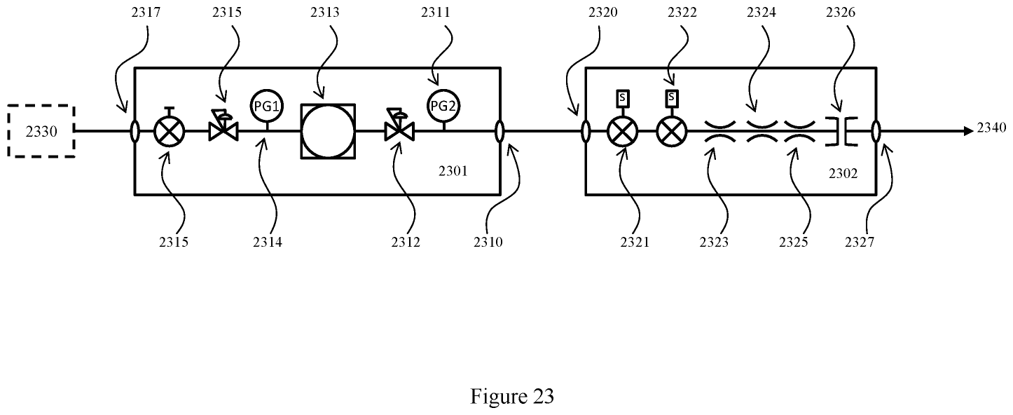

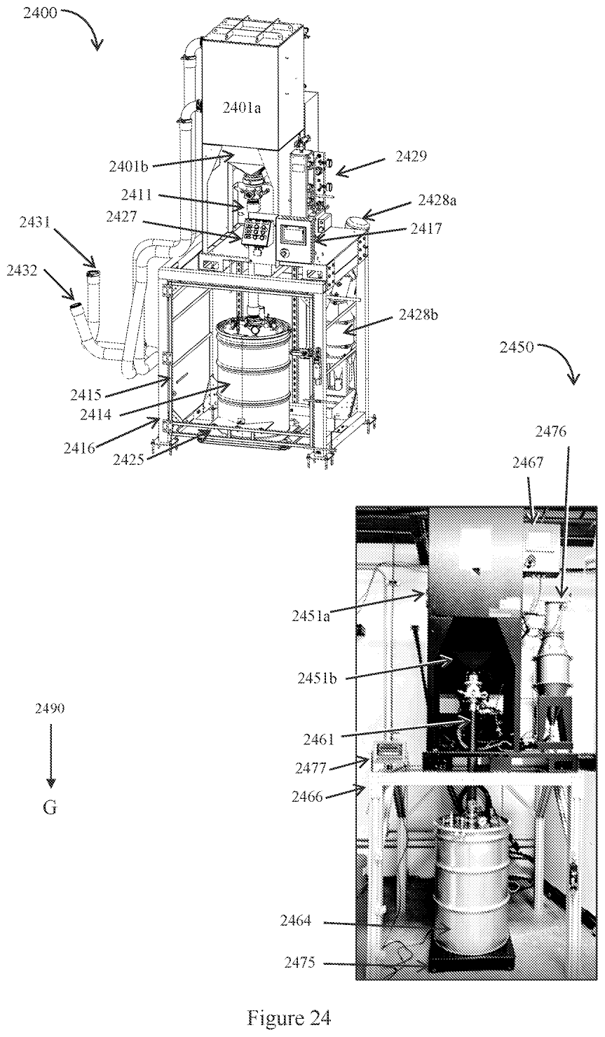

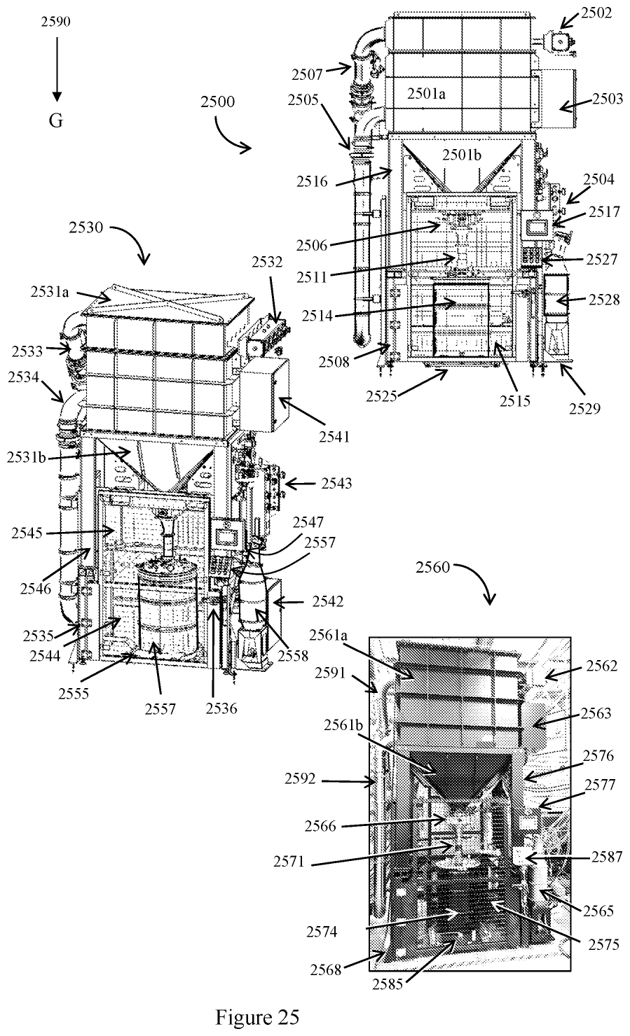

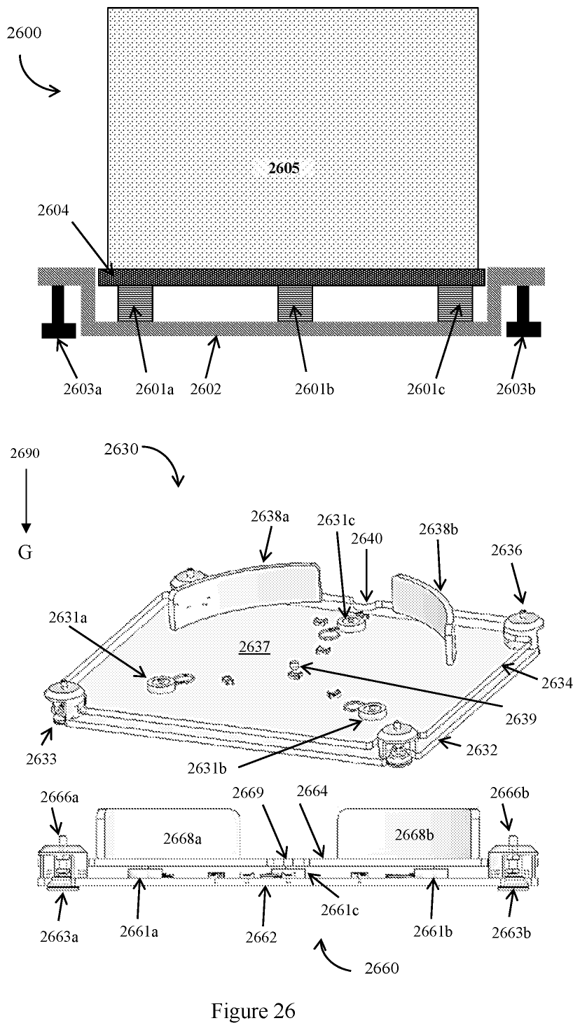

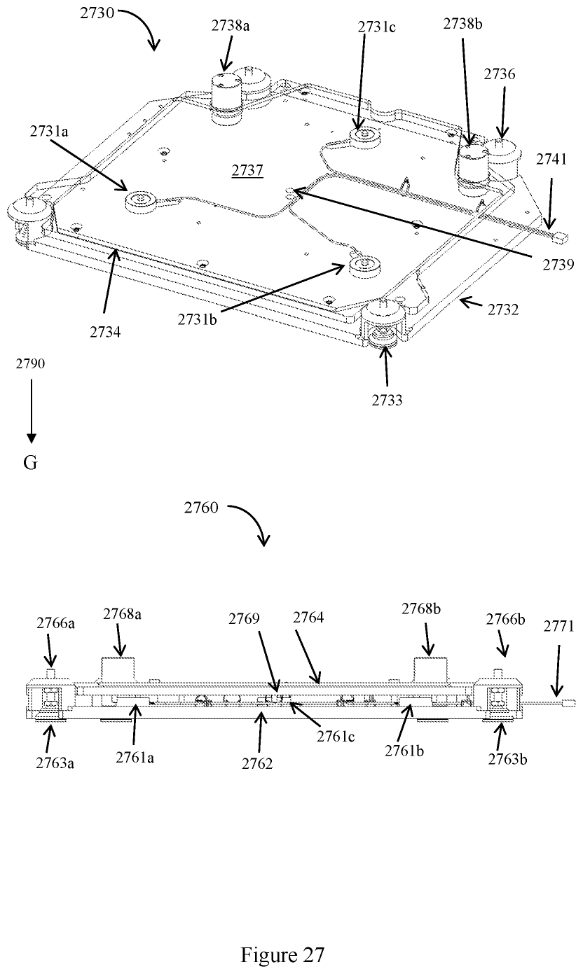

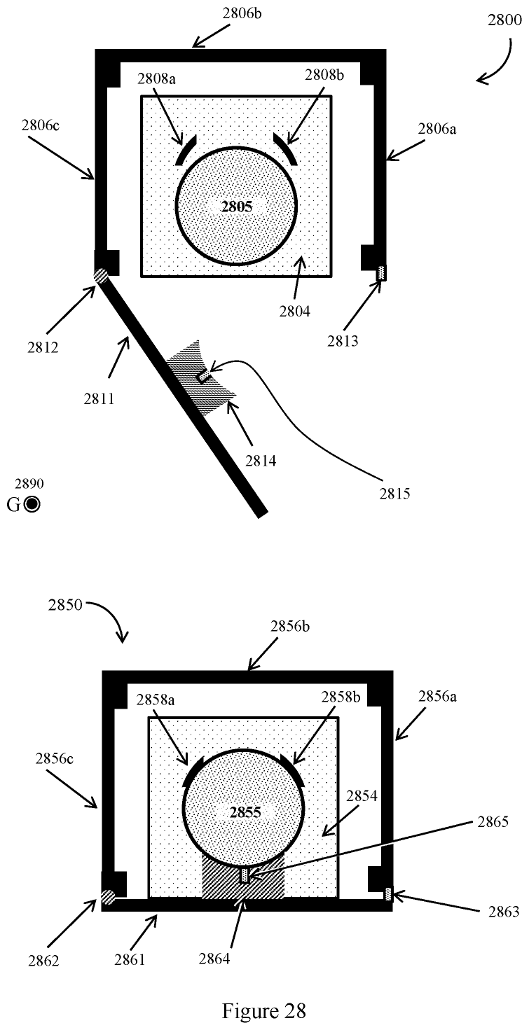

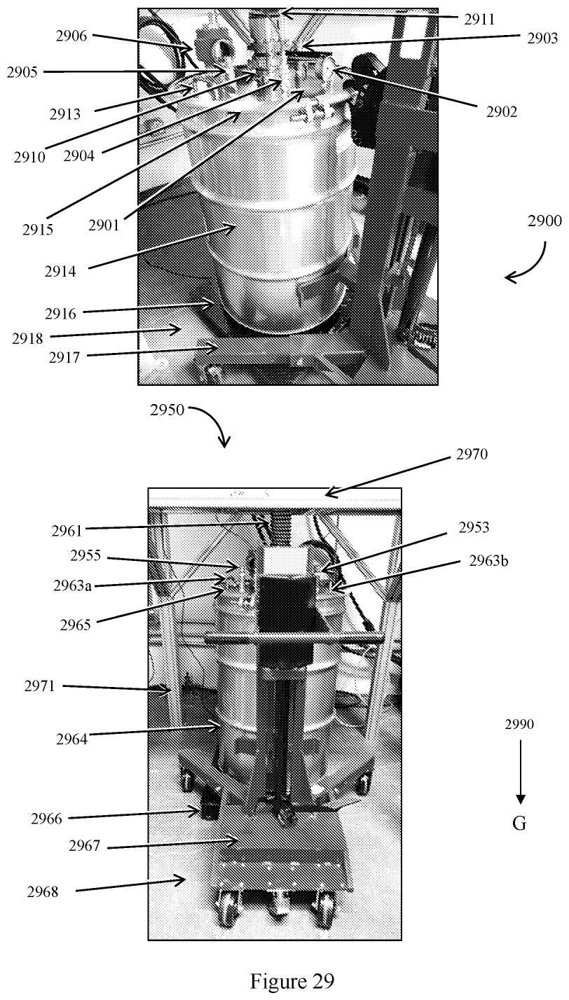

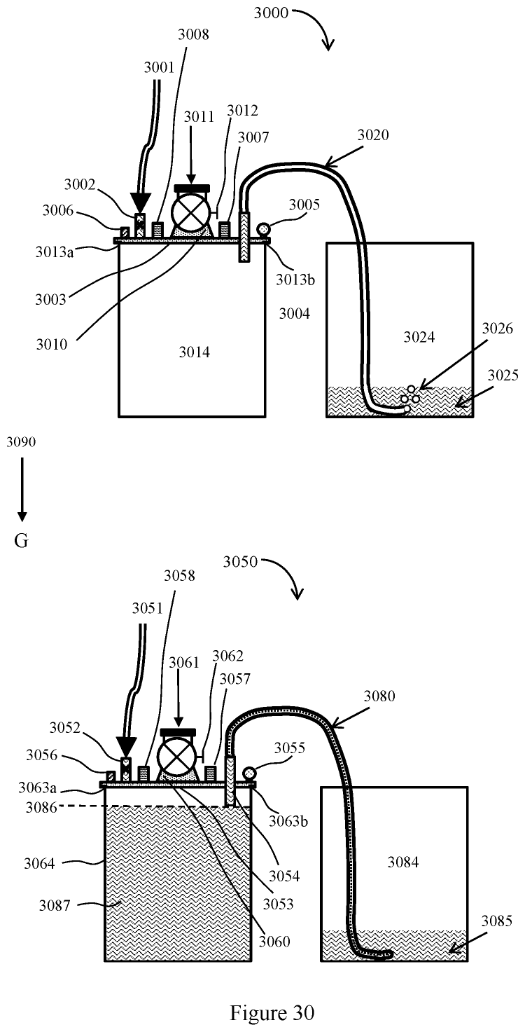

FIG. 11 schematically illustrates a side view of a component of a 3D printer;

FIG. 12 schematically illustrate perspective views of components of a 3D printer;

FIG. 13 schematically illustrates a side view of a component of a 3D printer;

FIG. 14 schematically illustrates a side view of a 3D printer and its components;

FIG. 15 schematically illustrates a side view of a filtering mechanism;

FIG. 16 shows a flowchart of operations relating to a filtering mechanism;

FIG. 17 shows a flowchart of operations relating to a filtering mechanism;

FIG. 18 shows a flowchart of operations relating to a filtering mechanism;

FIG. 19 shows a flowchart of operations relating to passivation;

FIG. 20 shows various perspective view examples of distal containers and associated components;

FIG. 21 shows perspective views of lids and associated components;

FIG. 22 shows a schematic view of a filtering system and associated components;

FIG. 23 shows a schematic view of a portion of a gas conveyance system;

FIG. 24 shows various view of a filtering system and associated components;

FIG. 25 shows various view of a filtering system and associated components;

FIG. 26 shows various view of a weighing system and associated components;

FIG. 27 shows various view of a weighing system and associated components;

FIG. 28 shows various views of a housing with a distal container disposed above a weighing system;

FIG. 29 shows various views of distal containers and associated components and a maneuvering mechanism; and

FIG. 30 shows various views of distal containers and associated components.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a,” “an” and “the” are not intended to refer to only a singular entity, but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) their endpoint(s) is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in X and/or Y (including in the specification and claims) is meant to include (i) X, (ii) Y, and (iii) X and Y. The conjunction of “and/or” in the phrase “including X, Y, and/or Z” is meant to include any combination and plurality thereof. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) can be referred herein as to any suitable scale (e.g., dimension) of an object. For example, a FLS of an object may comprise a length, a width, a height, a diameter, a spherical equivalent diameter, or a diameter of a bounding sphere. In some cases, FLS may refer to an area, a volume, a shape, or a density.

A central tendency as understood herein comprises mean, median, or mode. The mean may comprise a geometric mean.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter.

Where suitable, one or more of the features shown in a figure comprising a 3D printer and/or components thereof can be combined with one or more of the various features of other 3D printers and/or components thereof described herein. Any figure shown herein may not show certain features of a 3D printer and/or components thereof described herein. It should be understood that any such features can be incorporated within the 3D printer as desired and where suitable.

The present disclosure provides three-dimensional (3D) printing apparatuses, systems, software, and methods for forming a 3D object. For example, a 3D object may be formed by sequential addition of material or joining of pre-transformed material to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid, phase.

The 3D printing process may comprise printing one or more layers of hardened material in a building cycle (e.g., printing cycle). A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single material bed). The one or more 3D object(s) may or may not be physically anchored to the platform (e.g., a build platform) above which it/they are printed.

“Real time” as understood herein may be during at least part of an operation. In an example, the operation is at least part of: the printing of 3D object(s), filtering debris, passivating debris, insulation debris, and/or performing a safe disposal procedure. Real time may be during a print operation. Real time may be during a print cycle.

Pre-transformed material, as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process. The powder material may comprise an atomized powder. The atomized powder may be generated using an inert gas (e.g., comprising nitrogen or argon gas). At times, reactivity of the powder (e.g., surface thereof) to reactive agent(s) differs depending on (i) the central tendency of their FLS, (ii) the distribution of the central tendency, and/or (iii) the gas type used for the atomization process. In an example, powders atomized with nitrogen may have a different (e.g., slower and/or lesser degree of) reactivity with the reactive agent(s) as compared to powder atomized with argon. Powder particles having larger FLS may have a slower and/or lesser degree of reactivity with the reactive agent(s). Powder particles having a lower exposed surface to volume ratio may have a slower and/or lesser degree of reactivity with the reactive agent(s).

In a 3D printing process, the deposited pre-transformed material may be fused, (e.g., sintered or melted), bound or otherwise connected to form at least a portion of the requested (e.g., desired) 3D object. Fusing, binding or otherwise connecting the material is collectively referred to herein as “transforming” the material. Fusing the material may refer to melting, smelting, or sintering a pre-transformed material. Melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object, but may be utilized to generate one or more 3D objects simultaneously (e.g., in parallel) or separately (e.g., sequentially). The multiplicity of 3D object may be formed in one or more material beds (e.g., powder bed). In some embodiments, a plurality of 3D objects is formed in one material bed.

In some examples, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In some embodiments, the deposited pre-transformed material within the enclosure comprises a liquid material, semi-solid material (e.g., gel), or a solid material (e.g., powder). In some embodiments, the pre-transformed material is powder. The deposited pre-transformed material within the enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and a metal alloy, a metal alloy and a ceramic, a metal alloy and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than one member of a type of material.

In some examples the material bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The material bed may comprise a particulate material (e.g., powder). In some examples the material (e.g., powder, and/or 3D printer component) may comprise a material characterized in having high electrical conductivity, low electrical resistivity, high thermal conductivity, or high density. The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times.” The high electrical conductivity can be between any of the afore-mentioned electrical conductivity values (e.g., from about 1*10⁵ S/m to about 1*10⁸ S/m). The thermal conductivity, electrical resistivity, electrical conductivity, and/or density can be measured at ambient temperature (e.g., at R.T., or 20° C.). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸ or 1*10⁻⁸ Ω*m. The low electrical resistivity can be between any of the afore-mentioned values (e.g., from about 1×10⁻⁵ Ω*m to about 1×10⁻⁸ Ω*m). The high thermal conductivity may be at least about 10 Watts per meter times Kelvin (W/mK), 15 W/mK, 20 W/mK, 35 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be between any of the afore-mentioned thermal conductivity values (e.g., from about 20 W/mK to about 1000 W/mK). The high density may be at least about 1.5 grams per cubic centimeter (g/cm³), 1.7 g/cm³, 2 g/cm³, 2.5 g/cm³, 2.7 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore mentioned values (e.g., from about 1 g/cm³ to about 25 g/cm³).

In some embodiments, the elemental metal is an alkali metal, an alkaline earth metal, a transition metal, a rare-earth element metal, a precious metal, or another metal. The elemental metal may comprise Titanium, Copper, Platinum, Gold, or Silver.

In some embodiments, the metal alloy comprises iron based alloy, nickel based alloy, cobalt based alloy, chrome based alloy, cobalt chrome based alloy, titanium based alloy, magnesium based alloy, or copper based alloy. The alloy may comprise an oxidation or corrosion resistant alloy. The alloy may comprise a super alloy (e.g., Inconel). The alloy may comprise an alloy used for aerospace applications, automotive application, surgical application, or implant applications. The metal may include a metal used for aerospace applications, automotive application, surgical application, or implant applications.

In some embodiments, the metal alloys are Refractory Alloys. The refractory metals and alloys may be used for heat coils, heat exchangers, furnace components, or welding electrodes. The Refractory Alloys may comprise a high melting points, low coefficient of expansion, high mechanical strength, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy. Examples of materials, 3D printers, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the elemental carbon comprises graphite, Graphene, diamond, amorphous carbon, carbon fiber, carbon nanotube, or fullerene.

In some embodiments, the material comprises powder material (also referred to herein as a “pulverous material”). The powder material may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The fundamental length scale (abbreviated herein as “FLS”) of at least some of the particles can be from about 1 nanometers (nm) to about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 mm, 30 nm, 20 nm, 10 nm, or 5 nm. At least some of the particles can have a FLS of at least about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nanometers (nm) or more. At least some of the particles can have a FLS of at most about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nm or less. In some cases, at least some of the powder particles may have a FLS in between any of the afore-mentioned FLSs.

In some embodiments, the powder comprises a particle mixture, which particle comprises a shape. The powder can be composed of a homogenously shaped particle mixture such that all of the particles have substantially the same shape and FLS magnitude within at most about 1%, 5%, 8%, 10%, 15%, 20%, 25%, 30%, 35%, 40%, 50%, 60%, 70% distribution of FLS. In some cases, the powder can be a heterogeneous mixture such that the particles have variable shape and/or FLS magnitude. In some examples, at least about 30%, 40%, 50%, 60%, or 70% (by weight) of the particles within the powder material have a largest FLS that is smaller than the median largest FLS of the powder material. In some examples, at least about 30%, 40%, 50%, 60%, or 70% (by weight) of the particles within the powder material have a largest FLS that is smaller than the mean largest FLS of the powder material.

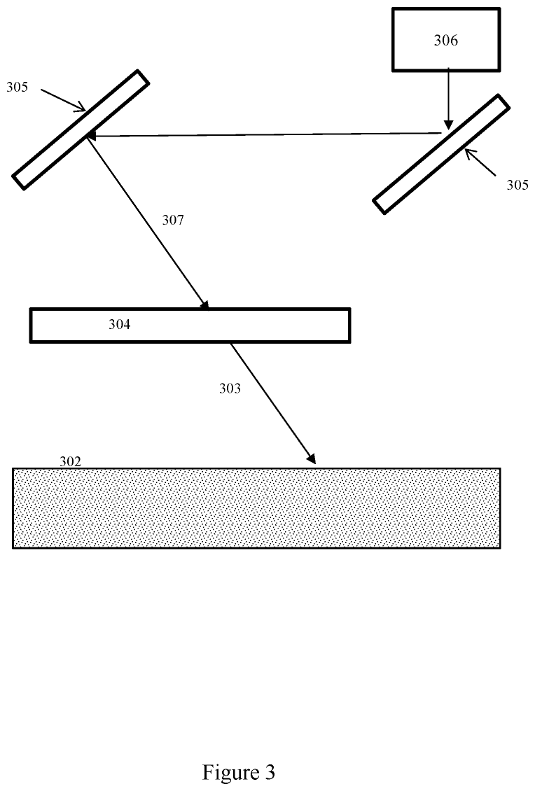

In an aspect provided herein is a system for generating a 3D object comprising: an enclosure for accommodating at least one layer of pre-transformed material (e.g., powder); an energy (e.g., energy beam) capable of transforming the pre-transformed material to form a transformed material; and a controller that directs the energy to at least a portion of the layer of pre-transformed material according to a path (e.g., as described herein). The transformed material may be capable of hardening to form at least a portion of a 3D object. The system may comprise an energy source, an optical system (e.g., FIG. 3), a control system, a material delivery mechanism (e.g., a layer dispensing mechanism such as a recoater), gas source(s), pump(s), nozzle(s), valve(s), sensor(s), display(s), chamber(s), processor(s) comprising or software (e.g., comprising algorithm(s)) inscribed on a computer readable media/medium. The control system may be configured to control temperature, pressure, gas flow, optics, actuator(s), energy source(s), energy beam(s), and/or atmosphere(s). The chamber may comprise a platform including a base and a substrate. The base may be referred to herein as the “build plat” or “building platform.” The substrate may comprise an elevator piston. The system for generating at least one 3D object (e.g., in a printing cycle) and its components may be any 3D printing system. Examples of 3D printers, their components, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

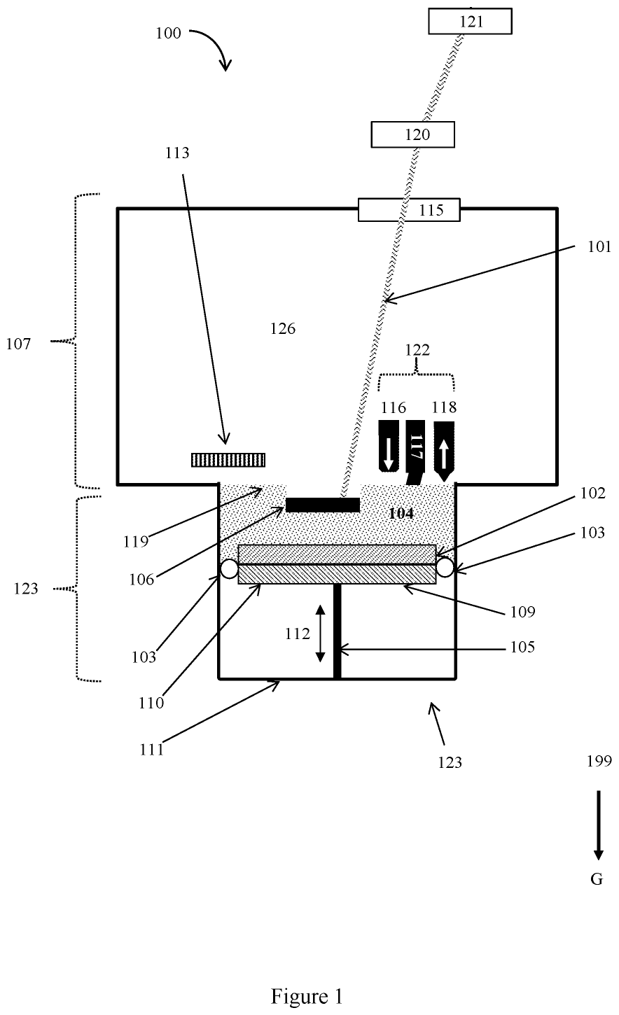

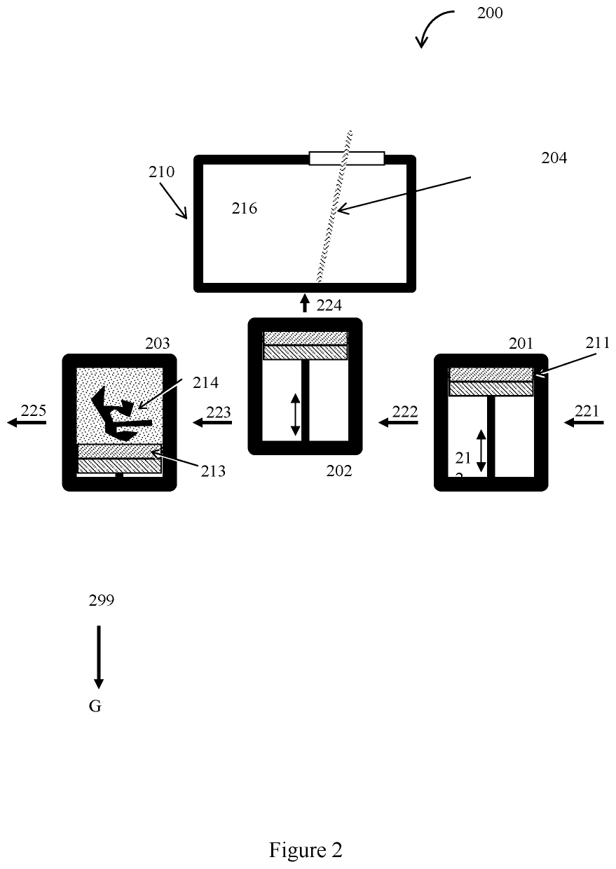

In some embodiments, the 3D printing system comprises a chamber (e.g., FIG. 1, 107 having interior space 126, or FIG. 2, 216). The chamber may be referred herein as the “processing chamber.” The processing chamber may facilitate ingress of an energy beam (e.g., FIG. 1, 101; FIG. 2, 204). The energy beam may be directed towards an exposed surface of a material bed (e.g., FIG. 1, 119). The 3D printing system may comprise one or more modules (e.g., FIG. 1, 123, or FIGS. 2, 201, 202, and 203). The one or more modules may be referred herein as the “build modules.” At times, at least one build module (e.g., FIG. 1, 123) may be situated in the enclosure comprising the processing chamber (e.g., FIG. 1, 116). At times, at least one build module may engage with the processing chamber (e.g., FIG. 1). At times, at least one build module may not engage with the processing chamber (e.g., FIG. 2). At times, a plurality of build modules (e.g., FIGS. 2, 201, 202, and 203) may be situated in an enclosure (e.g., FIG. 2, 200) comprising the processing chamber (e.g., FIG. 2, 210). In the examples shown in FIGS. 1 and 2, vectors 199 and 299 points towards a gravitational center. The build module may be configured to reversibly engage and disengage with (e.g., couple to and decouple from) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent. The FLS (e.g., width, depth, and/or height) of the processing chamber and/or the build plate can be at least about 50 millimeters (mm), 60 mm, 70 mm, 80 mm, 90 mm, 100 mm, 200 mm, 250 mm, 280 mm, 320 mm, 400 mm, 450 mm, 500 mm, 800 mm, 900 mm, 1 meter (m), 2 m, or 5 m. The FLS of the processing chamber and/or the build plate can be at most about 50 millimeters (mm), 60 mm, 70 mm, 80 mm, 90 mm, 100 mm, 200 mm, 250 mm, 400 mm, 500 mm, 800 mm, 900 mm, 1 meter (m), 2 m, or 5 m. The FLS of the processing chamber and/or the build plate can be between any of the afore-mentioned values (e.g., 50 mm to about 5 m, from about 250 mm to about 500 mm, or from about 500 mm to about 5 m).

FIG. 1 shows an example of a 3D printing system 100 having a processing chamber 107 coupled with (e.g., to) a build module 123. The build module comprises an elevator having shaft 105 that vertically translate a substrate (e.g., piston) 109 along arrow 112. The base (e.g., build platform) 102 is disposed on substrate (e.g., piston) 109. Material bed 104 is disposed above base 102 (e.g., also referred herein as “building platform”, or “build plate”). Energy source (e.g., laser source) 121 generates energy beam 101 that traverses through an optical system 120 and an optical window 115 into processing chamber 107 enclosing space 126 that can include an atmosphere. The processing chamber comprises a layer dispensing mechanism 122 that includes a dispenser 116, a leveler 117, and a remover 118. Processing chamber 107 includes an optional temperature adjustment device 113 (e.g., cooling plate). Seal 103 encircles the substrate and/or base, e.g., to deter (e.g., prevent) migration of material of the material bed from reaching the elevator mechanism (e.g., shaft 105). Energy beam 101 impinges upon an exposed surface 119 of material bed 104, to form at least a portion of a 3D object 106.

In some examples, at least one build module translates relative to the processing chamber. The translation may be parallel or substantially parallel to the bottom surface of the build chamber. In some embodiments, the 3D printing system comprises a plurality of build modules. The 3D printing system may comprise at least 1, 2, 3, 4, 5, 6, 7, 8, 9, or 10 build modules. FIG. 2 shows an example of three build modules (e.g., 201, 202, and 203) and one processing chamber 210. Examples of 3D printers and their components such as enclosures, build modules, unpacking stations, processing chambers and their components, associated methods, software, systems, devices, and apparatuses, can be found in International Patent Application Serial No. PCT/US17/60035, filed Nov. 3, 2017; in International Patent Application Serial No. PCT/US22/16550, filed Feb. 26, 2022; and in International Patent Application Serial No. PCT/US17/39422 filed on Jun. 27, 2017, each of which is entirely incorporated herein by reference.

FIG. 2 shows an example of a 3D printing system 200 having processing chamber 210 enclosing space 216 that can include an atmosphere. Energy beam 204 traverses into space 216 of processing chamber 210. FIG. 2 shows examples of three build modules 201, 202, and 203. Build module 201 includes an elevator that can vertically travel along direction 212, causing vertical translation of the build plate 211. Build module 202 assumes a position at which it is about to engage 224 with processing chamber 210. Build module 203 includes a material bed in which a 3D object 214 is disposed. The build plate 213 of build module 203 is at a lower position as compared to build plate 211 of build module 201, which lower position accommodates the material bed and 3D object 214. The build modules 201-203 may travel in a general direction of arrows 221, 222, 223, 224, and 225 (e.g., directed by controller(s) and/or actuators) towards engagement with the processing chamber before printing (e.g., 221, 222, and 224), or away from the processing chamber after printing 223 and 225.

In some examples, at least one build module engages with the processing chamber to expand the interior volume of the processing chamber (e.g., into the volume of the engaged build module). During at least a portion of the 3D printing process, the atmospheres of the chamber and enclosure may merge. At times, during at least a portion of the 3D printing process, the atmospheres of the chamber and enclosure may remain separate (e.g., one atmosphere above seal 103 and another atmosphere below seal 103, wherein above and below are with respect to gravitational vector 199). The seal may or may not be gas tight. The seal may or may not facilitate atmospheric equilibration. During at least a portion of the 3D printing process, the atmospheres of the build module and processing chamber may be separate. The build module may be mobile or stationary. The build module may comprise an elevator. The elevator may be connected to a platform. The elevator may be reversibly connected to at least a portion of the platform. The elevator may be irreversibly connected to the substrate (e.g., the piston). The build plate and/or substrate may be separated from one or more walls (e.g., side walls) of the build module by a seal (e.g., FIG. 1, 103). The seal may be permeable to at least one gas, and impermeable to the pre-transformed (e.g., and to the transformed) material. The seal may not allow a solid material (e.g., a pre-transformed material and/or a transformed material) to pass through.

FIG. 3 shows an example of an optical system in which an energy source 306 (e.g., a laser source) generates an energy beam 307 that travels between two reflective mirrors 305, through an optical window 304, and emerging as beam 303 that impinges upon an exposed surface 302 of a material bed.

In some embodiments, the gas in the gas conveyance system and/or enclosure comprises a robust gas. The robust gas may comprise an inert gas enriched with reactive agent(s). At least one reactive agent in the robust gas may be in a concentration below that present in the ambient atmosphere external to the gas conveyance system and/or enclosure. The reactive agent(s) may comprise water or oxygen. The robust gas (e.g., gas mixture) may be more inert than the gas present in the ambient atmosphere. The robust gas may be less reactive than the gas present in the ambient atmosphere. Less reactive may be with debris, and/or pre-transformed material, e.g., during and/or after the printing. In some embodiments, humidity levels and/or oxygen levels in at least a portion of the gas conveyance system and/or enclosure, (e.g., processing chamber, ancillary chamber, and/or build module) can be regulated such that an oxygenation and/or humidification of powder in the powder conveyance system is controlled. For example, oxygenation and/or humidification levels of recycled pre-transformed material (e.g., recycled powder material) can be about 5 parts per million (ppm) to about 1500 ppm. The gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 1500 ppm to about 500 ppm, or from 500 ppm to about 50 ppm). Oxygenation and/or humidification levels of pre-transformed material can be about zero ppm. Oxygen content in pre-transformed material can be about 0 weight percent (wt %), 0.1 wt %, 0.25 wt %, 0.3 wt %, 0.5 wt %, 0.75 wt %, 1.0 wt %, or more. At times, maintaining a level of reactive agent(s) in the robust gas during printing facilitates at least partial passivation of the debris generated during the printing. At times, maintaining a level of reactive agent(s) in the robust gas during printing reduces reactivity of the debris generated during the printing, the reactivity being with such or other reactive species present in the ambient atmosphere. For example, maintaining a minimal humidity level in the atmosphere of the processing chamber during print, may reduce the reactivity of the generated soot to reactive species such as water and/or to oxygen, e.g., at levels present in the ambient atmosphere. At times, atmospheric conditions can, in part, influence flowability of pre-transformed material (e.g., powder material) from the layer dispensing mechanism. A dew point of an internal atmosphere of an enclosure (e.g., of the processing chamber) can be (I) below a level in which the powder particles absorb water such that they become reactive under condition of 3D printing process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder material and/or on processing condition(s) of the 3D printing process(es). The gas composition of the chamber can contain a level of humidity that correspond to a dew point of at most about −10° C., −15° C., −20° C., −25° C., −30° C., −35° C., −40° C., −50° C., −60° C., or −70° C. The gas composition of the chamber can contain a level of humidity that correspond to a dew point between any of the aforementioned values, e.g., from about −70° C. to about −10° C., −60° C. to about −10° C. or from about −30° C. to about −20° C. For example, a dew point of an internal atmosphere of the enclosure (e.g., of the processing chamber) can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the enclosure. A dew point of an internal atmosphere of the enclosure can be any value within or including the afore-mentioned values. The 3D printing system may comprise an in-situ passivation system, e.g., to passivate filtered debris and/or any other gas borne material before their disposal. Examples of gas conveyance system and components (including control components), in-situ passivation systems, controlled oxidation methods and systems, 3D printing systems, control systems, software, and related processes, can be found in International Patent Applications Serial Nos. PCT/US17/60035 and PCT/US21/35350, each of which is incorporated herein by reference in its entirety.

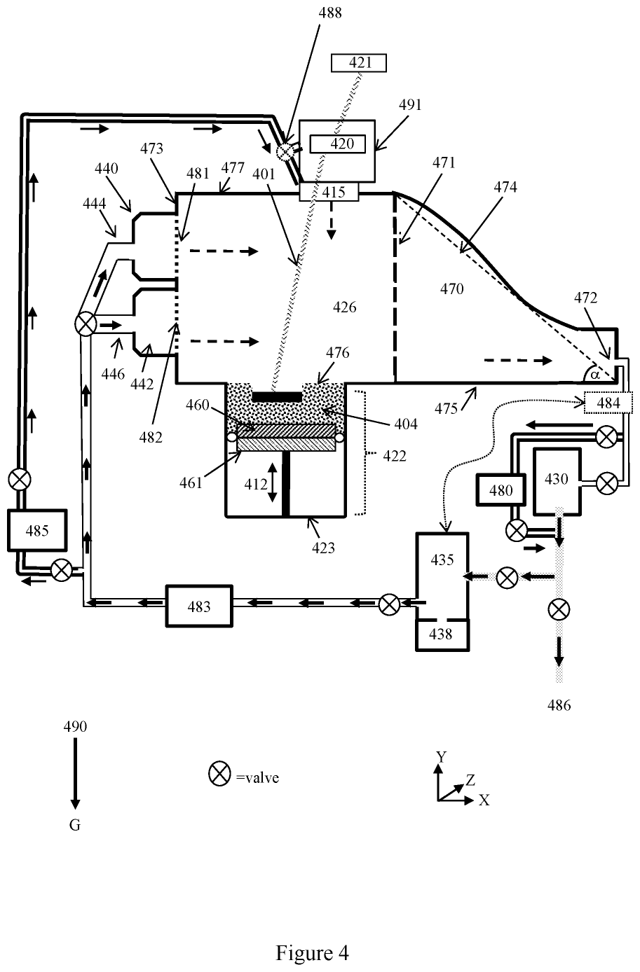

FIG. 4 shows an example of a 3D printing system having an energy beam source 421 generating an energy beam 401 that traverses an optical system 420 (e.g., comprising a scanner) that translates the energy beam along a path, which energy beam travels through an optical window 415 into processing chamber enclosing space 426 having an atmosphere. The optical system is disposed in an optical enclosure 491. In some embodiments, the 3D printer comprises more than one: (i) optical window, (ii) energy source, and/or, (iii) optical system (e.g., scanner). Energy beam 401 impinges upon an exposed surface 476 of material bed 404 to generate at least a portion of a 3D object. Material bed 404 is disposed above a base (e.g., build plate or build platform) 460 disposed above a substrate (e.g., piston) 461 that can traverse horizontally 412, e.g., using an elevator mechanism. Material bed 404 is disposed in a build module 422 having floor 423, enclosing at least a portion of the elevator mechanism, e.g., the elevator shaft. The processing chamber comprises gas inlets 444 and 446 and gas outlet 472. The gas inlet 444 (e.g., that expands) into gas inlet portion 440. The gas inlet 446 is diverted (e.g., expands) into gas inlet portion 442. The processing chamber has an outlet portion 470 coupled with (e.g., to) outlet port 472, which outlet portion tapers towards the outlet port in tapering angle 474 alpha (a). While FIG. 4 shows a non-linear tapering, other embodiments can have a linear tapering (e.g., along angle 474). The outlet portion 470 may or may not include an optional perforated outlet screen 471. Any of the inlet portions may or may not comprise a perforated inlet screen, e.g., such as in FIG. 11. Optional perforated inlet screens are depicted (i) in 481 coupled with (e.g., to) gas inlet portion 440, and (ii) in and 482 coupled with (e.g., to) gas inlet portion 442. The processing chamber is connected to pump 430 and to filtering mechanism 435 having a distal (e.g., residual) container 438 into which gas borne debris can be collected. In some embodiments, the filtering mechanism 435 (e.g., with its distal container) can be disposed in optional alternate location 484, the gas conveyance system comprises an enriching system 480. The enriching system may enrich the gas (e.g., gas mixture) flowing in the gas conveyance system by one or more reactive agents (e.g., water and/or oxygen). In some embodiments, the enriching system is configured to enrich the gas with humidity, e.g., controlled level of humidity. The gas flowing in the gas conveyance system may be a robust gas, e.g., that is more interest that the gas in the ambient atmosphere external to the 3D printer. For example, the robust gas can comprise an inert gas (e.g., Argon) at levels above those present in the ambient environment. The gas conveyance system can convey gas (e.g., overpressured gas above a threshold) to an exhaust location 486, e.g., that can comprise the ambient environment. The gas conveyance system comprises temperature conditioning system 483 (e.g., a cooler). The gas conveyance system may comprise a gas line to the optical window 415 and/or optical system 420, the gas line comprising filter 485, e.g., comprising a filter configured to facilitate streaming gas with a higher degree of purity, such as a HEPA filter. In some embodiments, the optical window is part of the optical system. In some embodiments, the optical system and the optical window are disposed in an optical enclosure, e.g., the optical window is disposed at a floor of the optical enclosure. In the example shown in FIG. 4, the optical window and the optical system receive gas streams from different lines split at junction 488. Junction 488 may comprise an optional valve. In FIG. 4, the processing chamber and the build module are depicted with respect to gravitational vector 490 pointing towards the gravitational center of the ambient environment external to the 3D printer. The gas conveyance system portion extending externally to the processing chamber from outlet 472 to optional perforated screens 481 and 482 and to junction 488, is not entirely depicted with relation vector 490, and is rather depicted schematically.

In some embodiments, the processing chamber (e.g., FIG. 4, enclosing space 426) comprises one or more side walls (e.g., 473), a floor (e.g., 475), and a ceiling (e.g., 477). The processing chamber may comprise at least one gas conveying inlet (e.g., FIG. 4, 444, 446) coupled with (e.g., to) a first of the processing chamber side walls. The processing chamber may comprise at least one gas conveying outlet (e.g., FIG. 4, 472) coupled with (e.g., to) a side wall of the chamber. The side wall that is connected to the inlet may not be connected to the outlet. The side wall connected to the inlet may be different from the side wall connected to the outlet. For example, the inlet may be coupled with (e.g., to) the first of the processing chamber side walls, and the outlet may be coupled with (e.g., to) the second of the processing chamber side walls. The first side wall may be different from the second side wall. For example, the first side wall may oppose the second side wall. The outlet opening may be (e.g., fluidly) connected to a gas recycling system. In some embodiments, the outlet opening (or a supplemental outlet opening) may be adjacent to an optical window. The outlet opening may be (e.g., fluidly) connected to a pump. Fluid connection may allow a gas to flow through. The gas may flow through the opening due to a pressure difference between the two ends of the outlet opening. The gas may be sucked through the outlet opening. The gas may be pressurized through the outlet opening. The pressure at the end of the opening away from the processing pressure may be lower than the pressure at the side of the outlet opening closer to the processing chamber.

In some embodiments, the temperature of the gas that flows to the processing chamber and/or processing cone may be temperature controlled. For example, the gas may be heated and/or cooled before, or during the time it flows into the processing chamber and/or cone. For example, the gas may flow through a heat exchanger and/or heat sink. The gas may be temperature controlled outside and/or inside the processing chamber. The gas may be temperature controlled at least one inlet to the processing chamber. In some embodiments, the temperature of the atmosphere in the processing chamber and/or cone may be kept (e.g., substantially) constant. Substantially constant temperature may allow for a temperature fluctuation (e.g., error delta) of at most about 15° C., 12° C., 10° C., 5° C., 4° C., 3° C., 2° C., 1° C., or 0.5° C.

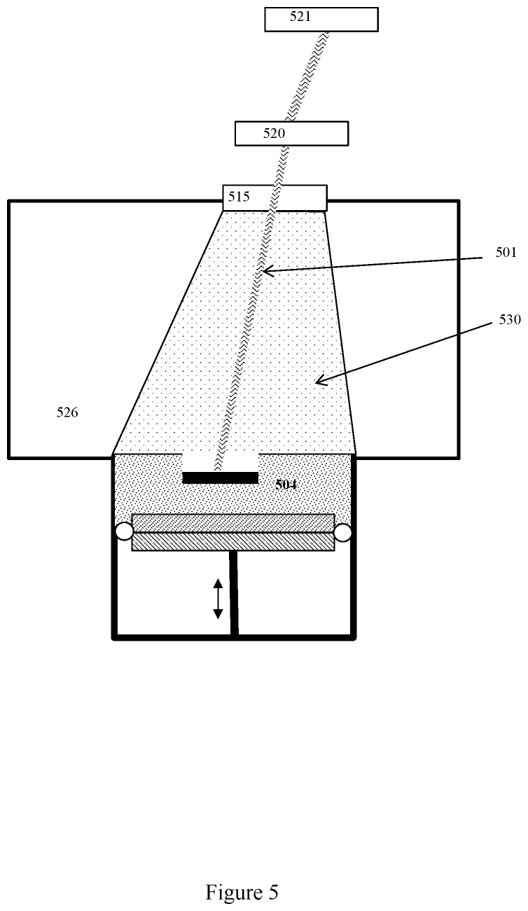

FIG. 5 shows an example of a 3D printing system having an energy source 521 generating an energy beam 501 that travels through an optical system 520 and an optical window 515 into an enclosed space 526 enclosing at atmosphere. The optical system 520 causes energy beam 501 to traverse along a path with a portion of the processing chamber space that defines a processing cone 530 that takes the form of a truncated cone. Energy beam 501 traverses in the processing cone and impinges upon an exposed surface of material bed 504 to print at least a portion of a 3D object.

In some examples, the 3D printing system requires operation of maximum a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some examples, the 3D printing system requires operation of maximum a single standard work week shift. The 3D printing system may require operation by a human operator working at most of about 50 h, 40 h, 30 h, 20 h, 10 h, 5 h, or 1 h a week. The 3D printing system may require operation by a human operator working between any of the afore-mentioned time frames (e.g., from about 40 h to about 1 h, from about 40 h to about 20 h, from about 30 h to about 10 h, from about 20 h to about 1 h, or from about 10 h to about 1 h a week). A single operator may support during his daily and/or weekly shift at least 1, 2, 3, 4, 5, 6, 7, 8, 9, or 10 3D printers (i.e., 3D printing systems).

In some embodiments, the enclosure and/or processing chamber of the 3D printing system may be opened to the ambient environment sparingly. In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer.

In some embodiments, the 3D printer has a capacity of 1, 2, 3, 4, or 5 full prints in terms of pre-transformed material (e.g., starting material such as powder) reservoir capacity. The 3D printer may have the capacity to print a plurality of 3D objects in parallel, e.g., in one material bed. For example, the 3D printer may be able to print at least 2, 3, 4, 5, 6, 7, 8, 9, or 10 3D objects in parallel.

In some embodiments, the 3D printer has a capacity to complete at least 1, 2, 3, 4, or 5 printing cycles before requiring human intervention. Human intervention may be required for refilling the pre-transformed (e.g., powder) material, unloading the build modules, unpacking the 3D object, removing the debris byproduct of the 3D printing, or any combination thereof. The 3D printer operator may condition the 3D printer at any time during operation of the 3D printing system (e.g., during the 3D printing process). Conditioning of the 3D printer may comprise refilling the pre-transformed material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some embodiments, the 3D printer comprises a filter. The 3D printer may comprise at least one filter. The filter may be a ventilation filter. The ventilation filter may capture gas-borne debris (e.g., fine powder such as soot) from the 3D printing system (e.g., from the gas conveyance system thereof). The filter may comprise a paper filter or any other suitable filter, e.g., as disclosed herein. The ventilation filter may capture debris comprising splatter, soot, or spatter. The spatter may result from the 3D printing process. The ventilator may direct the spatter in a requested (e.g., desired) direction (e.g., by using positive or negative gas pressure). For example, the ventilator may use vacuum. For example, the ventilator may use compressed gas such as gas blow.

In some embodiments, the enclosure comprises a gas pressure. The enclosure may comprise ambient pressure (e.g., one (1) atmosphere), negative pressure (i.e., vacuum) or positive pressure. For example, the enclosure may enclose an atmosphere having positive pressure relative to an ambient pressure external to the enclosure. The enclosure may include the processing chamber and/or the build module. Different portions of the enclosure may have different atmospheres. The different atmospheres may comprise different gas compositions, and/or different temperatures. The different atmospheres may comprise ambient pressure (e.g., 1 atmosphere), negative pressure (i.e., vacuum) or positive pressure. The different portions of the enclosure may comprise the processing chamber, build module, or enclosure volume excluding the processing chamber and/or build module. The vacuum may comprise pressure below 1 bar, or below 1 atmosphere. The positively pressurized environment may comprise pressure above 1 bar or above 1 atmosphere. At least a portion of the 3D printing system interior (e.g., gas flow mechanism) can be at least about 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, 1000 bar, or 1100 bar. At least a portion of the 3D printing system interior (e.g., gas flow mechanism) can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Tor. At least a portion of the 3D printing system interior (e.g., gas flow mechanism) can have a pressure between any of the afore-mentioned enclosure pressure values (e.g., from about 10⁷ Torr to about 1200 Torr, from about 10⁻⁷ Torr to about 1 Torr, from about 1 Torr to about 1200 Torr, or from about 10⁻² Torr to about 10 Torr). The gas flow mechanism may comprise the filtering mechanism. At least a portion of the 3D printing system interior (e.g., gas flow mechanism) can be pressurized to a pressure of at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. At least a portion of the 3D printing system interior (e.g., gas flow mechanism) can be pressurized to a pressure of at most 10⁻⁷ Torr, 10⁻⁶ Torr, 10⁻⁵ Torr, 10⁻⁴ Toer, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. At least a portion of the 3D printing system interior (e.g., gas flow mechanism) can have a pressure at a range between any of the afore-mentioned pressure values (e.g., from about 10⁻⁷ Torr to about 1000 bar, from about 10⁻⁷ Torr to about 1 Torr, from about 1 Torr to about 100 Barr, from about 1 bar to about 10 bar, from about 1 bar to about 100 bar, or from about 100 bar to about 1000 bar). In some cases, the pressure in at least a portion of the 3D printing system interior (e.g., gas flow mechanism) can be standard atmospheric pressure. The pressure may be measured at an ambient temperature, e.g., room temperature, 20° C., or 25° C.

In some embodiments, the enclosure includes an atmosphere comprising at least one gas. The enclosure may comprise a robust atmosphere such as a (e.g., substantially) inert atmosphere. The atmosphere in the enclosure may be (e.g., substantially) depleted by one or more gases present in the ambient atmosphere external to the enclosure. The atmosphere in the enclosure may include a reduced level of one or more gases relative to the ambient atmosphere. For example, the atmosphere may be substantially depleted, or have reduced levels of water (i.e., humidity), oxidizing gas (e.g., oxygen), nitrogen, carbon dioxide, hydrogen sulfide, or any combination thereof. For example, the atmosphere may be substantially depleted, or have reduced levels of a reactive agent. The reactive agent may react with the starting material for the 3D printing and/or with debris such as the debris generated as a byproduct of the 3D printing. The level of the depleted or reduced level may be at most about 1 ppm, 10 ppm, 50 ppm, 100 ppm, 500 ppm, 1000 ppm, 5000 ppm. 10000 ppm, 25000 ppm, 50000 ppm, or 70000 ppm volume by volume (v/v). The level of the depleted or reduced level may be at least about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level (e.g., depleted or reduced level gas, oxidizing gas, or water) may between any of the afore-mentioned levels. The atmosphere may comprise air. The atmosphere may comprise an inert gas (e.g., argon). The atmosphere may be non-reactive to a detectable degree. The atmosphere may be non-reactive with the pre-transformed material deposited in the layer of material (e.g., powder), the transformed material comprised in the 3D object, and/or with a byproduct of the 3D printing (e.g., debris such as soot). The atmosphere may reduce (e.g., deter or prevent) oxidation of the generated 3D object. The atmosphere may reduce (e.g., deter or prevent) oxidation of the pre-transformed material (e.g., starting material) (e.g., that is part of the layer of pre-transformed material before its transformation), during transformation of the starting material, after its transformation, before hardening of the transformed material, after its hardening, during gas filtration, during removal of the debris from the gas conveyance system, or any combination thereof. The atmosphere may comprise argon or nitrogen gas. The atmosphere may be a robust atmosphere. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe (e.g., to personnel) amount of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened transformed material, debris, or the material within the 3D object.

Ambient refers to a condition to which people are generally accustomed. For example, ambient pressure may be about 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. it may denote 20° C., 25° C., or any value from about 20° C. to about 25° C.

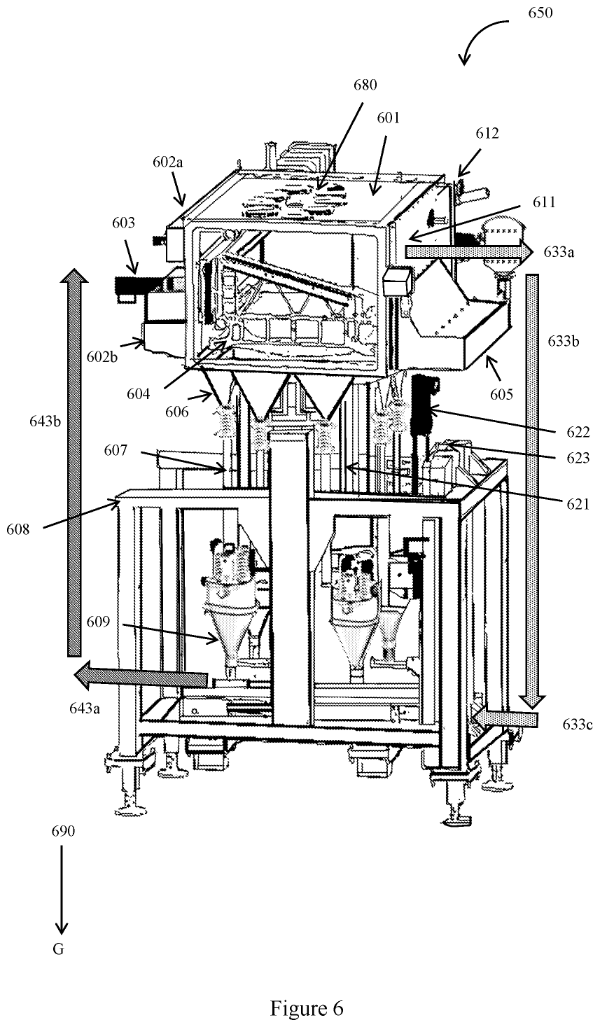

FIG. 6 shows a perspective view example of a portion of a 3D printing system including a processing chamber having a ceiling 601 in which optical windows such as 680, are disposed to each facilitate penetration of an energy beam into the processing chamber interior space, side wall 611 having a gas exit port (e.g., gas outlet port) covering 605 coupled thereto. The processing chamber has two gas entrance port coverings 602a and 602b coupled with (e.g., to) an opposing wall to side wall 611. The opposing wall is coupled with (e.g., to) an actuator 603 configured to facilitate translation of a layer dispensing mechanism (e.g., recoater) mounted on a framing 604 above a base disposed adjacent to a floor of the processing chamber, which framing is configured to facilitate (e.g., enable) reversible translation of the layer dispensing mechanism (back and forth) in the processing chamber along railings. The processing chamber floor has slots through which remainder material can flow downwards towards gravitational center G along gravitational vector 690. The slots are coupled with (e.g., to) funnels such as 606 that are connected by channels (e.g., pipes) such as 607 to material reservoir such as 609 (e.g., to facilitate unpacking of a remainder of a material bed after printing). The processing chamber is coupled with (e.g., to) a build module 621 that comprises a substrate to which the base is attached, which substrate is configured to vertically translate with the aid of actuator 622 coupled with (e.g., to) an elevator motion stage (e.g., supporting plate) 623 via a bent arm. The elevator motion stage and coupled components are supported by framing 608 that is missing a beam that is removed in FIG. 6 (e.g., the beam can be removed for installation and/or maintenance). Atmosphere (e.g., content, temperature, and/or pressure) may be equilibrated between the material reservoirs and the processing chamber via schematic channel (e.g., pipe) portions 633a-c. Remainder material in the material reservoirs may be conveyed via schematic channels (e.g., pipes) 643a-b to a material recycling system, e.g., for future use in printing. The components of the 3D printing system are disposed relative to gravitational vector 690 pointing to gravitational center G.

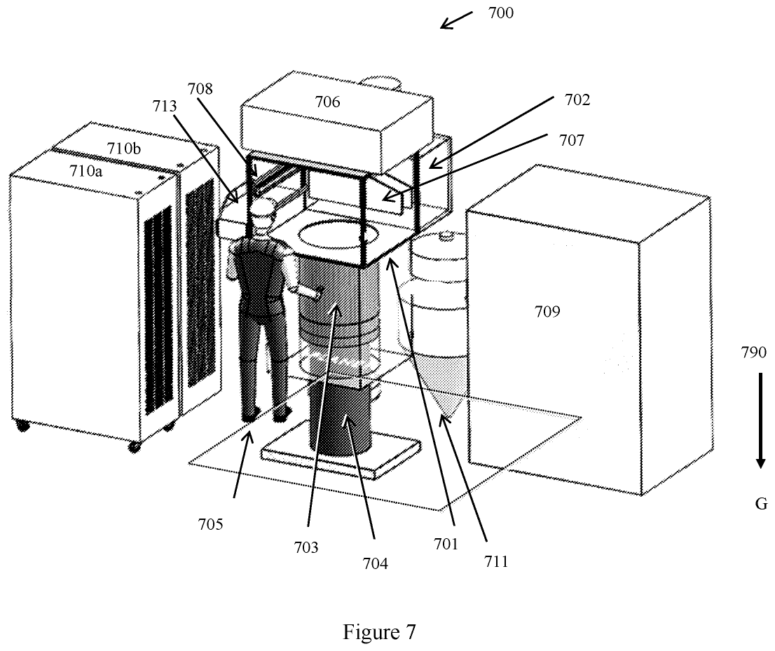

FIG. 7 shows an example of a 3D printing system 700 disposed in relation of gravitational vector 790 directed towards gravitational center G. The 3D printing system comprises processing chamber 701 coupled with (e.g., to) an ancillary chamber (e.g., garage) 702 configured to accommodate a layer dispensing mechanism (e.g., recoater), e.g., in its resting (e.g., idle) position. The processing chamber is also coupled with (e.g., to) a build module 703 that extends 704 under a plane (e.g., floor) at which user 705 stands on (e.g., can extend under-grounds). The processing chamber may comprise a door (not shown) facing user 705. 3D printing system 700 comprises enclosure 706 that can comprise an energy beam alignment system (e.g., an optical system) and/or an energy beam directing system (e.g., scanner)—not shown. A material dispensing mechanism (not shown) may be coupled with (e.g., to) a framing 707 as part of a movement system that facilitate movement of the material dispensing system along the material bed and garage (e.g., in a reversible back-and-forth movement). The movement system comprises a translation inducer system (e.g., comprising a belt or a chain 708). 3D printing system 700 comprises a filter unit 709, heat exchangers 710a and 710b, pre-transformed material reservoir 711, and gas guiding system (e.g., comprising gas inlets and gas inlet portions) disposed in enclosure 713. The filtering system may filter gas and/or pre-transformed material. The filtering system is configured to filter debris (e.g., comprising byproduct(s) of the 3D printing).

In some embodiments, a build module has a bottom to which encoder is connected. The build module can have at least one window. The window may be a single or a double pane window. The window may be an insulated glass unit (IGU), the window may be configured to withstand positive pressure within the build module, e.g., during printing. The positive pressure can be above ambient pressure external to the build module, e.g., of about one atmosphere. The build module can be configured to operatively coupled with (e.g., to) a shaft (e.g., elevator shaft). The posts may be disposed on stage that is disposed on supports disposed on floor. The support can comprise a column or a plank. Tilt of the stage may cause tilt in shaft by angle. Vertical translation of the build module can be aided by encoder(s). The encoder can be disposed adjacent to shaft portion that is an enlarged view of shaft. The encoder can be separated from shaft portion by a gap. The shaft portion can be connected to build module portion, which may comprise fasteners. When the shaft portion becomes tilted by an angle, gap may vary (e.g., increase or decrease), which gap variation may fault the encoder.

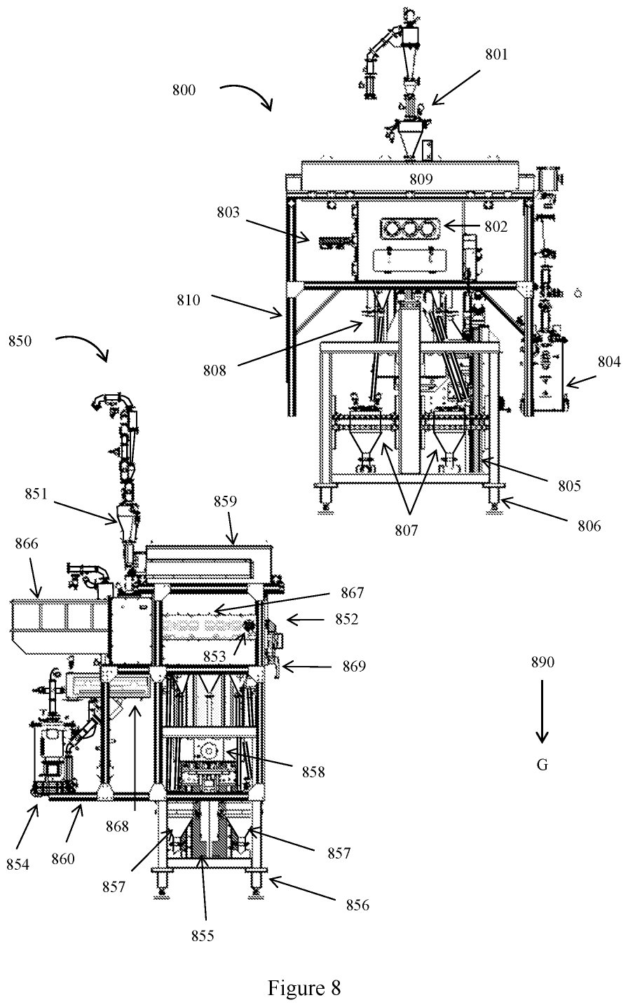

FIG. 8 shows in example 800 a front side example of a portion of a 3D printing system comprising a material reservoir 801 configured to feed pre-transformed material to a layer dispensing mechanism, an enclosure 809 configured to enclose, e.g., scanner(s) and/or director(s) (e.g., optical system) of at least one energy beam (e.g., laser beam) configured to transform the pre-transformed material into a transformed material to print one or more 3D object in a printing cycle. Example 800 of FIG. 8 shows a build module 802 having a door with three circular windows. The windows may be any window disclosed herein. The window may be a single or a double pane window. The window may be an insulated glass unit (IGU), the window may be configured to withstand positive pressure within the processing chamber, e.g., during printing. The positive pressure is above ambient pressure external to the build module, e.g., the ambient pressure may be about one atmosphere. Example 800 show a material reservoir 804 configured to accumulate recycled remainder starting material (e.g., pre-transformed material) from the layer dispensing process to form a material bed and/or a remainder of the material bed that did not form one or more 3D objects during a printing cycle, post 805 as part of an elevator mechanism of build module 808; two material reservoirs 807 for accumulating a remainder of the material bed that did not form the 3D object, and actuator 803 configured to translate the layer dispensing mechanism to dispense a layer of pre-transformed material as part of a material bed. Supports 806 are planarly stationed in a first horizontal plane, which supports 806 and associated framing support one section of the 3D printing system portion 800, and framing 810 is disposed on a second horizontal plane higher than the first horizontal plane. FIG. 8 shows in 850 an example side view example of a portion of the 3D printing system shown in example 800, which side view comprises a material reservoir 851 configured to feed pre-transformed material to a layer dispensing mechanism, an enclosure 859 enclosing, e.g., scanners and/or directors (e.g., optical system) of at least one energy beam (e.g., laser beam) configured to transform the pre-transformed material into a transformed material to print one or more 3D object in a printing cycle. Example 850 of FIG. 8 shows an example of a build module 852 having a door comprising handle 869 (as part of a handle assembly). Example 800 show a material reservoir 854 configured to accumulate recycled remainder from the layer dispensing process to form a material bed and/or a remainder of the material bed that did not form one or more 3D objects during a printing cycle, a portion of the material conveyance system 868 configured to convey the material to reservoir 854. The material conveyed to reservoir 854 may be separated (e.g., sieved) before reaching reservoir 854. The example shown in 850 shows post 855 as part of an elevator mechanism of build module 858; two material reservoirs 857 for accumulating a remainder of the material bed that did not form the 3D object, and actuator 853 configured to translate the layer dispensing mechanism to dispense a layer of pre-transformed material as part of a material bed, e.g., along railing 867 in processing chamber and into garage 866 in a reversible (e.g., back and forth) movement. Supports 856 are planarly stationed in a first horizontal plane, which supports 806 and associated framing support one section of the 3D printing system portion 850, and framing 860 is disposed on a second horizontal plane higher than the first horizontal plane. In the example shown in FIG. 8, the 3D printing system components may be aligned with respect to gravitational vector 890 pointing towards gravitational center G.

In some embodiments, the pre-transformed material (e.g., starting material for the 3D printing) is deposited in an enclosure. FIG. 1 shows an example of a build module container 123 (also referred to herein as a build module). The build module container can contain the pre-transformed material (e.g., without spillage; such as in a material bed FIG. 1, 104). Material may be placed in, or inserted to the container. The material may be deposited in, pushed to, sucked into, or lifted to a container. The material may be layered (e.g., spread) in the enclosure such as by using a layer dispensing mechanism 122. The build module container may be configured to enclose a substrate (e.g., FIG. 1, 109 such as an elevator piston). The substrate may be situated adjacent to the bottom of the build module container (e.g., FIG. 1, 111). Bottom may be relative to the gravitational field along gravitational vector 199 pointing towards gravitational center G, or relative to the position of the footprint of the energy beam (e.g., FIG. 1, 101) on the layer of pre-transformed material as part of a material bed such as 104. The footprint of the energy beam may follow a footprint comprising a Gaussian bell shape, or a ring shape (e.g., a corona beam or a doughnut beam). In some embodiments, the footprint of the energy beam does not follow a Gaussian bell shape. In some embodiments, the footprint of the energy beam does not follow a ring shape. The build module container may comprise a platform comprising a base (e.g., FIG. 1, 102 such as a build plate). The platform may comprise a substrate or a base. The base may reside adjacent to the substrate. For example, the base may (e.g., reversibly) connect to the substrate. The pre-transformed material may be layerwise deposited adjacent to a side of the build module container (e.g., above and/or on the bottom of the build module container). The pre-transformed material may be layered adjacent to the substrate and/or adjacent to the base. Adjacent to may be above. Adjacent to may be directly above, or directly on. The substrate may have one or more seals that enclose the material in a selected area within the build module container (e.g., FIG. 1, 103). The one or more seals may be flexible or non-flexible. The one or more seals may comprise a polymer or a resin. The build module container may comprise the base. The base may be situated within the build module container. The build module container may comprise the platform, which may be situated within the build module container. The enclosure, processing chamber, and/or building module container may comprise (1) a window (e.g., an optical window and/or a viewing window) or (TT) an optical system (e.g., FIG. 1, 120). An example of an optical window can be seen in FIG. 1, 115; and FIG. 3, 304. The optical window may allow the energy beam (e.g., 307) to pass through without (e.g., substantial) energetic loss (e.g., 303). During the 3D printing, a ventilator and/or gas flow may prevent spatter from accumulating on the surface optical window that is disposed within the enclosure (e.g., within the processing chamber). A portion of the enclosure that is occupied by the energy beam (e.g., during the 3D printing) can define a processing cone (e.g., FIG. 15, 1530). During the 3D printing may comprise during the entire 3D printing. The processing cone can be the enclosure space that is occupied by a non-reflected energy beam during the (e.g., entire) 3D printing. The processing cone can be the enclosure space that is occupied by an energy beam that is directed towards the material bed during the (e.g., entire) 3D printing. During the 3D printing may comprise during printing of a layer of hardened material.

In some embodiments, the 3D printer comprises a material dispensing mechanism. The pre-transformed material may be deposited in the enclosure by a material dispensing mechanism (also referred to herein as a layer dispenser, layer forming apparatus, or layer forming device) (e.g., FIG. 1, 122). In some embodiments, the material dispensing mechanism includes one or more material dispensers (also referred to herein as “dispensers”) (e.g., FIG. 1, 116), one or more leveling mechanisms (also referred to herein as “levelers”) (e.g., FIG. 1, 117), and/or one or more powder removal mechanisms (also referred to herein as material “removers”) (e.g., FIG. 1, 118) to form a layer of pre-transformed material within the enclosure. The deposited material may be leveled by a leveling operation. The leveling operation may comprise using a powder removal mechanism that does not contact the exposed surface of the material bed (e.g., FIG. 1, 118). The leveling operation may comprise using a leveling mechanism that contacts the exposed surface of the material bed (e.g., FIG. 1, 117). The material (e.g., powder) dispensing mechanism may comprise one or more dispensers (e.g., FIG. 1, 116). The material dispensing system may comprise at least one material (e.g., bulk) reservoir. The material may be deposited by a layer dispensing mechanism (e.g., recoater). The layer dispensing mechanism may level the dispensed material without contacting the material bed (e.g., the top surface of the powder bed). Examples of materials, 3D printers, associated methods, software, systems, apparatuses and devices such as layer dispensing mechanism may include any layer dispensing mechanism and/or a material (e.g., powder) dispenser, can be found in International Patent Application Serial No. PCT/US17/60035, filed Nov. 3, 2017; in International Patent Application Serial No. PCT/US22/16550, filed Feb. 26, 2022; and in International Patent Application Serial No. PCT/US17/39422 filed on Jun. 27, 2017, each of which is entirely incorporated herein by reference. At least one FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m or 5 m. At least one FLS (e.g., width, depth, and/or height) of the material bed can be at most about 50 millimeters (mm), 60 mm. 70 mm, 80 mm, 90 mm, 100 mm, 200 mm, 250 mm, 280 mm, 400 mm, 500 mm, 600 mm, 800 mm, 900 mm, 1 meter (m), 1.5 m, 2 m, or 5 m. At least one of the FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, the FLS of the material bed is in the direction of the gas flow. The layer dispensing mechanism may include components comprising a material dispensing mechanism, material leveling mechanism, material removal mechanism, or any combination or permutation thereof. The build module may be configured to accommodate the material bed, e.g., having the at least one FLS disclosed herein.

In some embodiments, the layer dispensing mechanism may reside within an ancillary chamber. Examples of 3D printers and their components (e.g., ancillary chamber), associated methods, software, apparatuses, systems, and devices, can be found in International Patent Application serial number PCT/US17/57340, filed Oct. 19, 2017, titled “OPERATION OF THREE-DIMENSIONAL PRINTER COMPONENTS”, which is entirely incorporated herein by reference in its entirety. The layer dispenser may be physically secluded from the processing chamber when residing in the ancillary chamber. The ancillary chamber may be connected (e.g., reversibly) to the processing chamber. The ancillary chamber may be connected (e.g., reversibly) to the build module. The ancillary chamber may convey the layer dispensing mechanism adjacent to a platform (e.g., that is disposed within the build module). The layer dispensing mechanism may be retracted into the ancillary chamber (e.g., when the layer dispensing mechanism does not perform dispensing).

In some embodiments, the 3D printer comprises a base. The base (also herein, “printing platform” or “building platform”) may be disposed in the enclosure (e.g., in the build module and/or processing chamber). A platform may comprise the base. The platform may be configured to support a material bed. The platform may be configured to support one or more layers of pre-transformed material (e.g., as part of the material bed). The platform may be configured to support at least a portion of the 3D object (e.g., during forming of the 3D object). The platform may comprise a substrate or a base. The substrate and/or the base may be removable or non-removable (e.g., from the 3D printing system and/or relative to each other). The platform (e.g., substrate and/or base) may be fastened to the build module container (e.g., build module) and/or to each other. The platform (or any of its components) may be transportable. The transportation of the platform may be controlled and/or regulated by at least one controller (e.g., by a control system). The platform may be transportable horizontally, vertically, or at an angle (e.g., planar or compound).

In some embodiments, the platform is transferable (e.g., translatable). The platform may be vertically translatable, for example using an actuator. The actuator may cause a vertical translation (e.g., and elevator). An actuator causing a vertical translation (e.g., an elevation mechanism) is shown as an example in FIG. 1, 105. The up and down arrow next to the elevation mechanism 105 signifies a possible direction of movement of the elevation mechanism, or a possible direction of movement effectuated by the elevation mechanism.

In some examples, auxiliary support(s) adhere to the upper surface of the platform. In some examples, the auxiliary supports of the printed 3D object may touch the platform (e.g., the bottom of the enclosure, the substrate, or the base). Sometimes, the auxiliary support may adhere to the platform. In some embodiments, the auxiliary supports are an integral part of the platform. At times, auxiliary support(s) of the printed 3D object, do not touch the platform. In any of the methods described herein, the printed 3D object may be supported only by the pre-transformed material within the material bed (e.g., powder bed, FIG. 1, 104). Any auxiliary support(s) of the printed 3D object, if present, may be suspended adjacent to the platform. Occasionally, the platform may have a pre-hardened (e.g., pre-solidified) amount of material. Such pre-solidified material may provide support to the printed 3D object. At times, the platform may provide adherence to the material. At times, the platform does not provide adherence to the material. The platform may comprise elemental metal, metal alloy, elemental carbon, or ceramic. The platform may comprise a composite material (e.g., as disclosed herein). The platform may comprise glass, stone, zeolite, or a polymeric material. The polymeric material may include a hydrocarbon or fluorocarbon. The platform (e.g., base) may include Teflon. The platform may include compartments for printing small objects. Small may be relative to the size of the enclosure. The compartments may form a smaller compartment within the enclosure, which may accommodate a layer of pre-transformed material.

In some embodiments, the 3D printer comprises an energy source that generates an energy beam. The energy beam may project energy to the material bed. The apparatuses, systems, and/or methods described herein can comprise at least one energy beam. In some cases, the 3D printing system can comprise two, three, four, five, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. In some embodiments, the energy source is an energy beam source. The energy source (e.g., FIG. 1, 121) may be a laser source. The laser may comprise a fiber laser, a solid-state laser, or a diode laser (e.g., diode pumped fiber laser).

In some embodiments, the energy source is a laser source. The laser source may comprise a Nd: YAG, Neodymium (e.g., neodymium-glass), or an Ytterbium laser. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro laser sintering. Examples of materials, 3D printers, associated methods, software, systems, apparatuses and devices such energy source generating an energy beam, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the 3D printer includes a plurality of energy beam, e.g., laser beams. The 3D printer may comprise at least 2, 4, 6, 8, 10, 12, 16, 20, 24, 32, 36, 64, or more energy beams. Each of the energy beam may be coupled with its own optical window. At times, at least two energy beams may shine through the same optical window. At times, at least two energy beams may shine through different optical windows.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut (e.g., ring) shaped beam profile.

In some embodiments, the energy beam (e.g., laser) has a power of at least about 10 Watt (W), 30 W, 50 W, 80 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy source may have a power of at most about 10 W, 30 W, 50 W, 80 W, 100 W, 120 W, 150 W, 200 W, 250 W, 300 W, 350 W, 400 W, 500 W, 750 W, 800 W, 900 W, 1000 W, 1500, 2000 W, 3000 W. or 4000 W. The energy source may have a power between any of the afore-mentioned energy beam power values (e.g., from about 10 W to about 100 W, from about 100 W to about 1000 W, or from about 1000 W to about 4000 W). The energy beam may derive from an electron gun.

The methods, apparatuses and/or systems disclosed herein may comprise Q-switching, mode coupling or mode locking to effectuate the pulsing energy beam. The apparatus or systems disclosed herein may comprise an on/off switch, a modulator, or a chopper to effectuate the pulsing energy beam. The on/off switch can be manually or automatically controlled. The switch may be controlled by the control system. The switch may alter the “pumping power” of the energy beam. The energy beam may be at times focused, non-focused, or defocused. In some instances, the defocus is substantially zero (e.g., the beam is non-focused).

In some embodiments, the energy source(s) projects energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

In some embodiments, the energy beam(s), energy source(s), and/or the platform of the energy beam array is moved. The energy beam(s), energy source(s), and/or the platform of the energy beam(s) can be moved via an optical system comprising a galvanometer scanner (e.g., moving the energy beam(s)), a polygon, a mechanical stage (e.g., X-Y stage), a piezoelectric device, gimble, or any combination of thereof. The galvanometer may comprise a mirror. The galvanometer scanner may comprise a two-axis galvanometer scanner. The scanner may comprise a modulator (e.g., as described herein). The scanner may comprise a polygonal mirror. The scanner can be the same scanner for two or more energy sources and/or beams. At least two (e.g., each) energy source and/or beam may have a separate scanner. The energy sources can be translated independently of each other. In some cases, at least two energy sources and/or beams can be translated at different rates, and/or along different paths. For example, the movement of a first energy source may be faster as compared to the movement of a second energy source. The systems and/or apparatuses disclosed herein may comprise one or more shutters (e.g., safety shutters), on/off switches, or apertures.

In some embodiments, the energy beam (e.g., laser) has a FLS (e.g., a diameter) of its footprint on the exposed surface of the material bed of at least about 1 μmicrometer (μm), 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the layer of it footprint on the exposed surface of the material bed of at most about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a footprint FLS on the exposed surface of the material bed (e.g., FIG. 3, 302) between any of the afore-mentioned energy beam FLS values (e.g., from about 5 μm to about 500 μm, from about 5 μm to about 50 μm, or from about 50 μm to about 500 μm). The beam may be a focused beam. The beam may be a dispersed beam. The beam may be an aligned beam. The apparatus and/or systems described herein may further comprise a focusing coil, a deflection coil, or an energy beam power supply. The defocused energy beam may have a footprint FLS of at least about 1 mm, 5 mm, 10 mm, 20 mm, 30 mm, 40 mm, 50 mm, or 100 mm. The defocused energy beam may have a FLS of at most about 1 mm, 5 mm, 10 mm, 20 mm, 30 mm, 40 mm, 50 mm, or 100 mm. The energy beam may have a defocused cross-sectional FLS on the layer of pre-transformed material between any of the afore-mentioned energy beam FLS values (e.g., from about 5 mm to about 100 mm, from about 5 mm to about 50 mm, or from about 50 mm to about 100 mm).

In some embodiments, the 3D printer comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The powder supply can comprise rechargeable batteries.

In some embodiments, the 3D printer comprises at least one controller, e.g., as part of a control system (such as any control system disclosed herein). The controller(s) may control one or more characteristics of the energy beam (e.g., variable characteristics). The control of the energy beam may allow a lower degree of material evaporation during the 3D printing process that would have otherwise transpire. The material evaporation may form debris (e.g., gas borne debris). For example, controlling on or more energy beam characteristics may (e.g., substantially) reduce the amount of spatter generated during the 3D printing process. The low degree of material evaporation may be measured in grams of evaporated material and compared to a Kilogram of hardened material formed as part of the 3D object. The low degree of material evaporation may be evaporation of at most about 0.25 grams (gr.), 0.5 gr, 1 gr, 2 gr. 5 gr, 10 gr, 15 gr, 20 gr, 30 gr, or 50 gr for every Kilogram of hardened material formed as part of the 3D object. The low degree of material evaporation for every Kilogram of hardened material formed as part of the 3D object may be any value between the afore-mentioned values (e.g., from about 0.25 gr to about 50 gr, from about 0.25 gr to about 30 gr, from about 0.25 gr to about 10 gr, from about 0.25 gr to about 5 gr, or from about 0.25 gr to about 2 gr).

In some cases, the 3D printing system can comprise two, three, four, five, or more energy sources. An energy source can be a source configured to deliver energy to an area (e.g., a confined area). An energy source can deliver energy to the confined area through radiative heat transfer.

In some embodiments, the energy source supplies any of the energies described herein (e.g., energy beams). The energy source may deliver energy to a point or to an area. The energy source may include an electron gun source. The energy source may include a laser source. The energy source may comprise an array of lasers. In an example, a laser can provide light energy at a peak wavelength of at least about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm. 1200 nm, 1500 nm, 1600 nm, 1700 nm, 1800 nm, 1900 nm, or 2000 nm. In an example a laser can provide light energy at a peak wavelength of at most about 100 nanometer (nm). 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength between the afore-mentioned peak wavelengths (e.g., from 100 nm to 2000 nm, from 100 nm to 1100 nm, or from 1000 nm to 2000 nm). The energy beam can be incident on the top surface of the material bed. The energy beam can be incident on, or be directed to, a specified area of the material bed over a specified time period. The energy beam can be substantially perpendicular to the top (e.g., exposed) surface of the material bed. The material bed can absorb the energy from the energy beam (e.g., incident energy beam) and, as a result, a localized region of the material in the material bed can increase in temperature. The increase in temperature may transform the material within the material bed. The increase in temperature may heat and transform the material within the material bed. In some embodiments, the increase in temperature may heat and not transform the material within the material bed. The increase in temperature may heat the material within the material bed.

In some embodiments, the energy beam is moveable with respect to a material bed and/or 3D printing system. The energy beam and/or source can be moveable such that it can translate relative to the material bed. The energy beam and/or source can be moved by an optical system (e.g., comprising a scanner). The movement of the energy beam can comprise utilization of a scanner. In some embodiments, the energy source is stationary.

In some embodiments, the formation of the 3D object includes transforming (e.g., fusing, binding and/or connecting) the pre-transformed material (e.g., 3D printing starting material such as a powder material) using an energy beam. The energy beam may be projected on to the starting material (e.g., disposed in the material bed), thus causing the pre-transformed material to transform (e.g., fuse). The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material.

The methods described herein may comprise repeating the operations of material deposition and material transformation operations to produce a 3D object (or a portion thereof) by at least one 3D printing (e.g., additive manufacturing) method. For example, the methods described herein may further comprise repeating the operations of depositing a layer of pre-transformed material and transforming at least a portion of the pre-transformed material to connect to the previously formed 3D object portion (e.g., repeating the 3D printing cycle), thus forming at least a portion of a 3D object. The transforming operation may comprise utilizing energy beam(s) to transform the material. In some instances, the energy beam is utilized to transform at least a portion of the material bed.

In some embodiments, the transforming energy is provided by an energy source. The transforming energy may comprise an energy beam. The energy source can produce an energy beam. The energy beam may include a radiation comprising electromagnetic, electron, positron, proton, plasma, or ionic radiation. The electromagnetic beam may comprise microwave, infrared, ultraviolet, or visible radiation. The ion beam may include a charged particle beam. The ion beam may include a cation, or an anion. The electromagnetic beam may comprise a laser beam. The laser may comprise a fiber, or a solid-state laser beam. The energy source may include a laser. The energy source may include an electron gun. The energy depletion may comprise heat depletion. The energy depletion may comprise cooling. The energy may comprise an energy flux (e.g., energy beam. E.g., radiated energy). The energy may comprise an energy beam. The energy may be the transforming energy. The energy may be a warming energy that is not able to transform the deposited pre-transformed material (e.g., in the material bed). The warming energy may be able to raise the temperature of the deposited pre-transformed material. The energy beam may comprise energy provided at a (e.g., substantially) constant or varied energy beam characteristics. The energy beam may comprise energy provided at (e.g., substantially) constant or varied energy beam characteristics, depending on the position of the generated hardened material within the 3D object. The varied energy beam characteristics may comprise energy flux, rate, intensity, wavelength, amplitude, power, cross-section, or time exerted for the energy process (e.g., transforming or heating). The energy beam footprint may be the average (or mean) FLS of the footprint of the energy beam on the exposed surface of the material bed. The FLS may be a diameter, a spherical equivalent diameter, a length, a height, a width, or diameter of a bounding circle. The FLS may be the larger of a length, a height, and a width of a 3D form.

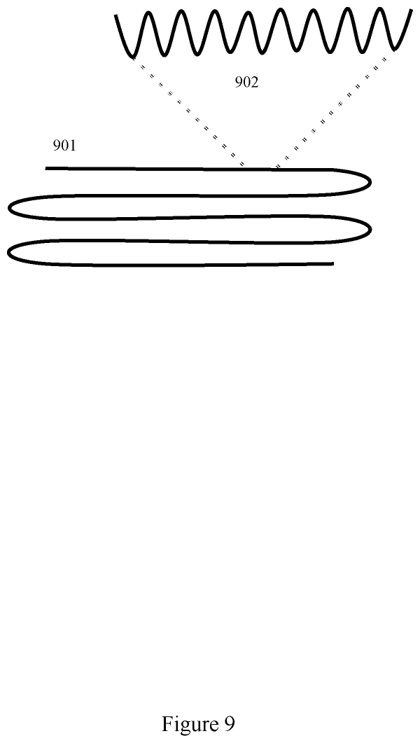

In some embodiments, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave. FIG. 9 shows an example of a path 901 of an energy beam comprising a zigzag sub-pattern, e.g., 902 shown as an expansion (e.g., blow-up or zoom in) of a portion of the path 901. The sub-path of the energy beam may comprise a wave (e.g., sine or cosine wave) pattern. The sub-path may be a small path that forms the large path. The sub-path may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof.

In some embodiments, the path comprises successive lines. The successive lines may touch each other. The successive lines may overlap each other in at least one point. The successive lines may substantially overlap each other. The successive lines may be spaced by a first distance (e.g., hatch spacing). Examples of materials, 3D printers, associated methods such as using successive lines, software, systems, apparatuses and devices, can be found in International Patent Application Serial No. PCT/US17/60035, filed Nov. 3, 2017, titled “GAS FLOW IN THREE-DIMENSIONAL PRINTING;” and in International Patent Application Serial No. PCT/US22/16550, filed Feb. 26, 2022, titled “GAS FLOW IN THREE-DIMENSIONAL PRINTING;” each of which is entirely incorporated herein by reference.

In some embodiments, the term “auxiliary support,” as used herein, generally refers to at least one feature that is a part of a printed 3D object, but not part of the desired, intended, designed, ordered, requested and/or final 3D object. Auxiliary support may provide structural support during and/or subsequent to the formation of the 3D object. The auxiliary support may be anchored to the enclosure. For example, an auxiliary support may be anchored to the platform (e.g., building platform), to the side walls of the material bed, to a wall of the enclosure, to an object (e.g., stationary or semi-stationary) within the enclosure, or any combination thereof. The auxiliary support may be the platform (e.g., the base, the substrate) or the bottom of the enclosure. The auxiliary support may enable the removal of energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, platform, or another stabilization feature. In some instances, the auxiliary support may be mounted, clamped, or situated on the platform. The auxiliary support can be anchored to the building platform, to the sides (e.g., walls) of the building platform, to the enclosure, to an object (stationary or semi-stationary) within the enclosure, or any combination thereof.

In some examples, the generated 3D object(s) can be printed without auxiliary support in a material bed in which it/they are formed. In some examples, overhanging feature of the generated 3D object can be printed without (e.g., without any) auxiliary support. The generated object can be devoid of auxiliary supports. The generated object may be suspended (e.g., float anchorlessly) in the material bed (e.g., powder bed). The term “anchorlessly,” as used herein, generally refers to without or in the absence of an anchor. In some examples, an object is suspended in a powder bed anchorlessly without attachment to a support. For example, the object floats in the powder bed. The generated 3D object may be suspended in the layer of pre-transformed material (e.g., powder material). The pre-transformed material (e.g., powder material) can offer support to the printed 3D object (or the object during its generation). Sometimes, the generated 3D object may comprise one or more auxiliary supports. The auxiliary support may be suspended in the pre-transformed material (e.g., powder material). The auxiliary support may provide weights or stabilizers. The auxiliary support can be suspended in the material bed within the layer of pre-transformed material in which the 3D object (or a portion thereof) has been formed. The auxiliary support (e.g., one or more auxiliary supports) can be suspended in the pre-transformed material within a layer of pre-transformed material other than the one in which the 3D object (or a portion thereof) has been formed (e.g., a previously deposited layer of (e.g., powder) material). The auxiliary support may touch the platform. The auxiliary support may be suspended in the material bed (e.g., powder material) and not touch the platform. The auxiliary support may be anchored to the platform.

In some examples, the energy is transferred from the material bed to the cooling member. Energy (e.g., heat) can be transferred from the material bed to the cooling member (e.g., heat sink) through any one or combination of heat transfer mechanisms. FIG. 1, 113 shows an example of a cooling member. The heat transfer mechanism may comprise conduction, radiation, or convection. The convection may comprise natural or forced convection. The cooling member can be solid, liquid, gas, or semi-solid. In some examples, the cooling member (e.g., heat sink) is solid. The cooling member may be located above, below, or to the side of the material bed. The cooling member may be disposed adjacent to the build module (e.g., 123). The cooling member may be disposed adjacent to, or in the elevator shaft (e.g., FIG. 1, 105). The cooling member may be disposed in the platform (e.g., in the substrate and/or in the base).

In some examples, when the energy source is in operation, the material bed reaches a certain (e.g., average) temperature. The average temperature of the material bed can be an ambient temperature or “room temperature.” The average temperature of the material bed can have an average temperature during the operation of the energy (e.g., beam(s)). The average temperature of the material bed can be an average temperature during the formation of the transformed material, the formation of the hardened material, or the generation of the 3D object. The average temperature can be below or just below the transforming temperature of the material. Just below can refer to a temperature that is by at most about 1° C., 2° C., 3° C., 4° C., 5° C., 6° C., 7° C., 8° C., 9° C., 10° C., 15° C., or 20° C. below the transforming temperature. The average temperature of the material bed (e.g., pre-transformed material) can be by at most about 10° C. (degrees Celsius), 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 10° C., 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be any temperature between the afore-mentioned material average temperatures. The average temperature of the material bed can be below a melting point of the material constituting the material bed. The average temperature of the material bed (e.g., pre-transformed material) may refer to the average temperature during the 3D printing. The pre-transformed material can be the material within the material bed that has not been transformed and generated at least a portion of the 3D object (e.g., the remainder). The temperature of the material bed can be conditioned (e.g., heated or cooled) before, during, or after forming (e.g., printing) the 3D object (e.g., hardened material). Bulk heaters can heat and/or cool the material bed. The bulk temperature conditioners can be situated adjacent to (e.g., above, below, or to the side of) the material bed, or within a material dispensing system. For example, the material can be heated using radiators (e.g., quartz radiators, or infrared emitters). The material bed temperature can be controlled (e.g., substantially maintained) at a predetermined value. The temperature of the material bed can be monitored. The material temperature can be controlled manually and/or by a control system (e.g., such as any control system disclosed herein).

In some embodiments, a container comprises one or more sensors. The container described herein may comprise at least one sensor. The container may comprise the build module container, the filtering container, the distal container, the processing chamber, or the enclosure. The sensor may be connected and/or controlled by the control system (e.g., computer control system, or controller(s)). The control system may be able to receive signals from the at least one sensor. The control system may act upon at least one signal received from the at least one sensor. The control may rely on feedback and/or feed forward control scheme that has been pre-programmed. The feedback and/or feed forward mechanisms may rely on input from at least one sensor that is connected to the controller(s).

In some embodiments, the sensor may be configured to detects the amount debris in the enclosure and/or gas flow system. The controller(s) may monitor the amount of debris. The one or more sensors can include a pressure sensor, a temperature sensor, a gas flow sensor, or an optical density sensor. The pressure sensor may measure the pressure of the chamber (e.g., pressure of the chamber atmosphere). The pressure sensor can be coupled with (e.g., to) the control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The sensor may comprise a material level sensor such as a powder level sensor. The sensor (e.g., material level sensor) may comprise a guided wave radar. The metrology sensor may comprise measurement sensor (e.g., height, length, width, depth, angle, and/or volume). The metrology sensor may comprise a magnetic, acceleration, orientation, or optical sensor. The optical sensor may comprise a camera (e.g., IR camera, or CCD camera (e.g., single line CCD camera)), or CCD camera (e.g., single line CCD camera). The sensor may transmit and/or receive sound (e.g., echo), magnetic, electronic, or electromagnetic signal. The electromagnetic signal may comprise a visible, infrared, ultraviolet, ultrasound, radio wave, or microwave signal. The metrology sensor may measure the tile. The metrology sensor may measure the gap. The metrology sensor may measure at least a portion of the layer of material, e.g., pre-transformed, transformed, and/or hardened. The layer of material may be a pre-transformed material (e.g., powder), transformed material, or hardened material. The metrology sensor may measure at least a portion of the 3D object, e.g., a height of the 3D object protruding from the exposed surface of the material bed. The metrology sensor may be part of a metrology system, e.g., a height mapper system. The sensor may comprise a temperature sensor, weight sensor, powder level sensor, gas sensor, or humidity sensor. The gas sensor may sense any gas enumerated herein. The temperature sensor may comprise Bolometer, Bimetallic strip, Calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, Pyrometer, IR camera, or CCD camera (e.g., single line CCD camera). The temperature sensor may measure the temperature without contacting the material bed (e.g., non-contact measurements). The pyrometer may comprise a point pyrometer, or a multi-point pyrometer. The Infrared (IR) thermometer may comprise an IR camera. The pressure sensor may comprise Barograph, Barometer, Boost gauge, Bourdon gauge, hot filament ionization gauge, Ionization gauge, McLeod gauge, Oscillating U-tube, Permanent Downhole Gauge, Piezometer, Pirani gauge, Pressure sensor, Pressure gauge, tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode as light sensor, Light-addressable potentiometric sensor, Nichols radiometer, Fiber optic sensors, optical position sensor, photo detector, photodiode, photomultiplier tubes, phototransistor, photoelectric sensor, photoionization detector, photomultiplier, photo resistor, photo switch, phototube, scintillometer, Shack-Hartmann, single-photon avalanche diode, superconducting nanowire single-photon detector, transition edge sensor, visible light photon counter, or wave front sensor. The weight of the enclosure (e.g., container), or any components within the enclosure (e.g., container) can be monitored by at least one weight sensor in or adjacent to the material. For example, a weight sensor can be situated at the bottom of the enclosure. The weight sensor(s) can be part of a weighing system (also herein “weight assembly,” “weight system assembly,” or “scale”). The weight sensor can be situated between the bottom of the enclosure and the substrate. The weight sensor can be situated between the substrate and the base. The weight sensor can be situated between the bottom of the container and the base. The weight sensor can be situated between the bottom of the container and the top of the material bed. The weight sensor can comprise a pressure sensor. The weight sensor may comprise a spring scale, a hydraulic scale, a pneumatic scale, or a balance. At least a portion of the pressure sensor can be exposed on a bottom of the container. In some cases, the at least one weight sensor can comprise at least one button load cell, e.g., load cell(s) disposed below the distal container. The distal container may be disposed horizontally such that (e.g., all) the load cell(s) are within the horizontal cross section of the distal container's floor. Alternatively, or additionally a sensor can be configured to monitor the weight of the material by monitoring a weight of a structure that contains the material (e.g., a material bed). One or more position sensors (e.g., height sensors) can measure the height of the material bed relative to the substrate. The position sensors can be optical sensors. The position sensors can determine a distance between one or more energy sources and a surface of the material bed. The surface of the material bed can be the upper surface of the material bed. For example, FIG. 1, 119 shows an example of an upper surface of the material bed 104. Top and bottom may be with respect to the gravitational vector of the ambient environment pointing to the environmental gravitational center. The sensor may comprise a guided wave radar, e.g., configured to measure an amount of material within the container. The material may comprise debris or dilutive media. Examples of materials, 3D printers, associated methods, software, systems, apparatuses, and devices sensors such as a guided wave radar (GWR), can be found, can be found in International Patent Application Serial No. PCT/US2022/053881, filed Jan. 20, 2023, titled “MATERIAL DETECTION, CONVEYANCE, AND CONDITIONING SYSTEMS,” which is entirely incorporated herein by reference.

In some embodiments, the 3D printer comprises one or more valves. The methods, systems and/or the apparatus described herein may comprise at least one valve. The valve may be shut or opened based at least in part on an input from the sensor(s) (e.g., automatically), or manually. The degree of valve opening or shutting may be regulated by the control system, for example, according to at least one input from at least one sensor. The systems and/or the apparatus described herein can include one or more valves, such as throttle valves or butterfly valves. The valve may or may not comprise a sensor sensing the open/shut position of the valve. The valve may be a component of a gas flow mechanism, e.g., operable to control flow of gas of the gas conveyance system. A valve may be a component of the gas conveyance system, e.g., operable to control a flow of gas in the gas conveyance system. The valve(s) may comprise a proportional valve or a discrete valve.

In some embodiments, the 3D printer comprises one or more motors. The motor may be controlled by the controller(s) (e.g., by the control system) and/or manually. The motor may alter (e.g., the position of) the substrate and/or to the base. The motor may alter (e.g., the position of) the elevator. The motor may alter an opening of the enclosure (e.g., its opening or closure). The motor may be a step motor or a servomotor.

In some embodiments, the 3D printer comprises one or more nozzles. The systems and/or the apparatus described herein may comprise at least one nozzle. The nozzle may be regulated according to at least one input from at least one sensor. The nozzle may be controlled automatically or manually. The controller may control the nozzle. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., at towards the material bed.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valve-less pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump. In some examples, the systems and/or the apparatus described herein include one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector.

In some embodiments, the 3D printer comprises at least one filter. The filter may comprise a ventilation filter. The ventilation filter may capture debris and/or other gas-borne material (e.g., fine powder) from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas borne pre-transformed material, or gas borne transformed material. The debris may result from the 3D printing process. The filter and/or gas flow may direct the debris in a requested direction (e.g., by using positive and/or negative gas pressure). For example, the filter and/or gas flow may use vacuum, overpressure, and/or gas pulsing. For example, the ventilator may use gas flow.

In some embodiments, the 3D printer comprises a communication technology. The systems, apparatuses, and/or parts thereof may comprise Bluetooth technology, systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, EOh, EFh, FEh, or FFh. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the 3D printer comprises a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of materials, 3D printers, associated methods, software, systems, apparatuses such as controllers, and devices, can be found in International Patent Application Serial No. PCT/US17/18191, filed Feb. 16, 2017, titled “ACCURATE THREE-DIMENSIONAL PRINTING,” which is incorporated herein by reference in their entirety.

Control may comprise regulate, modulate, adjust, maintain, alter, change, govern, manage, restrain, restrict, direct guide, oversee, manage, preserve, sustain, restrain, temper, or vary.

In some embodiments, the methods, systems, device, software and/or the apparatuses described herein comprise a control system. The control system can be in communication with one or more energy sources, optical systems, gas flow system, material flow systems, energy (e.g., energy beams) and/or with any other component of the 3D printing system. The energy sources may be of the same type or of different types. For example, the energy sources can be both lasers, or a laser and an electron beam. For example, the control system may be in communication with the first energy and/or with the second energy. The control system may regulate the one or more energies (e.g., energy beams). The control system may regulate the energy supplied by the one or more energy sources. For example, the control system may regulate the energy supplied by a first energy beam and by a second energy beam, to the pre-transformed material within the material bed. The control system may regulate the position of the one or more energy beams. For example, the control system may regulate the position of the first energy beam and/or the position of the second energy beam.

In some embodiments, a plurality of energy beams is used to transform the pre-transformed material and for one or more 3D objects. The plurality of energy beams may be staggered (e.g., in a direction). The direction of may be along the direction of the gas flow, or at an angle relative to the direction of flow. The angle may be perpendicular, or an angle different than perpendicular. The plurality of energy beam may comprise 2, 3, 4, 5, 6, 7, 8, 9, or 10. The plurality of energy beams may form an array. At least two of the plurality of energy beams may be controlled independently of each other. At least two of the plurality of energy beams may be controlled in concert. At least two of the plurality of energy beams may translate independently of each other. At least two of the plurality of energy beams may translate in concert. At least two of the plurality of energy beams may be controlled by the same controller. At least two of the plurality of energy beams may be controlled by different controllers.

In some embodiments, the 3D printing system comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor (e.g., 3D printer processor) may be programmed to implement methods of the disclosure. The controller may control at least one component of the systems and/or apparatuses disclosed herein. FIG. 10 is a schematic example of a computer system 1000 that is programmed or otherwise configured to facilitate the formation of a 3D object according to the methods provided herein. The computer system 1000 can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 1001 can be part of, or be in communication with, a 3D printing system or apparatus. The computer may be coupled with (e.g., to) one or more mechanisms disclosed herein, and/or any parts thereof. For example, the computer may be coupled with (e.g., to) one or more sensors, valves, switches, motors, pumps, scanners, optical components, or any combination thereof.

The computer system 1000 can include a processing unit 1006 (also “processor,” “computer” and “computer processor” used herein). The computer system may include memory or memory location 1002 (e.g., random-access memory, read-only memory, flash memory), electronic storage unit 1004 (e.g., hard disk), communication interface 1003 (e.g., network adapter) for communicating with one or more other systems, and peripheral devices 1005, such as cache, other memory, data storage and/or electronic display adapters. The memory 1002, storage unit 1004, interface 1003, and peripheral devices 1005 are in communication with the processing unit 1006 through a communication bus (solid lines), such as a motherboard. The storage unit can be a data storage unit (or data repository) for storing data. The computer system can be operatively coupled with (e.g., to) a computer network (“network”) 1001 with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with (e.g., to) the computer system to behave as a client or a server.

The processing unit can execute a sequence of machine-readable instructions, which can be embodied in a program or software. The instructions may be stored in a memory location, such as the memory 602. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1000 can be included in the circuit.

In some embodiments, the storage unit 1004 stores files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

In some embodiments, the 3D printer comprises communicating through a network. The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 1002 or electronic storage unit 1004. The machine executable or machine-readable code can be provided in the form of software. During use, the processor 1006 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code, or can be compiled during runtime. The code can be supplied in a programming language that can be selected to enable the code to execute in a pre-compiled or as-compiled fashion.

In some instances, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least about 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which may be disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 0.1 Tera FLOPS (T-FLOPS), 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1P-FLOPS, 2P-FLOPS, 3P-FLOPS, 4P-FLOPS, 5P-FLOPS, 10P-FLOPS, 50P-FLOPS, 100P-FLOPS, 1 EXA-FLOP, 2 EXA-FLOPS or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about 0.1 T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

In some instances, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

In some instances, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

In some instances, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, ethernet media access control (MAC) blocks, or high-speed serial transceivers. DSP blocks can be DSP slices.

In some examples, the computing system includes an integrated circuit. The computing system may include an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (s), 1 μs, 10 μs, 100 μs, or 1 millisecond (ms). The physical unit may produce the algorithm output in any time between the above mentioned times (e.g., from about 0.1 μs, to about 1 ms, from about 0.1 μs, to about 100 μs, or from about 0.1 s to about 10 s).

In some instances, the controller uses calculations, real time measurements, or any combination thereof to regulate the energy beam(s). The sensor (e.g., temperature and/or positional sensor) may provide a signal (e.g., input for the controller and/or processor) at a rate of at least about 0.1 KHz, 1 KHz, 10 KHz, 100 KHz, 1000 KHz, or 10000 KHz). The sensor may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real time measurements may be conducted during the 3D printing process. The real-time measurements may be in situ measurements in the 3D printing system and/or apparatus, the real time measurements may be during the formation of the 3D object. In some instances, the processing unit may use the signal obtained from the at least one sensor to provide a processing unit output, which output is provided by the processing system at a speed of at most about 100 min, 50 min, 25 min, 15 min, 10 min, 5 min, 1 min, 0.5 min (i.e., 30 sec), 15 sec, 10 sec, 5 sec, 1 sec, 0.5 sec, 0.25 sec, 0.2 sec, 0.1 sec, 80 milliseconds (msec), 50 msec, 10 msec, 5 msec, 1 msec, 80 microseconds (sec), 50 μpsec, 20 μsec, 10 μsec, 5 μsec, or 1 μsec. In some instances, the processing unit may use the signal obtained from the at least one sensor to provide a processing unit output, which output is provided at a speed of any value between the afore-mentioned values (e.g., from about 100 min to about 1 psec, from about 100 min to about 10 min, from about 10 min to about 1 min, from about 5 min to about 0.5 min, from about 30 sec to about 0.1 sec, from about 0.1 sec to about 1 msec, from about 80 msec to about 10 μsec, from about 50 μsec to about 1 μsec, from about 20 μsec to about 1 μsec, or from about 10 μsec to about 1 μsec).

In some embodiments, the processing unit comprises an output. The processing unit output may comprise an evaluation of the temperature at a location, position at a location (e.g., vertical and/or horizontal), or a map of locations. The location may be on the target surface. The map may comprise a topological or temperature map. The temperature sensor may comprise a temperature imaging device (e.g., IR imaging device).

In some embodiments, the processing unit receives a signal from a sensor. The processing unit may use the signal obtained from the at least one sensor in an algorithm that is used in controlling the energy beam. The algorithm may comprise the path of the energy beam. In some instances, the algorithm may be used to alter the path of the energy beam on the target surface. The path may deviate from a cross section of a model corresponding to the requested (e.g., desired) 3D object. The processing unit may use the output in an algorithm that is used in determining the manner in which a model of the requested (e.g., desired) 3D object may be sliced. The processing unit may use the signal obtained from the at least one sensor in an algorithm that is used to configure one or more parameters and/or apparatuses relating to the 3D printing process. The parameters may comprise a characteristic of the energy beam. The parameters may comprise movement of the platform and/or material bed. The parameters may comprise relative movement of the energy beam and the material bed. In some instances, the energy beam, the platform (e.g., material bed disposed on the platform), or both may translate. Alternatively or additionally, the controller may use historical data for the control. Alternatively or additionally, the processing unit may use historical data in its one or more algorithms. The parameters may comprise the height of the layer of powder material disposed in the enclosure and/or the gap by which the cooling element (e.g., heat sink) is separated from the target surface. The target surface may be the exposed layer of the material bed.

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some examples, the computer system comprises a memory. The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

In some instances, the computer system comprises an electronic display. The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

In some instances, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some instances, the computer system includes a user interface. The computer system can include, or be in communication with, an electronic display unit that comprises a user interface (UT) for providing, for example, a model design or graphical representation of an object to be printed. Examples of UI's include a graphical user interface (GUI) and web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., monitor) may display various parameters of the printing system (as described herein) in real time or in a delayed time. The display unit may display the requested (e.g., desired) printed 3D object (e.g., according to a model), the printed 3D object, real time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the pre-transformed material. The display unit may display the amount of a certain gas in the chamber. The gas may comprise an oxidizing gas (e.g., oxygen), hydrogen, water vapor, or any of the gasses mentioned herein. The gas may comprise a reactive agent. The display unit may display the pressure in the chamber. The computer may generate a report comprising various parameters of the methods, objects, apparatuses, or systems described herein. The report may be generated at predetermined time(s), on a request (e.g., from an operator) or at a whim.

Methods, apparatuses, and/or systems of the present disclosure can be implemented by way of one or more algorithms. An algorithm can be implemented by way of software upon execution by one or more computer processors. For example, the processor can be programmed to calculate the path of the energy beam and/or the power per unit area emitted by the energy source (e.g., that should be provided to the material bed in order to achieve the requested (e.g., desired) result). Examples of materials, 3D printers, associated methods such as control schemes (e.g., comprising algorithms), software, systems, apparatuses and devices, can be found in International Patent Application Serial No. PCT/US17/18191, filed Feb. 16, 2017, titled “ACCURATE THREE-DIMENSIONAL PRINTING,” which is incorporated herein by reference in their entirety.

In some embodiments, the 3D printer comprises and/or communicates with a multiplicity of processors. The processors may form a network architecture. The 3D printer may comprise at least one processor (referred herein as the “3D printer processor”). The 3D printer may comprise a plurality of processors. At least two of the plurality of the 3D printer processors may interact with each other. At times, at least two of the plurality of the 3D printer processors may not interact with each other.

In some embodiments, a 3D printer processor interacts with at least one processor that acts as a 3D printer interface (also referred to herein as “machine interface processor”). The processor (e.g., machine interface processor) may be stationary or mobile. The processor may be a remote computer systems. The machine interface one or more processors may be connected to at least one 3D printer processor. The connection may be through a wire (e.g., cable) or be wireless (e.g., via Bluetooth technology). The machine interface may be hardwired to the 3D printer. The machine interface may directly connect to the 3D printer (e.g., to the 3D printer processor). The machine interface may indirectly connect to the 3D printer (e.g., through a server, or through wireless communication). The cable may comprise coaxial cable, shielded twisted cable pair, unshielded twisted cable pair, structured cable (e.g., used in structured cabling), or fiber-optic cable.

In some embodiments, the machine interface processor directs 3D print job production, 3D printer management, 3D printer monitoring, or any combination thereof. The machine interface processor may not be able to influence (e.g., direct, or be involved in) pre-print or 3D printing process development. The machine management may comprise controlling the 3D printer controller (e.g., directly or indirectly). The printer controller may direct start (e.g., initiation) of a 3D printing process, stopping a 3D printing process, maintenance of the 3D printer, clearing alarms (e.g., concerning safety features of the 3D printer).

In some embodiments, the machine interface processor allows monitoring of the 3D printing process (e.g., accessible remotely or locally). The machine interface processor may allow viewing a log of the 3D printing and status of the 3D printer at a certain time (e.g., 3D printer snapshot). The machine interface processor may allow to monitor one or more 3D printing parameters. The one or more printing parameters monitored by the machine interface processor can comprise 3D printer status (e.g., 3D printer is idle, preparing to 3D print, 3D printing, maintenance, fault, or offline), active 3D printing (e.g., including a build module number), status and/or position of build module(s), status of build module and processing chamber engagement, type and status of pre-transformed material used in the 3D printing (e.g., amount of pre-transformed material remaining in the reservoir), status of a filter, atmosphere status (e.g., pressure, gas level(s)), ventilator status, layer dispensing mechanism status (e.g., position, speed, rate of deposition, level of exposed layer of the material bed), status of the optical system (e.g., optical window, mirror), status of scanner, alarm (boot log, status change, safety events, motion control commands (e.g., of the energy beam, or of the layer dispensing mechanism), or printed 3D object status (e.g., what layer number is being printed).

In some embodiments, the machine interface processor allows monitoring the 3D print job management. The 3D print job management may comprise status of each build module (e.g., atmosphere condition, position in the enclosure, position in a queue to go in the enclosure, position in a queue to engage with the processing chamber, position in queue for further processing, power levels of the energy beam, type of pre-transformed material loaded, 3D printing operation diagnostics, status of a filter. The machine interface processor (e.g., output device thereof) may allow viewing and/or editing any of the job management and/or one or more printing parameters. The machine interface processor may show the permission level given to the user (e.g., view, or edit). The machine interface processor may allow viewing and/or assigning a certain 3D object to a particular build module, prioritize 3D objects to be printed, pause 3D objects during 3D printing, delete 3D objects to be printed, select a certain 3D printer for a particular 3D printing job, insert and/or edit considerations for restarting a 3D printing job that was removed from 3D printer. The machine interface processor may allow initiating, pausing, and/or stopping a 3D printing job. The machine interface processor may output message notification (e.g., alarm), log (e.g., other than Excursion log or other default log), or any combination thereof.

In some embodiments, the 3D printer interacts with at least one server (e.g., print server). The 3D print server may be separate or interrelated in the 3D printer. One or more users may interact with the one or more 3D printing processors through one or more user processors (e.g., respectively). The interaction may be in parallel and/or sequentially. The users may be clients. The users may belong to entities that request (e.g., desire) a 3D object to be printed, or entities who prepare the 3D object printing instructions. The one or more users may interact with the 3D printer (e.g., through the one or more processors of the 3D printer) directly and/or indirectly. Indirect interaction may be through the server. One or more users may be able to monitor one or more aspects of the 3D printing process. One or more users can monitor aspects of the 3D printing process through at least one connection (e.g., network connection). For example, one or more users can monitor aspects of the printing process through direct or indirect connection. Direct connection may be using a local area network (LAN), and/or a wide area network (WAN). The network may interconnect computers within a limited area (e.g., a building, campus, neighborhood). The limited area network may comprise Ethernet or Wi-Fi. The network may have its network equipment and interconnects locally managed. The network may cover a larger geographic distance than the limited area. The network may use telecommunication circuits and/or internet links. The network may comprise Internet Area Network (IAN), and/or the public switched telephone network (PSTN). The communication may comprise web communication. The aspect of the 3D printing process may comprise a 3D printing parameter, machine status, or sensor status. The 3D printing parameter may comprise hatch strategy, energy beam power, energy beam speed, energy beam focus, thickness of a layer (e.g., of hardened material or of pre-transformed material).

In some embodiments, a user develops at least one 3D printing instruction and directs the 3D printer (e.g., through communication with the 3D printer processor) to print in a requested (e.g., desired) manner according to the developed at least one 3D printing instruction. A user may or may not be able to control (e.g., locally or remotely) the 3D printer controller. For example, a client may not be able to control the 3D printing controller (e.g., maintenance of the 3D printer).

In some embodiments, the user (e.g., other than a client) processor may use real-time and/or historical 3D printing data. The 3D printing data may comprise metrology data, or temperature data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

In some embodiments, the fundamental length scale (e.g., the diameter, spherical equivalent diameter, diameter of a bounding circle, or largest of height, width, depth, and length; abbreviated herein as “FLS”) of the printed 3D object or a portion thereof can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object or a portion thereof can be at most about 150 μm, 170 μm, 200 μm, 230 μm, 250 μm, 270 μm, 300 μm, 400 μm, 500 μm, 600 n, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. The FLS of the printed 3D object or a portion thereof can any value between the afore-mentioned values (e.g., from about 50 μm to about 1000 m, from about 500 μm to about 100 m, from about 50 μm to about 50 cm, or from about 50 cm to about 1000 m). In some cases, the FLS of the printed 3D object or a portion thereof may be in between any of the afore-mentioned FLS values. The portion of the 3D object may be a heated portion or disposed portion (e.g., tile).

In some embodiments, a projected energy beam heats a portion of the material bed. The projected energy beam may irradiate a portion of the material bed. The heat or irradiation of the portion of the material bed may generate debris (e.g., comprising splatter, spatter, soot, metal vapor, molten metal, plasma, or the like). The debris may be disposed in the enclosure (e.g., processing chamber). For example, the debris may be disposed in the atmosphere of the enclosure), e.g., the debris may become gas borne. For example, the debris may be disposed (e.g., accumulated) on one or more components within the enclosure. For example, the debris may be disposed on one or more internal surfaces (e.g., walls or optical window) of the enclosure. For example, the debris may float within the enclosure atmosphere. The debris (e.g., accumulation thereof) may cause damage to various components of the 3D printing system (e.g., the optical window). A gas may flow through the enclosure. The enclosure may comprise a gas flow mechanism (also referred to herein as the “gas conveyance system”) that allows displacement (e.g., removal) of the debris from a position in the enclosure atmosphere (e.g., from the entire enclosure atmosphere) to another position (e.g., to a filter). The other position may be disposed outside of the enclosure (e.g., outside of the processing chamber). The gas flow mechanism may be part of the gas conveyance system of the 3D printer.

In some embodiments, the gas flow mechanism (also referred to herein as “gas flow director,” “gas flow manager,” “gas flow management system,” or “gas flow management arrangement”) comprises structures that at least partially dictate the flowing of gas across the (e.g., entire) enclosure and/or a portion of the enclosure. The gas flow mechanism can be used to at least partially control a characteristic of gas flow adjacent (e.g., over) the target surface and/or the platform. Over the target surface may comprise at most 2 cm, 5 cm, 10 cm, or 20 cm above the target surface (e.g., the exposed surface of the material bed). Target surface may refer to a surface that is a radiation target for the energy beam. The gas flow mechanism can include a gas inlet portion that at least partially controls the flow of gas entering into the enclosure. The gas flow mechanism can include a gas outlet portion that at least partially controls the flow of gas exiting the enclosure. The gas flow mechanism can be used to at least partially control a characteristic of gas flow adjacent to or within a recessed portion of the enclosure (e.g., to purge the recessed portion). The gas flow director can include the gas inlet portion, the gas outlet portion, features for purging a recessed portion of the enclosure, or any suitable combination thereof. The recessed portion may be at the ceiling of the enclosure. The recessed portion (e.g., FIG. 14, 1418) may be disposed at a wall of the enclosure opposing to the target surface. The gas may comprise an inert gas (e.g., nitrogen and/or argon). The gas may flow in bulk. The gas may flow in one or more streams. The gas may comprise a non-reacting (e.g., inert) gas. The gas may comprise a reactive agent depleted gas and/or water depleted gas. The flow of the gas may comprise flowing across at least a portion of the height (e.g., Y axis. See FIG. 4) of the enclosure. For example, the flow of the gas may comprise flowing across the entire height of the enclosure. The flow of the gas may comprise flowing across at least a portion of the depth (e.g., Z axis. See FIG. 4) of the enclosure. For example, the flow of the gas may comprise flowing across the entire depth of the enclosure. The flow of the gas may comprise flowing across at least a portion of the width (e.g., X axis. See FIG. 4) of the enclosure (e.g., also referred herein as the length of the enclosure). For example, the flow of the gas may comprise flowing across the entire width of the enclosure. The flow of gas may comprise flowing onto an internal surface of the optical window (e.g., facing the exposed surface of the material bed). The area adjacent to the optical window may comprise one or more slots (e.g., a slot per optical window, or a single slot for all optical windows, or dispersed multiple slots across one or more optical windows), one or more channels, or a combination thereof. The flow of gas may comprise flowing through the slot(s), channels, or a combination thereof, on to the internal surface of the optical window. The slot and/or channel may facilitate directing the flow of gas onto the internal surface of the optical window. For example, the gas flow may be optionally evacuated from an area adjacent (e.g., directly adjacent) to the optical window(s). The flow of gas may reduce the amount of (e.g., prevent) powder, soot, and/or other debris from adhering to the internal surface of the one or more optical windows. The flow of gas may reduce the amount of (e.g., prevent) powder, soot, and/or other debris from obstructing an optical path of the energy beam that travels from the optical window to the exposed surface of the material bed. The flow of gas may be (e.g., substantially) lateral. The flow of gas may be (e.g., substantially) horizontal. The gas may flow along, away and/or towards the one or more optical windows. The gas may flow in a plurality of gas streams. The gas streams may be spread across at least a portion of the (e.g., entire) height and/or depth of the enclosure. The gas streams may be evenly spread. The gas streams may not be evenly spread (e.g., across at least a portion of the enclosure height and/or depth). The gas streams may flow across at least a portion of the enclosure height and/or depth Across the enclosure, the gas streams may flow in the same direction. The same direction may comprise from the gas-inlet to the gas-outlet. The same direction may comprise from one edge of the enclosure to the opposite end). The same direction may comprise from the gas-inlet to the gas-outlet. The gas flow may flow laterally across at least a portion of the (e.g., height and/or depth of the) enclosure. The gas flow may flow laminarly across at least a portion of the (e.g., height and/or depth of the) enclosure. The at least a portion of the enclosure may comprise the processing cone. In one embodiment, the gas streams may not flow in the same direction. In one embodiment, one or more gas streams may flow in the same direction and one or more gas streams may flow in the opposite direction. The gas flow (e.g., in the at least one stream) may comprise a laminar flow. The gas flow may comprise flow in a constant velocity during at least a portion of the 3D printing. For example, the gas flow may comprise flow in a constant velocity during the operation of the energy beam (e.g., during the transformation of at least a portion of the material bed). Laminar flow may comprise fluid flow (e.g., gas flow) in (e.g., substantially) parallel layers. The gas flow may comprise flow in a varied velocity during at least a portion of the 3D printing. For example, the gas flow may comprise flow in a varied velocity during the operation of the energy beam (e.g., during the transformation of at least a portion of the material bed). The gas streams may comprise a turbulent flow. Turbulent flow may comprise (e.g., random, and/or irregular) fluctuations in pressure, magnitude, direction and/or flow velocity of the gas. Turbulent flow may comprise a chaotic flow. In some embodiments, the chaotic flow comprises circular, swirling, agitated, rough, irregular, disordered, disorganized, cyclonic, spiraling, vortex, or agitated movement of the gas. In some embodiments, the mixing comprises laminar, vertical, horizontal, or angular movement. The gas flow within at least two of the gas streams within the enclosure may be of a different velocity and/or density. The gas flow within at least two of the gas streams within the enclosure may be of the same magnitude. The gas flow within at least two of the gas streams within the enclosure may be of variable magnitude. The gas flow (e.g., of at least one gas stream) within the enclosure may be free of standing vortices. A standing vortex may be described as a vortex in which the axis of fluid rotation remains in (e.g., substantially) the same location, e.g., not transmitted with the rest of the flow. Turbulent flow of gas within the enclosure may generate a vortex that transmits with the rest of the flow, thus generating a gas flow without standing vortices. The gas flow mechanism may not comprise (i) recirculation of gas, (ii) gas flow stagnation, or (iii) static vortices, within the enclosure. For example, the gas flow mechanism may not comprise recirculation of gas within the enclosure. The gas flow (e.g., in the enclosure) may be continuous. Continuously may be during the operation of the 3D printer (e.g., before, during and/or after the 3D printing or a portion thereof). The gas stream(s) may be altered (e.g., reduced, or cease to flow) when the energy beam is not operating (e.g., to transform at least a portion of the material bed). Optionally, at least portion of the gas flow may be changed before, during or after dispensing mechanism performs dispensing. The alteration may be in velocity, gas stream trajectory, gas content, pressure, humidity content, oxidizing gas content, gas flow cross section (e.g., at full width half maximum), or any combination thereof. The velocity of the gas (e.g., in the enclosure and/or in the gas conveyance system outside of the enclosure) can be at least about 0.1 m/s, 0.2 m/s, 0.3 m/s, 0.5 m/s, 0.7 m/s, 0.8 m/s, 1 m/s, 2 m/s, 5 m/s, 10 m/s, 15 m/s, 20 m/s, 30 m/s or 50 m/s. The velocity of gas can be at most about 0.1 m/s, 0.2 m/s, 0.3 m/s, 0.5 m/s, 0.7 m/s, 0.8 m/s, 1 m/s, 2 m/s, 5 m/s, 10 m/s, 15 m/s, 20 m/s, 30 m/s or 50 m/s. The velocity of the gas (e.g., in the enclosure and/or in the gas conveyance system outside of the enclosure) can be between any of the afore-mentioned values (e.g., from about 0.1 m/s to about 50 m/s, from about 0.1 m/s to about 1 m/s, from about 2 m/s to about 20 m/s, from about 30 m/s to about 50 m/s, or from about 0.7 m/s to about 1 m/s). The velocity of the gas can be during at least a portion of the 3D printing. The velocity of the gas can refer to its flow velocity along any one of its flow components (e.g., flow directions). The velocity of the gas can have a flow component along the width of the chamber (X direction, FIG. 4). The velocity of the gas can have a flow component along the height of the chamber (Y direction, FIG. 4). The velocity of the gas can have a flow component along the depth of the chamber (Z direction, FIG. 4).

In an example, a layer dispensing mechanism is reversibly parked in an isolatable ancillary chamber when it does not perform a layer dispensing operation. The energy beam may be projected on the material bed when the layer dispensing mechanism resides within the ancillary chamber (e.g., isolated from the processing chamber), and the gas flow may continue during operation of energy beam (i.e. lasing). The gas stream(s) may be altered (e.g., reduced, or cease to flow) when the layer dispensing mechanism performs a dispensing of a layer of material (e.g., and exits the ancillary chamber). The gas stream(s) may continue to flow when the layer dispensing mechanism performs a dispensing of a layer of material. Operation of the energy beam may comprise a dwell time of the energy beam.

In some examples, the gas flow mechanism comprises an inlet portion (e.g., FIG. 4, 440, 442), which can also be referred to as an inlet portion, gas inlet portion, gas inlet port, gas inlet portion, or other suitable term. The inlet portion may be connected to a side wall of the enclosure (e.g., FIG. 4, 473). The inlet portion may comprise one or more inlets. The side wall may be an internal side wall. The side wall may be a divider forming a processing chamber side wall. The inlet portion may include one or more openings to facilitate gas flow into the enclosure (e.g., into the inlet portion). In some embodiments, the inlet portion may be separated from the processing chamber by an internal inlet (e.g., separation) wall. The aspect ratio of the internal inlet wall relative to an inlet opening can be at least about 500:1, 250:1, 200:1, 100:1, 50:1, 25:1 or 10:1. The aspect ratio of the internal inlet wall relative to an outlet opening can be at most about 500:1, 250:1, 200:1, 100:1, 50:1, 25:1 or 10:1. The aspect ratio of the internal inlet wall relative to an inlet opening can be between any of the afore-mentioned values (e.g., from about 500:1 to about 10:1, from about 500:1 to about 100:1, from about 100:1 to about 50:1, or from about 50:1 to about 10:1). In some embodiments, the inlet portion is separated from the processing chamber by a filter. The filter may be one of the filters disclosed herein. In some embodiments, the outlet portion may be separated from the processing chamber by an internal outlet (e.g., separation) wall. The internal outlet wall and/or internal inlet wall may comprise an opening. The term “opening” may refer to the internal inlet wall opening, internal outlet wall opening, inlet opening, and/or outlet opening. Examples of internal wall opening(s) can be seen in the examples in FIGS. 10, 1010, and 1011. The opening(s) may be (e.g., reversibly) coupled with (e.g., to) at least one side wall of the inlet portion. For example, one or more openings may be coupled with (e.g., to) the same side wall. The opening may be gas inlet opening that facilitate gas flow into the enclosure. The opening may be gas outlet opening that facilitate gas flow out of the enclosure. The multiple openings on the wall may be uniformly spaced horizontally, vertically and/or at an angle. The multiple openings may not be uniformly spaced. The openings may run across the entire wall of the enclosure (e.g., height and/or depth thereof). For example, the openings may occupy a percentage of the enclosure height and/or depth (e.g., FIG. 11, 1100). The percentage may be at least about 50%, 60%, 70%, 80%, 90%, 95%, 98% or 99% of the enclosure height and/or depth. The openings may run across any number between the afore-mentioned heights and/or depths of the enclosure wall (e.g., from about 50% to about 99%, from about 50% to about 70%, from about 70% to about 90%, or from about 90% to about 99%). The openings may be evenly or non-evenly spaced. For example, a greater concentration of openings may reside closer to the platform and/or exposed surface of the material bed. For example, a lower concentration of openings may reside closer to the ceiling of the enclosure. For example, a greater concentration of passable openings may reside closer to the platform and/or exposed surface of the material bed. For example, a lower concentration of closed openings may reside closer to the ceiling of the enclosure FIG. 1n some examples, the openings may extend from an exposed surface of the material bed and/or platform, to the optical window. In some examples, the openings may extend from an exposed surface of the material bed and/or platform, to at least 50%, 60%, 70%, 80%, 90%, 95%, 98%, or 99% height of the enclosure. The openings extend from an exposed surface of the material bed and/or platform by any number between the afore-mentioned examples (e.g., from about 50% to about 99%, from about 50% to about 70%, from about 70% to about 90%, or from about 90% to about 99%). The opening may be oval Fig. For example, the opening may be circular (e.g., FIG. 11, 1110). The opening(s) may have a shape of a polyhedral such as a hexagon (e.g., FIG. 11, 1111). The opening may be pipe shaped. A cross section of the opening may be any geometrical shape (e.g., hexagonal, rectangular, square, circular or triangle). A cross section of the openings may be random. An opening may be a slit. The openings may comprise an array of openings (e.g., FIG. 11, 1100). The openings may comprise a single file (e.g., single line) of openings. The cross section of the openings may change its shape before, during, and/or after the 3D printing (or a portion thereof, e.g., during the operation of the energy beam). The cross-sectional shape of the openings can be controlled (e.g., manually and/or by a controller). The cross-sectional shape of the openings may be altered by the controller. The alteration may comprise an electronic, magnetic, temperature, audio, or optical signal. The alteration may be induced electronically, magnetically, by temperature alteration, audibly, optically, or by any combination thereof. The alteration of at least two openings (e.g., within the array of openings) may be collectively (e.g., simultaneously or sequentially) controlled. The alteration of at least two openings (e.g., within the array of openings) may be separately (e.g., individually) controlled. The percentage of void forming the opening may be controlled before, during, and/or after the 3D printing (or a portion thereof, e.g., during the operation of the energy beam). For example, at least an opening may be closed (e.g., a line of openings, a plurality of opening, or the entire array). The opening may have any opening values disclosed herein. In some examples, the opening can comprise sizes of at least about 0.1 millimeter (mm), 0.2 mm, 0.5 mm, 1 mm, 2 mm, 5 mm, 10 mm, 20 mm, 30 mm, 40 mm, 50 mm, 60 mm, 70 mm, 80 mm, 90 mm, or 100 mm. The opening can comprise sizes of at most about 0.1 millimeter (mm), 0.2 mm, 0.5 mm, 1 mm, 2 mm, 5 mm, 10 mm, 20 mm, 30 mm, 40 mm, 50 mm, 60 mm, 70 mm, 80 mm, 90 mm, or 100 mm. The opening can comprise sizes between any of the opening sizes disclosed herein. For example, the opening can comprise sizes from about 0.1 mm to about 100 mm, from about 5 mm to about 50 mm, or from about 50 mm to about 100 mm.

In some examples, the inlet portion comprises a perforated plate (a mesh, screen, e.g., FIG. 11, 1100). The internal inlet wall and/or internal outlet wall may comprise the perforated plate. In some instances, the inlet portion may comprise more than one perforated plates. The perforated plates may be stacked (e.g., vertically, horizontally, and/or at an angle). The perforated plates may be stacked in parallel to each other. The perforated plate may comprise one or more perforations (e.g., FIGS. 11, 1110 and/or 1111). The perforation may be an opening (e.g., as disclosed herein). The perforations (e.g., holes) may be uniformly spread across at least a portion (e.g., the entire) perforated plate. FIG. 11, 1100 shows an example of uniform perforations (e.g., circular holes) spread across the entire perforated plate. The perforated plate may comprise a single file (e.g., row) of perforations. At times, the size of the perforations in the plate may be uniform (e.g., FIG. 11), 1100. At times, the size of the perforations in the plate may not be uniform. At times, the angle of the perforations in the plate may not be uniform. At times, the angle of the perforations in the plate may not be uniform. At times, the pass-ability of the perforations in the plate may not be uniform. The size of the perforations may be controlled (e.g., as described herein re openings). For example, the perforations may be thermally controlled. The size of the perforations may contract with increase in surface temperature. The size of the perforations may expand with a decrease in temperature. The size of the openings (e.g., perforations) may be altered to control the amount and/or velocity of flow of gas through each opening. Altered may comprise increasing and/or decreasing the opening size.

In some examples, the inlet and/or outlet portion comprises one or more ledges (e.g., FIG. 11, 1120). The ledges may be baffles. At times, the inlet and/or outlet portion may comprise a perforated plate or a ledge. At times, the inlet and/or outlet portion may comprise both a perforated plate and a ledge. The ledge may be movable. For example, the ledge may be movable before, during, and/or after the 3D printing. For example, the ledge may be movable during a portion of the 3D printing. During a portion of the 3D printing may comprise during the operation of the energy beam, or during the formation of a layer of hardened material. The ledge may be controlled manually and/or automatically. The ledge may direct one or more streams of gas to flow in a certain direction. The ledge may alter the amount and/or velocity of the gas stream. For example, the ledge may (e.g., substantially) prevent the gas flow through it by closing an opening. The ledge may laterally extend from one edge of the intermediate wall to an opposing wall away from the processing chamber. The opposing wall may comprise an inlet or outlet opening. The ledge and/or opening may be passive. The position (e.g., horizontal, vertical, and/or angular) of the ledges may be controlled (e.g., during at least a portion of the 3D printing). The position of the ledge may be altered to control the amount, velocity, and/or direction of flow of at least one gas through each ledge. Altered may comprise reducing gas flow (e.g., preventing). Altered may comprise allowing gas flow.

In some examples, the inlet opening comprises a valve. In some examples, the outlet opening comprises a valve. In some examples, at least two openings may share the same valve. In some examples, at least two openings may have different valves. In some embodiments, at least one channel (e.g., the adapter channel) is connected to a valve. The valve may control the flow of gas through the valve. Control the flow may comprise flow velocity, pressure, gas content (e.g., oxidizing gas content), humidity content, gas make up. The valve may be a mechanical, electrical, electro-mechanical, manually operable, controlled, or an automated valve. The valve may comprise a pressure relief, pressure release, pressure safety, safety relief, pilot-operated relief, low pressure safety, vacuum pressure safety, low and vacuum pressure safety, pressure vacuum release, snap acting, or a modulating valve. The valve may comply with the legal industry standards presiding the jurisdiction. The valve may have a sensor configured to indicate the position (e.g., on or off) of the valve. In some embodiments, the position of the valve is indicated indirectly (e.g., using a flow sensor and/or a pressure sensor).

In some instances, the gas flow mechanism is coupled with (e.g., to) a recycling mechanism. The recycling system may be configured to recycle the gas flowing into the processing chamber, e.g., before, during and/or after printing. The recycling mechanism may comprise a closed loop system (e.g., having one or more vents). The recycling mechanism may collect the gas from the outlet portion (e.g., 870) and/or from the outlet opening (e.g., 872). The recycling mechanism may filter the gas from debris. The recycling mechanism may inject the recycled (e.g., cleaned) gas into the enclosure. For example, the recycling mechanism may inject the gas into the inlet opening, inlet portion, and/or processing chamber. The injection may be direct or indirect. At least a portion of the recycling may be performed before, after, and/or during the 3D printing. At least a portion of the recycling may be continuous (e.g., during at least a portion of the 3D printing). The recycling mechanism may comprise a filtering mechanism (e.g., FIG. 8, 830, FIG. 13, 1360). The filtering mechanism may comprise, or be operatively coupled with (e.g., to) a distal container. Operatively coupled may be using a physical adapter. The distal container may have a volume of at least about 50 liters, 100 liters, 150 liters, 200 liters, 250 liters, 300 liters, 500 liters, or 1000 liters. The distal container may have a volume between any of the aforementioned volumes, e.g., from 50 liters to 1000 liters, from 50 liters to 250 liters, from 150 liters to 500 liters, or from 500 liters to 1000 liters. The distal container, when closed by a lid, may be configured to maintain (e.g., during operation and/or storage) positive pressure above ambient pressure external to the distal container. The physical adapter may comprise a channel. The physical adapter (e.g., including the channel), the distal container, and the lid, may be configured to each maintain their prescribed internal atmospheric conditions during operation. The channel may be rigid or flexible. The channel may comprise a hose or a tube. In some embodiments, the channel is flexible. The channel may comprise a polymer or a resin. The channel may comprise elemental metal or metal alloy. The channel may comprise a transparent portion or an opaque portion. The channel may be configured to facilitate flow of debris and any dilutive media to fill at least about 10, 20, or 50 distal containers for safe disposal, e.g., while maintaining the internal atmosphere during operation. The channel may comprise a bellow, e.g., comprising elemental metal, metal alloy, polymer, or resin. The channel may have a FLS (e.g., diameter) of at least about 5 centimeters (cm), 8 cm, 10 cm, or 15 cm. The channel may have a FLS (e.g., diameter) of at most about 5 cm, 10 cm, 15 cm or 30 cm. The channel can have a FLS between any of the aforementioned values (e.g., from bout 5 cm to about 30 cm). In some embodiments, a flexible channel may facilitate a greater accuracy in measuring a weight of the distal container by the weighing system, e.g., as compared to a rigid channel, the channel being of the physical adapter. The filtering mechanism may comprise, or be operatively coupled with (e.g., to) one or more sensors (e.g., FIG. 13, 1315). The one or more sensors may comprise a sensor suite. The one or more sensors may be operatively coupled, or be included in, the physical adapter. The recycling mechanism may comprise a device configured to remove the debris (e.g., particulate material) from the gas. The removal may be using a filter, screen, perforated-plate, or any combination thereof. The removal may be using a charge such as a magnetic and/or electrical charge. For example, the removal may comprise using an electrostatic gas filter. The filtering mechanism may comprise a filter (e.g., polymer, polyester, paper, mesh, or electrostatic gas filter). The filter may enable gas to flow through it. The filter may prevent the debris from flowing through it. The filtering mechanism may allow gas to flow through. The filtering mechanism may separate the gas from debris (such as gas borne particulate material, splatter, spatter, and/or soot). The filtering mechanism may comprise a filter, an outlet opening, inlet opening, canister, channel, sensor, or valve. These may be any of the types disclosed herein. The filtering mechanism may comprise a pressure difference mechanism to filter gas from the debris. The filtering mechanism may comprise a gas removal mechanism (e.g., vacuum, overpressure, or gas channel). The suction mechanism may comprise a filter. The filter may be subject to vacuuming therethrough (e.g., to attract accumulation of debris on the filter). The filter may be subject to pushing pressurized gas therethrough (e.g., to release the accumulated debris on the filter). The recycling, pressurizing, and/or suction mechanism may facilitate (e.g., evacuate and/or channel) a flow of the gas from the outlet opening of the processing chamber to the inlet portion (e.g., through the inlet opening) of the processing chamber. At times, the gas from the outlet opening of the processing chamber may be conveyed via the filtering mechanism (e.g., using positive or negative pressure, for example, using a gas pump). The filtering mechanism may be continuously operational during at least a portion of the 3D printing (e.g., during the operation of the energy beam, during formation of a layer of hardened material, during deposition of a layer of pre-transformed material, during the printing of the 3D object). The filtering mechanism may be operation during one or more printing cycles. The filtering mechanism may be controlled (e.g., before, after, and/or during at least a portion of the 3D printing). The control may be manual and/or automatic, e.g., using at least one controller (e.g., using the control system). The at least one controller may be part of the control system of the 3D printer. For example, the at least one controller can be part of the control system that controls the energy beam(s) of the 3D printer. The filtering mechanism may comprise a paper, mesh, or an electrostatic filter. The filtering mechanism may include one or more sensors (e.g., optical, pressure). The sensors may detect incoming gas into the filtering mechanism. The sensors may detect debris in the filter. The sensors may detect clogging of the filter. The filtering mechanism may be done in batches and/or continuously. The filtering mechanism may operation during at least a portion of the 3D printing. The recycling mechanism, pressurizing mechanism, and/or suction mechanism as part of the gas conveyance system may release the gas into the filtering mechanism in batches. The release of gas may be timed, automatically controlled (e.g., using sensor feedback control scheme), or initiated at a whim. The recycling mechanism may comprise or be operatively coupled with (e.g., to) a pump. For example, the filtering mechanism may be operatively coupled (e.g., connected) to the pump (e.g., FIG. 4, 830, FIG. 13, 1350). The pump may receive filtered gas from the filtering mechanism. The pump may be coupled with (e.g., to) a variable frequency drive. The variable frequency drive may allow controlling the gas flow rate from the pump (e.g., into the enclosure). At times, the gas flow rate may be dynamically (e.g., real time) controlled. The control may be manual and/or automatic. The recycling mechanism may comprise a re-conditioning system. The re-conditioning system may recondition the gas (e.g., remove and/or add any reactive species such as oxidizing gas, or water). The re-conditioned gas may be recycled and used during (e.g., in) the 3D printing. For example, the reconditioning system may add humidity to the gas before it enters into the processing chamber and/or filter container (e.g., canister). Recycling may comprise transporting the recycled gas to the processing chamber. Recycling may comprise transporting the gas to the inlet portion of the processing chamber. Recycling may comprise transporting the gas within the processing chamber enclosure (e.g., FIG. 13, 1340, FIG. 1, 107). In some instances, the re-conditioning mechanism may re-condition the separated pre-transformed material (e.g., 3D printing starting material such as powder) that may be trapped in the filtering mechanism along with the other forms of debris. For example, the residual material may be filtered and/or collected in a separate container (e.g., FIG. 4, 438) such as a distal container (that may be a separable container). The re-conditioned material may be recycled and used in the 3D printing. Recycling may comprise transporting the separated material to the layer dispensing system. The recycling may be continuous and/or in batches during at least a portion of the 3D printing. The distal container (e.g., separable container) may be separated from the filtering container (e.g., integral container), e.g., during printing. Separation of the distal container from the filtering container may be done in a way such that it does not disrupt the 3D printing process. The coupling of the filtering container from the distal container may be configured to facilitate non-interrupted printing during separation, after separation, during integration, and after integration, of the filtering container from the distal container (e.g., separable container). The filtering container may remain integrated in the gas flow system during the printing, regardless of the integration status of the distal container.

In some embodiments, the gas conveyance system comprises an enriching system. The enriching system may be configured to enrich the gas, such as the recycled (or recycling) gas, by one or more reactive agents at a prescribed amount such as relative amount, percentage, or proportional amount. For example, the enriching system can enrich the recycled (or recycling) gas with oxygen and/or humidity. The enriching system may enrich the gas by an amount of reactive agent that is lower than its amount in the ambient environment external to the processing chamber and/or 3D printer. FIG. 13 shows an example of enriching system 1391. The Enriching system can be separated from the main line of the gas conveyance system by one or more valves. FIG. 13 shows an example of enriching system 1391 separated from the main line of the gas conveyance system two valves 1392a and 1391b.

In some embodiments, the gas conveyance system includes a temperature conditioning system. The temperature conditioning system may comprise a heater, a cooler, a heating ventilation and air conditioning system (HVAC), or any combination thereof. In an example, the temperature conditioning system is a cooler. FIG. 13 shows an example of a temperature conditioning system in 1393 disposed along the gas conveyance system channels, before the recycling gas enters the processing chamber.

In some embodiments, the recycling mechanism may be coupled with (e.g., to) a filter (e.g., sieve). In some embodiments, gas material may be filtered (e.g., sieved) before recycling and/or 3D printing. Filtering may comprise passing a gas borne material (e.g., liquid or particulate) through a filter. The filtering may comprise passing the gas borne material using a flow of the gas, through a cyclonic separator. Filtering may comprise classifying the gas borne material. Classifying may comprise gas classifying. Gas classifying may comprise air-classifying. Gas classifying may include transporting a material (e.g., particulate material) through a channel. A first set of gas flow carrying particulate material of various types (e.g., cross sections, or weights) may flow horizontally from a first horizontal side of the channel to a second horizontal side of the channel. A second set of gas flow may flow vertically from a first vertical side of the channel to a second vertical side. The second vertical side of the channel may comprise material collectors (e.g., bins). As the particulate material flows from the first horizontal direction to the second horizontal direction, the particulate material interacts with the vertical flow set, and gets deflected from their horizontal flow course to a vertical flow course. The particulate material may travel to the material collectors, depending on their size and/or weight, such that the lighter and smaller particles collect in the first collator, and the heaviest and largest particles collect at the last collector. Blowing gas (e.g., air or any other gas (e.g., mixture) disclosed herein such as robust gas) may allow classification of the particulate material according to the size and/or weight. The material may be conditioned before use (e.g., re-use) in the enclosure. The material may be conditioned before, or after recycling. Examples of materials. 3D printers, associated methods such as using gas classification systems, software, systems, apparatuses and devices, can be found in International Patent Application Serial No. PCT/US17/39422, filed on Jun. 27, 2017, and titled “THREE-DIMENSIONAL PRINTING AND THREE-DIMENSIONAL PRINTERS,” which is incorporated herein by reference in its entirety.

In some embodiments, a filtering mechanism may be operatively coupled with (e.g., to) at least one component of the layer dispensing mechanism, the pump (e.g., pressurizing pump), gas conveyance system, an ancillary chamber and/or the enclosure (e.g., processing chamber, and/or optical system enclosure). The filtering mechanism may be operatively coupled with (e.g., to) the gas flow mechanism (also referred to herein as the “gas conveyance system”). For example, the filtering mechanism may be operatively coupled (e.g., physically coupled) to the gas conveying channel of the gas flow mechanism. Physical coupling may comprise flowable coupling to allow at least flow of gas (e.g., and gas borne material). Operatively coupled may include fluid communication (e.g., a fluid connection, and/or a fluid conveying channel). Fluid communication may include a connection that allows a gas, liquid, and/or solid (e.g., particulate material) to flow through the connection. The filtering mechanism may be operatively coupled with (e.g., to) an outlet portion of the processing chamber. A gas comprising gas-borne materials (e.g., soot, spatter, splatter, reactive species, pre-transformed material and/or any other debris carried by the gas flow) may flow through the filtering mechanism. The filtering mechanism may be configured to facilitate separation of the gas-borne materials from gas. The filtering mechanism may comprise (e.g., one or more) filters or pumps. The one or more filters may comprise crude filters or fine filters (e.g., HEPA filters). The one or filters may be disposed before a pump and/or after a pump.

In some embodiments, the filtering mechanism comprises at least one container (e.g., a filtering container and a distal container) such as canisters. The container may comprise a uniform or a non-uniform shape. For example, the filtering system may comprise two or more containers. At least one of the containers may be directly coupled with (e.g., to) the gas conveying channels of the gas conveyance system (e.g., a filtering container may be an integral container). At least one of the containers may be indirectly coupled with (e.g., to) the gas conveying channels of the gas conveyance system (e.g., a distal container such as a separable container), such as through a physical coupler and/or adapter. The physical coupler and/or adapter may connect the filtering container with the distal container (e.g., separable container). The physical coupler and/or adapter may be (e.g., reversibly) disintegrated. The physical coupler and/or adapter may be (e.g., reversibly) bifurcated. The container may comprise a geometrical cross sectional shape (e.g., a cylinder, sphere, rectangular, and/or circular). The container may comprise a 3D shape. The container may have an internal and/or external 3D shape. The internal shape may be the same or different as the external 3D shape of the container. The container may have a uniform or a non-uniform internal 3D shape. The 3D shape may comprise a cuboid (e.g., cube), a tetrahedron, a polyhedron (e.g., primary parallelohedron), at least a portion of an ellipse (e.g., circle), a cone, a triangular prism, hexagonal prism, cube, truncated octahedron, or gyrobifastigium, a pentagonal pyramid, or a cylinder. The polyhedron may be a prism (e.g., hexagonal prism), or octahedron (e.g., truncated octahedron). A vertical cross section (e.g., side cross section) of the 3D shape may comprise a circle, triangle, rectangle, pentagon, hexagon, octagon, or any other polygon. The vertical cross section may be of an amorphous shape. The polygon may comprise at least 3, 4, 5, 6, 7, 8, 9, or 10 faces. The polygon may comprise at least 3, 4, 5, 6, 7, 8, 9, or 10 vertices. The cross-section may comprise a convex polygon. The polygon may be a closed polygon. The polygon may be equilateral, equiangular, regular convex, cyclic, tangential, edge-transitive, rectilinear, or any combination thereof. For example, the (e.g., vertical) cross-section of the 3D shape may comprise a square, rectangle, triangle, pentagon, hexagon, heptagon, octagon, nonagon, octagon, circle, or icosahedron. The container (e.g., distal container) may be replaceable, removable, exchangeable, and/or modular. The container may be removed, replaced, and/or exchanged before, during, and/or after 3D printing. Removing, replacing, and/or exchanging may be done manually and/or automatically (e.g., using at least one controller, controlled, and/or semi-automatic). The container may comprise a material that facilitates entrapment of the gas borne debris and/or internal 3D printer gas (e.g., inert gas). The container may comprise a material that facilitates impermeability of an external gas (e.g., air, oxidizing gas, water, and/or humidity) into the container. External may include an atmosphere on the exterior of the container. The container (e.g., body and/or lid thereof) may comprise a material that facilitates minimal gas and/or liquid leaks. The material of the container may facilitate adherence to safety standard prevailing in the jurisdiction, for example, by limiting the oxidizing gas and/or humidity concentration in the container (e.g., during and/or after the filtering process). The limit may be based at least in part on the standard in the jurisdiction. Example standards may include combustion and/or ignition related standard, fire related standard (e.g., American Society for Testing and Materials International (ASTM), Occupational Safety and Health Administration (OSHA), Hazard Communication Standard (HCS), Material Safety Data Sheet (MSDS), and/or National Fire Protection Association (NFPA)). In some embodiments, the container may comprise a partition (e.g., a wall) between one or more internal surfaces (e.g., solid material surface). The partition may form a gap (e.g., a void). The gap may be between a first internal surface and a second internal surface of the container. The gap may be filled with a gas. The gap may be filled with a material different than the material of the internal surface of the container (e.g., a liquid, semi-solid, and/or solid material). The gas may be comprised in an atmosphere. The atmosphere of the gap may facilitate maintaining the atmosphere of the container to (e.g., substantially) prevent an atmospheric leak (e.g., permeation of gas such as an oxidizing gas, reactive agent, and/or water). The atmosphere of the gap may be different than the atmosphere of the container interior. The container may facilitate containing gas-borne material (e.g., debris, pre-transformed material, and/or reactive species), for example, in an atmosphere that does not react with the gas borne material. The gas-borne material may be deposited within the container (e.g., adhering to a filter) as a result of filtering the gas (e.g., of flowing the gas) from the processing chamber. The container (e.g., a surface of the container) may be operatively coupled (e.g., fluidly connect) to one or more valves. The valve may allow a flow of gas into and/or out of the container. The container may comprise an entrance opening and an exit opening. The exit opening and the entrance opening may be in opposing sides of the container (e.g., opposing sides of a lid of the container). In some embodiments, the exit opening and the entrance opening to the container may be disposed on non-opposing sides of the container (e.g., of the lid of the container), for example, on adjacent sides of the container. The valve may connect the container (e.g., indirectly) to a gas conveyance system, a processing chamber, a member of the layer dispenser, an ancillary chamber, a controller, a control system, and/or a pump. The valve may be any valve disclosed herein.

In some embodiments, a filter is comprised of organic material, e.g., cellulose. Such organic material may have a hydration layer. Such organic material may be combustible. Such organic material may release one or more reactive species upon reaction, e.g., combustion. The reactive species may comprise water, alcohol, or oxygen (e.g., oxygen radical). Such organic material may combust, e.g., in elevated temperature, e.g., in the presence of oxidizing material such as oxy gen. In an example, the organic material may combust (e.g., and ignite) in contact with hot gas, hot pre-transformed material such as remainder material, and/or hot debris (e.g., comprising soot), with hot being sufficiently hot to cause the combustion. Gas borne material (e.g., solid, liquid, or semisolid) may be captured by the filter. The gas borne material may comprise pre-transformed material or debris. The organic material may release water that may react with pre-transformed material such as remainder material, and/or debris such as comprising soot. The pre-transformed material and/or debris may be of a material type that is susceptible to reacting with the reactive species. The pre-transformed material and/or debris may be of a material form that is susceptible to reacting with the reactive species. In an example, the material type comprises elemental metal. In an example, the elemental metal comprises Aluminum or Titanium. The material form may comprise particles ten micron or smaller such as one micron or smaller. In an example, the material form may comprise particles in the nanoscale regime. The filter may be disposed in the 3D printer, e.g., in the gas conveyance system of the 3D printer. It may be advantageous to use a filter that is devoid of such properties, or has these properties attenuated for safe use. Safe use can be from the perspective of the user, e.g., minimizing harm to the user. Safe use can be from the perspective of equipment and/or facility, e.g., minimizing damage to the equipment and/or to the facility. The equipment may comprise any component of the 3D printer and/or associated with the 3D printer. The equipment associated with the 3D printer may comprise an unpacking station or the distal container. It may be advantageous to carry on the 3D printing without having to interrupt it due to the filter, e.g., due to filter change and/or maintenance.

In some embodiments, the container that is part of the filtering system comprises a filter (e.g., a sieve, screen, a perforated plate, a perforated block, and/or baffle). The filter may be configured to separate the solid gas-borne material (e.g., the debris) from the gas in which it is disposed. The filter may be located within an interior of the filtering container (e.g., FIG. 15, 1500). At times a plurality of filters are disposed in the filtering container. The filter may be disposed adjacent to (or connected, and/or operatively coupled to) one or more internal surfaces (e.g., walls) of the filtering container. The filter may comprise a material that facilitates maintenance of an atmosphere within the container. For example, the filter may not expel the reactive agent (or precursors thereof). For example, the filter may not expel an oxidizing gas and/or humidity (or precursors thereof). Example filters include a composite material, a fiber media, a paper pulp, a fiber gas, polymer, HEPA, polyester, paper, mesh, polymeric, or electrostatic gas filter. At times, the filter may be cleaned. Cleaning may be done before, during, and/or after 3D printing. Cleaning may comprise isolating the container from the 3D printer (e.g., from the gas flow mechanism). Cleaning may include drenching (e.g., with water, liquid, and/or gas). The liquid may comprise a hydrophilic and/or hydrophobic substance and/or solution. The hydrophilic substance may comprise water. The hydrophobic substance may comprise oil. Cleaning (e.g., refurbishing) may require removal of the container comprising the filter. In some embodiments, the cleaning may be performed without removal of the container comprising the filter. In some embodiments, cleaning may require removal of the filter from the 3D printer and/or from the container. In some embodiments, the cleaning may be performed without removal of the filter from the container. The container having the filter may be a filtering container with the gas flow mechanism. For example, the container may be directly connected to channels of the gas flow mechanism.

In some embodiments, debris is be generated as a byproduct of the 3D printing process, which debris may be carried by a gas. The gas may flow as part of a gas circulation loop in which gas is recycled in the 3D printing system. During the recycling process, debris may be filtered to facilitate flow of clean gas, e.g., into a processing chamber of the 3D printing system. At times, the debris may accumulate in a filtering container (e.g., FIG. 15, 1500) as part of the filtering mechanism through which gas flows as part of a gas circulation loop, e.g., of a 3D printing system. The filtering may be done in a filtering container. The filtering container may be integrated in the gas flow system (e.g., gas flow channels). Removal of such integrated filtering container may disrupt the gas flow in the gas circulation loop. Such gas circulation may be required for operation of a 3D printing system, e.g., during printing. To prevent disruption to the 3D printing process and facilitate debris removal during the 3D printing process, the filtering container may lead to a distal container that may be removed without disruption (i) to the filtering operation taking place in the filtering container (e.g., FIG. 15, 1540), and (ii) to the gas flowing the gas recirculation loop. The removal of the distal container from the filtering container may be by severing a connection between the filtering container and the distal container. For example, the removal of the distal container from the filtering container may be by severing a connection between the distal container and a collection container (e.g., hopper such as 1501) that is part of, or is operatively coupled with (e.g., to), the filtering container. In the event the collection container (e.g., hopper) is not part of the filtering container: to prevent the disruption to the 3D printing process, a connection between the filtering mechanism and the collection container may be severed without disruption to the filtering operation taking place in the filtering container. At times, the debris may accumulate in a collection container (e.g., hopper) that is part of, or operatively coupled to (e.g., connected) to a filtering container as part of the filtering mechanism. To prevent disruption to the 3D printing process, the collection container (e.g., hopper) may lead to a distal container that may be removed without disruption to the filtering operation taking place in the filtering container. The removal of the distal container from the collection container may be by severing a connection between the collection container and the distal container.

In some embodiments, the debris is processed using a quelling material. The quelling material may comprise a passivating material and/or an insulating material. The passivating material may comprise an oxidizer. The passivating material may comprise water. The insulating material may comprise a hydrocarbon, e.g., oil. The passivating material may comprise (e.g., may be) the insulating material. The quelling material may comprise a flowable material. The quelling material may comprise a gas, a liquid, a semisolid (e.g., gel), or a flowable suspension. The flowable suspension may comprise solid material suspended in a flowable material. The flowable suspension may comprise vesicles suspended in a flowable material. The solid material may be in the form of a particulate material. The particulate material may comprise powder. The flowable material may comprise a gas, a liquid, or a semisolid. Disclosure concerning liquid quelling material herein may apply to other forms of flowable quelling material, e.g., non-gaseous flowable material. The other forms of flowable quelling material may comprise a flowable gel, a suspension of solid in a liquid, or a suspension of solid in flowable gel.

In some embodiments, the container of the filtering mechanism comprises an inlet portion and/or an outlet portion. For example, the container may be directly or indirectly connected to channels of the gas flow mechanism. The container may include a filtering container and/or a distal container (e.g., a separable container). When the container comprises a filter, the inlet portion and/or outlet portion may facilitate reconditioning (e.g., cleaning) of the filter. The inlet portion may be located adjacent to a top surface of the container (e.g., a lid of the container). Top may be in a direction away from the platform and/or against the gravitation center. The inlet may comprise an inlet channel (e.g., pipe, tube, and/or canal). The inlet may allow insertion of a quelling material including a passivating material and/or an insulating material. The inlet may allow insertion of a cleaning material for cleaning an interior of the filtering container. The inlet channel may extend to a location adjacent to a surface (e.g., top) of the filter. The outlet portion may be in an opposite side of the container where the inlet is located. The outlet may be located on a side of the inlet that is different from the side opposing the inlet. In some embodiments, the outlet does not oppose the inlet. For example, the outlet may not directly oppose the inlet. For example, the outlet may be located adjacent to a side surface of the container. Adjacent to a side surface may comprise in a direction perpendicular and/or at an angle to the inlet. If the inlet is disposed along a vertical line (e.g., along the gravitational vector), the outlet may be disposed at an angle relative to the vertical line. The outlet portion may be at an acute angle between an acute angle values with respect to the vertical line, for example, from about 10 to 90°, or from about 1° to about 30°, from about 300 to about 60°, or from about 600 to about 90°. The outlet portion may facilitate reconditioning (e.g., refurbishing) of the filter, for example, by separation of the gas borne material that adheres to the filter during the filtering operation, e.g., during gas circulation through the container. The separation may be facilitated by a cleansing material comprising a gas and/or a liquid. The separation may be facilitated by a dilutive media comprising a gas and/or a liquid. The cleansing material may comprise the dilutive media. The cleansing material may be a non-reactive, and/or inert to the gas-borne material. The outlet portion may facilitate cleansing of the filter, for example, by flowing off (e.g., blowing off) gas borne material that is adheres to (e.g., collected on/in) the filter. The outlet portion may comprise an outlet channel. The outlet portion may facilitate cleansing of the filter, for example, by flowing off (e.g., blowing off) the cleansing material such as dilutive media, which adheres to (e.g., collected on/in) the filter. The outlet portion may comprise an outlet channel. The outlet channel may facilitate the flow of the gas borne material from the filter to an area (e.g., collection area) outside the container.

In some embodiments, the passivating material is liquid such as comprising water. The liquid may be introduced to the debris slowly or in bulk. Bulk introduction of the passivating liquid may (a) react with the debris (e.g., with an exposed surface thereof) to form a passivating layer such as an oxide layer, and (b) act as a heat sink for any heat of the reaction, e.g., in case of an exothermic reaction. At times (e.g., in case the reaction is exothermic), it may be beneficial to introduce the passivating liquid at a rate sufficient to react and generate a heat sink for the passivation reaction. Temperature of the quelling material (e.g., including the passivating and/or insulating material) may be controlled, e.g., prior and/or during introduction of the quelling material (e.g., the passivating material and/or the insulating material) to the debris in the distal container, e.g., with any dilutive media. For example, the temperature of the quelling material (e.g., including the passivating and/or insulating material) may be conditioned, e.g., cooled. The temperature conditioning may be carried out prior to the quelling material (e.g., including the passivating and/or insulating material) reaching the interior of the distal container, e.g., using a temperature conditioning system such as the one disclosed herein. The temperature conditioning may be during passivation and/or insulation of the debris in the distal container, e.g., by conditioning the of temperature (e.g., cooling) the walls of the distal container.

In some embodiments, the filtering mechanism comprises one or more valves (e.g., flow, stopper, pressure, engaging, dis-engaging, and/or control valve). The valve may allow gas, liquid, and/or solid to (e.g., controllably) flow through. The solid may comprise a particulate material. The valve may allow gas, liquid, and/or solid to (e.g., controllably) prevent from flowing through. Examples of valves include a pressure relief, pressure release, pressure safety, safety relief, pilot-operated relief, low pressure safety, vacuum pressure safety, low and vacuum pressure safety, pressure vacuum release, snap acting, pinch, metering, flapper, needle, check, control, solenoid, flow control, butterfly, ball, piston, plug, popping, rotary, manual, or modulating valve. The valve may be configured for wired and/or wireless communication. The valve may be controlled manually and/or automatically (e.g., using controller(s) such as the ones disclosed herein).

In some embodiments, the filtering mechanism comprises one or more sensors (e.g., presence, mass flow, pressure, temperature, atmosphere, humidity, oxidizing gas, gas, flow, velocity, material density, detection, clogging detection, and/or level sensor). The sensor may sense the level (e.g., percentage) of reactive gas (e.g., oxygen or humidity). The reactive gas may comprise oxygen, water, carbon dioxide, or nitrogen. The reactive gas may react with the material used (e.g., starting material-pre-transformed material) or produced (e.g., transformed material) during the 3D printing. The material produced (e.g., generated, or created) during the 3D printing may comprise debris, e.g., as a byproduct of the 3D printing. The material used for the 3D printing may comprise a particulate material (e.g., powder). The sensor may detect at least one characteristic of the gas that flows through a filter, resides in the container, and/or resides or flows through the physical adapter. The at least one gas characteristic may comprise gas type, gas percentage, reactive gas level, temperature, pressure, or flow rate. The sensor may detect a presence of a container in the gas flow mechanism. The sensor may detect a presence of a filter in the filtering mechanism (e.g., in the container). The sensor may detect at least one gas characteristic of an atmosphere within the container. The at least one characteristic of the atmosphere may comprise gas type, reactive gas level, temperature, gas (e.g., atmosphere) pressure, or flow rate. The sensor may send a signal to one or more controllers operatively coupled with (e.g., to) the filtering mechanism. There may be a plurality of sensors operatively coupled with (e.g., to) the container and/or to the physical adapter. The plurality of sensors may be part of the physical adapter. At least two of the sensors may be of the same type. At least two of the sensors may be of a different type. The sensor may detect a state of at least one component of the filtering mechanism; for example, a level of clogging of the filter, the number of containers present in the gas flow mechanism (as part of the filtering mechanism), the number of containers engaged and/or disengaged from the gas flow mechanism, and/or the number of container in use. The controller may adjust one or more physical properties (e.g., flow of gas, pressure, velocity, temperature, reactive agent level, and/or atmosphere) of the filtering mechanism (e.g., based on a sensor signal). The controller may adjust a flow of gas in the gas flow mechanism (e.g., based on the amount of clogging within the filter in the container). For example, the controller may adjust a flow of gas in the filtering mechanism and/or the processing chamber (e.g., based on the amount of clogging within the filter in the container). The controller may adjust the flow of gas to maintain a requested gas flow velocity and/or acceleration. The control may be performed before, after, and/or during 3D printing. The control may be manual and/or automatic.

In some embodiments, the filtering mechanism comprises one or more indicators (e.g., visual, sound, and/or tactile). The indicator may alert one or more human senses (e.g., sound, visual, tactile, oral, and/or olfactory). The indicators may be a part of a user interface, and/or touchscreen. The indicator may comprise an optical signal. The indicators may reflect a state of the filtering mechanism. The state of the filtering mechanism may include sensing a signal from one or more sensors. Example states of the filtering mechanism may include an a safe to use, ready to use, in operation, unsafe to use, safe to change filter, and/or unsafe to change filter. The safety indicators may correspond to the safety standards in the jurisdiction.

In some embodiments, the debris required to be passivated before it can be safely discarded (e.g., to a landfill). Safe discard may include safe with respect to equipment and/or personnel. Collecting the debris (e.g., 3D printing byproduct) may utilize filtering the debris. Filtering the debris may utilize a filter such as a paper filter. Filtering the debris may comprise a solid filtering medial. The solid filtering media may comprise a porous media. The porous media may comprise a polymer, a resin, an elemental metal, a metal alloy, an allotrope of elemental carbon, or a ceramic. Filtering may comprise sieving and/or centrifugation. The filter container may comprise a separator. The separator can be a filter, e.g., which acts as a sieve. The filter container may comprise a cyclone. The filter container may comprise a centrifuge. Passivating the debris may comprise contacting the debris (including the debris (e.g., soot) containing filter) in or with a passivator (e.g., water) or an insulator (e.g., oil). The passivator may react with the debris (e.g., reactive surface thereof) to form a less reactive species (e.g., metal oxide). The insulator may coat the debris (e.g., surface thereof) with a layer that reduces contact (e.g., reduces the rate of contact) of the debris with reactive species in the ambient atmosphere. For example, the insulator can coat the debris with an insulating layer (e.g., oily layer). The debris (e.g., including the filter containing debris) may be immersed in the passivator and/or insulator. The passivation may comprise diluting the debris with a medium or media that has a reduced affinity to react with the debris and/or with the reactive species in the ambient atmosphere (e.g., water or humidity). For example, the diluting media may comprise glass (e.g., fused glass and/or glass beads), sand, silica, alumina, ceramic, clay, chalk, or stone. For example, the debris may comprise a zeolite. The particulate matter of the diluting media may or may not comprise pores. The diluting media particle may comprise an open pore or a closed pore. The diluting media may comprise particles having a sponge structure (e.g., porous volcanic rock such as pumice). The diluting media may comprise a particulate matter (e.g., comprising beads or powder). The diluting media may comprise vaporized glass beads. The diluting media may comprise particulate matter that has a reduced reactivity (e.g., is not reactive) with the debris. The dilutive media may be inert towards the debris. At times, passivating the mixture of debris and/or any diluting media with a stronger passivator (e.g., water) may present a safety problem, e.g., if overpressure is generated during passivation (e.g., when the water converts to pressurized vapor in the container, and such overpressure may violently expel the beads in the direction of a user and/or equipment). The dilutive media may comprise particulate matter. In an example, the dilutive media comprises expanded glass beads. In an example, the dilutive media comprises Poraver beads. An average FLS of the particulate matter may be at least about 0.05 millimeters (mm), 0.1 mm, 0.2 mm, 0.3 mm, 0.4 mm, 0.5 mm, 0.8 mm, or 0.9 mm. The average FLS (e.g., diameter) of the particulate matter may be of any value between the aforementioned values (e.g., from about 0.05 mm to about 0.9 mm, or from about 0.1 mm to about 0.4 mm). The dilutive media may accumulate on a (porous) filter, which diluting media and debris can be (e.g., substantially) disengaged from the filter. The disengagement may occur when the gas flow in a first direction (e.g., normal to the filter) will reduce in intensity, cease to flow, or flow in a second direction having a directional component (e.g., vectorial component) in a direction opposing the first direction. The second diction may be referred to herein as “backflow”. The backflow gas may be directly or indirectly opposing to the first gas flow direction. The backflow may initiate when the amount (e.g., quantity) of material adhering to the filter (e.g., debris with or without diluting media) exceeds a threshold (e.g., value or function). The backflow of gas may cause the debris accumulated on the filter (e.g., with or without the diluting media) to be released from the filter, and refresh the filter. The refreshed filter may now be ready for a subsequent round of debris filtering. Such method can facilitate repeated use of the filter to filter the debris from the gas flow.

In some embodiments, dilutive media is accumulated on the filtering media together with the debris, e.g., as the gas flows against the filter (e.g., sieve). The filter may comprise a filtering medium. The filtering medium may comprise paper, cellulose, polymer, resin, elemental metal, metal alloy, ceramic, or an allotrope of carbon (e.g., carbon fibers). In some embodiments, the filter may exclude cellulose. In some embodiments, the filter may exclude paper. For example, the filtering media may comprise polyethylene, or polytetrafluoroethylene. For example, the filtering media may comprise Teflon. The filter may comprise regular or irregular open holes. The holes of the filter may be arranged in a lattice structure, or may be randomly arranged. The filter may comprise fibers. The fibers may be organized (e.g., evenly space), or disorganized. For example, the fibers may be randomly disposed and may or may not be tangled with each other. The disorganized (e.g., randomly placed) fibers may generate a mesh (e.g., that is devoid of a lattice unit cell). The separator (e.g., filter medium, cyclone, or centrifuge) may be configured to filter the debris from the gas flow. The filter may facilitate separation of at a rate of at least about 0.1 milligrams per meter cubed (mg/m³), 0.2 mg/m³, or 0.5 mg/m³. The dilutive media and/or debris may be pressed onto the filter to form a pressed layer (e.g., a block, a board, or a “cake”) on a side of the filter against which the gas flows. The dilutive media may contact the filter media, and the debris may contact the dilutive media at a position away from the filter media. The filter may be covered with the dilutive media, e.g., compressed onto the filter media by the gas flow. The debris may compress onto the dilutive media, that in turn compresses onto the filter media. The dilutive media may at least in part form a separator between the filter media and the debris. The dilutive media may at least in part form a protective media for the filter against the debris. Usage of the dilutive media may increase the life of the filter. For example, usage of the dilutive media with the filter, may increase the life of the filter by at least about 1 year, 2 years, 4 years, or 5 years, when the 3D printer is in typical (e.g., continuous) use. Use of the dilutive media may reduce likelihood of debris penetrating into the filter elements. The pressed debris and/or dilutive media may be formed by virtue of the gas flowing towards and through the filtering media. The debris and/or dilutive media may accumulate in layers onto the filter. For example, the debris and dilutive media may form alternate layers of dilutive media and debris pressed onto a face of the filter. Such accumulation may occur until a threshold of material accumulates onto the filter, on which point backpressure is introduced through the filter to cause the accumulated matter (e.g., debris and/or dilutive media) to dislodge from the filter and fall downwards in the filtering container (e.g., the filtering container). The dilutive media (e.g., particulate matter thereof) may form a physical separator that dilutes critical mass of the debris, e.g., to prevent a harmful event. The harmful event may comprise combustion, ignition, flaring, fuming, burning, bursting, explosion, eruption, smelting, flaming, explosion, or any other safety violation, e.g., as disclosed herein. Using a weaker passivator than liquid water to passivate the debris (with or without the dilutive media) may be sufficiently safe when less reactive debris (e.g., comprising Inconel or stainless steel), allowing the container with the debris to be discarded to a landfill. The weaker passivator may comprise gas (e.g., air) having a (e.g., low) level of humidity. Low may be with respect to the level of humidity in an ambient atmosphere external to the container such as the atmosphere in a landfill. At times, the weaker passivator may still pose a risk when debris comprises a more reactive material (e.g., Titanium). Such debris may not be discarded safely since (i) the debris may heat up (e.g., smolder, melt, fuse, or liquify), (ii) the debris may ignite, (iii) the reaction of the debris with the passivator may harm the container in which the debris is in. For example, the container holding the debris may burst due to generation of a violent overpressure within (e.g., even when the container includes an exhaust vent). For example, the (e.g., hot and/or corrosive) debris may cause a crack, hole, erosion, or otherwise puncture the container. The container holding the debris may include the filtering container, the collection container, and/or the distal container.

In some embodiments, the debris released from the filter accumulates in a container such as a filtering container. In some embodiments, the filtering container comprises the filter. For example, the released debris from the filter may fall to a bottom of a container in which the filter is disposed, e.g., using gravity. The release of the debris (and dilutive media) from the filter may take place when a pulse of gas (e.g., pressurized robust gas) in a direction from the filter towards the dilutive media and debris. For example, if the debris and dilutive media accumulates above a filter, e.g., in the direction of the gravitational vector of the ambient environment, then the debris releasing gas pulse will be in the direction against the gravitational vector. For example, if the debris and dilutive media accumulates on filter in the direction of gas flow in the gas conveyance system, then the debris releasing gas pulse will be in the direction against that gas flow direction. In some embodiments, the pulse will be a pressurized gas pulse, e.g., having a pressure difference of at least about 20 millibars (mbar), 23 mbar, 25 mbar, 29 mbars, or 31 mbar. In some embodiments, the container is integrated with (e.g., connected to, such as directly connected to) the gas flow channels of the gas flow mechanism (e.g., gas conveyance system of the 3D printer). The container may be a filtering container such as an integral container that is physically integrated with the gas conveyance system. The fallen debris (e.g., with or without the diluting media) may continuously accumulate in the filtering container (e.g., in a collection container thereof) until it reaches a threshold. For example, the debris (e.g., with or without the dilutive media) may be allowed to accumulate in the filtering container until the filtering process cannot be (e.g., efficiently) take place. Once the threshold is reached, the debris (e.g., with or without the dilutive media) will have to be evacuated from the filtering container in order for the filtering to continue. When such situation occurs during a 3D printing cycle, the 3D printing cycle will have to be interrupted, unless the collection container can be removed without interruption to the filtering process taking place in the filtering container.

In some embodiments, the debris released from the filter accumulates in a container such as a distal container that is coupled with (e.g., to) the filtering container (e.g., through a physical adapter). For example, the released debris from the filter may fall to a bottom of the distal container, e.g., using gravity. In some embodiments, the distal container is integrated with (e.g., connected to, such as indirectly connected to) the gas flow channels of the gas flow mechanism (e.g., through the physical adapter). The fallen debris (e.g., with or without the diluting media) may continuously accumulate in the distal container until it reaches a threshold. For example, the debris (e.g., with or without the dilutive media) may be allowed to accumulate in the distal container until the filtering process cannot (e.g., efficiently) take place. Once the threshold is reached, the debris (e.g., with or without the dilutive media) will have to be evacuated from the distal container in order for the filtering to continue. When such situation occurs during a 3D printing cycle, the 3D printing cycle will have to be interrupted, unless the distal container can be removed without interruption to the filtering process taking place in the filtering container.

In some embodiments, the gas flow mechanism delivers gas at a pressure different from the ambient pressure external to the gas flow mechanism (e.g., gas conveyance system). The gas flow mechanism can convey gas in a pressure above ambient pressure, e.g., as disclosed herein. The gas may have a gas composition different from the ambient gas composition. For example, the gas may have a lower concentration of reactive species (e.g., oxygen or humidity) as compared to the ambient atmosphere. For example, the gas composition may have a higher concentration of inert gas (e.g., nitrogen, argon, or any other inert gas such as disclosed herein). The filtering container may be part (e.g., an integral part) of the gas flow mechanism. As such, the filtering container may have the atmosphere prevalent in the gas flow system (e.g., gas content, and pressure). The filtering container may be configured to operate in such atmospheric conditions. The filtering container may comprise valve(s) and/or sensor(s). The filtering container may be relatively expensive, e.g., due to its being configured to engage with the gas flow mechanism, its sensor(s) and/or its valve(s). The filtering mechanism may be operatively coupled (e.g., communicatively connected) to controller(s). For example, the filtering mechanism may be operatively coupled with (e.g., to) at least one control system of the 3D printer. For example, a control system that controls at least one other component of the 3D printing system (e.g., elevator, energy beam(s), layer dispensing mechanism, gas flow). The control system may be hierarchical. The control system may comprise at least the, four, or five hierarchical control levels.

In some embodiments, a physical adapter is coupled with (e.g., to) (i) a filtering container and/or (ii) a collection container. The physical adapter may be configured to allows connection between the filtering container to a distal container (e.g., reservoir) to collect the debris and/or dilutive media from the filtering container in which the filter is disposed. The physical adapter may facilitate separating the distal container from the filtering container, without disrupting the gas flow in the gas conveyance system, and without disrupting the filtering process taking place in the filtering container. The physical adapter may or may not be flexible. For example, the physical adapter may comprise a channel comprising a flexible material (e.g., comprising polymer or resin). The physical adapter may comprise a material (e.g., Flexaust) utilized in industrial and/or commercial applications (e.g., involving air, fumes, and/or dust, such as ducting, and/or air conditioning.

In some embodiments, flow of material in the physical adapter may be controlled. The physical adapter may comprise one or more valves, e.g., to facilitate (e.g., allow) the isolation of the filtering container from the physical adapter and/or to allow the isolation of the distal container from the physical adapter. The physical adapter may be operatively coupled with (e.g., to) one or more valves, e.g., valves of the lid and/or valves of the filtering container (or of the collecting container). The physical adapter may facilitate manipulation of the distal container without disrupting the filtering container (or the collecting container). Active filtering may (e.g., continuously) occur in the filtering container while the distal container is being manipulated. Manipulation of the distal container may comprise isolating the filtering container from the physical adapter using one or more valves. Manipulation of the distal container may comprise engaging or disengaging it from the physical adapter. Manipulation of the distal container may comprise replacing one distal container with another distal container. Manipulation of the distal container may comprise preconditioning the distal container prior engaging the distal container with the filtering container. Preconditioning of the distal container may comprise changing the composition of its atmosphere to a composition containing robust gas comprising less reactive gases (e.g., inert gas) as compared to the ambient atmosphere. Preconditioning of the distal container may comprise measuring and/or validating that the composition of its atmosphere comprises a concentration of reactive gases below a (e.g., predefined) threshold. The physical adapter may facilitate safely funneling the debris and/or dilutive media through the physical adapter and into the distal container. The physical adapter may comprise at least one channel. The physical adapter may comprise channels that may be separated. For example, the physical adapter may comprise a bifurcated channel. The physical adapter may or may not have valve(s). For example, the physical adapter may have a valve at each of its ends. For example, the physical adapter may have a valve at an end of the physical adapter channel at which end the channel is configured to connect to the container (e.g., filtering container and/or distal container). For example, the physical adapter may be a connection configured to operatively couple to a valve, which connection is at an end of the physical adapter channel at which end the channel is configured to connect to the container (e.g., filtering container and/or distal container). The valve may be part of the physical adapter, or may be part of a lid to which the physical adapter connects to. One end of the physical adapter may be configured to couple to the distal container, e.g., by being configured to couple to a lid of the distal container. An opposing end of the physical adapter may be configured to couple to the filtering container, e.g., by being configured to couple to the collecting container.

In some embodiments, the distal container has a (e.g., sophisticated) lid. The lid may include components comprising sensor(s), vent(s), port(s) or valve(s). The lid may be operatively coupled with (e.g., to) components comprising sensor(s), vent(s), port(s) or valve(s). The lid of the distal container may be exchangeable. For example, the (sophisticated) lid may be exchanged to a less sophisticated lid (e.g., having a smaller number (e.g., no) sensors, vents, and/or valves). The lid may facilitate ingress of gas into the distal container. The lid may facilitate egress of gas from the distal container. The lid may facilitate coupling to a gas source (e.g., any gas source disclosed herein). For example, the lid may facilitate coupling to a condensed gas canister. The distal container may comprise a collection container (e.g., drum). The distal container (e.g., lid thereof) may be configured for introduction of a passivator, e.g., at a controlled rate. The distal container (e.g., lid thereof) may be configured to allow overpressure to escape (e.g., using a vent). Component(s) of the lid may be controlled, e.g., by controller(s). Component(s) operatively coupled with (e.g., to) the lid may be controlled, e.g., by controller(s). At least one component of the lid may be manually controlled. At least one component operatively coupled with (e.g., to) the lid may be manually controlled. At least one component of the lid may be automatically controlled, e.g., by controller(s). At least one component operatively coupled with (e.g., to) the lid may be automatically controlled, e.g., by controller(s). The lid controller(s) may comprise a safety controller, e.g., as disclosed herein. The lid controller(s) may comprise, or be operatively coupled with (e.g., to), a filtering system controller. The lid controller(s) may be operatively coupled with (e.g., to), or may be included in, a 3D printer control system. The lid controller(s) may be operatively coupled with (e.g., to), or may be included in, an unpacking station control system.

In some embodiments, the filtering mechanism may comprise one or more sensors. The one or more sensors may comprise an oxygen, humidity, gas flow, temperature, or a pressure sensor. The one or more sensors may facilitate monitoring the state of (1) debris in the distal container, and/or (2) debris flowing into the distal container. The positive pressure may be any positive pressure disclosed herein. For example, the positive pressure may be of at least about 1 pound per square inch (psi), 2 psi, 3 psi, 4 psi, 5 psi, 6 psi, 7 psi, 8 psi, 9 psi, or 10 psi above the ambient pressure. The positive pressure may be any value between the afore-mentioned values (e.g., from about 1 psi to about 10 psi, or from about 1 psi to about 5 psi). The distal container (e.g., lid thereof) may be equipped with an exhaust valve (e.g., check valve) that facilitates relief of pressure when the pressure in the distal container exceeds a threshold. The threshold may be at least about 5 psi, 6 psi, 7 psi, 8 psi, 9 psi, 10 psi, 15 psi, or 20 psi above the ambient pressure. The distal container may be configured to enclose and seal (e.g., hermetical seal such as gas tight seal) an atmosphere having gas content different than the ambient atmosphere external to the container. The internal atmosphere in the distal container may comprise at least one reactive species (e.g., oxygen or humidity) at lower concentration than they preside in the ambient atmosphere. For example, the internal atmosphere in the distal container may comprise a more inert atmosphere than the ambient atmosphere. The more inert atmosphere comprises a more inert gas referred to herein as “robust gas.” The robust (e.g., more inert) pressurized internal container atmosphere may be maintained during coupling with the gas conveyance system, during decoupling from the gas conveyance system, during transfer of the container away from the 3D printer, and/or during maintenance of the container (e.g., in queue for passivation and/or insulation process).

In some embodiments, the filtering system comprises a filtering container in which a filter is disposed. A detachable physical adapter and/or distal container may couple to the filtering container. The filtering container is coupled with (e.g., to), or includes a collection container for accumulation of the debris and/or dilutive media. When the filtering container contains the collection container, the collection container is a portion of the filtering container. The collection container may taper downward (e.g., relative to a gravitational center). The collection container may be configured to discharge (e.g., via a first valve) its contents at the bottom (e.g., relative to a gravitational center). The collection container may comprise a hopper. The first valve may be any valve disclosed herein (e.g., butterfly valve). The first valve may be configured to facilitate flow of debris and/or dilutive media therethrough. The first valve may be manually and/or automatically controller (e.g., by one or more controllers such as disclosed herein). The first valve may be configured for wired and/or wireless communication. The first valve may be coupled with (e.g., to) a control line. The collection container may facilitate funneling of debris released from the filter disposed in the filtering container downwards towards gravitational center. The collection container may be coupled with (e.g., to) the first valve that is a remotely controlled valve. At times, the collection container may facilitate accumulation of debris and any dilutive media therein, e.g., up to a threshold. The first valve may be connected to a physical adapter. The physical adapter may comprise at least one channel. The channel may or may not be flexible. The channel may or may not be separatable (e.g., to several portions). The channel (e.g., tube) may be configured to connected at its first end to the first valve through a sensor bank. The sensor bank may comprise a plurality of sensors. The sensor bank may include, or may be operatively coupled with (e.g., to), one or more sensors comprising pressure sensor, a gas flow sensor, a material flow sensor, a temperature sensor, a humidity sensor, or an oxygen sensor. The sensor bank is coupled with (e.g., to) a vent line. The sensor bank may have one or more sensors, e.g., any sensor disclosed herein. The sensor(s) may be wired and/or wireless. For example, the sensors may communicate wirelessly (e.g., with the controller(s)). The vent line may comprise a filter, or valve(s). The valve(s) or the vent line may comprise a relief valve, or a check valve. The valve(s) of the relief line may comprise any valves disclosed herein. The channel of the physical adapter may be coupled with (e.g., to) a second valve (e.g., any valve disclosed herein such as a manual valve). The second valve may be manually and/or automatically controlled (e.g., using controller(s) such as disclosed herein). The second valve may be the same or different from the first valve. The second valve may be configured for wired and/or wireless communication. The second valve may be coupled with (e.g., to) the channel. The second valve may be coupled with (e.g., to) a lid of the distal container.

In some embodiments, the distal container has a lid. The lid may be reversibly openable and closeable. The lid may be reversibly attachable and detachable from a body of the distal container. The lid may comprise ports. The ports may comprise input port(s) or output port(s). The input port may be referred to herein as an “ingress port.” The output port may be referred to herein as an “egress port.” The port may be configured to facilitate gas and/or liquid flow therethrough. For example, the port may comprise (a) a vent output port, (b) a vent for ingress of the quelling material (e.g., including the passivating and/or insulating material), or (c). The material entering into the distal container through the ingress port can be a fluid material such as liquid and/or gas. The lid may comprise a gas input port for ingress of a gas (e.g., gas mixture) into the distal container to generate and/or maintain an internal atmosphere (e.g., that can be more inert than the atmosphere external to the distal container). The engrossing gas may be a robust gas. The port may or may not comprise a valve. The port may be operatively coupled with (e.g., to) a valve. The valve may comprise a pneumatic control valve, butterfly valve, vent valve, wired valves, wireless valves, manual valve, automatic valve, or any combination thereof. Examples of valves comprise butterfly valve, relief valve, ball valve, needle valve, solenoid valve, leak valve, pressure gauge, a (gas) inlet valve or a (gas) outlet valve. The valve may comprise any valve disclosed herein. Any of the lid ports can be manually and/or automatically controller (e.g., by one or more controllers such as the ones disclosed herein). Any of the lid ports may be configured for wired and/or wireless communication. The lid may include one or more valves. The valve(s) may comprise a blow off valve (e.g., exhaust valve). The exhaust valve can be configured for a pressure of at least about 1, 5, 10, 15, or 20 PSI. The lid can close (e.g., shut or seal) the distal container. For example, the lid may seal the distal container to be hermetically sealed. The seal can be gas tight. The lid or the upper rims (e.g., edges) of the container body (e.g., drum) may comprise a seal (e.g., O-ring). The seal may comprise a polymer or a resin. For example, the seal may comprise rubber, or Teflon. The seal can be a gas tight seal. The seal can be a hermetic seal. The container can be configured accommodate (e.g., enclosure) a volume of at least about 30 gallons (Gal.), 40 Gal, 50 Gal, 55 Gal, 60 Gal, 80 Gal, 90 Gal, 95 Gal, or 100 Gal. The container can be configured to enclose a volume between any of the aforementioned volumes. The container (e.g., without the lid) can be a standard container (e.g., readily available container). The commercially available standard container can have a lid different than the lid having the port(s) and/or the valve(s). For example, the other lid may have an exhaust valve, but may be devoid of the other port(s) and/or valve(s). Before discharging the container with the passivated debris, the lids of the distal container may be altered (e.g., a less expensive and/or sophisticated lid may close the body of the distal container. The lid may be coupled with (e.g., to) the body of the distal container using one or more fasteners. The one or more fasteners may comprise a (retention) strap, clamp, lock, lever, or a (closing) ring (e.g., lever-lock). The fastener may comprise one or more levers. The fastener may require a key to (e.g., reversibly) faster and unfasten the lid to the body of the distal container. For example, the fastener may require a key to move the lever(s) into the appropriate position, e.g., to faster and/or unfasten the lid to the body of the distal container. One or more retention straps and/or one or more clamps may secure the lid onto the container body, e.g., to deter separation of the lid from the container during their requested engagement. The distal container may have at least 2, 3, 4, or more fasteners (e.g., clamps, levers, closing rings, or straps). The distal container may comprise elemental metal, metal alloy, or an allotrope of elemental metal. The distal container may comprise a composite material. The distal container may comprise steel (e.g., any steel disclosed herein). The lid retention straps and/or clamps, may be integrated in the container or may be as part of the lid. The distal container may comprise, or be operatively coupled with (e.g., to) a base plate having slots configured to facilitate coupling with a maneuvering device (e.g., cart or forklift). The base of the container may include slots configured to facilitate coupling with a maneuvering device (e.g., cart or forklift). The distal container may include two lifting slots. The number of lifting slots will depend on the type of maneuvering device to which it is destined to be coupled with (e.g., to). The distal container can include, or can be operatively coupled with (e.g., to), top plate. The top plate may be coupled with (e.g., to) at least one load cell. A plurality of load cells may be used, e.g., for ensuring accurate measurement and/or for redundancy. For example, the weight measurement may be a central tendency of the measurement of the load cell. The load cell(s) may be operatively coupled with (e.g., to) a floor mounting plate. The load cell may facilitate determining (e.g., by weight) the amount of debris and/or dilutive media is in the distal container. For example, the load cell may facilitate determining if any debris and/or dilutive media (i) has entered the distal container, (ii) the rate at which it enters, and/or (iii) whether the container is full (e.g., based on predetermined weight and ratios of debris to any dilutive media). The load cell may comprise a transducer that converts force into a measurable electrical output. For example, the load cell may convert a force such as tension, compression, pressure, or torque into an electrical signal that can be measured and standardized. As the force applied to the load cell increases, the electrical signal may change proportionally. The load cell may comprise a strain gauge, hydraulic, pneumatic, vibrating, or a piezoelectric load cell. The distal container may be disposed on a floor. The op plate may be separated from floor mounting plate by spacers (e.g., guide bushings). There may be at least 2, 3, 4, or more spacers disposed between the top plate and the floor mounting plate. The spacers may be rigid spacers. The spacers may be elastic spacers. In some embodiments, the filtering container is filtering debris from a gas flow. The rate of filtering can be at least about 100 cubic feet per minute (CFM), 300 CFM, 500 CFM, 800 CFM, 1000 CFM, or 1500 CFM. The filtering rate can be of any value between the aforementioned rates (e.g., from about 100 CFM to about 1500 CFM). The distal container may have an internal volume of at least 20 gallons (Gal), 30 Gal, 35 Gal, 40 Gal, 50 Gal, 55 Gal, 60 Gal, or 80 Gal. The distal container may have an internal volume between any of the aforementioned volumes (e.g., from about 20 Gal to about 80 Gal, or from about 30 Gal to about 55 Gal).

FIG. 15 shows an example of a filtering system. Filtering container (e.g., an integral container) 1500 is coupled with (e.g., to), or includes collection container (e.g., hopper) 1501. Collection container 1501 facilitates funneling of debris released from the filter (not shown) disposed in the filtering container 1500 downwards towards gravitational center G towards which gravitational vector 1590 points to. Collection container 1501 can also facilitate accumulation of debris and any dilutive media therein. Collection container 1501 is coupled with (e.g., to) valve 1502 (e.g., butterfly or other remotely controlled valve) having valve control line 1503, e.g., a pneumatic control line. Valve 1502 may be operatively coupled with (e.g., to), or may comprise, a sensor to sense its state (e.g., closed/open). Valve 1502 is connected to channel 1511 of a physical adapter. The channel may be flexible. The channel may or may not be separatable (e.g., to several portions). In the example shown in FIG. 15, channel 1511 is not separatable. Channel 1511 is connected at its first end to valve 1502 through sensor bank 1506 that includes, or is coupled with (e.g., to), sensors such as pressure sensor 1504 and oxygen sensor 1505. Sensor bank 1506 is coupled with (e.g., to) vent line 1507 having vent line relief valve 1509, vent line filter 1510, and vent line check valve 1508 (e.g., ball check valve). Channel 1511 of the physical adapter is coupled with (e.g., to) valve 1512 (e.g., sanitary valve, e.g., manual valve) that is coupled with (e.g., to) lid 1514. Lid 1514 includes input and output (e.g., ingress and egress) ports including: gas output port 1515, e.g., gas egress port or vent output port. Gas output port 1515 may comprise an exhaust valve or a blow off valve. Lid 1514 includes quelling material (e.g., including the passivating and/or insulating material) input (e.g., ingress) port 1516 such as water input port. The material entering into the distal container 1540 through port 1516 can be a fluid material such as liquid and/or gas. The liquid may comprise water. A gas input port 1517 for ingress of gas (e.g., gas mix) to generate and/or maintain the atmosphere of the distal container, e.g., that can be more inert than the atmosphere external to container 1540 such as the robust gas. For example, the ingress gas can comprise an inert gas such as Argon. Any of the lid ports can be manually and/or automatically controlled (e.g., by one or more controllers such as the ones disclosed herein). Lid 1514 includes valves such as valves 1513a and 1513b (e.g., blow off valve, exhaust valve) controlling respective ports. The valves may comprise a valve 1513b to control egress (output) of the quelling material (e.g., including the passivating and/or insulating material). The two valves may be for redundancy (e.g., for safety of equipment and/or personnel). For example, valve 1513a may be redundant to valve 1515. At times, the lid may be devoid of redundant ports and/or valves. For example, there may be one gas output valve. Lid 1514 comprises a pressure gauge 1531. Lid 1514 closes container 1540, e.g., to seal it. Sealing can be hermetic sealing. Sealing can be gas tight sealing. The lid or the upper rims of the container body (e.g., drum) comprise seal 1518 (e.g., O-ring). The seal can be a gas tight seal. The seal can be a hermetic seal. The distal container (e.g., without the lid) can be a standard container (e.g., readily available container). The commercially available standard container can have a lid different than lid 1514. The lid may be coupled, or may include lid retention straps 1519. Instead of straps 1519, or in addition to straps 1519, the lid may be fastened to the body with clamp(s). Container 1540 (e.g., distal container) may comprise, or be coupled with (e.g., to), base plate 1520 having slots 1522. Slots 1522 are configured to facilitate coupling with a maneuvering device (e.g., cart, drone, or forklift). Distal container 1540 includes two (e.g., lifting) slots. Distal container 1540 includes, or is coupled with (e.g., to), top plate 1521 that is in turn coupled with (e.g., to) load cell 1524 to which floor mounting plate 1525 is coupled. Load cell 1524 facilitates determining (e.g., by weight) the amount of debris and/or dilutive media present in distal container 1540. For example, the load cell may facilitate determining if any debris and/or dilutive media enters distal container 1540, the rate at which it enters, and whether the container is full, e.g., based at least in part on predetermined weight and ratios of debris to any dilutive media. Distal container 1540 is disposed on floor 1530. Top plate 1521 is separated from floor mounting plate 1525 by spacers (e.g., guide bushings) such as 1523. There may be at least 2, 3, 4, or more spacers disposed between top plate 1521 and floor mounting plate 1525.

In some embodiments, a physical adapter and a distal container are integrated with the filtering container (e.g., the integrated container). Such integration may entail assembling a distal container assembly, integrating the distal container assembly with the physical adapter, and integrating the physical adapter with the filtering container.

In some embodiments, connection of the distal container to the filtering container (e.g., via the physical adapter) entails various operations, e.g., is configured for various operations such as configured to enable performance of various operations. The operations may comprise assembling a distal container assembly, coupling the distal container assembly to a physical adapter to form a distal container adapter assembly, and connecting the distal container adapter assembly to the filtering container.

In some embodiments, the distal container assembly includes several operations. The operations may include optionally placing the distal container body (e.g., drum) onto a base plate (e.g., as part of a load cell assembly). The operations may include placing a lid over the distal container body while engaging the seal. The operations may include shutting the distal container body and lid to form a shut distal container. For example, the operations may include engaging (and optionally tightening) retention straps and/or clamp(s) to (e.g., tightly) close, shut, and/or (e.g., hermetically) seal the distal container. Hermetically sealing may comprise gas tight sealing. A distal valve (e.g., the second valve such as 1512) may be a portion of the lid of the distal container and the physical adapter may be configured to engage with the distal valve (e.g., at one end of the adapter channel). The distal valve may be a portion of the physical adapter (e.g., be disposed at one end of the adapter channel) and the lid may be configured to engage with the distal valve. During these operations of forming the distal container assembly (e.g., closing the distal container), the distal valve may or may not be shut.

In some embodiments, the distal container assembly comprises a load cell assembly (e.g., in one or more operations). The operations of engaging the distal container with the load cell assembly may comprise engaging the distal container with a maneuvering device (e.g., forklift). The operations may comprise placing the (closed or shut) distal container onto a load cell assembly (e.g., on a top plate of the load cell assembly). Top is in a direction against the gravitational vector pointing towards the gravitational center. The load cell assembly may comprise a top plate, a load cell, and a bottom plate also referred to herein as the “floor mounting plate.” The load cell assembly may comprise one or more spacers such as rigid spacers (e.g., guide bushings). The maneuvering device may assist in placing the distal container onto the load cell assembly (e.g., onto a load cell top plate). During these operations of engaging the distal container with the load cell assembly, the distal valve may or may not be shut. The connection between the distal end of the adapter channel and the distal valve may be a direction connection (e.g., without an intervening mechanism, apparatus, or device).

In some embodiments, the distal container assembly is coupled (e.g., engaged) with the physical adapter to form a distal container adapter assembly (e.g., in one or more operations). For example, the operations may comprise connecting a distal valve (e.g., the second valve such as 1512) with the physical adapter (e.g., with the adapter channel) at one of its end (e.g., a distal end). The distal container adapter assembly may be coupled with (e.g., to) a proximal valve (e.g., the first valve such as 1502) of the filtering container, which proximal valve may be shut. Connection of the physical adapter to the proximal valve may be at least in part by connecting another end of the adapter channel (e.g., a proximal end of the channel) to the proximal valve. The connection may be direct, or through a sensor box (e.g., sensor bank 1506). Direct connection may be without an intervening mechanism, apparatus, or device. The proximal valve may be part of the filtering container. The proximal valve may be part of the collection container. The proximal valve may be part of the physical adapter, e.g., the proximal valve may be disposed at a proximal end of the adapter channel. The proximal end of the channel may oppose the distal end of the channel. Connection of the physical adapter to the filtering container may be via the collection container (e.g., the hopper).

FIG. 16 shows an example of operations forming the distal container adapter assembly and connecting it to the filtering container: in block 1620—covering the distal container body with a lid that includes, or is operatively coupled with (e.g., to), a distal valve. The distal valve may be shut. In block 1630—securing the lid onto the body of the distal container. For example, engaging, and optionally tightening, retention straps to tightly press the lid onto the body of the distal container to form a closed (e.g., sealed) distal container. In block 1640—optionally placing the closed (e.g., sealed) distal container onto a load cell top plate as part of the loadcell assembly. The placement may be at least in part by using a maneuvering device (e.g., forklift). In block 1650—connecting the distal valve with a distal end of a physical adapter (e.g., channel) to form the distal container adapter assembly. And in block 1660—connecting a proximal end of the physical adapter (e.g., channel) of the distal container adapter assembly to a proximal valve that engages, or is part of, a filtering (e.g., integral) container (e.g., to a hopper thereof). The proximal valve may be shut. These operations may be effectuated in any applicable order.

In some embodiments, the distal container is coupled with (e.g., to) the filtering container. Upon connection of the distal container adapter assembly to the filtering container (through the proximal valve), the distal valve can be opened. Robust gas that is more inert than gas of the ambient atmosphere, can be administered into the distal container and adapter channel that are part of the detachable assembly. The robust gas that is more inert may comprise argon or nitrogen. Connection of the distal container adapter assembly to the filtering container may comprise connection to the collection container (e.g., hopper). The more inert gas (e.g., the robust gas) can be more inert than an ambient atmosphere external to the distal container adapter assembly. The more inert gas (e.g., the robust gas) can be an inert gas. The more inert gas that is the robust gas, can be administered from a gas source such as a compressed gas cylinder. Controller(s) may monitor that the detachable assembly is coupled with (e.g., to) the filtering container in a gas tight manner. Such monitoring may comprise (i) administering gas into the distal container adapter assembly to a pressure, and (ii) monitoring any reduction in pressure after stopping the flow of gas into the distal container adapter assembly. Filling the distal container adapter assembly with gas may comprise opening a valve coupled with (e.g., to) the gas source to allow the robust (e.g., more inert) gas to flow into the interior of the distal container adapter assembly (having its distal valve open) that is coupled with (e.g., to) the filtering container (with its proximal valve shut). The controller(s) may monitor the gas pressure in the distal container adapter assembly for an increase to a requested gas pressure level (e.g., pressure of the internal atmosphere of the distal container adapter assembly). The controller(s) may be part of any control system disclosed herein. For example, the controller(s) can be part of the control system of the 3D printer. Monitoring for any (measurable) reduction in pressure after stopping the flow of gas into the distal container adapter assembly may comprise closing the gas ingress valve to stop the flow of the gas into the distal container adapter assembly. The controller(s) may monitor any drop in gas pressure after the pressure level in the detachable assembly has reached the requested level, and the valve is shut to stop additional flow of gas. Once the pressure has stabilized (e.g., does not substantially drop in a given time window) evidencing that the detachable assembly connected to the filtering container is gas tight, the interior of the detachable assembly is purged to reach a level of reactive species (e.g., oxygen and/or humidity) below a threshold value (e.g., while maintaining the requested pressure level in the distal container adapter assembly). The threshold value may be at most about 400 ppm, 300 ppm, 200 ppm, or 100 ppm reactive species (e.g., oxygen). The level of reactive species may be sufficient to react with a surface of the debris, e.g., to generate at least a portion of an external passivation later. The pressure threshold may be at least about 10 kilo pascal (kPa), 15 kPa, or 20 kPa above the ambient atmospheric pressure (e.g., about one atmosphere, or about 101.325 kPa). The level of pressure may be detected using a pressure sensor. The level of pressure may be detected based at least in part on the rate of gas flow into the distal container adapter assembly, e.g., taking account the internal volume of the distal container adapter assembly and/or historical rate, pressure, and time, measurements. After the requested level of pressure and reactive species has been reached, the proximal valve connecting the filtering container with the physical adapter can be opened. At this stage, both proximal valve and distal valves are open, and any debris and/or dilutive media can flow from the filtering container to the distal container through the adapter channel, e.g., using gravity. The load cell may be monitored (A) to detect if the debris and/or dilutive media is flowing into the distal container, (B) at what rate it is flowing, and/or (C) whether the weight of accumulating debris and/or dilutive media reaches a threshold of maximum amount in the distal container (e.g., to ensure that the distal container does not overfill).

FIG. 17 shows an example of operations in preparing the distal container to accept debris and/or dilutive media from the filtering container. In block 1710—providing an assembly having a distal container that is coupled with (e.g., to) a shut distal valve that is coupled with (e.g., to) an adapter channel that is coupled with (e.g., to) a shut proximal valve that is coupled with (e.g., to) a filtering container (e.g., to a hopper of the filtering container). In block 1720—engaging the distal container with a robust gas source (e.g., a more inert gas source such as argon or nitrogen) through an ingress port of the distal container, which robust gas source (e.g., more inert gas source) is more inert than an atmosphere external to the distal container, physical adapter, and/or filtering container. In block 1730—opening the distal valve, e.g., to allow atmospheric exchange (e.g., gas flow) between the internal volume of the physical adapter (e.g., channel) and the internal volume of the distal container. In block 1740—allowing the robust gas (e.g., the more inert gas) to ingress into the interior of the distal container adapter assembly, e.g., to reach a requested positive pressure, which distal container adapter assembly includes the distal container and adapter channel. In block 1750—Purge the distal container adapter assembly interior to reach a requested level of reactive species in the atmosphere of the distal container adapter assembly. In block 1760—opening the proximal valve disposed between the distal container adapter assembly (e.g., adapter channel thereof) and the filtering container (e.g., hopper thereof). e.g., to allow flow of debris and/or dilutive media from the filtering container to the distal container. These operations may be effectuated in any applicable order.

In some embodiments, the distal container is detached from the gas conveyance system, e.g., when the distal container is full of debris and/or dilutive media. In some embodiments, detachment of the distal container from the gas conveyance system (e.g., gas flow mechanism) is without disconnecting the filtering container and without disrupting its function to filter the gas flow from any (detectable) debris. Detachment of the distal container from the gas conveyance system may entail one or more operations including (i) closing the proximal (e.g., first) valve connecting the filtering container and the physical adapter, (ii) closing the distal (e.g., second) valve connecting the physical adapter and the distal container, (ii) venting any pressure from the adapter channel to reach equilibrium with the ambient atmosphere (e.g., using a vent line such as FIG. 15, 1507), (iv) disconnecting the distal valve from the adapter channel, (v) disconnecting gas source from the distal container lid, and/or (vi) using the maneuvering device to relocate the distal container, e.g., to a passivation station. In some embodiments, the distal container may be (e.g., reversibly) connected and disconnected from the physical adapter. In some embodiments, the physical adapter may be (e.g., reversibly) connected and disconnected from the filtering container (e.g., from the collection container such as from the hopper). For example, when the distal container becomes full, it may be disconnected from the physical adapter and removed from the 3D printing system. In this case, the physical adapter remains connected with the filtering container upon removal of the distal container from the gas conveyance system. For example, when the distal container becomes full, the physical adapter may be disconnected from the filtering container (e.g., from the collection container thereof) and removed from the 3D printing system. In this case, the physical adapter remains connected with the distal container upon removal of the distal container from the gas conveyance system.

FIG. 18 shows an example of operations relating to disconnecting the distal container from the gas conveyance system (e.g., and from the physical adapter), while the physical adapter remains connected to the filtering container (e.g., and to the collection container). In block 1810—providing an assembly having a distal container coupled with (e.g., to) an open distal valve coupled with (e.g., to) an adapter channel coupled with (e.g., to) an open proximal valve coupled with (e.g., to) a filtering container (e.g., to a hopper of the filtering container). In block 1820—closing the open proximal valve and closing the open distal valve. In block 1840—equilibrating (e.g., using a vent line such as FIG. 15, 1507) the adapter atmosphere with the ambient atmosphere, e.g., by venting any over pressure in the adapter channel. In block 1850—closing a port through which the robust gas (e.g., more inert gas) enters the detachable assembly (e.g., enters the distal container) and disconnecting the source of the robust gas (e.g., of the more inert gas) from the detachable assembly, e.g., from the distal container. In block 1870—engaging the distal container with a maneuvering device and maneuvering the device away from the gas conveyance system, e.g., to a passivation station, to storage, or for disposal. These operations may be effectuated in any applicable order.

In some embodiments, the distal container facilitates (e.g., controlled) passivation and/or insulation of the debris (with or without dilutive media). The passivation may including the operations of: (i) introducing a robust (e.g., less reactive) gas into the distal container; (ii) measure a level of a reactive species to ensure it is below a threshold; (iii) open a first valve connecting the physical adapter to the filtering container to allow flow of debris through the physical adapter and into the distal container, and a second valve connecting the physical adapter to the distal container to allow the debris (with or without the dilutive media) to accumulate in the distal container; (iv) closer the first valve and the second valves and disconnect the robust (e.g., less reactive) gas from the distal container (e.g., lid thereof); (v) relocate the distal container (e.g., to a passivation station) and introduce the passivator and/or insulator: (vi) discard the debris (e.g., along with the distal container and any dilutive media). After the debris is passivated (e.g., quenched) and before the distal container is discarded, the container may be fit with a less sophisticated and/or less expensive lid. The sophisticated lid may be reused in a second debris collection cycle, using a different distal container. The robust (e.g., less reactive) atmosphere may comprise a reactive species (e.g., oxygen or humidity) in a concentration lower than the ambient atmosphere extrarenal to the distal container. The robust (e.g., less reactive) atmosphere may comprise an inert gas. In an example, the robust (e.g., less reactive) atmosphere comprises argon or nitrogen. The level of reactive species can be a level of oxygen. The level of reactive species can be a level of or of humidity. The level can be any level disclosed herein for the reactive species. For example, the oxygen level may be below 300 ppm, 400 ppm, 500 ppm, 1000 ppm, 2000 ppm, 3000 μm, 4000 ppm, or 5000 ppm. The oxygen level may be below any of the aforementioned values (e.g., from about 300 ppm to about 5000 ppm, or from about 1000 ppm to about 5000 ppm). In some embodiments, the first valve and the second valves remain open during filtration (e.g., during the 3D printing) until the debris (and any dilutive media) reach a threshold indicating that the distal container is full. Once the first distal is full, it may be replaced with a second distal container, e.g., during filtration and during the 3D printing. In some embodiments, the first valve is generally shut during filtration (e.g., except for when debris and any dilutive media accumulates in the filtering container above a threshold value). In some embodiments, the proximal (e.g., first) valve is generally open during filtration (e.g., except for when debris and any dilutive media accumulates in the distal container above a threshold value and the distal container requires replacement). During passivation, the temperature in the distal container may be at most about 50° C., 80° C., 100° C., 150° C., 200° C., 250° C., or 500° C. The distal container may couple to a temperature conditioning device (e.g., cooling device), e.g., during passivation. For example, the distal container may be disposed on a temperature conditioning plate. For example, the container may be surrounded at some sides by a temperature conditioning sleeve.

In some embodiments, the distal container is disconnected from the gas conveyance system. The distal container may be maneuvered away from the gas conveyance system (e.g., and from the 3D printing system). The distal container may be relocated to storage, to a passivation station, and/or to disposal (e.g., to a landfill). The debris in the distal container may or may not require passivation. The distal container (e.g., with the debris) may or may not be stored prior to passivation. The distal container (e.g., with the debris) may or may not be stored prior to disposal (e.g., to a landfill).

FIG. 19 shows an example of operations relating to removal of the distal container from the gas flow system (e.g., from the 3D printing system). In block 1910—providing a closed distal container containing debris. In block 1920—engaging the distal container with a maneuvering device and maneuver the device to a passivation station, to storage, or for disposal. In block 1930—engaging passivator and/or insulator with the distal container, and ingress the passivator and/or insulator. In block 1940—optionally storing the distal container with the debris and/or dilutive media. In block 1950—optionally exchanging the distal container lid. In block 1960—disposing the distal container, e.g., to a landfill. These operations may be effectuated in any applicable order.

For example, after the distal container is maneuvered (included in block 1920) it may follow path 1921a-c in which the debris is passivated/insulated (e.g., included in block 1930), then the more sophisticated and/or expensive lid is exchanged for a simpler and/or cheaper lid (e.g., included in block 1950), and then disposed of (e.g., included in block 1960). For example, after the distal container is maneuvered (included in block 1920) it may follow path 1922a-d in which the debris is stored (e.g., included in block 1940), then passivated/insulated (e.g., included in block 1930), then, then the more sophisticated and/or expensive lid is exchanged for a simpler and/or cheaper lid (e.g., included in block 1950), and then disposed of (e.g., included in block 1960). For example, after the distal container is maneuvered (included in block 1920) it may follow path 1923a-d in which the debris is passivated/insulated (e.g., included in block 1930), then stored (e.g., included in block 1940), then the more sophisticated and/or expensive lid is exchanged for a simpler and/or cheaper lid (e.g., included in block 1950), and then disposed of (e.g., included in block 1960). For example, after the distal container is maneuvered (included in block 1920) it may follow path 1924a-c in which the debris is stored (e.g., included in block 1940), then the more sophisticated and/or expensive lid is exchanged for a simpler and/or cheaper lid (e.g., included in block 1950), and then disposed of (e.g., included in block 1960). Path 1924a-c may be followed in case the debris does not require passivation.

In some embodiments, the distal container and/or weighting system are configured for self-maneuvering. In an example, the weighing system comprises a maneuvering device (e.g., comprising wheels) that facilitate its maneuvering. In an example, the distal container comprises a maneuvering device (e.g., comprising wheels) that facilitate its maneuvering. The maneuvering device can be controlled, e.g., via remote control.

In some embodiments, the maneuvering device (e.g., any maneuvering device disclosed herein) comprises a controller. The maneuvering device can be manually and/or automatically controlled. The maneuvering device may have its own dedicated controller. The controller may or may not be part of the control system of the 3D printer. In an example, the maneuvering device may have a controller that is different from the control system of the 3D printer. The controller of the maneuvering device may be configured to communicatively couple (e.g., interact) with the controller of the 3D printer. The controller of the maneuvering device may be configured to communicatively couple (e.g., interact) with the controller of the unpacking station.

FIG. 20 shows a perspective view example of distal container 2001 with respect to gravitational vector 2090 directed towards the gravitational center of the ambient environment external to distal container 2001 that is engaged with lid 2002 to close distal container 2001. Lid 2002 comprises surface 2003 of the lid being exposed to the ambient environment external to the distal container 2001. Lid 2002 comprises connector 2010 configured to couple to a channel (not shown) of a physical adapter. Connector 2010 is configured for ingress of debris into the interior space of distal container 2001 closed by lid 2002. Connector 2010 comprises a valve (e.g., sanitary valve) controlled by handle 2011, e.g., manually. Controlling a valve includes fully opening, fully shutting, or partially opening the valve. Lid 2002 comprises ingress and egress ports 2012a and 2012b. These ports may be utilized for the quelling material that includes the passivating and/or insulating material. These ports may be utilized for pressure relief valves. The ingress and egress ports can be configured for ingress of the quelling material (e.g., including the passivating and/or insulating material), and for egress of the quelling material (e.g., including the passivating and/or insulating material). Lid 2002 can be held by handles 2013a and 2013b, e.g., for maneuvering. In the example shown in FIG. 20, distal container 2001 is disposed on platform 2004 comprising wheels such as 2005 that facilitate maneuvering of the distal container, e.g., on a floor. The wheels are coupled with platform 2004 via couplers such as 2006. The coupler can be part of the platform, or be operatively coupled with the platform. One or more wheels may be connected to a coupler. In the example shown in FIG. 20, each coupler is connected to a wheel. The platform may be configured for self-maneuvering, for maneuvering by a user, or for maneuvering by a maneuvering device (autonomous and/or operated by a user). Robust gas may enter the interior space of distal container 2001 through channel 2014.

FIG. 20 shows a perspective view example of distal container 2051 with respect to gravitational vector 2090. Distal container 2051 is engaged with lid 2052 to close distal container 2051. Lid 2052 comprises surface 2053 of the lid being exposed to the ambient environment external to the distal container 2051. Lid 2052 comprises connector 2060 configured to couple to a channel (not shown) of a physical adapter. Connector 2060 is configured for ingress of debris into the interior space of distal container 2051 closed by lid 2052. Connector 2060 comprises a valve (e.g., sanitary valve) controlled by handle 2061, e.g., manually. Lid 2052 comprises ingress and egress ports 2062a and 2062b for the quelling material respectively. The quelling material comprises the passivating material or the insulating material. The passivating material can comprise (e.g., can be) the insulating material. Lid 2052 can be held by handles 2063a and 2063b, e.g., for maneuvering lid 2052. Lid 2052 comprises pressure release valve 2071, pressure gauge 2072, and gas inlet 2073. Lid 2052 closes distal container 2051 at least in part by clamp 2080. In the example shown in FIG. 20, distal container 2051 is disposed on top plate 2054 coupled with adjustable feet such as adjustable foot such as 2055, e.g., that facilitate leveling top plate 2054 and/or distal container 2051. The adjustable feet and top plate 2054 are coupled with mounting plate 2056. Load cells are disposed between top plate 2054 and mounting plate 2056 (load cells not shown), and are connected to electrical connectors (wires) 2066. Top plate 2054 and/or mounting plate 2056 are coupled with supports such as 2057, e.g., comprising cylindrical supports such as studs.

FIG. 21 shows a perspective view example of a lid of a distal container. Example 2000 shows the lid side having surface 2101 configured to face the ambient environment when closing the distal container (e.g., in a similar manner to lid surface 2003 of FIG. 20 facing the ambient environment); and example 2050 shows the lid side having surface 2151 configured to face the internal environment of the distal container when closing the distal container with the lid. In example 2100, lid surface 2101 comprises connector 2110 configured to couple to a channel (not shown). Connector 2110 is configured to couple to a physical adapter (not shown). The physical adapter, and the connector may be configured for ingress of debris (and any dilutive media) therethrough and into a distal container (not shown). Connector 2110 comprises a valve controlled by a valve (e.g., sanitary valve) controlled at least in part by handle 2111, e.g., manually. Control of a valve includes fully opening, fully shutting, or partially opening the valve. The lid having surface 2101 comprises (i) pressure sensor that is a pressure gauge 2102, (ii) egress port 2106 (with valve) for overpressure gas release, (iii) ingress port 2104 (with valve) for the quelling material, (iv) egress port 2105 for (with valve) for the quelling material (e.g., passivating and/or insulating material), and (v) ingress port 2003 (with valve) for robust gas, the quelling material comprising the passivating material or the insulating material. In some embodiments, the pressure sensor (e.g., gauge) may be digital. The egress port 2106 (e.g., with valve) for overpressure gas release may be a pressure release valve (PLV). Lid surface 2101 comprises extra ports 2114a and 2114b, e.g., that can each server as an optional connection for an auxiliary component such as pressure relief valve, or material level sensor. The material lever sensor can be a guided wave radar (GWR) sensing system. The material level sensor may be configured to sense the level of debris and any dilutive media disposed in (e.g., accumulating in) the distal container, e.g., in real time as they accumulate. Lid surface 2101 comprises handles 2113a and 2113b, e.g., for maneuvering the lid. Example 2150 shows lid surface 2151 configured to face the interior environment of the distal container when closing the distal container. Lid surface 2151 comprises an overfill prevention pipe 2152 configured to reduce the risk of overfilling the container with the quelling material that is a liquid. Overfill prevention pipe 2152 is coupled with port 2105. Port 2153 coupled with pressure gauge 2102, port 2154 coupled with ingress port 2103 (with valve), port 2155 coupled with ingress port 2104 (with valve), port 2156a is coupled with 2114a, port 2157 coupled with connector 2110, port 2156b is coupled with 2114b, and port 2158 coupled with egress port 2106.

In some embodiments, the filtering system is coupled with a first controller, and the physical adapter with the distal container—optionally with the weighing system—are coupled with a second controller different from the first controller. The first controller may be operatively coupled with the second controller. Operatively coupled may comprise communicatively coupled. Communicatively coupled may comprise wired and/or wireless communication. The second controller may be a safety controller. The second controller may be operatively coupled with one or more sensors, e.g., in a sensor suite. The sensor(s) may be included in, or be operatively coupled with, the physical adapter. The second controller may be operatively coupled with the sensor(s). The sensor(s) may be configured to sense at least one characteristic of the internal environment of the physical adapter and/or of the distal container. The at least one characteristic may comprise temperature, pressure, oxygen content, water content (e.g., humidity). The sensor(s) may be operatively coupled with the weighing system, e.g., to the load cell(s). The second controller may be configured to prevent connection of the distal connector to the filtering system (e.g., through the physical adapter) before all safety conditions are met, e.g., as sensed by the sensor(s). The filtering system may comprise one or more filters. The filter may comprise a corrugated structure, e.g., a corrugated exposed surface. The filter may include a material comprising a polymer, a resin, a ceramic, an elemental metal, or a metal alloy. The filter may be expensive relative to the dilutive media. With use of the dilutive media, filter exchange may be less frequent as compared to use of the filter without the dilutive media, e.g., that separates the filter from the debris.

FIG. 22 shows a schematic example of a filtering system portion and associated control system. Filtering container (e.g., an integral container) 2200 is coupled with, or includes collection container (e.g., hopper) 2201. Collection container 2201 facilitates funneling of debris released from the filter (not shown) disposed in the filtering container 2200 downwards towards gravitational center G towards which gravitational vector 2290 points to. Collection container 2201 can also facilitate accumulation of debris and any dilutive media therein. Collection container 2201 is coupled with valve 2202 (e.g., butterfly or other remotely controlled valve) controlled by filter controller 2252 through control line 2203, e.g., a pneumatic control line. Sensor 2291 may be connected along control line 2203. Sensor 2291 may be configured to sense an opening and/or closed position of valve 2202. For example, sensor 2291 can be a position sensor such as a closed position sensor (e.g., sensing that valve 2202 is closed) or an open position sensor (e.g., sensing that valve 2202 is open). Valve 2202 may be operatively coupled with, or may comprise, a sensor to sense its state (e.g., closed/open), such as a position sensor. Valve 2202 is connected to channel 2211 comprised in a physical adapter. The channel may be flexible. The channel may or may not be separatable (e.g., to several portions). In the example shown in FIG. 22, channel 2211 is not separatable. Channel 2211 is connected at its first end to valve 2202 through sensor bank 2206 that includes, or is coupled with, sensors such as pressure sensor 2204 and oxygen sensor 2205. Sensor bank 2206 is coupled with vent line 2207a comprising (a) vent line relief valve 2209, (b) vent line filter 2210, and (c) vent line check valve 2208 (e.g., ball check valve). Channel 2211 of the physical adapter is coupled with valve 2212 (e.g., manual valve and/or sanitary valve) that is coupled with lid 2214 through a connector. Lid 2214 includes input and output (e.g., ingress and egress) ports including: gas ingress port 2217, e.g., for ingress of robust gas. Lid 2214 includes quelling material input (e.g., ingress) port 2215 such as water input port. The material entering into the distal container 2240 through port 2215 can be a fluid material such as liquid and/or gas. The liquid may comprise water. A gas ingress (e.g., input) port 2217 may be configured for ingress of robust gas (e.g., gas mix) to generate and/or maintain the atmosphere of the distal container, e.g., that can be more inert than the atmosphere external to container 2240. For example, the ingressing robust gas can comprise an inert gas such as Argon. Any of the lid ports can be manually and/or automatically controlled (e.g., by one or more controllers such as the ones disclosed herein). Lid 2214 includes pressure relief port 2216 (with valve). Lid 2214 includes valves (e.g., blow off valve, exhaust valve) controlling respective ports. The valves may comprise a valve of egress port 2213 to control egress (output) of the quelling material. Egress port 2213 extends into distal container 2240 by an overfill prevention pipe, e.g., to prevent overfilling the distal container (when closed by lid 2214) when the quelling material is liquid such as water. Lid 2214 comprises pressure gauge 2231. In the example shown in FIG. 22, lid 2214 is devoid of redundant ports and/or valves. Lid 2214 closes container 2240, e.g., to seal it. Sealing can be hermetic sealing. Sealing can be gas tight sealing. The lid or the upper rims of the container body (e.g., drum) comprise seal 2218 (e.g., O-ring). The seal can be a gas tight seal. The seal can be a hermetic seal. The distal container (e.g., without the lid) can be a standard container (e.g., readily available container). The commercially available standard container can have a lid different than lid 2214. The lid may be coupled, or may include lid retention straps 2219. Instead of straps 2219, or in addition to straps 2219, the lid may be fastened to the body with clamp(s). Container 2240 (e.g., distal container) may comprise, or be coupled with, base plate 2220 having slots 2222. Slots 2222 are configured to facilitate coupling with a maneuvering device (e.g., cart, drone, or forklift). Container 2240 includes two slots. Distal container 2240 includes, or is coupled with, top plate 2221 that is in turn coupled with load cells 2224a-c to which floor mounting plate 2225 is coupled. Load cells 2224a-c facilitates determining (e.g., by weight) the amount of debris and/or dilutive media present in distal container 2240. For example, the load cell may facilitate determining if any debris and/or dilutive media enters distal container 2240, the rate at which it enters, and whether the container is full, e.g., based at least in part on predetermined weight and ratios of debris to any dilutive media. Distal container 2240 is disposed on floor 2230. Top plate 2221 can be separated from floor mounting plate 2225 by spacers (e.g., guide bushings—not shown). There may be at least 2, 3, 4, or more spacers disposed between top plate 2221 and floor mounting plate 2225. Filtering container (e.g., an integral container) 2200 is coupled with robust gas source 2251 controller by filter controller 2252. Safety controller 2253 is configured to operatively couple (e.g., directly) to filter controller 2252. Direct coupling between filter controller 2252 and safety controller 2253 exclude coupling (i) through another controller or (ii) through another device. Filtering controller 2252 controls first valve 2261 flowing robust gas from 2251 to filter 2200 coupled with the physical adapter and to, e.g., and to distal container 2240 when valve 2212 is open. Second valve 2262 is controlled by safety controller 2253. Second valve 2262 and first valve 2261 are disposed along gas line from gas source 2251 to valve 2202. Safety controller 2253 is also operatively coupled with (i) pressure sensor 2204, (ii) oxygen sensor 2205, (iii) to third valve 2263, to (iv) load cells 2224a-c, and (v) to vent line 2207a as depicted by 2207b. Third valve 2263 is disposed between robust gas source 2270 and gas inlet port 2217 (including a valve such as a ball check valve).

In some embodiments, a gas enriching system is operatively coupled with the distal container and/or to the physical adapter. The gas enriching system may enrich an incoming gas with a prescribed level of reactive agent(s). The prescribed level may be within a threshold window. The prescribed level may be at a threshold, e.g., with acceptable tolerances. The gas enriching system may control the robust gas to maintain an oxygen level of at most about 300 ppm, 400 ppm, 500 ppm, 600 ppm. 800 ppm, 1000 ppm. The gas enriching system may control the robust gas to maintain an oxygen level of at least about 100 ppm, 200 ppm, 300 ppm, 400 ppm, 500 ppm, or 600 ppm. The gas enriching system may control the robust gas to maintain an oxygen level below the oxygen level in the ambient atmosphere external to the distal container. The gas enriching system may control the robust gas to maintain a humidity level below the humidity level in the ambient atmosphere external to the distal container. The gas composition in the distal container can contain a level of humidity that correspond to a dew point of at most about −10° C., −15° C., −20° C., −25° C., −30° C., −35° C., −40° C., −50° C., −60° C., or −70° C. The gas composition of the distal container can contain a level of humidity that correspond to a dew point between any of the aforementioned values, e.g., from about −70° C. to about −10° C., −60° C. to about −10° C. or from about −30° C. to about −20° C. A dew point of an internal atmosphere of the distal container can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the distal container. A dew point of an internal atmosphere of the distal container can be any value within or including the afore-mentioned values. The distal container may have an atmosphere having a pressure of at least about 10 kilo-Pascals (kPa), about 12 kPa, about 14 kPa, about 16 kPa, about 18 kPa, about 20 kPa above ambient pressure external to the distal container. The distal container can have an atmosphere (e.g., substantially) similar to that of the processing chamber, e.g., before generation of debris. The atmosphere of the distal container can be controlled (e.g., maintained) at a time comprising: during the printing, after the printing, before conducting the safe disposal procedure, during the safe disposal procedure, after the safe disposal procedure such as during the wait time for save disposal from the facility per jurisdictional regulation, or any combination thereof. The atmosphere in the distal container may be controlled by at least one controller. The controller(s) may or may not be part of the control system of the 3D printer and/or of the unpacking station.

In some embodiments, the distal container is connected (through the physical adapter) with the filtering system. Connecting a distal container with the filtering system may initiate with the filtering system valve (e.g., FIG. 15, 1502) in a closed configuration, e.g., to curtain disruption to the atmosphere in the 3D printing system and/or allow continuation of the printing process during attachment of the (e.g., new and/or empty) distal container. In some embodiments, the distal container is connected to the filtering system through the physical adapter. The internal space of the distal container and the physical adapter may be purged with robust gas, e.g., when the valve separating the distal container and the physical adapter (e.g., sanitary valve) is at its open position. The internal space may be purged with robust gas until reading of one or more sensors (e.g., as part of the sensor suite) indicate that the atmosphere in the internal space reached the prescribed atmospheric characteristic(s). The prescribed atmospheric characteristic(s) may comprise temperature, pressure, gas content, or reactive agent(s) level. The robust gas may initially contain an inert gas, e.g., comprising nitrogen or argon. The initial robust gas may become enriched, e.g., using the gas enriching system. The gas enriching system may enrich the initial robust gas with the reactive agent(s) until they reach their prescribed threshold level, e.g., as detected by appropriate sensors. For example, the enriching system comprises an oxygen generator and the appropriate sensor may be an oxygen sensor. For example, the enriching system comprises a humidity generator and the appropriate sensor may be a humidity sensor. The robust gas may ingress the internal space until reaching a threshold pressure level, e.g., an overpressure with respect to the ambient environment. A pressure sensor may indicate the pressure in the internal space of the distal container and the physical adapter.

At times, the gas circulation system may be operatively coupled with a reactive agent generator. In some embodiments, the gas may be supplemented by a predetermined level of reactive agent(s). The reactive agent may act as a passivator, e.g., passivating gas borne debris and/or any other pre-transformed material. The reactive agent generator may be operatively coupled with the gas conveyance system. The reactive agent generator may comprise an oxygen generator or a humidity generator. The reactive agent generator may be confined in a first housing, e.g., comprising sensor(s), restrictor(s), pressure gauge(s), valve(s), or any combination thereof. The reactive agent generator may be operatively coupled with one or more restrictors, e.g., held in a second housing. The restrictor(s) and component(s) relating to the reactive agent generator may be disposed along the gas conveyance system, e.g., gas conveyance channel.

FIG. 23 shows an example of components of a passivation and/or insulation system including a passivation components set 2301 and a restrictors set 2302 along a gas flow path. The gas flow path flows from gas source 2330 in a direction towards 2340, e.g., to a processing chamber. The component set comprise pressure gauges 2311 and 2314, pneumatic operated pressure regulators 2312 and 2315, a reactive agent generator 2313, and valve 2315. The passivation component set is enclosed in a housing having openings 2317 and 2310, e.g., bulk heads. Restrictors set 2302 includes solenoid valves 2321 and 2322, restrictor 2326, and restrictors (e.g., pinch restrictors) 2323-2325. The restrictor set 2302 is housed in a housing having openings 2320 and 2327, e.g., bulk heads. The gas (e.g., robust gas) can flow back to the recirculation loop 2340 of the 3D printer. The reactive agent generator can comprise a passivating agent generator. The reactive agent generator can be an oxygen generator or a humidity generator (e.g., humidifier). The pneumatic operated pressure regulators can be the same or different. For example, pressure regulator 2315 may regulate pressure a higher pressure threshold level than pressure regulator 2312, e.g., higher may be by about half a magnitude, or by about a magnitude.

In some embodiments, the control system comprises a portal such as a panel. The portal can be a human machine interface (HMI). The portal can comprise a visual interface or dashboard that connects a user to one or more components associated with the 3D printer. The portal may provide a (e.g., graphical) user interface (UI) that shows the status and/or control of a control target comprising the 3D printer, the associated component of the 3D printer, or any associated process. The UT may comprise a screen. The associated process may comprise printing, filtering, or gas recycling. The portal may allow the user to control (e.g., monitor and/or manipulate) the control target, e.g., by providing input, e.g., using a keyboard, buttons, or the like. The portal may use dedicated software, e.g., to program and/or design the UI according to the control target.

In some embodiments, controller(s) at least in part control replacement of the bin, e.g., when the debris and/or dilutive media therein reach a maximum threshold. The controller(s) may be safety controller(s), or a safety control system. The controller(s) may operatively couple to the physical adapter, bin, distal container, and/or weighing system. For example, when the distal container reaches a predetermined weight threshold, the controller(s) may signal and/or direct replacement of the bin. The replacement of the distal container can be during the printing and/or after the printing. The controller(s) can execute one or more operations associated with the distal container's status comprising: (a) read and/or analyze data from the weighing system, (b) signal and/or direct a maneuvering device to pick up the distal container, (c) signal and/or direct a maneuvering device to bring another (empty) distal container, (d) read and/or analyze data from the sensor suite, (e) read and/or analyze data from sensor(s) of the lid, (f) control one or more associated valves, (g) communicate with the controller of the filtering system, (h) communicate with the control system of the 3D printer, (i) communicate with the control system of the unpacking station, (j) communication with the control system of the safe disposal, or (k) any combination thereof. Reading and/or analyzing data from the weighing system may be indicative of (i) presence/absence of the distal container on the weighing system, (ii) the content of the distal container in terms of their collective weight, or (iii) rate at which the internal space of the distal container is being filled. Reading and/or analyzing data from the sensor suite may indicate if the atmospheric conditions are within their boundary conditions relating to the process taking place, e.g., purging the internal space of the physical adapter and distal container, or filtering. Reading and/or analyzing data from the lid sensor(s) may indicate if an unexpected condition is taking place in the sealed container, e.g., start of a harmful reaction that requires attention, opening of pressure release valve, and/or disconnection of the distal container from the filtering system, e.g., and from the distal adapter. A portal (e.g., HMI) of the controller(s) may facilitate control (e.g., monitor and/or input) by a user. For example, the HMI of the controller(s) may announce that the distal container should be changed.

FIG. 24 shows a schematic example 2400 of a filtering system portion and associated control system portion in 2400, and a photograph of a similar system example in 2450. Filtering container (e.g., an integral container) 2401a is coupled with, or includes, collection container (e.g., hopper) 2401b from which debris (e.g., and dilutive media) can flow through physical coupler including channel 2411 to distal container 2414 disposed on a floor mounting plate 2425 of a weighing system. Distal container 2414 is disposed in housing 2415 in the form of a cage, e.g., for safety (screen of the case is absent for illustrative purposes). Filtering container 2401a and collection container 2401b are supported by framing system 2416 disposed relative to gravitational vector 2490 pointing to the gravitational center of the ambient environment external to the filtering system portion. Filtering container 2401a and collection container 2401b (e.g., and any associated components) are controlled based at leases in part on input from portal 2417 as part of a first control system. Portal 2417 (e.g., HMI interface) can facilitate monitoring the filtering in the filtering container and/or collection container. Filtering container 2401a is coupled with a first pneumatic panel comprising a first gas flow manifold. A second pneumatic panel comprising a second gas flow manifold is dedicated the filter's downstream components comprising the physical adapter, the distal container lid, and the weighing system. Numeral 2429 points to the first pneumatic panel and to the second pneumatic panels that are disposed adjacent to each other, configured to allow inflow of robust gas, e.g., used for pulsing the accumulating debris and any dilutive media on a face of a filter disposed in the filtering container 2531a. A physical adapter is coupled with collection container 2401b, the physical adapter comprising channel 2411. In the example of 2400, the physical adapter is disconnected from the lid of distal container 2414. The physical adapter and/or distal container are controlled based at least in part on input from portal 2427 as part of a second control system. Portal 2427 (e.g., HMI interface) can facilitate monitoring the physical adapter and/or distal container and any associated component(s), e.g., including the component(s) of the lid. Filtering container 2401a is coupled with channels 2433 and 2434, one of which is configured to flow gas with debris to be filtered and the other is configured to flow clean gas back to the gas conveyance system. A dilutive media reservoir 2428b having opening 2428a is disposed on a shelf coupled with framing 2415, are The first control system and the second control system can be different control systems, or the same control system. For example, the first control system can be the second control system that is the control system of the 3D printer of which the filtering system portion is comprised in. FIG. 24 shows filtering system portion and associated control system in 2450. Filtering container (e.g., an integral container) 2451a is coupled with, or includes collection container (e.g., hopper) 2451b from which debris (e.g., and dilutive media) can flow through physical coupler including channel 2461 to distal container 2464 disposed on a floor mounting plate 2475 of a weighting system. A dilutive media container 2476 is disposed above framing system 2466 relative to gravitational vector 2490. Filtering container 2451a and collection container 2451b are supported by framing system 2466 disposed in relation to gravitational vector 2490 pointing to the gravitational center of the ambient environment external to the filtering system portion. Filtering container 2451a and collection container 2451b (e.g., and any associated component(s)) are controlled based at least in part on input from portal 2467 as part of the first control system. Portal 2467 (e.g., HMI interface) can facilitate monitoring the filtering in the filtering container and/or collection container. A physical adapter is coupled with the collection container, the physical adapter comprising channel 2461. In the example of 2450, the physical adapter is connected to the lid of distal container 2464. The physical adapter and/or distal container (e.g., and any associated component(s)) are controlled based at least in part on input from portal 2477 as part of the second control system. Portal 2477 (e.g., HMI interface) can facilitate monitoring the physical adapter and/or distal container and any associated component(s), e.g., including the component(s) of the lid.

FIG. 25 shows a schematic front view example 2500 of a filtering system portion and associated control system portion, a schematic perspective view example 2530 of the filtering system portion and associated control system portion shown in 2500, and a photograph of a similar system example in 2560. Filtering container (e.g., an integral container) 2501a is coupled with, or includes, collection container (e.g., hopper) 2501b from which debris (e.g., and dilutive media) can flow through physical coupler including sensor box 2506 and channel 2511, to distal container 2514 disposed on a floor mounting plate 2525 of a weighting system. Filtering container 2501a is coupled with a first pneumatic panel comprising a first gas flow manifold 2502 configured to allow inflow of robust gas, e.g., used for pulsing the accumulating debris and any dilutive media on a face of a filter disposed in the filtering container 2501a. A second pneumatic panel comprising a second gas flow manifold 2504 is dedicated the filter's downstream components comprising the physical adapter, the distal container lid, and the weighing system. Distal container 2514 is disposed in housing 2515 in the form of a cage, e.g., for safety. Housing 2515 has a door swayable by hinges 2508. Filtering container 2501a and collection container 2501b are supported by framing system 2516 disposed relative to gravitational vector 2590 pointing to the gravitational center of the ambient environment external to the filtering system portion. Filtering container 2501a and collection container 2501b (e.g., and any associated component(s)) are controlled based at leases in part on input from portal 2517 as part of a first control system. Portal 2517 (e.g., HMI interface) can facilitate monitoring the filtering in the filtering container and/or collection container. A physical adapter is coupled with collection container 2501b, the physical adapter comprising channel 2511. In the example of 2500, the physical adapter is connected to the lid of distal container 2514, e.g., at least in part by using a connector. The physical adapter and/or distal container (e.g., and any associated component(s)) are controlled based at least in part on input from portal 2527 as part of a second control system. Portal 2527 (e.g., HMI interface) can facilitate monitoring the physical adapter and/or distal container and any associated component(s), e.g., including the component(s) of the lid. The first control system and the second control system can be different control systems, or the same control system. For example, the first control system can be the second control system that is the control system of the 3D printer of which the filtering system portion is comprised in. Container 2528 can contain fresh dilutive media disposed on shelf 2529. Filtering container 2501a is coupled with electrical box 2503. Filtering container 2501a is coupled with channels 2505 and 2507, one of which is configured to flow gas with debris to be filtered and the other is configured to flow clean gas back to the gas conveyance system. FIG. 25 shows the schematic perspective view example 2530 of the filtering system portion and associated control system portion shown in 2500. Filtering container (e.g., an integral container) 2531a is coupled with, or includes, collection container (e.g., hopper) 2531b from which debris (e.g., and dilutive media) can flow through physical coupler to distal container 2544 disposed on a floor mounting plate 2555 of a weighting system. Filtering container 2531a is coupled with a first pneumatic panel comprising a first gas flow manifold 2532 configured to allow inflow of robust gas, e.g., used for pulsing the accumulating debris and any dilutive media on a face of a filter disposed in the filtering container 2531a. Distal container 2544 is disposed in housing 2545 in the form of a cage, e.g., for safety. Housing 2545 comprises a door that swivels about hinge axis of hinges such as hinge 2535. The door of housing 2545 has a handle 2536. Filtering container 2531a and collection container 2531b are supported by framing system 2546 disposed relative to gravitational vector 2590 pointing to the gravitational center of the ambient environment external to the filtering system portion. Filtering container 2531a and collection container 2531b (e.g., and any associated component(s)) are controlled based at leases in part on input from portal 2547 as part of the first control system. Portal 2547 (e.g., HMI interface) can facilitate monitoring the filtering in the filtering container and/or collection container. A physical adapter is coupled with collection container 2531b. The physical adapter and/or distal container (e.g., and any associated component(s)) are controlled based at least in part on input from portal 2557 as part of the second control system. Portal 2557 (e.g., HMI interface) can facilitate monitoring the physical adapter and/or distal container and any associated component(s), e.g., including the component(s) of the lid of distal container 2544. Container 2558 can hold fresh dilutive media. A first electrical box 2541 servers the Filtering container 2531a and collection container 2531b and their associated components; and a second electrical box 2542 serves the filter's downstream components comprising the physical adapter, the distal container lid, and the weighing system. A second pneumatic panel comprising a second gas flow manifold 2543 is dedicated the filter's downstream components comprising the physical adapter, the distal container lid, and the weighing system. Filtering container 2531a is coupled with channels 2533 and 2534, one of which is configured to flow gas with debris to be filtered and the other is configured to flow clean gas back to the gas conveyance system. FIG. 25 shows the photograph of the similar system example in 2560 of the filtering system portion and associated control system portion shown in 2500. Filtering container (e.g., an integral container) 2561a is coupled with, or includes, collection container (e.g., hopper) 2561b from which debris (e.g., and dilutive media) can flow through physical coupler comprising (i) sensor box 2566 and (ii) channel 2571, to distal container 2574 disposed on a floor mounting plate 2585 of a weighting system. Container 2565 can hold fresh dilutive media. Distal container 2574 is disposed in housing 2575 in the form of a cage, e.g., for safety. Housing 2575 comprises a door held by hinges such as 2568 facilitating its swiveling to reversibly open and closer. Filtering container 2561a and collection container 2561b are supported by framing system 2576 disposed relative to gravitational vector 2590 pointing to the gravitational center of the ambient environment external to the filtering system portion. Electrical box 2563 serves filtering container 2561a and collection container 2561b and their related components. Filtering container 2561a is coupled with a first pneumatic panel comprising a first gas flow manifold 2562 configured to allow inflow of robust gas, e.g., used for pulsing the accumulating debris and any dilutive media on a face of a filter disposed in the filtering container 2561a. Filtering container 2561a and collection container 2561b (e.g., and any associated component(s)) are controlled based at leases in part on input from portal 2577 as part of the first control system. Portal 2577 (e.g., HMI interface) can facilitate monitoring the filtering in the filtering container 2561a and/or collection container 2561b. A physical adapter is coupled with collection container 2561b. The physical adapter and/or distal container (e.g., and any associated component(s)) are controlled based at least in part on input from portal 2587 as part of the second control system. Portal 2587 (e.g., HMI interface) can facilitate monitoring the physical adapter and/or distal container and their associated component(s), e.g., including the component(s) of the lid of distal container 2544. Filtering container 2561a is coupled with channels 2591 and 2592, one of which is configured to flow gas with debris to be filtered and the other is configured to flow clean gas back to the gas conveyance system.

In some embodiments, the distal container may be held by a top plane. The distal container may be aligned by the top plane. In an example, the top plane may comprise one or more supports configured to align the distal container with respect to the top plane. The top plane may be included in a weighing system. The weighing system may comprise one or more load cells. The weighing system may comprise one or more sensors, e.g., as disclosed herein. The weighing system may comprise a maneuvering device (e.g., wheels), e.g., as disclosed herein. The support(s) may comprise a curved section (e.g., portion) or a non-curved section (e.g., portion). The supports can comprise a curved portion, e.g., be curved. The supports can comprise a non-curved portion, e.g., be non-curved. The supports can comprise a curved plane. The support can comprises a stud. The support can comprise a cylinder. The support can comprise a stopper, e.g., configured to hinder lateral movement of the distal container. The supports can be configured to respectively match an external shape of a portion of the distal container. In an example, the supports are parts of a cylinder, and are configured to match (e.g., and support) the cylindrical portion of a distal container. The top plane may comprise a central aligner. The central aligner may comprise a depression or a protrusion with respect to the exposed surface of the top plate. The distal container may be configured to engage with the support(s) and/or with the central aligner. The central aligner may be configured to align the center of the distal container with the center of the top plane such as with a center of the top plane. The central aligner may be configured to align the center of the distal container with a position at a prescribed distance from the support(s). The central aligner may be configured to align the center of the distal container with a position of the top plane such that a floor of the distal container will be disposed in an exposed surface of the top plane. The top plane may be disposed above a mounting plate and/or above the load cell(s). The weighing system may comprise a mounting plate, load cell(s), a top plate, or a maneuvering device. The maneuvering device may be configured to translate the weighing system (with or without the distal container) about a surface such as a floor. The maneuvering device may comprise wheel(s) or actuato(s). In an example, a wheel is operatively coupled with an actuator. The actuator may manually and/or automatically cause translation of the mounting device, or a component thereof such as a wheel. The actuator may be automatically controlled, e.g., by controller(s). The actuator may be configured for wireless and/or remove communication. Remove communication may comprise (i) communication within the facility in which the maneuvering device is disposed, or (ii) communication outside of the facility in which the maneuvering device is disposed. The load cells may be symmetrically related, e.g., in at least a Cn rotational symmetry, with the rotational axis running (e.g., substantially) along a height of the distal container and in the middle of the horizontal cross section of the distal container's floor, and n being the number of load cells. For example, when there are three load cells, they are related in a C₃ symmetry, with the symmetry axis running normal to the top. The Cₙ symmetry axis can go through a location in the top plate above which the center of the horizontal cross section of the distal container's floor is (e.g., substantially) intended.

FIG. 26 shows various view examples of a weighting system and associated components arranged with respect to gravitational 2690 pointing to the gravitational center of the ambient environment external to distal container 2605. Example 2600 shows a schematic front view of a weighing system comprising load cells 2601a, 2601b, and 2601c. The load cells are disposed on mounting plate 2602 (e.g., scale frame) configured to engage with feet 2603a and 2603b. The feet are configured for disposition on a surface such as a floor. Load cells 2603a-c are configured to support top plate 2604, that is configured to support distal container 2605. Any of the feet can be adjustable, e.g., to level (i) mounting plate 2602, (ii) top late 2604, and/or (iii) floor of distal container 2605. A feet may be adjustable manually and/or automatically, e.g., using a controllable actuator such as a servo-motor. Example 2630 shows a schematic perspective view of a weighing system comprising load cells 2631a, 2631b, and 2631c shown in this example through top plate 2634 that is transparent, e.g., for didactive purposes. Load cells 2631a-c are disposed on mounting plate 2632 (e.g., scale frame) configured to engage with feet such as foot 2633. Load cells 2633a-c are configured to support top plate 2634, that is configured to support a distal container (not shown). Any of the feet can be adjustable, e.g., to level (i) mounting plate 2632, (ii) top late 2634, and/or (iii) floor of distal container (not shown). The feet can be operatively coupled with adjusters such as 2636. The adjuster can be operatively coupled, or include, the actuator. Top plate 2634 comprises top surface 2637 (with respect to gravitational vector 2690) to which two supports 2638a and 2638b are coupled. The supports can be configured to support the distal container. In the example shown in 2630, the supports comprise curved planes that are parts of a cylinder configured to hold a cylindrical portion of the distal container. Top plate 2634 comprise optional aligner 2639 configured to align top plate 2634 with mounting plate 2632. In some embodiments, the top plate may comprise an aligner configured to align the distal container on top plate 2634, e.g., (i) at its center, (ii) with respect to supports and/or (iii) with respect to the load cells. In the example shown in FIG. 26, optional aligner 2639 is in the form of a receptacle. Top plate 2634 comprises depression 2640 configured to accommodate one or more cables, e.g., electrical cables (not shown). Example 2660 shows a schematic side view of a weighing system comprising load cells 2661a, 2661b, and 2661c. Load cells 2661a-c are disposed on mounting plate 2662 (e.g., scale frame) configured to engage with feet such as feet 2663a and 2633b. Load cells 2663a-c are configured to support top plate 2664 that is configured to support distal container (not shown). Any of the feet can be adjustable, e.g., to level (i) mounting plate 2662, (ii) top late 2664, and/or (iii) floor of distal container (not shown). Any (e.g., each) of the feet can be operatively coupled with a respective adjuster. For example, foot 2663a is operatively coupled with adjusted 2666a, and foot 2663b is operatively coupled with adjuster 2666b. Two supports 2668a and 2638b are coupled with top plate 2664. The supports can be configured to support the distal container. In the example shown in FIG. 26, optional aligner 2669 is in the form of a receptacle. Top plate 2664 comprises optional aligner 2669 aligning top plate 2664 with mounting plate 2662.

FIG. 27 shows various view examples of a weighting system and associated components arranged with respect to gravitational 2790 pointing to the gravitational center of the ambient environment external to distal container 2705. Example 2730 shows a schematic perspective view of a weighing system comprising load cells 2731a, 2731b, and 2731c shown in this example through top plate 2734 that is transparent, e.g., for didactive purposes. Load cells 2731a-c are disposed on mounting plate 2732 (e.g., scale frame) configured to engage with feet such as foot 2733. Load cells 2733a-c are configured to support top plate 2734, which is configured to support a distal container (not shown). Load cells 3733a-c are connected with wiring 2741, e.g., to a control system (now shown). Any of the feet can be adjustable, e.g., to level (i) mounting plate 2732, (ii) top late 2734, and/or (iii) floor of distal container (not shown). The feet can be operatively coupled with adjusters such as 2736. The adjuster can be operatively coupled, or include, the actuator. Top plate 2734 comprises top surface 2737 (with respect to gravitational vector 2790) to which two supports 2738a and 2738b are coupled, e.g., cylindrical studs. The supports can be configured to support the distal container. In the example shown in 2730, the supports comprise cylinders. Top plate 2734 comprise optional aligner 2739 configured to align top plate 2734 with mounting plate 2732. In the example shown in FIG. 27, optional aligner 2739 is in the form of a receptacle. Top plate 2734 comprises depression 2740 configured to accommodate one or more cables, e.g., electrical cables (not shown). Example 2760 shows a schematic side view of a weighing system comprising load cells 2761a, 2761b, and 2761c. Load cells 3761a-c are connected with wiring 2771, e.g., to a control system (now shown). Load cells 2761a-c are disposed on mounting plate 2762 (e.g., scale frame) configured to engage with feet such as feet 2763a and 2733b. Load cells 2763a-c are configured to support top plate 2764 configured to support a distal container (not shown). Any of the feet can be adjustable, e.g., to level (i) mounting plate 2762, (ii) top late 2764, and/or (iii) floor of distal container (not shown). Any (e.g., each) of the feet can be operatively coupled with a respective adjuster. For example, foot 2763a is operatively coupled with adjusted 2766a, and foot 2763b is operatively coupled with adjuster 276b. Two supports 2768a and 2738b are coupled with top plate 2764. The supports can be configured to support the distal container. Top plate 2764 is coupled with optional aligner 2769 aligning top plate 2764 with mounting plate 2762.

In some embodiments, the distal container is disposed in a housing. For example, when filtered debris enters (ingresses) the distal container. For example, when quelling material enters (ingresses) the distal container, the quelling material comprising the passivating material or the insulating material. The passivating material may comprise an oxidizer. The passivating material may comprise water. The insulating material may comprise a hydrocarbon, e.g., oil. The passivating material may comprise (e.g., may be) the insulating material. The housing may comprise a door. The housing (when closed) may laterally surround the distal container, e.g., with its associated weighing system. The housing (when closed) may laterally surround the weighing system. The housing (when closed) may prevent the enclosed distal container and/or weighing system, from traversing laterally to a position outside of the housing, e.g., along a floor. The housing may include at least one stationary wall. The wall may comprise a curvature, e.g., may be curved. The wall may be devoid of curvature, e.g., may be planar. The housing may comprise a door. The door may be coupled with the wall by a hinge. The hinge may allow the door to reversibly open and close. Opening of the door may facilitate entrance of the distal container (e.g., and its weighing system) into the housing. The status of the door may be detected by at least one sensor. The door status sensor(s) may be disposed in the wall and/or in the door. The door status sensor(s) may be disposed in the side of the door configured to (i) contact the wall upon closure of the door, and (ii) not contact (e.g., be released from) the wall upon opening of the door. The door status sensor(s) may be disposed in the side of the wall configured to (i) contact the door upon closure of the door, and (ii) not contact (e.g., be released from) the door upon opening of the door. The door status sensor(s) may comprise a proximity sensor or a contact sensor. The door status sensor(s) may be configured to sense whether the housing is closed (e.g., door contacts the wall), or whether the housing is open (e.g., the door does not contract the wall). The door (when closed) may allow the housing to laterally surround the distal container, e.g., with its associated weighing system. The door (when closed) may allow the housing to laterally surround the weighing system. The door (when closed) may hinder (e.g., prevent) the enclosed distal container and/or weighing system, from traversing laterally to a position outside of the housing, e.g., along a floor. The door (when open) may be configured to allow the distal container and/or weighing system to enter into the internal space of the housing. The door may comprise at least one spacer. The spacer may be configured to contact the distal container upon closure of door, e.g., and hinder its lateral movement in the housing. The spacer may have a shape configured to snuggly fit the distal container upon closure of door. The spacer may comprise at least one spacer sensor. The spacer sensor(s) may be configured to sense whether the distal container is proximal to spacer and/or at what distance is the distal container from the spacer. The spacer sensor(s) may be configured to sense if the distal container contacts spacer, and/or at what distance the distal container is from the spacer, e.g., from the spacer sensor. The spacer sensor(s) may comprise a proximity sensor or a contract sensor. The door status sensor(s) and/or the spacer sensor(s) may be automatically controlled, e.g., by controller(s). The door status sensor(s) and/or the spacer sensor(s) may be configured for wireless and/or remove communication. Remove communication may comprise (i) communication within the facility in which the maneuvering device is disposed, or (ii) communication outside of the facility in which the maneuvering device is disposed. The door status sensor(s) and/or the spacer sensor(s) may be operatively coupled with at least one controller, e.g., housing controller(s). The housing controller(s) may or may not be communicative coupled with, or be part of, the control system of the 3D printer. The housing controller(s) or may not be communicative coupled with, or be part of, the control system of the unpacking station. The housing may be configured to engage with a 3D printer, an unpacking station, or a facility where the passivation and/or isolation operation takes place. The wall and/or door may comprise a mesh. The wall and/or door may comprise a transparent material or an opaque material. The wall and/or door may comprise elemental metal, a metal alloy, a ceramic, or a composite material. The wall and/or door may comprise a hole. The wall and/or door may comprise a window. The housing may be configured to situate the distal container at a prescribed distance from its wall(s) and/or door. The housing may be devoid of a floor and/or a ceiling. The housing may be configured for disposition below the filtering system. The housing may be configured to allow connection of the physical adapter between the filtering system and the distal container. The housing may comprise an elevator mechanism, e.g., to elevate the distal component and any associated device (e.g., the weighing system) towards the filtering mechanism. The housing may be devoid an elevator mechanism. The channel coupling the filtering mechanism and the distal container may be sufficiently long and/or flexible to accommodate a varying gap between the distal container inlet (e.g., lid inlet) and the filtering mechanism outlet connected by the channel (e.g., hose, or tube.). The mounting plate and door spacer may offer a plurality of contact points (e.g., three points of contact) with the distal container, e.g., to increase a probability that the floor of the distal container will have horizontal cross section that engulfs the (e.g., all the) load cells, e.g., for accurate weight measurement. The plurality of contact points may comprise (a) the supports and (b) the contacting spacer—when the door of the housing is closed.

FIG. 28 shows various examples of a housing and housed components viewed from the top down with respect to gravitational 2690 pointing to the gravitational center of the ambient environment. The various examples show a door of the housing in an open and in a closed configuration. Example 2800 shows the distal container not contacting the supports (2808a and 2808b) and the spacer 2814. Example 2850 shows the distal container contacting the supports (2858a and 2858b) and the spacer 2864. Example 2800 shows distal container 2805 disposed on top frame 2804. Distal container 2805 is supported (e.g., and aligned) using supports 2808a and 2808b. Top frame 2804 is disposed with distal container 2805 in a housing comprising walls 2806a, 2806b, and 2806c. The housing comprise door 2861 that swivels about wall 2806c about hinge 2812, wall 2806c being connected to door 2811 by hinge 2812. Wall 2806a comprises latch 2863 configured to engage with door 2811 upon closure, a side of wall 2806a being configured to contact door 2811 upon closure. Latch 2813 can be a safety latch. Latch 2813 may comprise, or be operatively coupled with, a door status sensor configured to sense a status of door 2811 with respect to latch 2813, e.g., closure and/or opening of door 2811. Door 2811 comprises spacer 2814 having a shape configured to snuggly fit distal container 2805 upon closure of door 2811. In the example shown in 2800, door 2811 is open with respect to wall 2806a. Spacer 2814 comprises spacer sensor 2815. Spacer sensor 2815 may be configured to sense if the distal container is proximal to spacer 2814. Spacer sensor 2815 may be configured to sense if the distal container contacts spacer 2814. Spacer sensor 2815 may comprise a proximity sensor. The ambient environment is external to distal container 2805. Top plate 2804 may be part of the weighting system, e.g., configured to weight distal container 2805. Example 2850 shows distal container 2855 disposed on top frame 2854. In example 2850, door 2861 is closed with respect to wall 2856a. Distal container 2855 is supported (e.g., and aligned) using supports 2858a and 2858b. Top frame 2854 is disposed with distal container 2855 in a housing comprising walls 2856a, 2856b, and 2856c. The housing comprise door 2861 that swivels about wall 2856c about hinge 2862, wall 2856c being connected to door 2861 by hinge 2862. Wall 2856a comprises latch 2863 engaged with door 2861 that is closed. Door 2861 comprises spacer 2864 that has a shape that snuggly fits to distal container 2855 as door 2861 is closed. Spacer 2864 comprises sensor 2865. Sensor 2865 may be configured to sense if the distal container is proximal to spacer 2864. Sensor 2865 may be configured to sense if the distal container contacts spacer 2864. Sensor 2865 may be a proximity sensor. The ambient environment is external to distal container 2855. Top plate 2854 may be part of the weighting system, e.g., configured to weight distal container 2855. The load cells may be disposed below the horizontal cross section of distal container 2855, e.g., symmetrically disposed about a center of the horizontal cross section of distal container 2855. The load cells may be symmetrically related, e.g., in at least a Cn rotational symmetry, with the rotational axis running (e.g., substantially) along a height of the distal container and in the middle of the horizontal cross section of the distal container's floor, and n being the number of load cells.

FIG. 29 shows various photographic view examples of a lid closing each a distal container. In example 2900, a lid having exposed surface 2901 comprises connector 2910 coupled with a physical adapter. Connector 2910 is coupled with channel 2911 as part of the physical adapter. Connector 2110 is configured for ingress of debris therethrough. The lid having surface 2901 comprises (i) pressure gauge 2902, (ii) egress port 2903 (with valve) for the quelling material, (iii) ingress port 2104 (with valve) for robust gas, (iv) ingress port 2105 for (with valve) for the quelling material, and (v) egress port 2006 (with valve) for robust gas, e.g., pressure release valve. Lid surface 2901 comprises handles such as 2013, e.g., for maneuvering. The lid closes distal container 2914 at least in part with clamp 2915. Distal container 2914 is disposed on top plate 2916, e.g., as part of a weighing system. A transport mechanism 2917 engages with distal container 2914, e.g., for maneuvering about floor 2918. In example 2950, a lid comprises a connector connected to a physical adapter. The lid is coupled with channel 2961 included in the physical adapter, e.g., via the connector—not shown. The lid comprises (i) egress port 2953 (with valve) for the quelling material, and (ii) egress port 2955 for (with valve) for the quelling material. The lid comprises handles 2963a and 2963b, e.g., for maneuvering. The lid closes distal container 2964 at least in part with clamp 2965. Distal container 2964 is disposed on top plate 2966, e.g., as part of a weighing system. A transport mechanism 2967 engages with distal container 2964, e.g., for maneuvering about floor 2968. Distal container 2964 is disposed beneath to portion 2970 of framing 2971. The framing can be configured to support a filtering container (e.g., an integral container) and/or collection container (not shown). Example 2950 is shown with respect to vector 2990 pointing towards the gravitational center of the ambient environment.

In some embodiments, a safe disposal of the debris comprises one or more operations. The safe disposal may be carried out with a quelling material that is a flowable nongaseous material, e.g., as disclosed herein. The flowable nongaseous material may comprise liquid or flowable semisolid material (e.g., gel). The passivating material may comprise an oxidizer. The passivating material may comprise water. The insulating material may comprise a hydrocarbon, e.g., oil. The passivating material may comprise (e.g., may be) the insulating material. The safe disposal may be carried out at a separate location away from the filtering system, e.g., away from the 3D printing system and/or away from the unpacking station. The distal container having the debris therein may be transported by a maneuvering device to the separate location. During transport, the lid connector configured to couple the lid with the physical adapter has its valve (e.g., the sanitary valve) shut prior to disconnecting from the filtering system, e.g., and prior to disconnecting from the physical adapter. Care can be taken to prevent from overflowing and/or over pressurizing the distal container. Care can be taken to have a layer of robust gas above the debris, e.g., including above any dilutive media, and above the quelling material. The distal container may be filled to at most about 80%, 70%, 60%, 50%, or 40% of its volume with (a) the filtered gas borne material (e.g., soot) and (b) any dilutive media. The distal container may be filled to at most about 95%, 90%, 80%, or 70% of its volume with (A) the filtered gas borne material (e.g., soot), (B) dilutive media, and (C) the liquid that is the quelling material such as comprising water. Determination of any of the above percentages can be by weighing the distal container and the materials included in it, e.g., in real time, before filling with the liquid, and/or after filing with the liquid, the liquid being the quelling material. Weighing the distal container (and its content) may be at least in part by using the weighing system, e.g., as disclosed herein. For example, when the distal container has an internal volume of about 55 gallon, the liquid included in its interior space can weigh (e.g., at most) about 950 pounds (libras-lbs.) when the liquid is water. For example, when the distal container has an internal volume of about 210 liters, the liquid filled in it can weigh (e.g., at most) about 430 kilograms when the liquid is water. The safe disposal operations of a distal container containing material to be passivated and/or insulated may comprise (a) attaching a first channel to the lid port configured for ingress of the quelling material (e.g., liquid such as water), (b) attach a second channel to the lid port configured for egress of the liquid quelling material, (c) place the second channel in an ancillary container configured to accommodate the egressing liquid quelling material, (d) open the valve to facilitate ingress of the liquid quelling material into the distal container, (e) allow gas and/or the liquid to flow into the second channel and into the ancillary container, and (f) shut the valve to stop flow of the liquid into the first channel and into the distal container, the liquid being the quelling material. In some embodiments, during filling of the distal container, (i) the lid is secured to the distal container, (ii) the connector valve (e.g., sanitary valve) of the lid is shut, (iii) the pressure in the distal container is maintained at a level of positive pressure (overpressure) relative to the ambient environment external to the distal container, (iv) the atmosphere in the distal container comprises the robust gas supplemented with any gaseous reaction products of a passivating reaction occurring in the distal container, (v) a temperature is at or below a threshold level, or (vi) any combination thereof. The level of positive pressure can be within a positive pressure window, e.g., as disclosed herein. The pressure of at least about 5 kilo-Pascals (kPa), 10 kPa, 12 kPa, 14 kPa, 16 kPa, 18 kPa, 20 kPa above ambient pressure external to the enclosure, at room temperature, pressure of at most about 20 kilo-Pascals (kPa), 30 kPa, 40 kPa, or 50 kPa above ambient pressure, at room temperature. The pressure window can be between any of the aforementioned pressure windows, e.g., from about 5 kPa to about 50 kPa, from about 5 kPa to about 30 kPa, or from about 5 kPa to about 20 kPa, at room temperature, e.g., 20° C. or 25° C. The maximal level of liquid in the distal container may be controlled at least in part by using an overfill prevention pipe (e.g., tube). The overfill prevention pipe may be part of, or may be operatively coupled with, the egress port for an excess of the quelling material. The outflowing flowable quelling material may comprise (i) any reaction products of the passivation reaction, (ii) starting material of the passivation reaction (e.g., debris and/or other pre-transformed material), (iii) debris, (iv) pre-transformed material, (v) dilutive media, or (vi) any combination thereof. The ancillary container may or may not be filled with an indicator. The indicator may comprise a flowable material. The indicator may comprise a liquid or a semisolid. Prior to initiating the passivation and/or insulation operation, the indicator (e.g., preliminary liquid) in the ancillary container may or may not be of the same type as the quelling material. The ancillary container may or may not have (e.g., substantially) the same internal volume as the distal container. While the disclosure describes liquid material (e.g., for the quelling material and/or indicator), other forms of flowable material may be utilized such as the ones disclosed herein, e.g., a flowable gel, a suspension of solid in a liquid, a suspension of solid in flowable gel, a suspension of vesicles in a liquid, or a suspension of vesicles in flowable gel.

In some embodiments, the second channel is disposed in the ancillary container during the safe disposal operation, the second channel having an exit opening. Gas, passivating material, and/or insulating material may flow out of the second channel. The gas may comprise the robust gas. An indicator (e.g., preliminary liquid material) may be disposed in the ancillary container such that the outlet opening of the second channel is immersed in the indicator, e.g., below the surface level of the indicator. When the level of the quelling material in the distal container is below the overflow prevention pipe, gas (e.g., robust gas) exits the second channel and into the indicator disposed in the ancillary container, and bubbles upwards on its transit into the atmosphere, e.g., ambient atmosphere. When the level of the quelling material in the distal container reaches the overflow prevention pipe, the non-gaseous flowable quelling material exits the second channel and into the indicator (e.g., preliminary liquid), and the exiting non-gaseous flowing quelling material is added to the indicator instead of the gas, e.g., gas bubbles. Cessation of gas emerging from the indicator may indicate that the distal container has reached its predetermined filling capacity by the flowable non-gaseous quelling material. In the event the reaction product of the passivation is gas (i.e., not a liquid and/or flowable semisolid), the outflowing gas may flow into the ancillary container and bubbles will continue to emerge after the ancillary container has reached its filling threshold. In such an event, cessation of the bubbles may indicate that the passivation reaction has reached safe handling and/or has reached its end. In an example, the indicator (e.g., preliminary liquid) is water and the non-gaseous flowing quelling material comprises (e.g., is) water.

In some embodiments, the second channel is disposed in the ancillary container during the safe disposal operation, the second channel having an exit opening. Gas, passivating material, and/or insulating material may flow out of the second channel and into an empty ancillary container. When the level of the quelling material in the distal container is below the overflow prevention pipe, gas (e.g., robust gas) exits the second channel and into the ancillary container, which may not be visible. In an example, when the level of the quelling material in the distal container reaches the overflow prevention pipe, the flowable non-gaseous quelling material exits the second (e.g., exhaust) channel and into the distal container, and the exiting quelling material is (e.g., visibly) detected in the distal container. Detection of the quelling material in the ancillary container may indicate that the distal container has reached its predetermined filling capacity by the (e.g., liquid) quelling material. In an example, the indicator is water and the quelling material is water. The liquid quelling material may be substituted with other flowable non-gaseous quelling material, e.g., as disclosed herein. In the event the quelling material type is gas (i.e., not liquid), the outflowing gas may flow into the ancillary container (e.g., if that gas is toxic) or into the ambient atmosphere, e.g., if that gas is non-toxic. In the event the reaction product of the passivation is gas (not liquid), the outflowing gas may flow into the ancillary container (e.g., if that gas is toxic) or into the ambient atmosphere (e.g., if that gas is non-toxic).

FIG. 30 shows example stages of a passivation and/or insulation process with respect to vector 3090 pointing towards the gravitational center of the ambient environment external to the distal container and the ancillary container. In example 3000 liquid quelling material can be introduced along arrow 3001, e.g., through a first channel (e.g., tubing). The liquid quelling material may be substituted with other flowable non-gaseous quelling material, e.g., as disclosed herein. The quelling material may be introduced into an internal space of distal container 3014 through ingress port 3002, that may include a valve. Ingress port 3002 is disposed in lid 3003 that closes distal container 3014. Lid 3003 includes egress port 3004 configured for egress of the quelling material. Egress port 3004 includes (or is operatively coupled with) an overflow prevention pipe. Lid 3003 includes pressure gauge 3005, gas ingress port (e.g., for robust gas) 3006, a first gas egress port 3007 such as a PRV, and a second gas egress port 3008 such as a pressure release valve (PRV). The duplicative gas egress ports may be for safety. The first gas ingress port may or may not be the same as the second gas egress port. The first gas ingress port and/or the second gas egress port may comprise a pressure release gas (e.g., blow off valve). The lid may comprise one or more sensors comprising a temperature sensor, an oxygen sensor, a humidity sensor, hydrogen sulfide sensor, a hydrogen sensor, a gas flow sensor, or a pressure sensor. Lid 3003 seals distal container 3014 using seals 3013a and 3013b (e.g., as part of an O-ring). Lid 3003 is coupled with connector 3010 configured to couple a physical adapter (not shown) to the lid along direction 3011 to flow debris (e.g., with any dilutive media) into distal container 3014 through connector 3010. Connector 3010 comprises valve 3012 (e.g., sanitary valve) that can control the rate of inflow of debris (and any dilutive area) into distal container 3014. Valve 3012 can be controlled manually and/or automatically. Port 3004 is connected to second channel 3020 (e.g., exhaust channel such as a tubing or a hose) configured to follow liquid quelling material out of distal container 3014 and into ancillary container 3024. The ancillary container includes preliminary liquid 3025 at a level above an exit opening of second channel 3020. Gas bubbles 3026 are flowing out of the exit opening of the second channel 3020 and into indicator 3025 (e.g., a preliminary liquid), e.g., as the pressure is maintained above ambient pressure in the closed distal container 3014. The preliminary liquid indicator may be substituted with other flowable non-gaseous material, e.g., as disclosed herein. In the example shown in 3000, distal container 3014 is devoid of quelling material. Example 3000 illustrates a situation before the quelling material has entered distal container 3014. Example 3050 illustrates a situation after the quelling material has entered distal container 3064. In example 3050 the liquid quelling material was introduced along arrow 3051, e.g., through a channel (e.g., tubing). The quelling material was introduced into the internal space of distal container 3064 through ingress port 3052, that may include a valve. Ingress port 3052 is disposed in lid 3053 that closes distal container 3064. Lid 3053 includes egress port 3054 configured for egress of the quelling material. Egress port 3054 includes (or is operatively coupled with) an overflow prevention pipe. Lid 3053 includes pressure gauge 3055, gas ingress port (e.g., for robust gas) 3056, a first gas egress port 3057 such as a PRV, and a second gas egress port 3058 such as a PRV. The duplicative gas egress ports may be for safety. The first gas ingress port may or may not be the same as the second gas egress port. The first gas ingress port and/or the second gas egress port may comprise a pressure release gas (e.g., blow off valve). The lid may comprise one or more sensors comprising a temperature sensor, an oxygen sensor, a humidity sensor, hydrogen sulfide sensor, a hydrogen sensor, a gas flow sensor, or a pressure sensor. Lid 3053 seals distal container 3064 using seals 3063a and 3063b (e.g., as part of an O-ring). Lid 3053 is coupled with connector 3060 configured to couple a physical adapter (not shown) to the lid along direction 3061 to flow debris (e.g., with any dilutive media) into distal container 3064 through connector 3060. Connector 3060 comprises valve 3062 (e.g., sanitary valve) that can control the rate of inflow of debris (and any dilutive area) into distal container 3064. Valve 3062 can be controlled manually and/or automatically. Port 3054 is connected to second channel 3080 (e.g., tubing) configured to follow liquid quelling material out of distal container 3064 and into ancillary container 3084. Indicator 3085 (e.g., liquid preliminary material) is disposed in ancillary container 3084, e.g., for illustrative purposes. In the example shown in 3000, distal container 3014 is devoid of the liquid quelling material. In the example shown in 3050, the level of the liquid quelling material in distal container 3064 exceeded its threshold level 3086 determined at least in part by the overflow prevention pipe. An excess of the liquid material (e.g., water) was transferred through overflow prevention pipe and egress port 3054 through second channel 3080 into ancillary container 3084, as illustrated by overflow liquid material 3085, and bubbles no longer emerge, e.g., indicating that the fill level in the distal container has reached its maximum threshold level 3086. Liquid quelling material 3087 remains in distal container 3064, being below threshold level 3086, e.g., facilitating maintaining the robust gas blanketing the exposed surface of the liquid in distal container 3064.

In some embodiments, the distal container containing the debris and any dilutive media, includes quelling material that has reached its maximum threshold filling level. The container may be disposed at this stage, or may be left to ensure completion of the quelling reaction, e.g., the passivating reaction and/or the insulating reaction. The container may be left for a predetermined time deemed sufficient for save disposal, e.g., according to the safety procedures in the jurisdiction. For example, the container may be left for at least about a day, a week, two weeks, or a month.

In some embodiments, the distal container is configured for maneuvering. The distal container may be configured to allow for coupling of a maneuvering (e.g., lifting and translating) device (e.g., mechanism) such as a forklift, a cart, or a drone. The distal container may include couplers that are configured to couple to a maneuvering mechanism (e.g., device or apparatus). The maneuvering device may travel horizontally and/or vertically. The maneuvering device may comprise a vehicle (e.g., forklift, truck, tractor, or care), or a plane (e.g., drone). The maneuvering device may be translated (e.g., driven) by personnel or may be robotic. The maneuvering device may be autonomous.

In some embodiments, the debris and/or dilutive media in the distal container are passivated. The passivation operations(s) include (i) maneuvering the closed distal container to the passivation station, (ii) connecting the distal container (e.g., through the ingress port of its lid) to a passivator and/or insulator source, (iii) opening the port to allow passivator and/or insulator to flow into the closed distal container, (iv) monitoring passivation reaction (if passivator used), (v) removing any retention straps and removing the lid to replace it with a cheaper (e.g., standard) lid, and/or (vi) dispose (e.g., to landfill), e.g., according to the rules and regulations of the applicable jurisdictions. The more sophisticated and/or expensive lid may be reused with another distal container to collection of the debris and/or dilutive media. The passivation may comprise ingress of gaseous (e.g., water vapor), gas borne (e.g., water droplets), or liquid material (e.g., bulk liquid water) into the distal container that is disconnected from the gas flow mechanism. The liquid material (e.g., oxidizing agent such as water) may react with the debris to form a less reactive compound (e.g., reach with a metal to form a metal oxide and/or hydroxide). The liquid material (e.g., oil) may coat the debris to deter (e.g., prevent or slow down) its reaction with reactive species in the ambient atmosphere.

An administration rate (e.g., flow rate) of the passivation agent (e.g., oxidizing agent) may be controlled, e.g., manually and/or automatically such as by controller(s) (e.g., any controller(s) disclosed herein). For example, a lower administration rate of the passivating agent into the distal container housing the debris will react slower with the debris as compared to a higher administration rate of passivating agent into that distal container enclosing the debris. A concentration of the passivation agent (e.g., oxidizing agent) may be controlled, e.g., manually and/or automatically such as by controller(s) (e.g., any controller(s) disclosed herein). The passivating agent may be mixed with a carrier. The carrier may be inert (e.g., non-reactive) with the debris. A ratio between the carrier and the passivating agent (e.g., water) may determine the rate of reaction of the passivating agent with the debris. For example, a more diluted mixture of passivating agent in a carrier will react slower with the debris as compared to a more concentrated mixture of passivating agent in a carrier. For example, a gas mixture having 80% humidity in argon will react faster with titanium powder debris than a gas having 2% humidity in argon.

In some embodiments, the 3D printing system comprises a filtering mechanism having one or more containers (e.g., a filtering container and a distal container). The gas conveying channel of the gas conveying system may comprise a valve. The valve may facilitate reversibly connecting the container to the processing chamber (e.g., during, before and/or after the 3D printing), e.g., through the gas conveying channel and/or physical adapter. The filtering mechanism may facilitate a continuous filtering of the gas that flows within at least the processing chamber. The gas that flows within the gas flow mechanism comprises flowing through the processing chamber, ancillary chamber, a component of the layer dispenser, the gas conveying channel(s), or a pump. The continuous filtering is before, after and/or during the 3D printing. The continuous filtering may be enabled by a reversibly removable and attachable the distal container (e.g., a separable container), which may facilitate continuous filtering of the gas that flows within at least a portion of the gas circulation system (e.g., the processing chamber), which continuous filtering is before, after and/or during the 3D printing. The continuous filtering may facilitate maintaining a requested physical property of the gas within the processing chamber and/or ancillary chamber. The requested physical property of the gas may be pre-determined and/or constant. The physical property of the gas may comprise density, velocity, type, temperature, reactive species content, and/or acceleration. The physical property of the gas may comprise an amount of a reactive agent (e.g., reactive species) in the gas. The reactive agent may comprise an oxidizing agent. The filtering mechanism may facilitate maintaining a constant and/or diminished amount of gas-borne debris in the processing chamber and/or ancillary chamber. In some embodiments, the continuous filtering may comprise alternating (e.g., switching) between different distal containers that connect to the filtering container, e.g., before, after, and/or during printing. For example, the continuous filtering may comprise closing a valve (e.g., the proximal valve and/or the distal valve) that connects the filtering container, from the physical adapter and/or from the distal container. The filtering container may or may not comprise a filter. For example, the filtering container may comprise a cyclonic separator. Switching (e.g., exchanging (between distal containers may be done before, during, and/or after 3D printing. The switching may be controlled (e.g., manually and/or automatically using controller(s)). The switching may be between a distal container containing debris to a distal container devoid of debris. The switching may be between a full distal container with an empty distal container. Alternating may comprise dis-engaging a first distal container from the filtering container, which may include a filter, a centrifuge, or a cyclonic separator. Switching (e.g., alternating) may comprise engaging a second distal container with the filtering container. Alternating may comprise controlling one or more valves and/or ports. Alternating may comprise detecting a status of a first distal container, for example, by reading signals from one or more sensors (e.g., loadcell). The alternating process may comprise (i) sensing a physical property (e.g., accumulated debris level in the distal container, clogging, gas velocity, rate of gas flow, direction of gas flow, rate of mass flow, direction of mass flow, temperature, reactive agent level, weight, and/or gas pressure) related to the first distal container, (ii) engaging the second distal container with the filtering container (e.g., through the physical adapter), (iii) optionally storing the disengaged first distal container, (iv) optionally passivating the debris collected in the first distal container, and (v) disposing of the first distal container and/or the debris within the first distal container. Operations (i)-(v) may be performed in any order and/or sequence, for example, sequentially. At least two of operations (i)-(v) may be performed in parallel. At least two of operations (i)-(v) may be performed sequentially. In some embodiments, the filtering container is reconditioned. Reconditioning the filtering mechanism may comprise removing the filtering container from the gas conveyance system. Reconditioning the filtering mechanism may comprise drenching the filter and/or debris within the container. Drenching may comprise inserting a cleaning material (e.g., liquid, gas, semi-solid, and/or any other cleaning medium) into the filter. Drenching may be performed before, after, or during removal of the filter from the filtering container. Drenching may be performed before, after, or during the 3D printing. Replacing the first filtering mechanism may be performed when the second filter mechanism is in operation (e.g., during the 3D printing). Replacing may comprise replacing a canister. Replacing may comprise replacing the filter. Engaging and/or dis-engaging the filtering mechanism may comprise opening and/or closing one or more valves. Engaging and/or dis-engaging the filtering mechanism may be performed manually and/or automated (e.g., controlled). Engaging and/or dis-engaging the plurality of filtering mechanisms (e.g., plurality of canisters and/or filters) may be performed sequentially and/or in parallel. Any of the operations (i)-(v) may be performed sequentially or in parallel. In some embodiments, disengaging the filtering container that is integrated into the gas flow mechanism is performed when the 3D printing does not take place in the 3D printing system of which the gas flow mechanism is part of.

In some embodiments, the filtering mechanism is operatively coupled with a pump. The pump may facilitate the flowing of gas (e.g., filtered gas) into the processing chamber and/or through the gas flow mechanism. The pump may facilitate recycling of gas (e.g., filtered gas) into the processing chamber and/or through the filter mechanism(s). The pump may control a property of gas flow (e.g., rate of flow, velocity of gas, and/or pressure of gas). At times, the pump may control a property of the gas-borne material (e.g., velocity, and/or acceleration thereof, in at least one component of the gas flow mechanism). The pump may be located adjacent to the filtering mechanism, ancillary chamber, and/or the processing chamber. The pump may be located below, above, and/or adjacent to a side of the ancillary chamber. The pump may be located below, above, and/or adjacent to a side of the processing chamber, e.g., with respect to a gravitational center. The pump may facilitate maintaining a gas pressure within at least a portion of a gas flow mechanism of the 3D printer. The gas flow mechanism may comprise the processing chamber, the ancillary chamber, the build module, the first filtering mechanism, and/or the second filtering mechanism. The gas pressure may be controlled (e.g., to limit an ingress of atmosphere into at least one component of the gas flow mechanism). Controlling may comprise limiting occurrence of a negative pressure with respect to the ambient pressure, in at least one section of the gas flow mechanism. For example, controlling may comprise preventing formation of a negative pressure (with respect to the ambient pressure) in at least one section of the gas flow mechanism. For example, controlling may comprise preventing formation of a negative pressure (with respect to the ambient pressure) in the gas flow mechanism. The section(s) of the gas flow mechanism may comprise an area enclosing the pump (e.g., behind the pump relative to a direction of the gas flow). Controlling may comprise raising pressure (e.g., the pressure of the recirculating gas in the gas flow mechanism) within the gas recirculation system. The pressure may be raised such that there may be (e.g., substantially) no negative pressure within the gas flow mechanism, with respect to the ambient pressure. For example, the pressure in the area enclosing the pump may be at a positive pressure with respect to the ambient pressure, and the pressure within the gas recirculation system may be above the pressure in the area enclosing the pump (e.g., the area just behind the pump). At times, the gas flow pressure within the processing chamber and the pressure directly adjacent to the pump may be different. The raised pressure may be at least about 1 pound per square inch (psi), 2 psi, 3 psi, 4 psi, 5 psi, 6 psi, 7 psi, 8 psi, 9 psi, or 10 psi above the ambient pressure. The raised pressure may be any value between the aforementioned values, for example, from about 1 psi to about 10 psi, or from about 1 psi to about 5 psi. The raised pressure may be the pressure directly adjacent to the pump (e.g., behind the pump). The raised pressure may be the average pressure in the gas flow mechanism.

In some embodiments, a flow of a reactive agent (e.g., a reactive gas, such as an oxidizing gas) can cause the gas-borne material to react violently (e.g., react in a hazardous, dangerous, and/or perilous manner with respect to personnel and/or equipment). The violent reaction may comprise combustion, ignition, flaring, fuming, burning, bursting, explosion, eruption, smelting or flaming. The violent reaction may be exothermic. The violent reaction may be oxophilic. The violent reaction may be difficult to contain and/or control once it initiates. The violent reaction may be thermogenic. The violent reaction may exert heat. The violent reaction may comprise oxidation. The 3D printing system may comprise purging. Purging may (e.g., substantially) reduce the likelihood (e.g., prevent) that the gas-borne material violently reacts, e.g., during the 3D printing. Purging may comprise evacuation of a gas (e.g., comprising the reactive agent) from one or more segments (e.g., a processing chamber, an ancillary chamber, a build module, and/or a filtering mechanism) of the 3D printing system. Purging may comprise evacuation of a gas (e.g., comprising a reactive agent) from one or more segments of the gas flow mechanism. A segment may include a compartment (e.g., processing chamber, ancillary chamber, a build module, and/or a filtering mechanism) and/or a channel (e.g., a gas conveying channel, and/or a pre-transformed material conveying channel). Purging may be performed on an individual (e.g., isolatable) segment of the 3D printing system; for example, purging of the distal container and/or filtering adapter (e.g., physical adapter). The isolatable segments may be physically isolated from the gas flow mechanism. The isolatable segments may be fluidly isolated from the gas flow mechanism (e.g., by shutting one or more valves). Purging may be performed on selectable segments of the 3D printing system. Purging may be performed on all segments of the 3D printing system. Purging may be performed individually and/or collectively. Purging of at least two segments may be performed in parallel. Purging of at least two segments may be performed sequentially. Purging may comprise exchanging large quantities of gas in a short amount of time.

In some embodiments, a reactive agent (e.g., oxygen) flows into the gas flow mechanism or any of its components at a maximal rate (e.g., during, or after the 3D printing). A component of the gas flow mechanism may be the filtering mechanism (e.g., including the filtering container, physical adapter, and distal container). For example, the reactive agent may flow into the distal container during passivation. For example, the reactive agent may flow into the gas flow mechanism (or any portion thereof) at a rate of at most about 5*10⁻² liters per minute (L/min), 10⁻² L/min, 5*10⁻³ L/min, 10⁻³ L/min, 5*10⁻⁴ L/min, 5*10⁻⁴ L/min, 5*10⁻⁵ L/min, 10⁻⁵ L/min, 5*10⁻⁶ L/min, or lower. The reactive agent may flow into the gas flow mechanism any rate between the aforementioned rates (e.g., from about 5*10⁻² L/min to about 5*10⁻⁶ L/min, or from about 10⁻³ L/min to about 10⁻⁵ L/min). For example, the reactive agent may flow into the distal container (e.g., during passivation) at a rate of at least about 10⁻² L/min, 5*10⁻² L/min, 10⁻¹ L/min, 5*10⁻¹ L/min, or higher.

In some embodiments, the likelihood of the violent reaction is a combination of the velocity of gas, gas temperature, gas pressure, concentration of the reactive agent, concentration of the gas-borne material, or any combination thereof. In an example, in an elevated level of the reactive agent in the one or more segments (at a temperature and pressure), the purging may comprise slow gas flow (e.g., excluding use of a pump). When the reactive species and/or gas-borne material is lowered below a threshold value (at the temperature and pressure), purging may comprise faster gas flow (e.g., using a pump that facilitates the faster flow of the gas). The slow gas flow may reduce the likelihood (e.g., prevent) of a violent reaction of the reactive agent with the gas-borne material (when the reactive agent and/or gas-borne material concentration is height). In reduced levels of the reactive agent and/or gas-borne material (e.g., in the temperature and pressure), faster gas flow velocity may be (e.g., substantially) safe to use as the chance of a violent reaction of the reactive agent with the gas-borne material is lowered. Purging can be performed (i) without engaging the pump, (ii) while engaging the pump, (iii) or any combination thereof. When at most a requested low level of the reactive agent is present in the gas flow mechanism, purging ceases, and the gas flow mechanism engages in a maintenance mode. In some embodiments, at most a requested low level of the reactive agent is present, and purging is not required. In some embodiments, purging is initiated after the maintenance mode is engaged, for example, when the level of the reactive agent and/or gas-borne material exceeds a minimum level (e.g., that increases the chance for the violent reaction). In some embodiments, the gas flow mechanism may switch between the purging mode(s) and maintenance mode, depending on the level of the gas-borne material and/or reactive agent. Example of purging operations, controller(s), 3D printers, and associated methods, software, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, a segment is operatively coupled with one or more valves. The valve may facilitate adequate (e.g., minimal) use of gas within one or more segments of the 3D printing system. The valve may facilitate flow of gas through the valve (e.g., FIGS. 13, 1310, 1320, and/or 1362), connection of one or more segments, and/or disconnection of one or more segments. The valve may facilitate insertion of a (e.g., requested) gas into a segment of the gas flow mechanism (e.g., a gas purge inlet valve, FIGS. 13, 1355, 1365, and/or 1330). The valve may facilitate discharge of a (e.g., contaminated) gas from the segment (e.g., a gas purge vent valve, FIGS. 13, 1375, and/or 1335). The valve may facilitate controlling a physical property (e.g., atmosphere, pressure, temperature and/or reactive agent level) within the segment, for example, using a modulating valve, e.g., outlet modulating valve 1345, and/or inlet modulating valve 1325. At least two valves in the gas flow mechanism may have a different cross-section. At least two valves in the gas flow mechanism may have the same cross section. The valves may be manually and/or automatically controlled. The valves may be controlled based on a signal from one or more sensors and/or controller. Valves may be controlled (e.g., opened, closed and/or adjusted) before, during, and/or after the 3D printing. At least one of the valve may comprise a valve status (e.g., on/off) sensor. At least one of the valve may be devoid of a valve status (e.g., on/off) sensor. The valve may facilitate flow from one input channel into one output channel. FIG. 13 shows an example of valve 1362 receiving input flow from segment 1381 and controlling output flow 1382 through valve 1362. The valve may facilitate flow from one channel into more than one output channel. The valve may be a split valve. FIG. 13 shows an example of valve 1362 receiving input flow from segment 1381 and controlling output flow 1383a and 1383b through valve 1362. In FIG. 13, output flows 1383a-b are alternates to output flow 1382, and valve 1362 represents two alternate valves: (i) controlling a junction having multiple output channels, or (ii) controlling a junction having a single output channel.

In some embodiments, one or more segments of the gas flow mechanism may be operatively (e.g., physically and/or flowable) coupled with the processing chamber. The coupling may be direct and/or indirect. The coupling may be through a channel (e.g., through a gas conveying, a material conveying channel, and/or a physical adapter). Examples of indirect coupling include coupling through an atmosphere in the segment. For example, an atmosphere of the processing chamber may be coupled with an opening in at least one component of a layer dispensing mechanism (e.g., recoater), the layer dispensing mechanism may be in turn coupled with a pre-transformed material conveyance system, e.g., that comprises a bulk reservoir. The pre-transformed material conveyance system may be any pre-transformed material conveyance system. Examples of 3D printers and their components (e.g., material conveyance system), associated methods, apparatuses, software, systems, and devices can be found in International Patent Application Serial No. PCT/US18/24667, filed Mar. 27, 2018, titled “MATERIAL MANIPULATION IN THREE-DIMENSIONAL PRINTING,” which is entirely incorporated herein by reference. A material removal mechanism opening may be opened into the processing chamber atmosphere. For example, a material dispenser exit opening may be opened to the processing chamber atmosphere and thus fluidly connect the material conveyance mechanism to the gas flow mechanism. The one or more segments may include a segment that comprises a gas-borne material. A reactive agent (e.g., reactive species such as an oxidizing gas) within the at least one segment of the gas flow mechanism (e.g., filtering mechanism) may be operatively coupled (e.g., fluidly connected and/or shared) with the pre-transformed material conveyance system. The flow of gas-borne material within one or more segments of the 3D printing system may violently react with the reactive agent. To reduce the likelihood of (e.g., prevent) the violent reaction (e.g., to ensure safety of the 3D printing system and/or personnel), purging may be performed within the one or more segments of the gas flow mechanism.

In some embodiments, the gas flows at a speed in the processing cone and/or processing chamber. The gas flow may be from one end of the processing chamber to its opposing end. The gas flow may be from one end of the processing cone to its opposing end. The gas may flow laterally. At least a portion of the gas flow may be horizontal. At least a portion of the gas flow may be laminar. The (e.g., average or mean) speed of the gas flow may be at least about 10 millimeters per second (mm/sec), 20 mm/sec, 50 mm/sec, 80 mm/sec, 100 mm/sec, 200 mm/sec, 400 mm/sec, or 500 mm/sec. The (e.g., average or mean) speed of the gas flow may be at most about 20 mm/sec, 50 mm/sec, 80 mm/sec, 100 mm/sec, 200 mm/sec, 4000 mm/sec, or 600 mm/sec. The (e.g., average or mean) speed of the gas flow may be at any value between the afore-mentioned values (e.g., from about 10 mm/sec to about 600 mm/sec, from about 10 mm/sec to about 300 mm/sec, or from about 50 mm/sec to about 200 mm/sec).

In some instances, the atmosphere (e.g., comprising a gas) is exchanged (e.g., during the 3D printing or a portion thereof). Exchanged may comprise changing the position of one or more atmospheric components (e.g., gas and/or debris). In some examples, the time it takes for an atmospheric component to leave the processing cone and/or chamber is at most about 1 second, 2 sec, 5 sec, 8 sec, 10 sec, 15 sec, 20 sec, 30 sec, 50 sec, 1 min, 5 min, 10 min, or 30 min. In some examples, the time it takes for an atmospheric component to leave the processing cone and/or chamber is of any time values between the afore-mentioned values (e.g., from about 1 sec to about 30 min, from about 1 sec to about 30 sec, from about 1 sec to about 15 sec, or from about 5 sec to about 1 min). In some embodiments, the gaseous atmosphere is flowing during at least a portion of the 3D printing. The gaseous atmosphere may flow at a rate of at least about 10 cubic feet per minute (CFM), 20 CFM, 30 CFM. 50 CFM, 80 CFM, 100 CFM, 300 CFM, 500 CFM, 800 CFM, 1000 CFM, or 3000 CFM. The gaseous atmosphere may flow at a rate between any of the afore-mentioned rates (e.g., from about 10 CFM to about 3000 CFM, from about 1° C. FM to about 1000 CFM, or from about 100 CFM to about 500 CFM). The gaseous atmosphere may be translated by a pump (e.g., a blower).

In some examples, the processing cone and/or processing chamber is devoid of standing vortices, and/or turbulence that are larger than a threshold value. For example, the processing cone and/or processing chamber may be devoid of standing vortices, and/or turbulence that have a FLS of at least about 0.25 millimeter (mm), 0.5 mm, 1 mm, 2 mm, 5 mm, 10 mm, 15 mm, 20 mm, or 50 mm. The processing cone may be devoid of standing vortices, and/or turbulence that have a FLS greater than any value between the afore-mentioned values (e.g., from about 0.25 mm to about 50 mm, from about 0.5 mm to about 20 mm, or from about 1 mm to about 20 mm). In some embodiments, the processing chamber and/or processing cone may be (e.g., substantially) devoid of standing vortices and/or turbulence. The standing vortex may be horizontal, angular, and/or angled.

In some embodiments, a non-gaseous material is disposed in the atmosphere. The material may comprise debris (e.g., soot), or pre-transformed material (e.g., powder). The material may be dispersed in the atmosphere of the processing chamber and/or cone. The debris may be ejected to the atmosphere of the processing chamber and/or cone during at least a portion of the 3D printing. In some embodiments, most of the material that is ejected during the 3D printing is evacuated by the gas flow. Most of the evacuated material may be at least about 70%, 80%, 90%, 95%, 98%, or 99% of the total material (percentages are volume per volume). Substantially all the material may be any value between the afore-mentioned values (e.g., from about 70% to about 99%, from about 80% to about 99%, or from about 90% to about 99%).

In some embodiments, during at least a portion of the 3D printing, pre-transformed material is transformed (e.g., using an energy beam). The transformed material may transfer to the atmosphere of the processing cone and/or processing chamber (e.g., as debris and/or plasma). At times, at least a portion of the material that transfers to the atmosphere may have a (e.g., average or mean) FLS of at most about 20 micrometers (μm), 15 μm, 10 μm, 8 μm, 5 μm, 4 μm, 3 μm, 2 μm, 1 μm, or 0.5 μm. At least a portion of the material that transfers to the atmosphere may have a (e.g., average or mean) FLS of any value between the afore-mentioned values (e.g., from about 15 μm to about 15 μm, from about 15 μm to about 15 μm, from about 15 μm to about 15 μm, from about 15 μm to about 15 μm). The portion of the material that transfers to the atmosphere having the above-mentioned (e.g., average or mean) FLS, may be at least about 70%, 80%, 90%, or 95% of the total material that transfers to the atmosphere (e.g., debris ejected by the vaporization of the transformed material, e.g., using the energy beam). The portion of the material that transfers to the atmosphere (e.g., the gas borne material) may be carried by the gas flow.

In some embodiments, the atmosphere of the processing cone and/or chamber comprises debris. The debris may be at most 100 ppm, 50 ppm, 10 ppm, 5 ppm, 1 ppm, 500 ppb, 250 ppb, 150 ppb, 100 ppb, or 50 ppb of the volume of the processing cone and/or chamber (calculated weight per weight). The debris may be a portion of the volume of the processing cone and/or chamber (calculated weight per weight) between any of the afore-mentioned values (e.g., from about 100 ppm to about 50 ppb, from about 10 ppm to about 50 ppb, from about 5 ppm to about 50 ppb, or from 1 ppm to about 50 ppb).

In some embodiments, pre-transformed material and/or debris is ejected into the atmosphere of the processing chamber and/or processing cone during at least a portion of the 3D printing. In some embodiments, at least a portion of the ejected material (comprising debris) remains in the processing cone and/or processing chamber for at least about 0.1 second (sec), 0.2 sec, 0.5 sec, 1 sec, 5 sec, 10 sec, 30 sec, 50 sec, or 80 sec. In some embodiments, the at least a portion of the ejected material remains in the processing cone and/or processing chamber for any time period between the above-mentioned time periods (e.g., from about 0.1 sec to about 80 sec, from about 0.5 sec to about 10 sec, from about 0.1 sec to about 5 sec, or from about 0.1 sec to about 10 sec). The at least a portion of the ejected material that remains in the processing chamber and/or cone (e.g., for the above-mentioned time (periods)) may be at most about 0.001%, 0.005%, 0.01%, 0.05%, 0.1%, 0.5%, or 1% of the total ejected material (calculated either volume per volume or weight per weight).

In some embodiments, the gas flow mechanism comprises at least one sensor (e.g., FIGS. 13, 1390, 1395, 1391, 1396, 1370, 1380, 1385, 1390, 1395, 1315 and 1316). The sensor may (e.g., continuously) operate during at least a portion of the 3D printing process. The sensor may be controlled (e.g., manually and/or automatically). For example, the sensor may be activated and/or de-activated by a controller. The sensor may be placed between the enclosure and the recycling system. The sensor may be placed within the enclosure. The sensor may be placed between the inlet portion and the processing chamber. The sensor may be placed between the outlet portion and the processing chamber. The sensor may comprise pressure sensors, position sensors, velocity sensors, optical sensors, mass flow sensors, gas flow sensors, motion sensors, thermal sensors, pressure transducers, or any other sensor mentioned herein.

In some embodiments, the controller(s) is operatively coupled with any system, mechanism, device, or apparatus disclosed herein (or any of their components). The term “operatively coupled” or “operatively connected” refers to a first mechanism that is coupled (or connected) to a second mechanism to allow the intended operation of the second and/or first mechanism.

In some embodiments, the gas flow mechanism includes at least one controller (e.g., a variable frequency driver) to control the gas flow rate. The gas flow mechanism may sense the rate of gas flow and/or the rate of mass flow. Gas flow sensor(s) may comprise sensing the volumetric flow of gas. Mass flow sensor(s) may comprise sensing the mass flow of gas. Based on the sensed rate, the controller may direct the inlet portion and/or outlet portion to alter the amount of gas flow. The alteration of the gas flow may comprise (i) closing an opening at least in part, (ii) reshaping the opening, (iii) changing a position of a ledge, or (iv) changing a position of a baffle. At least one characteristic of gas may be controlled. The at least one characteristic of gas can include pressure, temperature, acceleration, and/or velocity. Based at least in part on the sensed property(ies) of the sensed gas, the property(ies) of gas that exits the recycling mechanism may be altered. Altered may comprise increasing the gas velocity. Altered may comprise decreasing the gas velocity. Altered may comprise statically or dynamically altering the property(ies) of the gas. For example, altered may comprise statically setting the velocity of the gas. For example, altered may comprise dynamically changing the velocity of the gas (e.g., based on a sensed gas value). The dynamic change may comprise utilizing a closed loop control scheme. The dynamic change may comprise utilizing a feedback loop control scheme. The dynamic change may comprise comparison to a threshold (e.g., value or function). Altered may comprise statically setting the threshold. Altered may comprise dynamically changing the threshold.

In some embodiments, the gas flow mechanism comprises a sensor (e.g., optical sensor) that senses a composition of gas. The sensor may be operatively coupled with a gas filtering mechanism. The sensor may sense impurities and/or reactive agent(s) (e.g., oxygen, and/or water) of the gas (e.g., gas mixture). The sensor may sense reactive species (e.g., oxidizing gas, water) within the gas (e.g., gas mixture). The gas may be reconditioned based on the sensed impurities and/or reactive species (also referred to herein as “reactive agents”).

In some embodiments, the gas flow mechanism comprises at least one sensor that senses the amount of debris in the enclosure. For example, the sensor may be an optical sensor. For example, the sensor may be a plasma sensor. The sensor may be a spectroscopic sensor. The sensor may be operatively coupled with the pump, the gas channel (e.g., the physical adapter), and/or to the valve. At least one controller may control the velocity of at least one gas stream (e.g., within the multiplicity of incoming gas streams to the processing chamber). The control(s) may take into account (e.g., consider) a signal from the sensor. For example, when the enclosure contains a large amount of debris (e.g., compared to a threshold), the controller(s) may direct a stronger flow of the gas at least into the processing cone (e.g., into the enclosure). For example, when the enclosure contains a small amount of debris (e.g., compared to the threshold), the controller(s) may direct a softer flow of the gas at least into the processing cone (e.g., into the enclosure). The at least one sensor may sense a debris in a portion of the enclosure (e.g., in the processing cone) and/or other parts of the gas conveyance system. The at least one sensor may comprise a plurality of sensors. At least one controller may individually control the velocity of at least two of a plurality of gas streams (e.g., within the multiplicity of incoming gas streams to the chamber). At least one controller may (e.g., collectively) control the velocity of at least two of a plurality of gas streams (e.g., within the plurality of incoming gas streams to the chamber). At times, at least two gas streams are controlled by separate controllers (e.g., that makeup a control system). At times, at least two gas streams are controlled by the same controller. The control may take into account a signal from the sensor which provides information on the concentration, type, and/or location of the debris in the 3D printing system, such as in the processing chamber (e.g., in the processing cone). For example, the processing cone may contain a large amount of debris in a first enclosure atmosphere location and a small amount of debris in a second enclosure atmosphere location, the controller may direct a stronger flow of the gas to the first location and a softer stream of gas to the second location. The first and second atmosphere locations may differ in their horizontal and/or vertical position. A decision regarding removal of the distal container from the filtering mechanism may take into account the sensed amount of debris in the gas conveyance system (e.g., in the gas conveyance channels and/or in the processing chamber such as in the processing cone).

In some embodiments, the controller(s) adjusts the relative flow of the individual gas streams based at least in part on a debris in a position in at least the atmosphere of the processing chamber (e.g., in the enclosure) and/or gas conveyance channel(s). For example, when the enclosure contains debris that slows down the flow of a gas stream, the controller may direct an increase of the flow of that gas stream (e.g., to that position), and/or slowing down the gas flow in adjacent gas streams (e.g., to direct the debris towards that adjacent gas streams). For example, when the enclosure contains debris that absorbs and/or deflects the energy beam that is directed towards the material bed (e.g., FIG. 4, 404), the controller may direct an increase of the flow of that gas stream (e.g., to that position), and/or slow down the gas flow in adjacent gas streams (e.g., to direct the debris towards that adjacent gas streams).

In some embodiments, the gas flow mechanism comprises one or more valves and/or gas apertures (e.g., gas opening-ports). The valve and/or a gas aperture may be disposed adjacent to the recycling system. The valve and/or a gas aperture may be disposed adjacent to the pump. The valve and/or a gas aperture may be disposed between the processing chamber and the recycling system. The valve and/or a gas aperture may be disposed adjacent to the inlet portion. The valve and/or a gas aperture may be disposed adjacent to the outlet portion. FIG. 13 shows an example of valves (e.g., 1310, 1320). The gas may travel (e.g., enter and/or exit) through the valve. The valve may control the amount, and/or direction of gas flow through it. The valve may control if a gas does or does not flow through it. For example, the gas may enter or exit one or more components of the 3D printing system (e.g., the build module, processing chamber, and/or gas conveying channel, filtering mechanism (e.g., any component thereof)) through the valve. The valves may control (e.g., regulate) the flow of gas to and/or from a compartment. The compartment may comprise the enclosure, pump, or the recycling mechanism. The valves may comprise a pneumatic control valve, butterfly valve, vent valve, wired valves, wireless valves, manual valve, automatic valve, or any combination thereof. The valves may isolate the filter from the enclosure and/or pump. Examples of valves comprise butterfly valve, relief valve, ball valve, needle valve, solenoid valve, leak valve, pressure gauge, or a gas inlet. The valve may comprise any valve disclosed herein. The valve may be controlled manually and/or electronically (e.g., by a controller). The control of the valve may be during at least a portion of the 3D printing.

In some cases, a 3D printing system includes features that cooperate with or compensate for certain flow dynamics of gas within an enclosure. At times, a power density of an energy beam that reaches a target surface can be altered (e.g., reduced), e.g., due to being absorbed by and/or reflected from gas-borne debris (e.g., soot) that is generated during a 3D printing. The target surface may comprise an exposed surface of a material bed, or an exposed surface of a 3D object. The gas-borne debris may deposit onto at least one surface within the enclosure (such as surfaces of an optical window) which deposited debris can reduce a power density of the energy beam that reaches the target surface. Providing a gas flow across the target surface (an exposed (e.g., top) surface of a material bed) may be used to alter (e.g., lessen) a concentration of the debris within at least a portion of the processing chamber during, before, and/or after a 3D printing (e.g., in a controlled manner).

In some embodiments, the 3D printer comprises gas flow in the processing chamber. The gas flow can be before, after, and/or during the 3D printing. The gas flow can be controlled manually and/or automatically. The automatic control may comprise using one or more controllers, e.g., as described herein.

In some embodiments, one or more characteristics of gas-borne debris are measured (e.g., in situ and/or in real time, e.g., during the 3D printing). For example, the debris may flow in at least a portion of the 3D printing system, such as a gas conveyance channel, or the processing cone (in the processing chamber). The debris velocity can be measured using any suitable device(s). For example, a device that articulates a triangulation measurement method. The device may comprise one or more sensors. The one or more sensors may comprise an optical sensor (e.g., a digital camera device, a single pixel detector, a detector that detects a range of wavelengths, a single wavelength detector, or a spectrometer). The one or more sensors may be configured to measure the one or more energy beams (or their respective reflections). For example, a plurality of energy beams (e.g., two or more lasers) can be directed in a region within the processing cone (e.g., within the processing chamber). The one or more sensors may be operatively coupled with the plurality of energy beams (e.g., respectively). In some examples, one sensor is coupled with at least two energy beams. In some examples, at least two of the energy beams are each coupled with its own (different) sensor. In some embodiments, at least one, two, or three of the plurality of energy beams are stationary during the measurement. The radiation of the energy beam may comprise continuous or discontinuous (e.g., pulsing) radiation. In some embodiments, at least one, two, or three of the plurality of energy beams are moving during the measurement. The movement of the at least one of the plurality of energy beams may comprise linear or curved movement. The movement of the at least one of the plurality of energy beams may comprise continuous or discontinuous (e.g., pulsing) movement. The movement may be along a (e.g., predetermined) path. The movement velocity may comprise a constant or varying velocity. In some examples, a first beam and a second beam may travel in the processing chamber (e.g., atmosphere thereof) towards a target surface. For example, during the measurement, the first energy beam can be stationary at a position, while the second energy beam can be move along a trajectory (e.g., in a circular motion) in the vicinity (e.g., around) that position. The first and/or second energy may interact and/or react with a debris during the measurement. The interaction may comprise reflectance, absorbance, or a photochemical reaction. The interaction may induce a change in that energy beam (e.g., or to its reflection). For example, a change in intensity, direction, and/or wavelength of the energy beam. The one or more sensors may sense (e.g., a difference in) a signal from the first energy beam (or its reflection) and a signal from the second energy beam (or its reflection). The sensed signals may be compared to each other (e.g., using a processor) and produce a result. For example, the first energy beam (or its reflection) may be compared with the second energy beam (or its reflection) and produce a result. The processor and the one or more sensors may be used to determine an amount (e.g., via density or concentration measurement(s)) and/or a velocity of debris particles within, for example, a processing cone of the energy beam. A detection system (e.g., comprising the one or more sensors) can detect at least one difference in the optical property(ies) of each of the plurality of energy beams, to determine a velocity and/or material properties of debris in that position and/or that vicinity. The optical properties may correspond to a reflectance, or absorbance of an energy beam that interacts with the (e.g., moving) debris. The optical properties may comprise intensity, wavelength, etc. Examples of 3D printers, various sensors, detectors and components thereof, associated methods, apparatuses, software, devices, and systems, can be found in International Patent Application Serial No. PCT/US15/65297, filed Dec. 11, 2015, titled “FEEDBACK CONTROL SYSTEMS FOR THREE-DIMENSIONAL PRINTING,” which is incorporated herein by reference in its entirety.

In some embodiments, the flow dynamics of the gas as it exits a gas inlet portion and directed over a target surface, is controlled. For example, turbulence of the flow of gas from the gas exit port can be reduced using a flow aligning structure (also referred to herein as flow aligner). The flow alignment structure can be more proximate to the platform than the baffle(s). The flow alignment structure can be more proximate to the outlet port of the gas inlet portion than the baffle(s). The flow alignment structure can direct gas within the gas inlet portion toward the outlet port or include the outlet port. In some embodiments, the flow aligning structure is part of (e.g., within) an outlet port section of the gas inlet portion. The outlet port section can have an elongated shape (e.g., in accordance with an elongated shape of the outlet port. FIG. 12 shows examples of perspective views of flow aligning structures 1200 and 1220, respectively, in accordance with some embodiments. The flow aligning structure (e.g., 1200 or 1220) can include flow aligning walls (e.g., 1202 or 1222) (which can be referred to as walls, partitions, separators, dividers, or other suitable term), which walls can at least partially define flow aligning passages (e.g., 1204 or 1224) that are configured to allow gas to flow therethrough. The flow aligning passages can be referred to as channels, tunnels, elongated holes, elongated openings, conduit, pipe, tube, or other suitable term. The flow aligning passages can run lengthwise in accordance with a flow gas (e.g., in the X direction in FIG. 12) such that flow aligning walls (e.g., 1202 or 1222) can reduce gas flow widthwise and/or height-wise (e.g., in Y and Z directions in FIGS. 12A, and 12B), thereby channeling gas flow along their lengthwise direction (e.g., in the X direction of FIG. 12 (e.g., direction 1206 or 1226 respectively)). The walls of the flow aligning structure can align different portions of the flow gas in accordance with a requested (e.g., desired) direction (e.g., X direction). The length of the flow aligning structure (e.g., 1 in each of 1200 and 1220 of FIG. 12) can vary. In some embodiments, length of the flow aligning structure (e.g., comprising the flow aligning channels) is in accordance with a length of the gas exit port. In some embodiments, a length of the flow aligning structure (e.g., as measured from a top of the target surface (e.g., material bed) to a top of the flow aligning structure) is at most about 5″ (inches), 4″, 3″, 2″, 1″, or 0.5″. In some embodiments, the height of the flow aligning structure ranges between any of the afore-mentioned heights (e.g., between 0.5″ and 5″, between 0.5″ and 3″, or between 3″ and 5″). The number and shape of the channels of the flow aligning structure can vary. In some embodiments, flow aligning passage has a polygonal (e.g., hexagonal) cross sections (e.g., as shown in the example of FIG. 12, 1200). The polygon may be a space filling polygon. The flow aligning passage may comprise a prism, a cone, or a cylinder. The prism may comprise a polygonal cross section (e.g., any polygon described herein). The flow aligning passages can (i) have a cross section that facilitates, and/or (ii) can be packed in, a space-saving configuration that maximizes the cross-sectional area of flow aligning passages (e.g., in a direction perpendicular to the direction of flow). In some embodiments, the flow aligning passage may have a round cross section (e.g., as shown in FIG. 12, 1226), thereby forming flow aligning passage having corresponding round cross sections (e.g., a cylindrical shaped passage)—which may be packed in a space saving configuration (e.g., cubic closed packed, a.k.a., face-centered cubic configuration). In some embodiments, a ratio of the total cross sectional area of flow aligning passages is at least about 80%, 85%, 90%, 94%, 95%, 96%, 98, or 99% of a respective total cross sectional area of the flow aligning structure (e.g., which includes the thicknesses of the flow-aligning walls). It should be noted that the flow aligning structures described herein is not limited to honeycomb shaped or cylindrical shaped flow aligning walls and/or passages. That is, the flow aligning structures can have flow aligning walls and/or passages having any suitable 3D shape or combination of shapes (e.g., polyhedron, prism, cone (e.g., having an elliptical base, e.g., circular base), cylinder (e.g., right elliptical cone, e.g., right circular cone), pyramid (e.g., having a polygonal base), or any combination thereof). For example, the flow aligning walls and/or passages can have any suitable 3D or cross-sectional shape described herein with reference to FIGS. 10A-10B. Furthermore, flow aligning structures described herein can have any suitable number of passages (e.g., channels), and walls having any suitable thickness. In some embodiments, the flow aligning structure comprises a (e.g., substantially) two-dimensional structure that amounts to a mesh structure or plate that includes perforations (i.e., a perforated plate) for allowing gas to flow therethrough. In some embodiments, more than one flow aligning structure is used in combination.

As described herein, the gas inlet portion of the 3D printing system can include flow aligning structures that align (e.g., straighten) the flow of gas as it exits the gas inlet portion and/or enters the processing chamber. In some embodiments, the flow aligning structure is not limited to being within an outlet port section. It should be noted that the various embodiments of structures, features, and mechanisms of 3D printing systems described herein can be combined in any suitable arrangement. For example, a gas inlet portion can include features that direct gas flow toward a target surface, e.g., a surface of a material bed; as well as gas flow channeling structures such as baffles (e.g., FIG. 11, 1120) and/or flow straighteners (e.g., FIG. 12) described herein. As another example, a unidirectional window purging system can be combined in any suitable way with a window recessed portion and/or a window housing. As another example, gas outlet portions can be combined in any suitable way with any feature of a gas inlet portion (e.g., FIG. 12). That is, the various advantages provided by individual structures, features, and mechanisms described herein can be combined an any suitable way within a 3D printing system. The outlet portion may be separate from the processing cone portion of the processing chamber by one or more baffles (e.g., FIG. 14, 1451a and 1451b) or one or more screens (e.g., FIG. 4, 471). FIG. 12 shows an example of gas flow channeling structure 1200 that comprises closed packed hollow hexagonal prisms such as 1204 having length (l) 1202. Gas can flow through structure 1200 in the direction 1206, or in a direction opposing to 1206. FIG. 12 shows an example of gas flow channeling structure 1220 comprising closed packed hollow cylinders disposed in a closed packed (e.g., face center cubic) arrangement, which cylinders have a length 1222 (l), and a circular cross section 1224. Gas can flow through structure 1220 in the direction 1226, or in a direction opposing to 1226.

The one or more channels in the aligning structure may be configured and/or adjusted to facilitate a gas flow trajectory (e.g., alignment), velocity, chemical makeup, or temperature of the gas flow. The velocity and/or trajectory, may of the gas flow expelled from the aligning structure may minimally alter the target surface. For example, the temperature of the one or more channels may adjust (e.g., heat or cool) during the passing of the gas flow adjacent thereto. For example, the temperature of the gas flow may adjust (e.g., heat or cool) during its passage through the aligning structure. The adjustment may be before, after, and/or during at least a portion of a 3D printing operation (e.g., during a period when the energy beam irradiates the material bed, or when no energy beam irradiates a material bed). The adjustment may be controlled manually and/or automatically (e.g., using a controller). In some embodiments, one or more channels in the aligning structure are exchangeable, movable, expandable, and/or contractible. In some cases, the channel(s) are heated and/or cooled. In some embodiments, the one or more channels comprise a desiccant (e.g., molecular sieves or silica). The desiccant may be covalently bound, or adhered, to an interior surface of the one or more channels. The desiccant may be embedded in a matrix that is casted onto the internal surface of the one or more channels. In some cases, the one or more channels may be operatively coupled with one or more sensors (e.g., humidity, temperature, and/or oxygen sensors) for measuring characteristics of the gas flow within the aligning structure. The one or more channels may be operatively coupled with one or more sensors. The one or more sensors may comprise humidity, temperature, or oxygen sensors.

As described herein, gas-borne debris (e.g., soot or powder) may be present in a processing chamber during a 3D printing operation. In some cases, the gas-borne debris can interfere with the efficacy of the energy beam (e.g., laser or electron beam) used to transform pre-transformed material of a material bed. For example, the gas-borne debris can encroach an area near a window (sometimes referred to as an optical window) through the energy beam passes into the processing chamber, and/or can deposit on an internal surface of the window. The debris can attenuate the power density of the energy beam as it travels in towards the target surface. In some embodiments, the 3D printing systems described herein include structures and/or mechanisms to reduce an amount of gas-borne debris near one or more optical windows and/or adhere thereto.

The 3D printing system can include at least two energy beam sources: a first energy beam source and a second energy beam source which are each configured to generate corresponding energy beams. At times, there may be at least 2, 4, 5, 6, 8, 10, 12, 24, or 36 energy sources, each generating an energy beam that participates in the 3D printing. Optical mechanisms can be used to control aspects of the energy beams (e.g., their translation). For example, the optical mechanisms can control the trajectories of the respective energy beams through respective optical windows (which can also be referred to as windows), into the processing chamber, and to a target surface. In some embodiments, the first and second energy sources are configured to generate energy beams. The energy beams may be different in at least one energy beam characteristics. The energy beams may be the same in at least one energy beam characteristics. In some embodiments, the first and second energy beams are used together (e.g., sequentially and/or in parallel) during printing of a single layer of transformed material. In some embodiments, the first energy beam can be used to form a first layer of transformed material and second energy beam can be used to form a second layer of transformed material that is different than the first layer.

A window holder for supporting a window (e.g., an optical window) and/or at least partially shielding a window from debris can have any suitable hollow shape (e.g., cylindrical, polyhedron, e.g., prism, or a truncated cone). For example, the window may have a first cross-sectional shape, and the window holder may have the same or a different second cross sectional shape as the window. The first and/or second cross-sectional shapes may be a geometric shape (e.g., any polygon described herein). The first and/or second cross-sectional shapes may comprise a straight line or a curved line. The first and/or second cross-sectional shapes may comprise a random shape.

In some embodiments, a 3D printing system includes, or is operationally coupled with, one or more gas recycling systems. FIG. 14 shows a schematic side view of an example 3D printing system 1400 that is coupled with a gas recycling system 1403 in accordance with some embodiments. 3D printing system 1400 includes processing chamber 1402, which includes gas inlet 1404 and gas outlet 1405. The gas recycling system (e.g., 1403) of a 3D printing system can be configured to recirculate the flow of gas from the gas outlet (e.g., 1405) back into the processing chamber (e.g., 1402) via the gas inlet (e.g., 1404). Gas flow (e.g., 1406) exiting the gas outlet can include solid and/or gaseous contaminants such as debris (e.g., soot). In some embodiments, a filtration system (e.g., 1408) filters out at least some of the solid and/or gaseous contaminants, thereby providing a clean gas (e.g., 1409) (e.g., cleaner than gas flow 1406). The filtration system can include one or more filters. The filters may comprise physical filters or chemical filters. The clean gas (e.g., 1409) exiting the filtering mechanism (also herein “filtration system”) can be under lower pressure relative to the incoming gas pressure into the filtering mechanism. The clean gas therefore can be directed through a pump (e.g., 1410) to regulate (e.g., increase) its relative pressure prior to entry to the processing chamber. Clean gas (e.g., 1411) with a regulated pressure that exits the pump can be directed through one or more sensors (e.g., 1412). The one or more sensors may comprise a flow meter, which can measure the flow (e.g., pressure) of the pressurized clean gas. The one or more sensors may comprise temperature, humidity, oxygen sensors, or any other sensor disclosed herein. In some cases, the clean gas can have an ambient pressure or higher. The higher pressure may provide a positive pressure within the processing chamber (see example values of positive pressure described herein). A first portion of the clean gas can be directed through an inlet (e.g., 1404) of a gas inlet portion of the enclosure, while a second portion of the clean gas can be directed to first and/or second window holders (e.g., 1414 and 1416) that provide gas purging of optical window areas, as described herein. That is, the gas recycling system can provide clean gas to provide a primary gas flow for the 3D printing system, as well as a secondary gas flow (e.g., window purging). In some embodiments, the pressurized clean gas is further filtered through a filter (e.g., 1417) prior to reaching one or both of the window holders. In some embodiments, the filter(s) (e.g., as part of filters 1417 and/or filtration system 1408) are configured to filter out particles having nanometer-scale (e.g., about 10 nm to about 500 nm) diameters. In some embodiments, the gas recycling system provides clean gas to a recessed portion (e.g., 1418) of the enclosure.

In some embodiments, the 3D printing system comprises a window holder configured to hold an optical window. The window holder for supporting a window and/or at least partially shielding a window from debris can have any suitable shape (e.g., cylindrical, polyhedron, truncated cone, e.g., prism). For example, the window may have a first cross-sectional shape, and the window holder may have the same or a different second cross sectional shape as the window. The first and/or second cross-sectional shapes may be a geometric shape (e.g., any polygon described herein). The first and/or second cross-sectional shapes may comprise a straight line or a curved line. The first and/or second cross-sectional shapes may comprise a random shape. Window holder examples, 3D printers, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the distal container is configured to enclose and maintain a pressure above ambient pressure external to the distal container. The distal container (when closed with the lid) can be equipped with pressure release valve to prevent overpressure in the closed distal container. The distal container may be configured to hold a positive pressure that having a value (e.g., substantially) as the positive pressure in the processing chamber and/or gas conveyance system, e.g., as disclosed herein. The distal container may be configured to hold a positive pressure that is different from the positive pressure in the processing chamber and/or gas conveyance system. Different from can be lower or higher. The distal container may be configured to operatively coupled with at least one controller, e.g., a control system. The controller(s) may control the pressure in the distal container to reach a first maximum threshold. The container lid may comprise a pressure relief valve. The pressure relief valve may be configured to release pressure at a second maximum threshold level. The first maximum threshold level may be lower than the second maximum threshold level. The second maximum threshold level may be at least about 1.25*, 1.5*, 1.75* or 2* times the first maximum threshold level, with the symbol “*” designating the mathematical operation times. The second maximum threshold level can be a multiplier of the first maximum threshold level, the multiplier being from about 1.25* to about 2*. In an example, the nominal pressure in the closed distal container is from about 10 kilo Pascal (kPa) to about 20 kPa, the first maximum threshold level is about 25 kPa and the second maximum threshold level is about 40 kPa.

Examples. The following are illustrative and non-limiting examples of methods of the present disclosure.

Example 1: In a processing chamber, Inconel-718 powder having a diameter distribution of from about 15 micrometers (μm) to about 45 μm was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber, comprising robust gas including argon. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above ambient atmospheric pressure (e.g., above about 101 KPa), and was at ambient temperature. The atmosphere comprised a robust gas, e.g., including argon. The robust gas circulated in a gas conveyance system of the 3D printer. The robust gas accumulated debris during the printing. The debris in the gas was removed using a filtering system similar to the one depicted in FIG. 24, 2450 including a filter container and a distal container. The filtering operation comprised usage of the dilutive media comprising Poraver® beads. The removed debris accumulated in a distal container such as 2464. The distal container comprised the robust gas in a positive pressure of about 16 KPa above the atmospheric pressure in the ambient environment external to the distal container. The processing chamber was equipped with two optical windows made of sapphire in a configuration similar to the one depicted in FIG. 14, e.g., 1414 and 1416. Each laser beam was guided by an optical setup in an optical system enclosure, the optical system enclosure disposed above the processing chamber, the optical chamber comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. The layer dispensing mechanism formed a powder bed by sequential layerwise deposition, the powder bed being disposed in a build module above the build plate. The build plate was disposed above a piston. The build plate traversed down at increments of about 50 m at a precision of +/−2 am using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater. The debris (with the dilutive media) in the distal container was passivated with the liquid passivating material water, e.g., using a procedure similar to the one depicted in FIG. 29.

Example 2: In a processing chamber, Inconel-718 powder having a diameter distribution of from about 15 micrometers (μm) to about 45 μm was dispensed by a layer dispensing mechanism (e.g., recoater), the powder being dispensed above a build plate having a diameter of about 600 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The atmosphere comprised a robust gas, e.g., including argon. The robust gas circulated in a gas conveyance system of the 3D printer. The robust gas accumulated debris during the printing. The debris in the gas was removed using a filtering system similar to the one depicted in FIG. 25, 2560. The filtering system comprised the dilutive media comprising Poraver® beads. The removed debris and dilutive media accumulated in a distal container similar to 2574, comprising the robust gas at a pressure of about 16 KPa above ambient atmospheric pressure of the ambient environment external to the distal container. The processing chamber was equipped with eight optical windows made of sapphire in a configuration similar to the one depicted in FIG. 6, e.g., 680. Each laser beam was guided by an optical setup in an optical system enclosure, the optical system enclosure disposed above the processing chamber, the optical chamber comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. A user was able to view the laser beams during printing using a viewing window assembly similar to the one depicted in FIG. 8, 802 showing a circular viewing window. The viewing assembly comprise a reflective coating (as disclosed herein) facing the interior of the processing chamber. The layer dispensing mechanism formed a powder bed by sequential layerwise deposition, the powder bed being disposed in a build module above the build plate. The build plate was disposed above a piston. The build plate traversed down at increments of about 50 m at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater. The debris (with the dilutive media Poraver® beads) disposed in the distal container, was passivated with a liquid passivating material comprising water, e.g., using a procedure similar to the one depicted in FIG. 29.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A device for filtering debris generated by three-dimensional printing, the device comprising:
a distal container configured accommodate the debris filtered at a filtering container, the distal container being configured to reversibly engage and disengage with the filtering container during the filtering of the debris at the filtering container, the device being configured to facilitate a flow of the debris from the filtering container to the distal container, and (i) the device being configured to enclose an internal atmosphere having at least one characteristic different from an ambient atmosphere external to the device,
(ii) the device being configured to operatively couple with, or be a portion of, a three-dimensional printing system configured for the three dimensional printing, and (iii) the debris being a byproduct of the three-dimensional printing.

2. The device of claim 1, wherein the debris is prone to harmfully react with one or more reactive agents present in the ambient atmosphere, when the debris is exposed to the ambient atmosphere without further treatment comprising passivation or insulation; and wherein the debris comprises an elemental metal, or a metal alloy.

3. (canceled)

4. The device of claim 1, wherein the distal container includes a lid that comprises (a) gas inlet port, (b) gas outlet port, (c) one or more vents, (d) at least one inlet port for a quelling material, or (e) at least one outlet port for the quelling material and any quelling reaction product; wherein, the quelling material comprises (i) a passivating material or (ii) an insulating material; wherein the passivating material is configured to passivate the debris from reacting with a reactive agent present in the ambient atmosphere; and wherein the insulating material is configured to insulate the debris at least in part from contacting a reactive agent present in the ambient atmosphere.

5. (canceled)

6. The device of claim 1, wherein the distal container is configured to operatively couple to at least one sensor configured to sense (i) an amount of debris accumulating in the distal container and/or (ii) status of accumulation of material in the distal container, the material comprising the debris.

7. (canceled)

8. The device of claim 1, wherein the device is configured to facilitate connection and disconnection of the distal container from the filtering container during debris filtering at least in part by the distal container remaining coupled with a channel during its connecting to the filtering container and during its disconnecting from the filtering container; wherein the channel is disposed between the distal container and the filtering container; and optionally wherein the connection and/or disconnection is reversible.

9. The device of claim 1, wherein the device is configured to facilitate reversible connection and disconnection of the distal container from the filtering container during debris filtering at the filtering container and during accumulation of the debris and any dilutive media: (i) in the filtering container and/or (ii) in a collection container that is part of, or is operatively coupled with, the filtering container.

10. The device of claim 1, wherein the device is configured to facilitate a flow of the debris from the filtering container to the distal container; and wherein (i) the device is configured to enclose an internal atmosphere having at least one characteristic different from an ambient atmosphere external to the device,
(ii) the device is configured to operatively couple to, or be a portion of, a three-dimensional printing system printing in an atmosphere that (A) comprises at least one reactive agent at a concentration lower than in the ambient atmosphere and (B) is at a pressure above ambient pressure of the ambient atmosphere external to the three-dimensional printer.

11-46. (canceled)

47. A device for filtering debris generated by three-dimensional printing, the device comprising a lid comprising:
a first surface configured to being exposed to an ambient environment, the first surface comprising: a first inlet configured for receiving gas;
a second inlet configured for receiving a quelling material comprising passivating material or an insulating material;
a first outlet configured for expelling the gas;
a second outlet configured for expelling the quelling material; and
a third inlet configured for receiving the debris and any dilutive media, the device being configured to close an opening of the distal container configured accommodate the debris filtered at a filtering container, the lid being configured to reversibly engage and disengage with the filtering container during the filtering of the debris at the filtering container, the device being configured to facilitate a flow of the debris from the filtering container to the distal container, and wherein (i) the lid being configured to close the distal container such that the distal container closed by the lid is configured to enclose an internal atmosphere having at least one characteristic different from an ambient atmosphere external to the distal container when closed by the lid, (ii) the lid being configured to operatively couple with, or be a portion of, a three-dimensional printing system configured for the three dimensional printing, and (iii) the debris is a byproduct of the three-dimensional printing.

48. (canceled)

49. The device of claim 47, wherein the lid is configured to engage with a channel having a proximal end and an opposing distal end, the proximal end of the channel being configured to couple with the filtering container, and the distal end of the channel being configured to couple with the distal container.

50-51. (canceled)

52. The device of claim 47, wherein (A) the lid is configured to reversibly engage and disengage with a channel disposed between (i) the distal container and (ii) the lid of the filtering container closed by the lid.

53. (canceled)

54. The device of claim 47, wherein the second outlet is operatively coupled with an overfill prevention pipe, the at least one outlet port being for a quelling material comprising (i) a passivator or (ii) an insulator.

55. The device of claim 47, wherein the filtering container is configured to filter the debris by using (a) at least one filter disposed in the filtering container, (b) dilutive media disposed in the filtering container, and (c) gas flow in a first direction towards the filter during the filtering of the debris.

56. The device of claim 47, wherein the lid is configured to operatively couple with, or include, at least one sensor indicative of (i) an amount of debris accumulating in the distal container and/or (ii) status of accumulation of material in the distal container, the material comprising the debris; and optionally wherein the lid is configured to operatively couple to at least one sensor indicating that (i) a volume of any free volume in the distal container, (ii) an amount of any material in the distal container, which material in the distal container comprises the debris and/or (iii) a weight of the distal container with any of the material.

57. The device of claim 47, wherein the device is configured to facilitate a flow of the debris from the filtering container to the distal container closed by the lid, and wherein (i) the device is configured to enclose an internal atmosphere in the distal container closed by the lid, the internal atmosphere having at least one characteristic different from an ambient atmosphere external to the device, and (ii) the device is configured to operatively couple to, or be a portion of, the three-dimensional printing system; and optionally wherein a printing atmosphere (A) comprises at least one reactive agent at a concentration that is lower than that in the ambient atmosphere and/or (B) is at a pressure above ambient pressure of the ambient atmosphere.

58-61. (canceled)

62. A method for debris disposal, the method comprising:
a. transferring an amount of the debris into a distal container closed by a lid, the amount reaching a first threshold being a first maximum threshold;
b. inserting quelling material into the distal container to engage the quelling material with the debris and form a content of the distal container, the quelling material reaching a second threshold being a second maximum threshold, the quelling material comprising a passivating material or an insulating material; and
c. transferring the distal container for disposal of the debris, the distal container comprising the content, wherein (i) at least during operation (a) and (b), the distal container closed by the lid comprises an internal atmosphere having at least one characteristic different from an ambient atmosphere external to the distal container closed by the lid, (ii) the distal container being configured to operatively couple with, or be a portion of, a three-dimensional printing system configure for three dimensional printing, and (iii) the debris is a byproduct of the three-dimensional printing.

63. The method of claim 62, further comprising filtering the debris at least in part by using (a) at least one filter disposed in a filtering container, (b) dilutive media disposed in the filtering container, and (c) gas flow in a first direction towards the filter during the filtering of the debris.

64. The method of claim 62, further comprising (A) determining the first threshold based at least in part on measuring of an amount of the debris and any dilutive media in the distal container and/or (B) determining the second threshold based at least in part on using an overflow prevention pipe that is operatively coupled with the lid, or that is part of the lid, the overflow prevention pipe extending into an internal space of the distal container closed by the lid.

65. The method of claim 62, wherein the internal atmosphere comprises (A) comprises at least one reactive agent at a concentration that is lower than that in the ambient atmosphere and/or (B) is at a pressure above ambient pressure of the ambient atmosphere.

66. The method of claim 62, wherein the at least one three-dimensional object includes a material comprising an elemental metal, or a metal alloy.

67. The method of claim 62, further comprising engaging a distal end of a channel with the distal container, and engaging a proximal end of the channel with a filtering container, the distal end opposing the proximal end, the channel configured to convey the debris therethrough.

68-72. (canceled)
